(19) United States
(12) Patent Application Publication
(10) Pub. No.: US 2024/0303594 A1
(43) Pub. Date: Sep. 12, 2024

(54) ORDER FULFILLMENT USING STORE SECTIONS

(71) Applicant: Thomas Francis, Dubuque, IA (US)

(72) Inventor: Thomas Francis, Dubuque, IA (US)

(21) Appl. No.: 18/323,650

(22) PCT Filed: Nov. 29, 2021
(86) PCT No.: PCT/US2021/060966

§ 371 Date: May 25, 2023

Related U.S. Application Data
(60) Provisional application No. 63/118,836, filed on Nov. 27, 2020.

(51) Int. Cl. G06Q 10/087; G06Q 10/047

(52) U.S. Cl. CPC G06Q 10/087; G06Q 10/047

(57) ABSTRACT

A system includes a plurality of location indicators for arrangement throughout a store that includes a plurality of stocked items. Each of the location indicators defines a different area of the store. The system includes a computing system configured to generate a location map that defines a plurality of sections in the store. Each section includes a plurality of areas of the store defined by different location indicators. The location map defines how the sections and the areas are arranged. The system includes a mobile scanning device that is configured to wirelessly receive an electronic customer order including a plurality of ordered items. The mobile scanning device determines a location value associated with a location indicator and arranges at least some of the plurality of ordered items on the display based on the determined location value and the location map.

### CROSS-REFERENCE TO RELATED APPLICATION

This application is a National Stage entry of PCT Application No. PCT/US21/60966, filed on Nov. 29, 2021, which claims the benefit of U.S. Provisional Application No. 63/118,836, filed on Nov. 27, 2020. The disclosure of the above applications are incorporated herein by reference in their entirety.

### TECHNICAL FIELD

The disclosure relates to techniques for filling orders, and more particularly, to techniques for filling orders using mobile computing devices.

### BACKGROUND

Customers purchase products from a variety of different types of stores. Stores may sell a variety of different products or be limited to particular types of products. Example products include dry goods, grocery products, or any other items a customer may purchase. Different stores may have a variety of different sizes and layouts. Some stores may sell tens of thousands of products over a floor space covering tens of thousands of square feet. Stores may be referred to by different names, depending on the types of products sold at the store, the size of the store, the location of the store, and other factors. For example, a store may be referred to as a retail store, a grocery store, a supermarket, a hypermarket, a warehouse, a distribution facility, an outdoor market, or by another name.

Customers may interact with stores in a variety of different ways. In some scenarios, a customer may travel to the store and select products from within the store. Typically, the customer selects the desired products within the store and purchases the products at a checkout section of the store. In other scenarios, a customer may place an order for products from a location remote from the store (e.g., via the Internet or phone). In these scenarios, the purchased products may be shipped from the store to the customer's home.

### SUMMARY

In one example, the present disclosure is directed to a system comprising a plurality of stocked items arranged throughout a store for picking, wherein each of the stocked items is associated with one of a plurality of locations in the store. The system comprises a central computing system configured to receive a customer order that includes a plurality of ordered items indicating which of the stocked items are to be picked, determine historical movement of a user through a set of locations in the store, and generate a route for the customer order based on the historical movement of the user, wherein the route indicates a sequence in which one or more of the ordered items should be picked. The system comprises a mobile scanning device comprising a display. The mobile scanning device is configured to wirelessly receive the route from the central computing system and arrange items included in the route on the display based on the sequence indicated in the route.

In one example, the present disclosure is directed to a system comprising a plurality of stocked items arranged throughout a store for picking, wherein each of the stocked items is associated with one of a plurality of locations in the store. The system comprises a central computing system configured to receive a customer order that includes a plurality of ordered items indicating which of the stocked items are to be picked, determine historical item scans associated with a user, and generate a route for the customer order based on the historical item scans associated with the user, wherein the route indicates a sequence in which one or more of the ordered items should be picked. The system comprises a mobile scanning device comprising a display. The mobile scanning device is configured to wirelessly receive the route from the central computing system and arrange items included in the route on the display based on the sequence indicated in the route.

In one example, the present disclosure is directed to a system comprising a plurality of stocked items arranged throughout a store for picking, wherein each of the stocked items is associated with one of a plurality of locations in the store. The system comprises a central computing system configured to receive a plurality of customer orders, each including a plurality of ordered items indicating which of the stocked items are to be picked. The central computing system is configured to generate a route based on an item constraint parameter indicating a number of items that can be assigned to the route, wherein the route indicates a sequence in which one or more of the ordered items should be picked. The system comprises a mobile scanning device comprising a display. The mobile scanning device is configured to wirelessly receive the route from the central computing system and arrange items included in the route on the display based on the sequence indicated in the route.

In one example, the present disclosure is directed to a system comprising a plurality of location indicators for arrangement throughout a store that includes a plurality of stocked items for picking according to one or more electronic customer orders, wherein each of the location indicators defines a different area of the store. The system comprises a central computing system configured to generate a location map that defines a plurality of sections in the store, wherein each section includes a plurality of areas of the store defined by different location indicators, and wherein the location map defines how the sections and the areas are arranged. The system comprises a mobile scanning device comprising a display. The mobile scanning device is configured to wirelessly receive an electronic customer order comprising a plurality of ordered items indicating which of the stocked items are to be picked, determine a location value associated with a location indicator, and arrange at least some of the plurality of ordered items on the display based on the determined location value and the location map.

In one example, the present disclosure is directed to a system comprising a plurality of stocked items arranged throughout a store for picking, one or more mobile scanning devices, and a computing system configured to receive a plurality of customer orders that each include a plurality of ordered items indicating which of the stocked items are to be picked. The computing system is configured to determine a priority value for each of the customer orders, wherein the priority value indicates a level of picking priority for the customer order, wherein a first set of customer orders are associated with a first priority value, wherein a second set of customer orders are associated with a second priority value, and wherein the first priority value indicates a higher level of picking priority than the second priority value. The computing system is configured to select items from the first set of customer orders based on the first priority value associated with the first set of customer orders and assign the selected items from the first set of customer orders to the one or more mobile scanning devices.

In one example, the present disclosure is directed to a system comprising a plurality of stocked items arranged throughout a store for picking. The system comprises a computing system configured to receive a customer order that includes a plurality of ordered items indicating which of the stocked items are to be picked. The system comprises a mobile scanning device configured to render a graphical user interface (GUI) including a plurality of user-selectable location selection GUI elements, each of which indicates a different picking location in the store. The mobile scanning device is configured to receive user selection of a first one of the location selection GUI elements associated with a first location in the store, wherein the computing system is configured to assign items from the customer order in the first location to the mobile scanning device in response to the user selection.

In one example, the present disclosure is directed to a system comprising a plurality of location indicators for arrangement throughout a store that includes a plurality of stocked items for picking according to one or more electronic customer orders, wherein each of the location indicators is configured to transmit a different location signal that defines a different area of the store. The system comprises a central computing system configured to store a location map that defines a plurality of sections, wherein each section includes a plurality of areas of the store, and wherein the location map defines how the sections and the areas are arranged. The system comprises a mobile scanning device comprising a display. The mobile scanning device is configured to wirelessly receive an electronic customer order comprising a plurality of ordered items indicating which of the stocked items are to be picked, detect a location signal, and determine a current location of the mobile scanning device based on the detected location signal, wherein the current location indicates a current section and a current area including the mobile scanning device. The mobile scanning device is configured to arrange at least some of the plurality of ordered items on the display based on the current location and the location map.

In one example, the present disclosure is directed to a system comprising a plurality of location indicators for arrangement throughout a store that includes a plurality of stocked items for picking according to one or more electronic customer orders, wherein each of the location indicators includes a different readable code that defines a different area of the store. The system comprises a central computing system configured to store a location map that defines a plurality of sections, wherein each section includes a plurality of areas of the store, and wherein the location map defines how the sections and the areas are arranged. The system comprises a mobile scanning device comprising a display. The mobile scanning device is configured to wirelessly receive an electronic customer order comprising a plurality of ordered items indicating which of the stocked items are to be picked, scan a readable location indicator, and determine a current location of the mobile scanning device based on the scanned readable location indicator, wherein the current location indicates a current section and a current area including the mobile scanning device. The mobile scanning device is configured to arrange at least some of the plurality of ordered items on the display based on the current location and the location map.

In one example, the present disclosure is directed to a system comprising a plurality of stocked items arranged throughout a store for picking and a central computing system configured to receive a customer order that includes a plurality of ordered items indicating which of the stocked items are to be picked, wherein each of the ordered items is associated with a location in the store. The central computing system is configured to store a location map that defines a plurality of sections in the store, wherein each section includes a plurality of locations in the store defined by different location indicators, wherein the location map defines how the sections and the locations are arranged, and wherein the location map includes junctions that represent physical transitions between the sections. The central computing system is configured to generate a route for the customer order using the location map, wherein the route indicates a sequence in which one or more of the ordered items should be picked. The system comprises a mobile scanning device comprising a display. The mobile scanning device configured to wirelessly receive the route from the central computing system and arrange items included in the route on the display based on the sequence indicated in the route.

In one example, the present disclosure is directed to a system comprising a plurality of stocked items arranged throughout a store for picking and a central computing system configured to receive a customer order that includes a plurality of ordered items indicating which of the stocked items are to be picked, wherein each of the ordered items is associated with a location in the store. The central computing system is configured to store a location map that defines a plurality of sections in the store, wherein each section includes a plurality of locations in the store defined by different location indicators, wherein the location map defines how the sections and the locations are arranged, wherein the location map includes junctions between adjacent locations, and wherein a subset of the junctions are between the sections. The central computing system is configured to generate a route for the customer order using the location map, wherein the route indicates a sequence in which one or more of the ordered items should be picked. The system comprises a mobile scanning device comprising a display. The mobile scanning device is configured to wirelessly receive the route from the central computing system and arrange items included in the route on the display based on the sequence indicated in the route.

### BRIEF DESCRIPTION OF THE DRAWINGS

FIG. 1 shows an example implementation of an order filling system (OFS) implemented in a store.

FIGS. 2A-2D illustrate a central computing system (CCS) and a third-party computing system (TPCS) communicating with a plurality of customer computing devices.

FIGS. 3A-3B show perspective views of example racks of a store.

FIGS. 4A-9 show example racks including location indicators in different locations.

FIGS. 10A-10C show example location indicators that transmit location signals.

FIGS. 11A-11C show different example readable codes which may be used as location indicators.

FIGS. 12-18 illustrate example arrangements of location indicators and associated location values that are associated with different areas of a store.

FIGS. 19A-22B show example stores and associated location maps.

FIGS. 23A-23B show an example store and an associated location map including items.

FIGS. 24-25 show functional block diagrams of example mobile scanning devices (MSDs).

FIGS. 26A-26I show example MSD form factors.

FIG. 27 shows the placement of customer orders with a CCS and wireless transmission of the customer orders to MSDs.

FIGS. 28A-28C show how multiple MSDs may display customer orders to users.

FIGS. 29A-29B show example communications between MSDs and a CCS.

FIGS. 30A-30C show the store and the MSDs of FIGS. 28A-28C after the MSDs have moved through the store and some items have been picked.

FIGS. 31A-31C show how a display of an MSD may be updated as the MSD is moved throughout a store.

FIGS. 32A-32E show displays of multiple MSDs and how the displays are updated when items are picked.

FIG. 33 is a method that describes operation of an OFS from the time a customer order is received until the order is provided to the customer.

FIG. 34 is a method that describes operation of an MSD configured to receive location signals.

FIG. 35 is a method that describes operation of an MSD configured to scan location indicators that include readable codes.

FIG. 36 is a method that describes operation of an MSD when items are picked by the MSD and other MSDs.

FIGS. 37A-37E show generation of an item association table and updating of the item association table.

FIG. 38 illustrates a method for generating an item association table.

FIGS. 39A-39C illustrate GUIs for an MSD in an item association mode.

FIG. 40 illustrates an example method for generating a location map.

FIGS. 41A-41D illustrate automatic generation of a location map using a single MSD.

FIGS. 42A-42F illustrate automatic generation of a location map using multiple MSDs.

FIGS. 43A-43B illustrate automatic updating of a location map upon the introduction of a location indicator to the store.

FIGS. 44A-44B illustrate automatic updating of a location map in response to loss of a location indicator.

FIGS. 45A-45B illustrate an example store including a plurality of items and an item adjacency map indicating adjacency of the items.

FIGS. 46A-46C illustrate example item scan time data and item adjacency maps generated based on the item scan time data.

FIG. 47 illustrates a method describing operation of an MSD configured to generate an item adjacency map indicating adjacency of a plurality of items.

FIG. 48 illustrates an example store including a plurality of items.

FIG. 49 illustrates an example item adjacency map indicating adjacency of a plurality of items included in a store.

FIG. 50 illustrates a method describing operation of an MSD configured to display a plurality of items based on an associated item adjacency map.

FIG. 51 illustrates an example CCS that generates tables and maps based on scan data from a plurality of MSDs.

FIG. 52 illustrates an example method for generating an item adjacency map.

FIGS. 53A-53B illustrate example clusters of items.

FIG. 54 illustrates an example method for generating, using, and updating an item adjacency map.

FIG. 55 illustrates an example method for using an item association table, location map, and item adjacency map.

FIGS. 56A-56D illustrate an example implementation of the OFS that uses location indicators and item adjacency mapping.

FIGS. 57A-57D illustrate an example implementation of the OFS that uses item adjacency and directionality to display items.

FIG. 58 illustrates an example image of a rack that includes a plurality of items.

FIGS. 59A-60B describe communication between MSDs and the CCS with respect to generating image-based maps and/or picking items based on acquired images.

FIGS. 61A-61B illustrate example camera directions, orientations, and fields of view.

FIGS. 62A-62B illustrate multiple images of items on the same rack.

FIG. 63 illustrates a box of Kellogs Froot Loops cereal including portions that may be used to identify the item.

FIGS. 64A-64C illustrate example store objects that the CCS and/or MSDs may identify.

FIGS. 65A-66B illustrate portions of stores that include object-based zones.

FIG. 67 illustrates an example method for making maps including object-based zones.

FIGS. 68A-68B illustrate example methods for generating maps and picking items.

FIGS. 69A-69C illustrate features of an inventory system.

FIGS. 70A-70C illustrate features of an advertisement system.

FIGS. 71-89B illustrate example features of an OFS associated with generating routes, updating routes, and displaying routes in GUIs.

FIGS. 90-94B illustrate example stores and maps including sections.

FIGS. 95A-95B illustrate determination and usage of priority values for orders and items.

FIGS. 96A-96B illustrate example GUIs for picking a route associated with a plurality of sections.

FIGS. 97A-97B illustrate example GUIs that provide for user selection of picking locations and items.

### DETAILED DESCRIPTION

An order filling system (OFS) of the present disclosure may be used to fill orders (e.g., customer orders) for a variety of different products. The OFS may be implemented in a variety of different locations (e.g., a retail store, a warehouse, an outdoor market, etc.). Although the OFS is generally described herein as being implemented in a store (e.g., a grocery store) to fill customer orders, the OFS may be implemented in other locations to fill other types of orders. For example, the OFS may be implemented in a warehouse or other building to fill warehouse orders. As used herein, a “store” may generally refer to any location in which the OFS may be implemented (e.g., a retail store, grocery store, warehouse, outdoor market, etc.).

The OFS of the present disclosure may include a central computing system (CCS) and one or more mobile scanning devices (MSDs). In some implementations, the OFS may include one or more location indicators. Although the OFS may include one or more location indicators, some features of the OFS described herein may not require location indicators. Although various features (e.g., various computing operations) of the OFS may be attributed to the CCS and one or more MSDs, the CCS and MSDs may generally implement any of the OFS features (e.g., various computing operations) alone or in combination. For example, one or more MSDs may implement features attributed to the CCS herein. As another example, the CCS may implement one or more features attributed to the MSDs herein.

The CCS may receive electronic customer orders from customer computing devices (CCDs) via a computer network, such as the Internet. The CCDs may include any type of computing device used by customers to place orders with the CCS. For example, the CCDs may include cell phones, tablet computers, laptop computers, desktop computers, wearable computers, or other computing devices. Each of the customer orders may include one or more items located in the store (e.g., arranged on racks). An item may generally refer to any type of product that may be picked from the store (e.g., items for purchase by a customer and/or inventory included in a factory/warehouse). For example, an item may be a food product, a personal hygiene product, an electronic product, or any other product in inventory in the store.

The CCS, which may be located within/outside the store, may wirelessly transmit the customer orders to one or more of the MSDs. For example, the CCS may include wireless communication functionality (e.g., Bluetooth, IEEE 802.11, cellular, etc.) for wirelessly transmitting the customer orders to the MSDs. The MSDs, which may be transported throughout the store by users, may wirelessly receive the customer orders and display the customer orders to the users so that the users may fill the customer orders transmitted to the MSDs. In general, the users may be employees (e.g., store employees/contractors) that transport the MSDs around the store while filling the customer orders displayed on the MSDs. In some examples, the MSDs may be configured to be held in the users' hands. In other examples, the MSDs may be placed in carts (e.g., a shopping cart, basket, or similar cart for carrying items), which may be pushed around the store by users while the users gather items to fill customer orders. In still other examples, the MSDs may be configured to attach to a user (e.g., around the forearm of a user or as a display worn on a user's head). In some implementations, the CCS is present in a location other than the store. In these implementations, the CCS transmits the customer orders to the MSDs in a similar manner as described herein using any of a variety of different wireless transmission techniques (e.g., via the Internet and an intermediate computing device that is located within the store or via cellular communication).

In some cases, the customer may use an MSD owned by the store to pick their own customer orders. In some cases, the functionality of the MSD may be included on a CCD (e.g., a customer's smartphone). In these cases, the customer may place the order using their own CCD and then pick the order using their own CCD, which may have the functionality of an MSD described herein. In other cases, the customer may place their order using a first CCD (e.g., their laptop or desktop computer) and then pick the order using a second CCD (e.g., their smartphone).

The users may begin filling the customer orders by gathering (i.e., picking) the items displayed on the MSDs. After gathering the items, one or more of the users may assemble (e.g., pack) the customer orders from the gathered items (e.g., in a store packing area). Subsequently, the customer that placed the customer order with the CCS may receive the filled customer order. In some examples, the customer may pick up the filled customer order at the store. In other examples, the filled customer order may be delivered to the customer (e.g., at the customer's home).

Each of the items in the store may be associated with an item indicator (e.g., a barcode/sticker/RFID), which may be located along with the item, such as on the item (e.g., a barcode), attached to the item (e.g., a sticker/tag), or located with the item (e.g., an RFID tag within the item's box). In general, an item indicator may be any object or device that the MSDs/CCS can use to identify (e.g., uniquely identify) the item. For example, the item indicators may be barcodes or analogous indicators. In some examples, the MSDs may scan the item indicators (e.g., scan the barcodes) and identify the items based on the scanned item indicators. In other examples, the item indicators may generate item signals (e.g., via a RFID device). For example, the item indicators may wirelessly transmit the item signals. The MSDs may receive the transmitted item signals and determine one or more items located within the store based on the detected item signals. The item indicators may be scanned by the MSDs or transmit item signals in a variety of different ways. Similarly, the MSDs may be configured to scan the item indicators or detect the transmitted item signals in a variety of different ways. Examples of item indicators, item signals, and of scanning the item indicators or detecting the item signals by an MSD are described hereinafter in more detail. In some examples, an item indicator is associated with a single item. In other examples, an item indicator is associated with multiple items. In still other examples, multiple item indicators are associated with a single item.

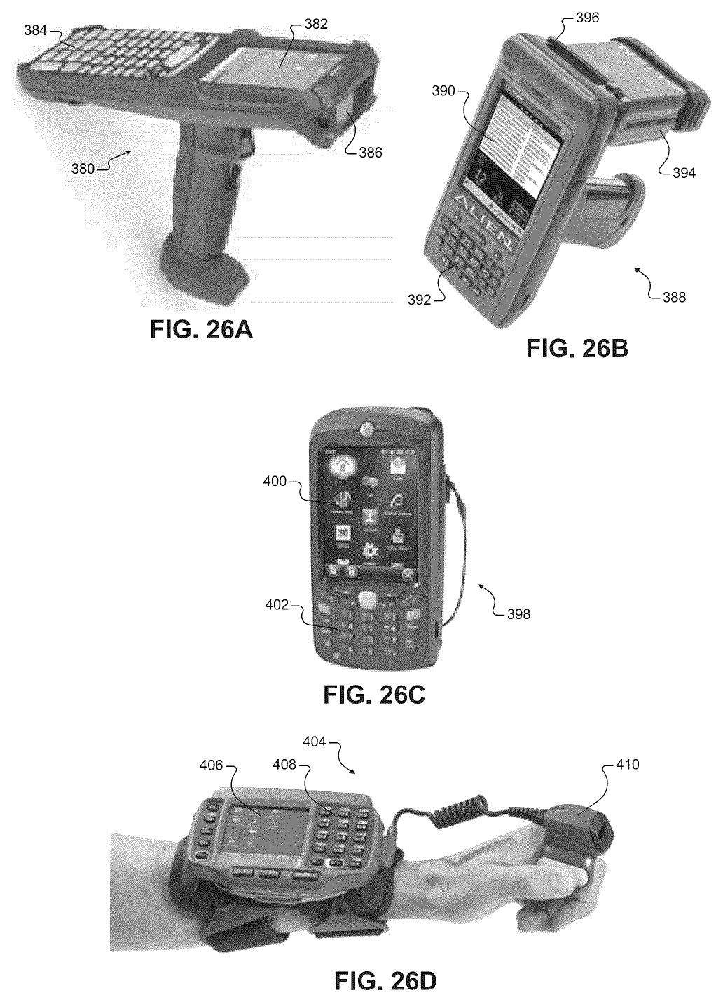

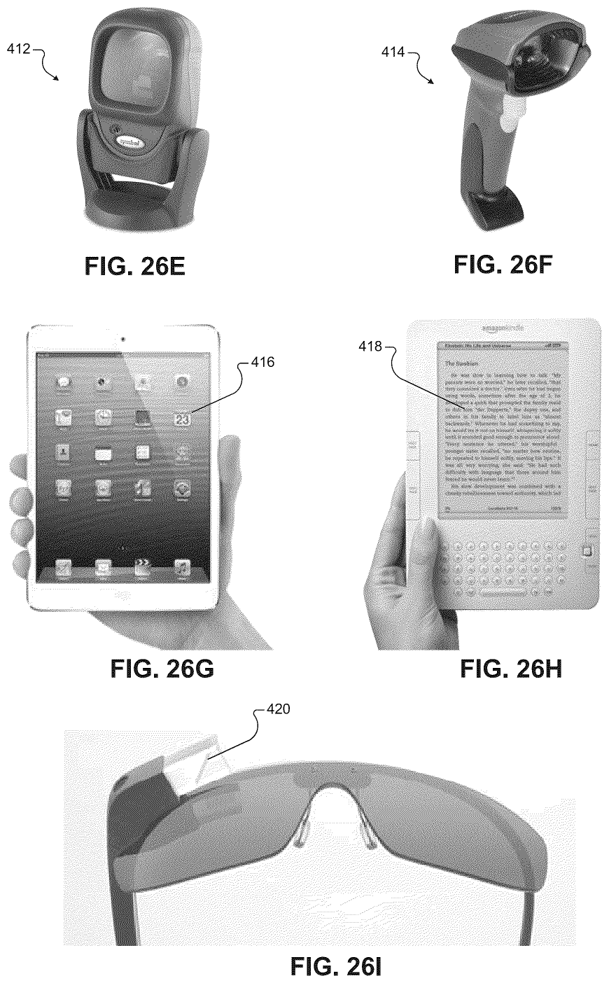

The MSDs may have a variety of different configurations. For example, the MSDs may have a variety of different form factors and different functionalities, depending on how the OFS is implemented in the store. As described herein, the MSDs may have handheld form factors and/or be configured to be placed in carts and pushed by a user. Example form factors are illustrated and described in FIGS. 26A-26I.

The MSDs may include wireless communication functionality (e.g., IEEE 802.11, Bluetooth, cellular, etc.) for communicating with the CCS, other MSDs, and/or other wireless devices. For example, the MSDs may receive customer orders wirelessly from the CCS/Internet and indicate to the CCS and/or other MSDs when items from the customer orders have been scanned.

An MSD may also include a display for displaying information to the user. In some examples, the display may be a liquid crystal display (LCD), an organic light-emitting diode (OLED) display, an electrophoretic display, or be implemented using other display technologies. For example, an MSD having a handheld form factor may include an LCD display. In other examples, an MSD having a head-mounted form factor may include a head-mounted display.

The MSD display may display the items of the customer orders to the users. Additionally, the MSD display may display information to the users other than the customer orders. The users may view the items on the display and subsequently pick the items from racks or other containers in the store. The users may then scan the items (e.g., scan barcodes on the items) and take the items to an area in the store (e.g., a collection/packing area) where the orders may be bagged for customer pickup or delivery.

A customer order may include one or more items. For example, an item included in a customer order may be any product that a customer may purchase at the store. In some examples, the customer order may include a plurality of grocery items, such as cereal, canned food, chicken, milk, ice cream, eggs, fruits, vegetables, etc. In some examples, a customer order may include other items available at a retail store, such as personal hygiene items (e.g., shampoo, razor blades, and soap). A customer order may also include items such as movies, videogames, and electronic devices.

An item indicator corresponding to an item located within the store may be associated with an item identification code (hereinafter, “item ID code”). An item ID code, as used herein, may generally refer to any code (e.g., alphanumeric or other type of code) that may be associated with an item located within the store that serves to identify that item (e.g., uniquely identifies the item). Each item in the store may be associated with, or identified by, an item ID code. In some examples, an item ID code corresponding to an item may be acquired by scanning an item indicator associated with the item, such as a barcode (e.g., 1 or 2 dimensional barcode) present on the item. The barcode may be printed on packaging of the item and/or or printed on a sticker attached to packaging of the item. In other examples, the item ID code may be retrieved from an item signal transmitted by the item indicator, such as an RFID device (e.g., an RFID tag or other RFID form factor) attached to packaging of the item and/or included in packaging of the item. In still other examples, the item ID code may be a number (e.g., a product look-up code) printed on the item indicator (e.g., an adhesive label attached to the item) that may be entered manually by a user. Such a code may be used to identify produce items (e.g., fruits and vegetables), for example.

An MSD may acquire an item ID code in a variety of different ways, depending on the type of item ID code associated with the item. As described herein, an item ID code may be acquired from a barcode, an RFID tag, or may be manually entered by a user. In some examples, an MSD may include a scanning module configured to scan barcodes to retrieve the item ID code. In some examples, an MSD may include a scanning module configured to acquire item ID codes from RFID tags. For example, as described herein, the MSD may scan/acquire an item ID code corresponding to a particular item by detecting an item signal transmitted by an RFID tag associated with the item. In some examples, an MSD may include a user interface (e.g., touchscreen and/or buttons) configured to receive user input, such as manually-entered item ID codes. Although an item ID code may be acquired via a barcode, an RFID tag, or be manually-entered in some examples, it is contemplated that other types of item ID codes and modes of acquisition may be implemented. It is also contemplated that an MSD may be configured to acquire other types of item ID codes.

A customer order may be identified by a customer order identification number (hereinafter, “order ID number”). An order ID number may generally refer to any code (e.g., alphanumeric or other type of code) that may be associated with a customer order that serves to identify that customer order (e.g., uniquely identifies the customer order). In some examples, the CCS may assign each customer order a different order ID number that may uniquely identify that customer order. Each of the items included in the customer order may also be associated with the order ID number.

A store may include location indicators that indicate locations in the store. In some implementations, location indicators may transmit location signals that indicate the location within the store, such as a location within an aisle. In some implementations, location indicators (e.g., readable location indicators) may be objects (e.g., printed barcodes) including codes that indicate a location within a store. An MSD may scan (e.g., read) a readable location indicator to determine a location in the store associated with the location indicator.

The CCS and/or MSDs may generate item association tables that indicate the location of items relative to location indicators. For example, the item association tables may include items and associated location values determined from the location indicators near the items. The CCS and/or MSDs may also generate location maps that indicate how areas associated with location indicators (e.g., near location indicators) are arranged relative to one another in the store. The CCS and/or MSDs may map the store using the item association tables and location maps. The MSDs may use the item association tables and location maps to efficiently pick items from customer orders.

Additionally, or alternatively, the CCS and/or MSDs may generate item adjacency maps that indicate the location of items relative to one another. In some cases, the CCS and/or MSDs may generate the item adjacency maps based on scan times between consecutively scanned items. For example, scanning two items within less than a threshold amount of time may indicate that the items are near each other (e.g., less than a threshold distance from one another). The CCS and/or MSDs may generate and update item adjacency maps to indicate the items that are adjacent to one another. The CCS and/or MSDs may map the store using the item adjacency maps alone, or in combination with the item association tables and location maps. The CCS and/or MSDs may also use the item adjacency maps alone, or in combination with the item association tables, to efficiently pick items from customer orders.

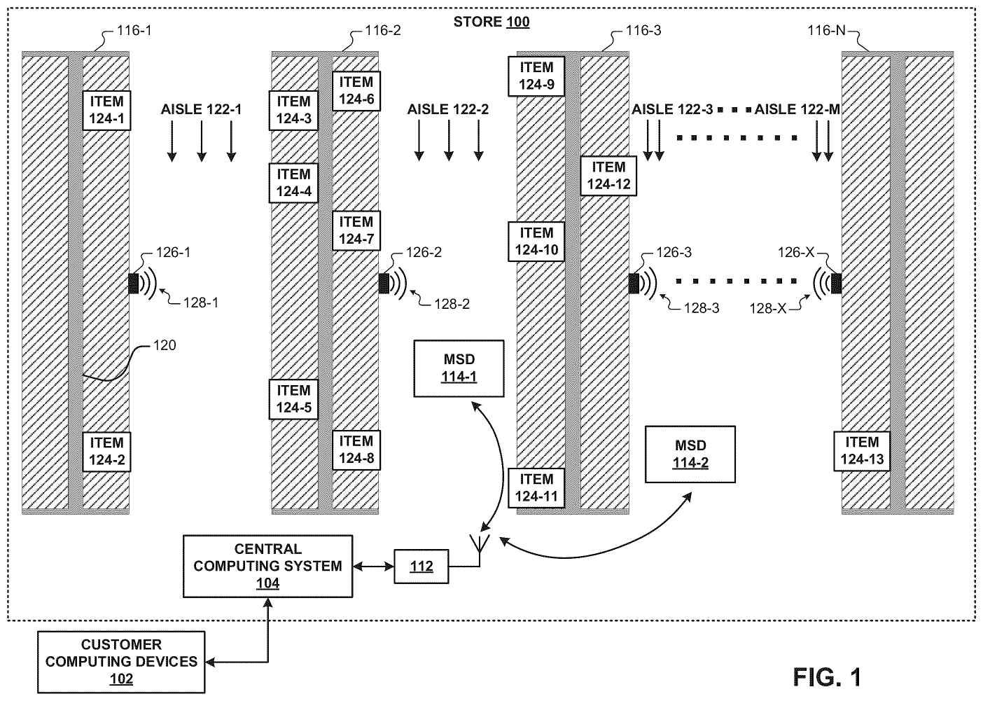

FIG. 1 shows an example implementation of an OFS implemented in a store 100. Store 100 is illustrated as a dotted box. Store 100 may represent any building structure that may house the items described herein. Although store 100 is generally described herein as a grocery store, supermarket, big-box store, hypermarket, etc., it is contemplated that the systems and methods for filling orders described herein may be applicable to other types of businesses and buildings, such as warehouses (e.g., a manufacturer or retailer warehouse), factories, distribution centers (e.g., a manufacturing or retail company distribution center), convenience stores, shopping plazas, or outdoor markets.

Customers may place customer orders to have filled at store 100 using CCDs 102. A CCS 104 may receive the customer orders from CCDs 102. A CCD 102 may include any electronic device that a customer may use to place a customer order. For example, a CCD 102 may include a desktop computer or a mobile computing device such as a laptop computer, smart phone, or tablet computer. In some examples, CCDs 102 may be devices that are located external to store 100. In these examples, CCS 104 may be configured to receive the customer orders from CCDs 102 via the Internet, or other computer network. In other examples, CCDs 102 may be located in store 100. For example, CCDs 102 may be mobile computing devices that customers have brought into store 100. As an additional example, store 100 may include CCDs 102 (e.g., desktops or kiosks) that may be used by the customers to place customer orders.

CCS 104 may implement a variety of different functions. In general, CCS 104 may refer to one or more of a variety of computing devices configured to provide the functionality described herein. For example, CCS 104 may include computer networks, servers (e.g., web servers), data stores, routers, software, etc. Although CCS 104 is illustrated as included in store 100 (e.g., FIG. 1), a portion of CCS 104, or all of CCS 104, may be located outside of store 100 in some examples. Put another way, CCS 104 may include one or more different computing devices that are located at one or more locations within or outside of store 100.

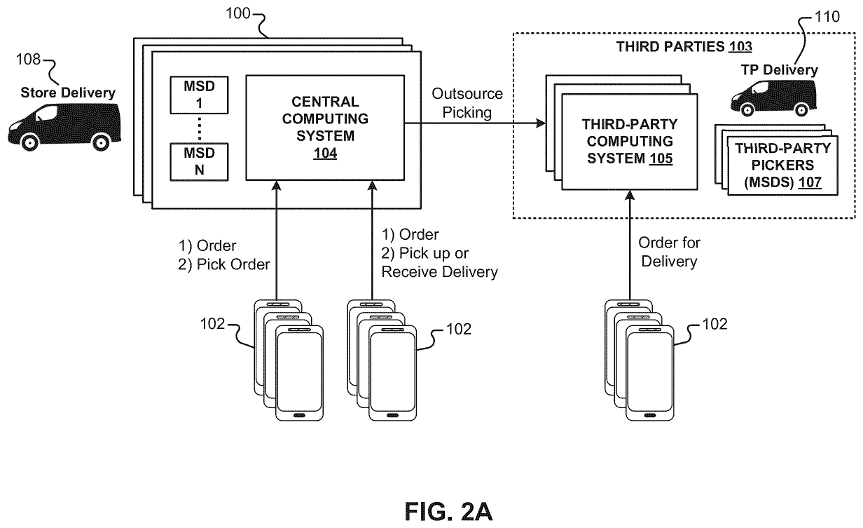

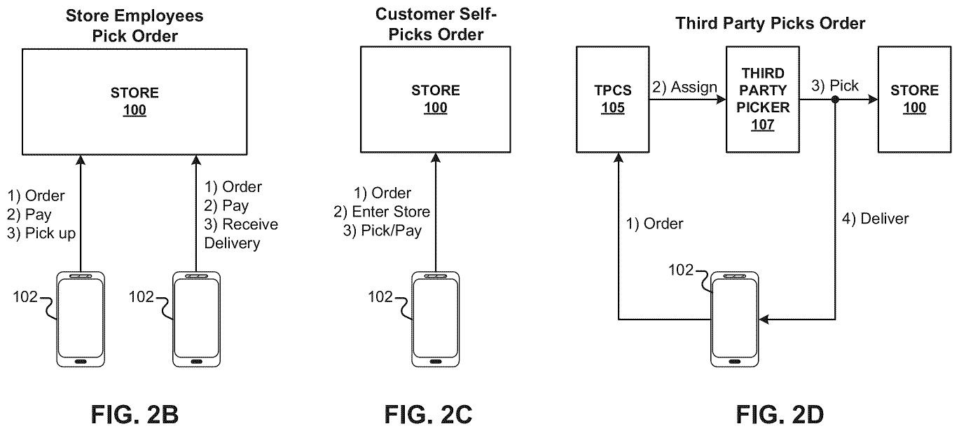

Referring to FIG. 2A, CCS 104 may be configured to communicate with a plurality of CCDs 102 via a computer network (e.g., the Internet). CCS 104 may provide electronic commerce (i.e., ecommerce) functionality so that customers may use CCDs 102 to place customer orders with store 100. In some examples, CCS 104 may provide online shopping functionality. For example, CCS 104 may provide a shopping website to CCDs 102 or provide other data to an application running on CCDs 102 so that customers may place electronic customer orders with store 100 using CCDs 102. The shopping website or other data provided to CCDs 102, may include information related to items the customer may order at store 100, such as item names, prices, availability, and reviews.

A customer may place an electronic customer order that includes one or more items. In some examples, the customer may place a customer order via a website accessed using a CCD 102. In other examples, a customer may place a customer order via a dedicated software application (e.g., an “app”) running on a CCD 102, such as a mobile phone or a tablet computer. CCS 104 may be configured to accept payment for the customer order (e.g., using a credit card). Additionally, or alternatively, a customer may pay for the customer order in store 100 (e.g., using a credit card, check, or cash).

After a customer order is placed, CCS 104 may transmit (e.g., wirelessly transmit) the customer order to one or more MSDs. The users in store 100 may then pick each of the items of the customer order and pack the items of the customer order for customer pickup or delivery. In some examples, CCS 104 may notify the customer that the customer order has been picked by sending a notification to a CCD 102 (e.g., a text message, email, and/or notification via a shopping application).

FIG. 2A illustrates a plurality of stores 100 that may each include a CCS 104 and MSDs for picking items. In some implementations, third parties 103 (e.g., business other than the store) may operate third-party computing systems 105 (“TPCS 105”) that include similar functionality as the CCS 104. TPCS 105 may be configured to communicate with CCDs 102 via a computer network (e.g., the Internet). TPCS 105 may provide electronic commerce (i.e., ecommerce) functionality so that customers may use CCDs 102 to place customer orders with the third parties. For example, TPCS 105 may provide online shopping functionality, such as a shopping website or other application running on CCDs 102 so that customers may place electronic customer orders with the third parties using CCDs 102. A customer may place an electronic customer order that includes one or more items with TPCS 105.

After a customer order is placed with TPCS 105, TPCS 105 may transmit the customer order to one or more third-party MSDs 107 being used by third-party pickers (e.g., employees/contractors of the third-party businesses). The third-party MSDs 107 may include similar form factors and functionality as MSDs used by the store 100. For example, third-party MSDs 107 may include personal computing devices (e.g., smartphones or tablets) and/or specific hardware for picking customer orders. The third-party pickers may be located remotely from the store 100 when the customer order is received. In these cases, third-party MSDs 107 may receive customer orders via the Internet or other communication system. After receiving a customer order, a third-party picker may pick each of the items of the customer order and pack the items of the customer order for delivery by the third party. For example, the third-party picker may deliver the picked order or have another third-party delivery service 110 deliver the order. In some cases, a customer may pick up an order at the store 100 that was picked by a third party. In some examples, TPCS 105 may notify the customer that the customer order has been picked by sending a notification to a CCD 102.

FIGS. 2A-2D illustrate a plurality of scenarios in which customer orders may be picked by one or more parties. In one example, a customer may use a CCD 102 to place a customer order with the CCS 104 and subsequently pick the order from the store. In this example, the customer may use their CCD that placed the customer order (or another CCD) as an MSD to pick the order. Alternatively, a customer may use an MSD provided by the store to pick their own order. In another example, a customer may use a CCD to place a customer order with the CCS that is then picked by users (e.g., employees) in the store 100. The customer may then pick up the filled customer order or have the order delivered. FIGS. 2B-2C further illustrate these scenarios.

In another example, the customer may use a CCD 102 to place a customer order with a TPCS 105. The TPCS 105 may assign the order to a third-party MSD 107 (e.g., a third-party picker) that may pick the items from the store 100. The third-party picker may then deliver the filled customer order to the customer. FIG. 2D further illustrates the scenario of a third-party picking service being used by the customer. FIG. 2A illustrates another example scenario in which the customer places a customer order with the CCS 104, and the CCS 104 subsequently outsources the picking of the order to a third party via the TPCS 105.

Note that FIG. 2A illustrates a plurality of delivery options. In some implementations, the store 100 may operate a delivery service 108 that delivers customer orders to the customers. In other implementations, the third-party pickers 107 may deliver the customer orders to the customers. In other implementations, third parties may operate delivery services 110 (e.g., delivery-only services) that deliver customer orders for the store 100 and/or other third-party pickers.

The various features (e.g., mapping/picking) of the OFS attributed to the CCS and/or MSDs herein may also be provided by the TPCS, third-party MSDs, and CCDs. For example, the TPCS may receive customer orders, store one or more tables and maps for one or more stores, and send the tables and maps to store MSDs, third-party MSDs, and/or CCDs. As another example, any features of the CCS and/or MSDs described herein, such as processing and communication features, may be implemented by the TPCS and/or the third-party MSDs. As another example, the CCS and/or TPCS may communicate with the MSDs, third-party MSDs, and/or CCDs in a similar manner described herein with respect to the CCS and the MSDs.

Referring back to FIG. 1, the OFS may include a wireless communication system 112 (hereinafter “communication system 112”) configured to provide wireless communication functionality within store 100. Communication system 112 may represent electronic hardware and software that provides wireless communication functionality with a plurality of wireless devices within store 100. For example, communication system 112 may include one or more wireless routers, antennas, and other devices that facilitate communication with wireless devices in store 100. In some examples, communication system 112 may provide wireless communication using Bluetooth, IEEE 802.11, and/or another wireless communication technology. In some examples, the one or more MSDs may communicate via a communication system that includes components that are external to store 100, such as via cellular communication.

The OFS includes one or more MSDs (e.g., MSD 114-1 and/or MSD 114-2). MSD 114-1 and MSD 114-2 may be referred to collectively as “MSDs 114.” MSDs 114 may be transported throughout store 100 by users. Although two MSDs 114 are illustrated in FIG. 1, it is contemplated that more than two MSDs may be included in the OFS of the present disclosure. It is also contemplated that only a single MSD may be used in some implementations of the OFS of the present disclosure.

Communication system 112 may communicate with MSDs 114. For example, communication system 112 may transmit data (e.g., customer orders) to MSDs 114 and receive data from MSDs 114. Communication system 112 may also communicate with CCS 104. For example, communication system 112 may receive data from CCS 104 and transmit the received data to MSDs 114. As another example, communication system 112 may receive data from MSDs 114 and transmit data to CCS 104. Accordingly, MSDs 114 may communicate (e.g., transmit/receive data) with CCS 104 via communication system 112. In some implementations, CCS 104 may communicate with MSDs 114 via communication systems outside of store 100, such as via cellular communication.

In some implementations, the users (e.g., pickers) and their MSDs (e.g., cell phones) may be located outside of the store. For example, the users may be employees of the store that are offsite performing other services, such as delivering filled orders. As another example, the users may be store employees/contractors that pick/deliver items for the one or more stores. In these cases, a user MSD may receive a customer order from the Internet (e.g., via a cellular connection) and use their MSD (e.g., cell phone) in the store to pick the customer order.

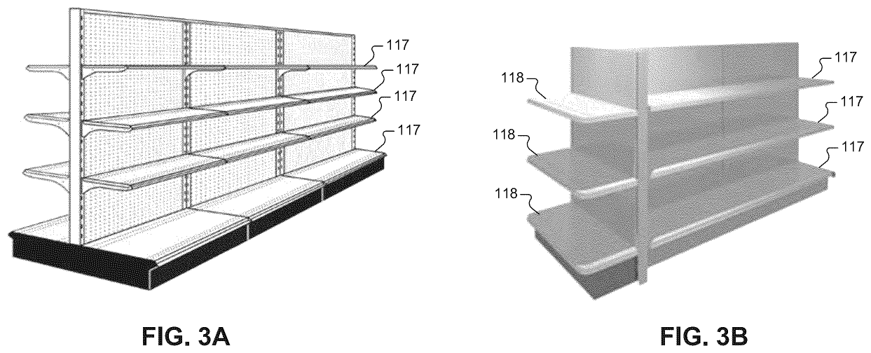

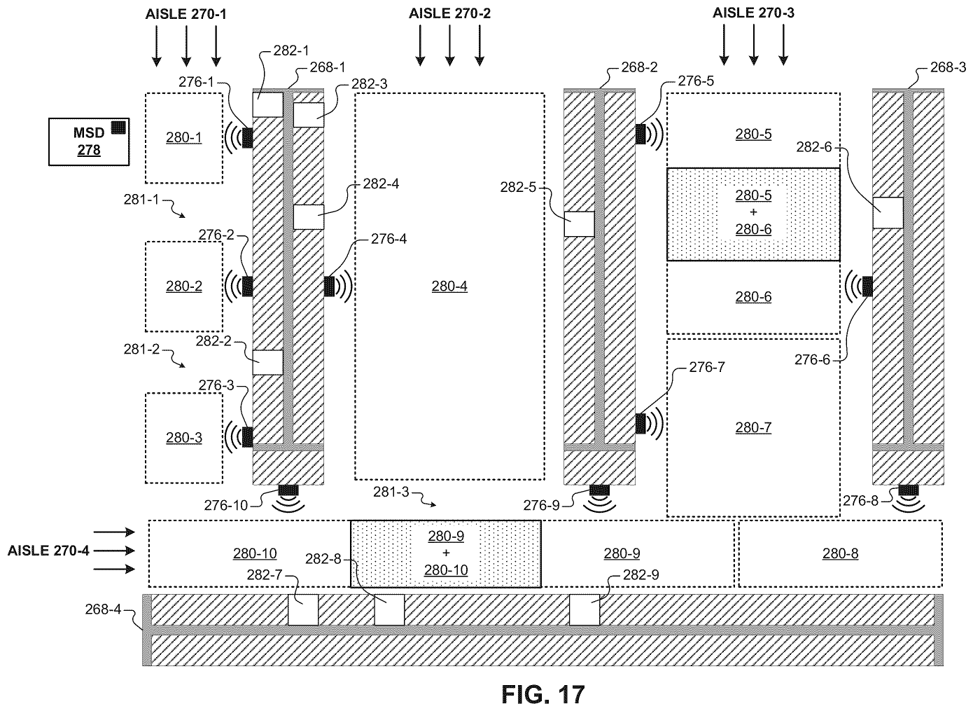

Store 100 includes racks 116-1, 116-2, 116-3, . . . , and 116-N (collectively “racks 116”). Racks 116 may represent any type of structure used to hold items. Racks 116 in FIG. 1 are illustrated from a top down perspective. The material (e.g., metal) that forms racks 116 is represented by gray shaded areas. Space on racks 116 for the storage of items is illustrated as hashed regions. In some figures (e.g., FIG. 1), specific items included in customer orders are illustrated and labeled (e.g., items 124-1 to 124-13 in FIG. 1). Illustrations of racks 116 herein are meant to represent a top down view of racks/shelving that are typically found in retail and grocery stores. Example 3D perspective views of racks 116 are shown in FIG. 3A and FIG. 3B. FIG. 3A shows a perspective view of racks 116 illustrated in FIG. 1 that include space on shelves 117 for storage of items. FIG. 3B shows a similar rack that includes shelves 117 and an end portion 118. The rack shown in FIG. 3B is illustrated in a top down perspective in FIG. 17, for example.

Racks (e.g., racks 116) described herein are not limited to the types of racks illustrated in FIG. 3A and FIG. 3B. Instead, racks 116 may represent any type of structure used to hold items, such as shelving, bins, baskets, pallets, and hooks. Racks 116 may also represent refrigerated storage units including, but not limited to, beverage refrigerators, display coolers/freezers, and walk-in refrigerators/freezers. In some examples, racks 116 may be mobile. For example, racks 116 may include pallets or carts having wheels.

Each of racks 116 illustrated in FIG. 1 include space for items (hashed regions) and a dividing portion (e.g., dividing portion 120 of rack 116-1) that divides the spaces for items. The hashed regions of racks 116 represent one or more shelves on which items may be placed. The number of shelves included on a rack may vary. In some examples, racks may include a single shelf. In other examples, racks may include a plurality of shelves which may be spaced evenly from one another or may be variably spaced. The dividing portions (e.g., portion 120) of racks may separate the shelves. Typically, when items on one side of a rack are accessible to a user, items on the other side of the rack are out of reach of the user due to the dividing portion.

Store 100 may include open floor space where a user (e.g., store employee and/or store customer) may move. In some examples, open floor space between racks may be referred to as aisles, such as aisles 122-1, 122-2, . . . , and 122-M (collectively “aisles 122”). Although FIG. 1 illustrates racks 116 as linear and illustrates aisles 122 as linear portions of open floor space defined by racks 116, it is contemplated that store 100 may include racks and aisles having a variety of different geometries. The techniques of the present disclosure are not limited to any specific type of rack and aisle layout, but instead, the techniques may be implemented in any variety of different rack and aisle layouts.

As described above, the hashed regions on racks 116 illustrate space on racks where items are stored. Some portions of the hashed regions on racks 116 include white boxes labeled with item numbers. For example, racks 116 include items 124-1 to 124-13. The boxes labeled as items 124-1 to 124-13 illustrate the location of items on shelves. For example, items 124-1, 124-2, 124-3, 124-4, 124-5 are included on rack 116-1 and rack 116-2. Items 124-1, 124-2, 124-3, 124-4, 124-5 are accessible by a user that is located in aisle 122-1. Similarly, items 124-6, 124-7, . . . , 124-11 are accessible by a user that is located in aisle 122-2.

Similar types of items may be grouped together along an aisle in a typical store. For example, the items located along aisle 122-1 (i.e., the items accessible in aisle 122-1 from rack 116-1 and rack 116-2) may be items of a similar type. In one example, the items along aisle 122-1 may be cereal items (e.g., bags or boxes of cereal). In another example, items along aisle 122-1 may be beverage items such as soft drinks and water. In another example, items along aisle 122-1 may be frozen items such as frozen entrees, pizzas, and ice cream. In examples where items along aisle 122-1 are frozen items, rack 116-1 and rack 116-2 may be refrigerated storage units (e.g., display coolers/freezers). Although the techniques of the present disclosure may be implemented in stores in which similar types of items are grouped together (e.g., in a typical grocery store), the techniques of the present disclosure do not require that similar types of items be grouped along the same aisle.

Store 100 includes location indicators 126-1, 126-2, 126-3, . . . , and 126-X (collectively “location indicators 126”). Location indicators 126 may include any device or object that indicates a location in store 100. In some examples, location indicators 126 may indicate a location within store 100 by transmitting location signals that indicate the location within store 100. For example, location indicator 126-1 may transmit location signal 128-1 that may indicate a location within aisle 122-1. Similarly, location indicator 126-2 may transmit location signal 128-2 that may indicate a location within aisle 122-2. Although location signals (e.g., 128-1, 128-2) are illustrated as transmitted in a cone radiation pattern having approximately a 90 degree angle, the illustration of location signals (e.g., 128-1, 128-2) in this manner is merely meant to indicate that location indicators of the present disclosure are transmitting/emitting signals. It is contemplated that the location signals may be transmitted in a variety of different radiation patterns and distances. Additionally, the location indicators described herein may be mounted to racks, or other structures (e.g., walls, floors, ceilings), at different angles in order to direct the transmission of location signals in different directions.

In other examples, location indicators may be objects (e.g., printed barcodes) including codes that indicate a location within a store. For example, location indicator 126-1 may be replaced by a location indicator including a code (e.g., a printed barcode) indicating a location within aisle 122-1. Similarly, location indicator 126-2 may be replaced by a location indicator including a code (e.g., a printed barcode) indicating a location within aisle 122-2. Such location indicators including codes (e.g., barcodes) may be scanned by MSDs (e.g., using barcode scanners included in the MSDs).

MSDs 114 may be configured to determine a location within store 100 in a variety of different ways, depending on the type of device or object used as a location indicator. In examples where location indicators 126 wirelessly transmit location signals that indicate a location within store 100, MSDs 114 may be configured to acquire the location signals and determine locations within store 100 based on the acquired location signals. In examples where location indicators are objects that include codes (e.g., barcodes), MSDs 114 may be configured to scan the codes on the location indicators and determine a location within store 100 based on the scanned codes.

Location indicators 126 may be configured to transmit location signals using any type of wireless transmission technology. In some examples, location indicators 126 may include an antenna (e.g., a metal antenna) that transmits location signals. In some examples, location indicators 126 may include a light emitting device (e.g., an LED or other photonic devices) that transmit location signals. In some examples, location indicators 126 may include an acoustic device that transmits location signals (e.g., sound waves).

The distance over which location indicators 126 transmit location signals 128, and the area covered by location signals 128, may vary depending on a variety of different factors including, but not limited to, the amount of power used to generate location signals 128, the location of location indicators 126 within store 100, and the technology included in location indicators 126 (e.g., an antenna, an LED, or acoustic device). In some examples, location indicators 126 may be configured to transmit location signals 128 over a relatively short distance and a small area within store 100. In other examples, location indicators 126 may be configured to transmit location signals 128 over longer distances and larger areas within store 100. For example, location indicators 126 may be configured to transmit location signals 128 from a few centimeters up to distances of tens of meters (e.g., 100 meters). In some examples, location indicators 126 may transmit location signals 128 along the length of an aisle or even across the length of store 100.

Location indicators 126 may transmit location signals 128 in a variety of different patterns which are described hereinafter with respect to location indicator 126-1. In some examples, location indicator 126-1 may transmit a location signal 128-1 along a line. For example, location indicator 126-1 may include a laser that transmits a laser beam along a straight line. In other examples, location indicator 126-1 may include an antenna that radiates location signal 128-1 in a directional manner. For example, location indicator 126-1 may include an antenna that radiates location signals having lobes and nulls. In other examples, location indicator 126-1 may transmit location signal 128-1 in nearly all directions. For example, location indicator 126-1 may include an antenna that generally radiates in all directions, or an LED that emits light in nearly all directions. It is contemplated that the directionality and power of the location signals may be adjusted to adjust the area of store 100 covered by the location signals. For example, the amount of power used to generate a location signal may be increased in order to transmit the location signal a greater distance.

The location of location indicators 126 within store 100 may affect the distance and area covered by location signals 128. As described herein, location indicators 126 may be placed in a variety of different locations in store 100. For example, location indicators 126 may be attached to the walls of store 100, mounted on shelves (e.g., near the floor or head height), placed on the floor, mounted overhead of the users, connected to the ceiling, or located at any other location within store 100.

Referring to FIG. 1, location indicator 126-1 transmits location signal 128-1 into aisle 122-1. Location indicator 126-1 is illustrated as connected to rack 116-1. Location indicator 126-1 may be connected to rack 116-1 in a variety of different locations. In some examples, location indicator 126-1 may be attached to, or placed on, any one of a plurality of shelves of rack 116-1. In some examples, location indicator 126-1 may be placed where rack 116-1 meets the floor. In other examples, location indicator 126-1 may be connected to rack 116-1 overhead of users. For example, rack 116-1 may include a piece that overhangs aisle 122-1. Although location indicators 126 are illustrated as connected to racks 116 in FIG. 1, location indicators 126 may be placed in other locations (e.g., on the floor, attached to the ceiling, etc.).

The area covered by location signals 128 may depend on the location of location indicators 126. With respect to FIG. 1, if location indicator 126-2 is attached to a shelf of rack 116-2, location signal 128-2 may be transmitted throughout aisle 122-2. In other words, if location indicator 126-2 is attached to a shelf of rack 116-2, location signal 128-2 may cover some or all of aisle 122-2. Depending on the directionality and power of location signal 128-2, location signal 128-2 may cover only a portion of aisle 122-2, or may cover all of aisle 122-2 and even spill outside of aisle 122-2 to floor space adjacent to aisle 122-2. If location indicator 126-2 is attached to a shelf of rack 116-2, location signal 128-2 may not penetrate racks 116-2, 116-3 and/or the items on racks 116-2, 116-3 in some examples. In these examples, location signal 128-2 may not cover floor space in aisles 122-1 and 122-3, and, therefore, location signal 128-2 may not be detectable in these areas in some examples. In other examples, location signal 128-2 may be detectable in aisles 122-1, 122-3. For example, location signal 128-2 may penetrate racks 116-2, 116-3 and items on racks 116-2, 116-3 such that location signal 128-2 covers some area in aisles 122-1, 122-3. As an additional example, location signal 128-2 may be detectable by MSDs 114 in aisles 122-1, 122-3 if gaps exist in racks 116-2, 116-3 and between items on racks 116-2, 116-3. Furthermore, in some examples, location signal 128-2 may be detectable by MSDs 114 in aisles 122-1, 122-3 if location signal 128-2 exits aisle 122-2 and reflects back into aisles 122-1, 122-3.

The location indicators may be arranged throughout the store. In general, a location indicator may be any object or device that indicates a location within the store. In some examples, the location indicators may generate location signals. For example, the location indicators may wirelessly transmit the location signals. The MSDs may receive the transmitted location signals and determine a location within the store based on the detected location signal(s). The location indicators may transmit location signals and the MSDs may be configured to detect the transmitted location signals in a variety of different ways. Although the location indicators may transmit location signals in some examples, in other examples, the location indicators may be objects that may be read by the MSDs. For example, the location indicators may be barcodes attached to racks in the store. Furthermore, although the MSDs may determine a location within the store based on location signals generated by location indicators within the store, in other examples, the MSDs may determine a location within the store in response to signals generated outside of the store, such as in response to global positioning system (GPS) signals received from GPS satellites. In still other examples, the MSDs may determine a location within the store using other techniques and technologies. For example, the MSDs may determine a location using a Wi-Fi signal transmitted within the store.

The MSDs may be configured to detect the location signals transmitted from the location indicators and perform various operations in response to detecting the location signals. A location signal received by an MSD may be thought of as indicating a particular location within the store. For example, assuming that a first aisle of the store includes a first location indicator that transmits a first location signal and a second aisle includes a second location indicator that transmits a second location signal, an MSD may determine that the MSD is located in the first or second aisle when the MSD detects the first or second location signal, respectively. The location signals may also be thought of as indicating which items included in the store are in proximity to an MSD at a given time. For example, since each of the items in the store may be associated with one or more location signals (i.e., a location value), an MSD may, upon detection of a location signal, determine which one or more of the items are in the vicinity of the MSD. As described herein, based on this determination, the MSD may further arrange items included in a customer order on a display of the MSD.

Using location indicators and/or location signals, an MSD may determine a location within, or outside of, the store. In some examples, an MSD may determine a location value based on detected location signals. As described herein, a location value may generally refer to any value or plurality of values (e.g., alphanumeric values) determined by an MSD that indicate a location of the MSD within, or outside of, the store. A location value determined by an MSD based on a location indicator and/or a location signal may depend on the types of location indicators and/or location signals used in the store.

An MSD may acquire location signals from location indicators as the MSD is transported throughout the store by a user. The location indicators may be set up throughout the store in various configurations. In some examples, the location indicators are set up such that the MSD picks up a location signal at any location within the store. In these examples, the location indicators are set up such that the location signals generated by the location indicators overlap to varying degrees and an MSD may acquire multiple location signals simultaneously in some locations. Additionally, or alternatively, the location indicators may be arranged such that the location signals do not quite overlap, but instead abut one another or are separated by a short distance. In these examples, an MSD may detect a first location signal in a first location and then abruptly detect a second location signal upon moving out of range of the first location signal. In other examples, the location indicators are set up such that an MSD does not pick up location signals at some locations within the store. In these examples, there may be dead zones in which an MSD may not acquire location signals because location signals may be absent, or not be sufficiently strong. Various configurations of location indicators within a store are illustrated and described herein.

In some implementations, the techniques of this disclosure may make use of location indicators and/or location signals in conjunction with the item indicators, item signals, and/or an item adjacency map. As described herein, an MSD may perform a variety of different operations based on a location and a corresponding location value determined by the MSD, irrespective of whether the location and location value are determined using location indicators/signals alone or in conjunction with item indicators/signals.

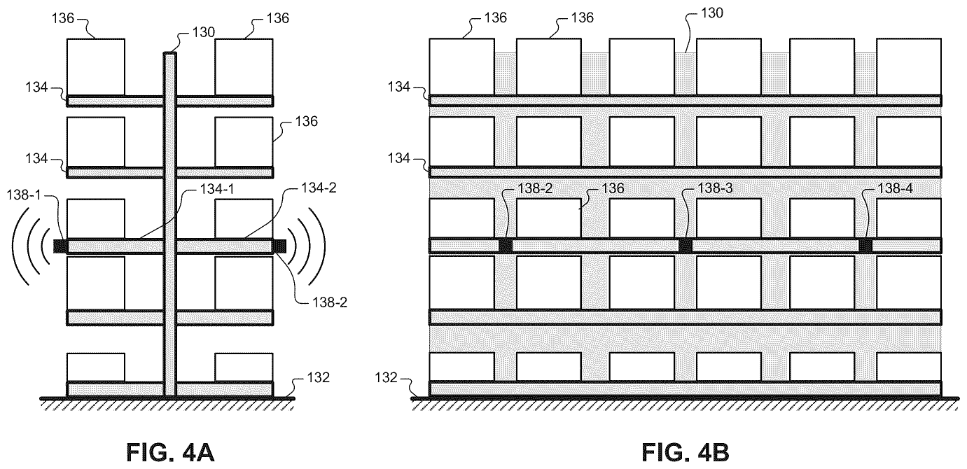

FIGS. 4A-9 show example racks including location indicators in different locations. FIGS. 4A-4B show an example rack 130 on floor 132. Rack 130 includes shelves 134. Items 136 (illustrated as white boxes) are arranged on shelves 134. In some implementations, rack 130 may be approximately 6 feet high. Shelves 134 may be approximately 1-2 feet apart. FIG. 4A shows a view of rack 130 from the end of rack 130 such that rack 130 would extend into and out of the page. FIG. 4B shows a view of rack 130 as would be viewed from an aisle.

In FIGS. 4A-4B, location indicators 138-1, 138-2, 138-3, 138-4 are attached to shelves 134-1, 134-2. Shelves 134-1, 134-2 may be approximately waist height (e.g., approximately 3 feet from floor 132). Accordingly, location indicators 138-1, 138-2 are located at approximately waist height and may transmit location signals from approximately waist height.

Location indicators of the present disclosure may be arranged along racks at a variety of different distances. With respect to FIG. 4B, location indicators 138-2, 138-3, 138-4 are evenly separated along rack 130. Although location indicators 138-2, 138-3, 138-4 are evenly separated in FIG. 4B, in other examples, location indicators 138-2, 138-3, 138-4 may be separated by varying distances. Although 3 location indicators 138-2, 138-3, 138-4 are illustrated in FIG. 4B, in some examples, more or less than 3 location indicators may be arranged along rack 130.

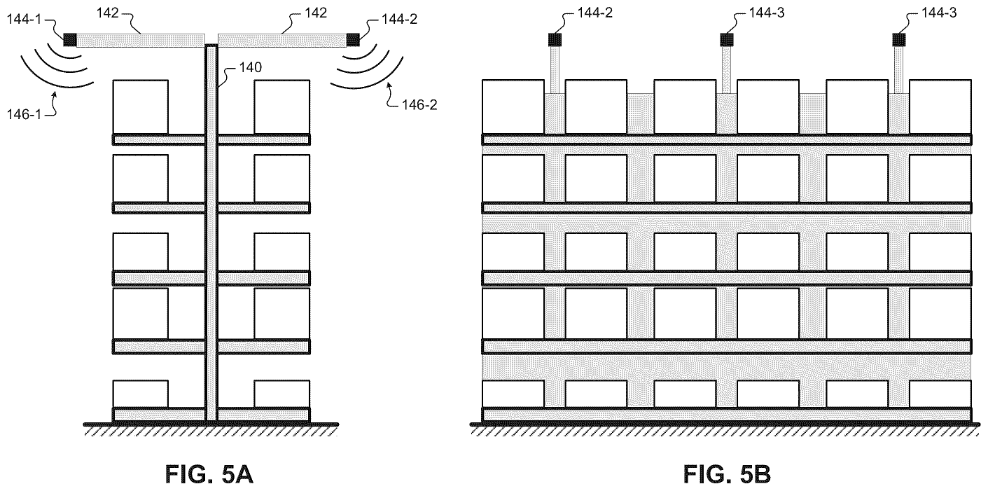

FIGS. 5A-5B show another example arrangement of location indicators along a rack. In FIGS. 5A-5B, rack 140 includes supporting members 142 configured to hold location indicators 144-1, 144-2, 144-3, 144-4 above rack 140 (e.g., over customer heads). In some examples, supporting members 142 may include metal rods that may be connected (e.g., clamped) to rack 140. Supporting members 142 may also be used to hold other objects, such as signs indicating what items are included in the aisle. Location indicators 144-1, 144-2, 144-3, 144-4 are connected to supporting members 142 and configured to generate location signals (e.g., 146-1, 146-2) that cover areas of the store adjacent to rack 140. For example, location indicators 144-1, 144-2, 144-3, 144-4 may be configured to point downward toward areas adjacent to rack 140 such that an MSD located in the aisle adjacent to rack 140 may detect one of location signals 146-1, 146-2.

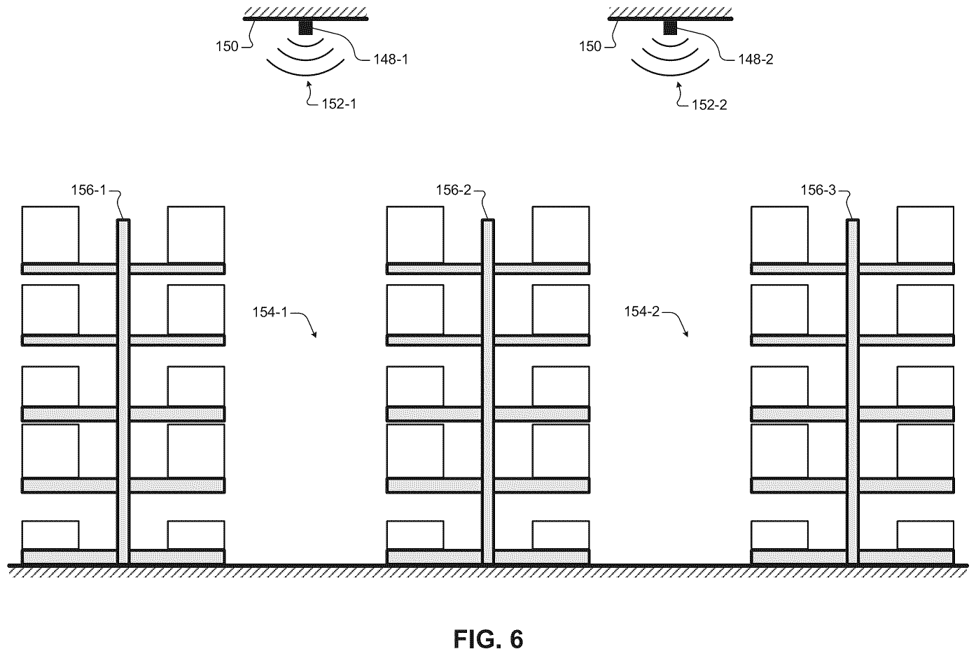

FIG. 6 shows another example arrangement of location indicators in which location indicators are located above racks. For example, location indicators 148-1, 148-2 may be attached to ceiling 150 (e.g., rafters or lighting) of the store. In this example, location indicators 148-1, 148-2 may transmit location signals 152-1, 152-2 into aisles 154-1, 154-2 between racks 156-1, 156-2, 156-3. In some implementations, lighting in the store may implement similar functionality as the location indicators (e.g., lighting may transmit location signals in a manner that is not perceptible by a user).

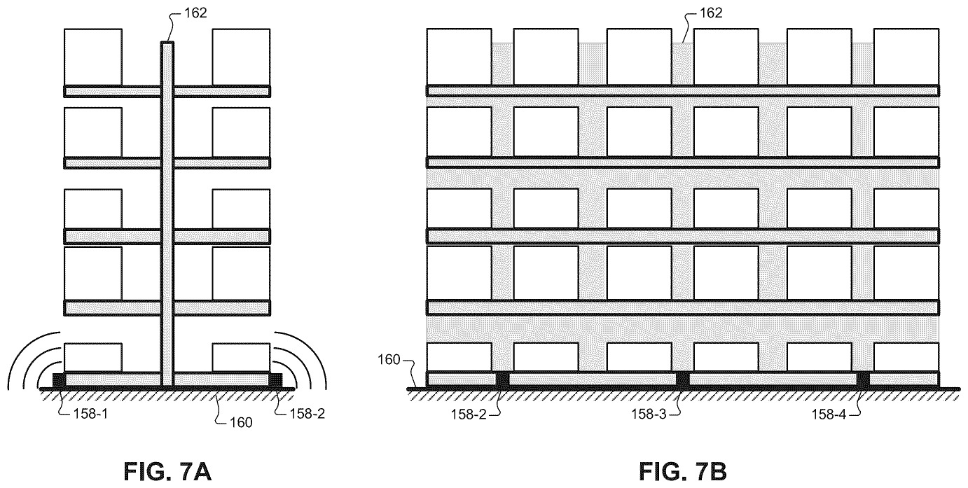

FIGS. 7A-7B show another example arrangement of location indicators. In FIGS. 7A-7B, location indicators 158-1, 158-2, 158-3, 158-4 are located near floor 160. For example, location indicators 158-1, 158-2, 158-3, 158-4 may be attached to the bottom shelves of rack 162 or connected to floor 160 near the bottom of rack 162. In some examples, location indicators 158-1, 158-2, 158-3, 158-4 may be embedded in floor 160. Although location indicators 158-2, 158-3, 158-4 are evenly separated in FIG. 7B, in other examples, location indicators 158-2, 158-3, 158-4 may be separated by varying distances. Although 3 location indicators 158-2, 158-3, 158-4 are illustrated in FIG. 7B, in some examples, more or less than 3 location indicators may be arranged along rack 162.

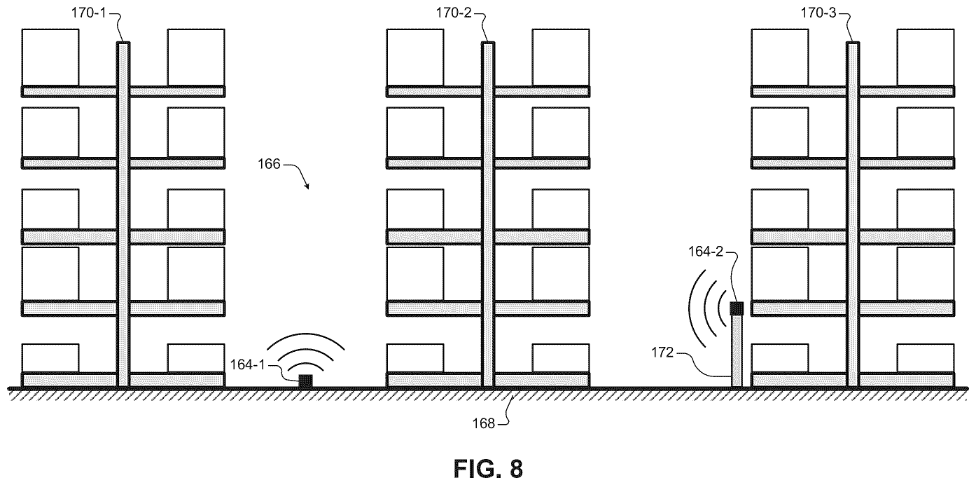

FIG. 8 shows other example arrangements of location indicators. In FIG. 8, location indicator 164-1 is located in aisle 166 on floor 168. Although location indicator 164-1 is illustrated as centrally located in aisle 166, location indicator 164-1 may instead be located nearer to one of racks 170-1, 170-2. Location indicator 164-1 may be attached to the surface of floor 168 in some examples. In other examples, location indicator 164-1 may be embedded in floor 168. For example, location indicator 164-1 may be embedded flush with floor 168 or embedded under floor 168 such that location indicator 164-1 is not visible.

In FIG. 8, location indicator 164-2 is connected to a supporting member 172. Supporting member 172 may rest on floor 168 or be connected to floor 168. Supporting member 172 may be a pole, tripod, or other device configured to hold location indicator 164-2. Accordingly, supporting member 172 may be configured to hold location indicator 164-2 at one end and connect to floor 168, or rest on floor 168, at the other end. Using supporting member 172 to hold location indicator 164-2 may allow placement of location indicator 164-2 in any location within the store, regardless of the location of racks, walls, or other structures in the store that may also be used for mounting location indicator 164-2.

FIG. 9 shows an example arrangement of location indicators that include readable codes (e.g., printed barcodes). In FIG. 9, location indicators 174-1, 174-2, 174-3 are barcodes that are attached to shelf 176 of rack 178. Since location indicators 174-1, 174-2, 174-3 are barcodes, location indicators 174-1, 174-2, 174-3 may not transmit location signals. Instead, as described hereinafter, a user may use an MSD to scan location indicators 174-1, 174-2, 174-3 using a barcode scanner to determine a current location. Location indicators 174-1, 174-2, 174-3 may include different barcode values that indicate different locations to MSDs. In some examples, a store may include only location indicators that have readable codes (e.g., barcodes). In other words, in these examples, the store may not include location indicators that transmit location signals. In other examples, a store may not include location indicators with readable codes. Instead, in these examples, the store may include only location indicators that transmit location signals. In still other examples, a store may include both location indicators that have readable codes and location indicators that transmit location signals.

Although location indicators 174-1, 174-2, 174-3 are illustrated as attached to a shelf in FIG. 9, other arrangements of readable location indicators are contemplated. For example, readable location indicators may be attached to lower shelves or higher shelves, the wall of a store, the ceiling of the store, and/or attached to the floor. In general, readable location indicators may be attached in any location in a store that may be read by an MSD. It is contemplated that a store may include location indicators in any of the locations described with respect to FIGS. 4A-9. Additionally, a store may include location indicators in other locations which may not be explicitly illustrated in FIGS. 4A-9.

The number of location indicators and the arrangement of location indicators in a store may vary. In some examples, a larger store may include more location indicators to cover the larger area of the store. The density of location indicators (e.g., the number of location indicators per area of the store) may also vary. In some examples, a greater number of location indicators per area of store may create more locations per area of store, which may result in smaller zones (i.e., a higher location resolution).

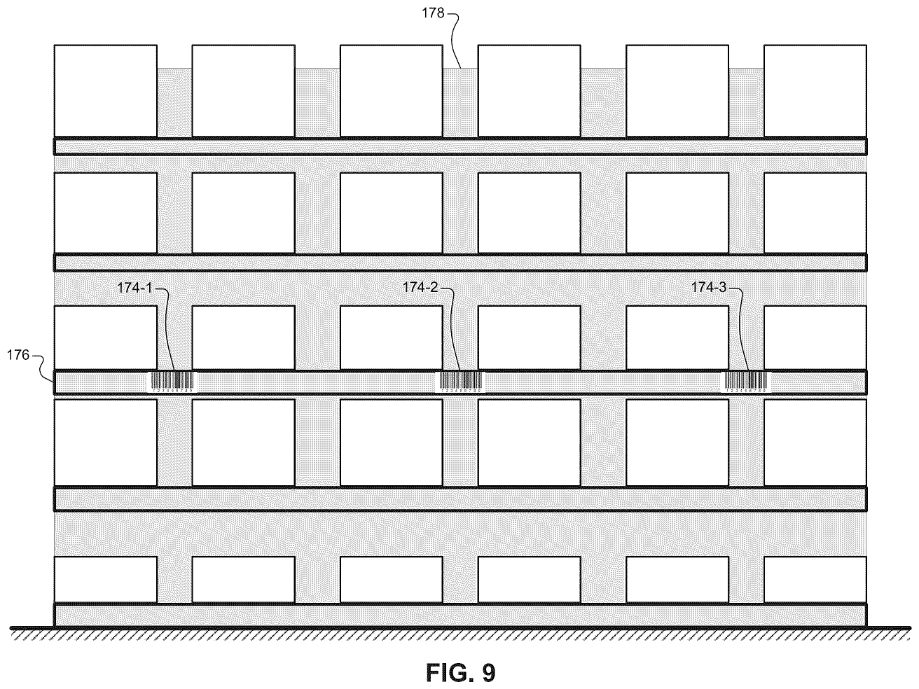

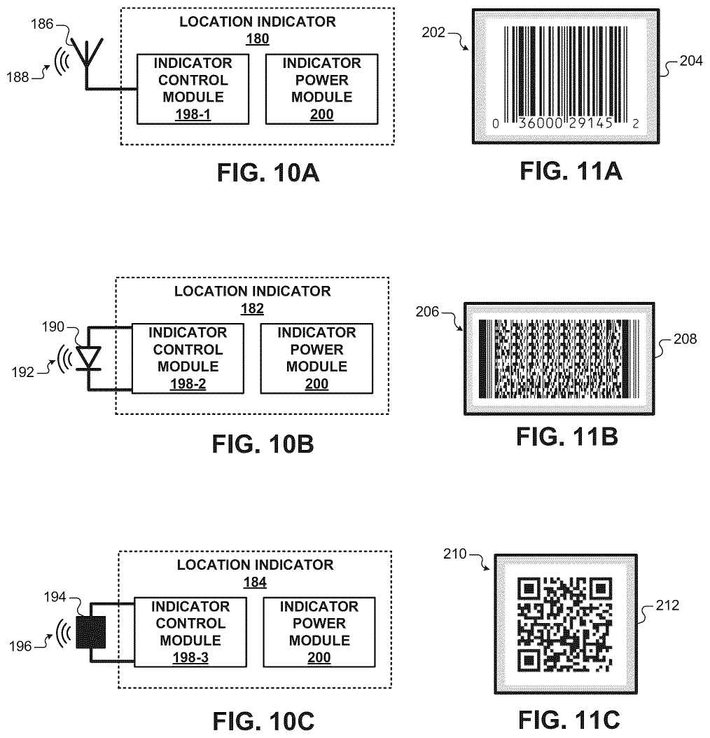

Example location indicators are described hereinafter with reference to FIGS. 10A-10C. Location indicators may include one or more different technologies for wirelessly transmitting location signals. For example, location indicators 180, 182, 184 of FIGS. 10A-10C may transmit location signals via an antenna, an LED, or an acoustic device. Additionally, location indicators of the present disclosure may encode location signals in a variety of different formats. In general, location indicators may be configured so that each location indicator transmits a different location signal. For example, when location indicators encode location signals using different frequency content, each location indicator may transmit a location signal having different frequency content. MSDs may be configured to acquire the different location signals and discriminate between the different location signals.

Location indicators may include a variety of different technologies. FIGS. 10A-10C illustrate some example technologies that may be used in location indicators that transmit location signals. FIG. 10A shows an example location indicator 180 that includes an antenna 186 for transmitting location signal 188. In some implementations, the location indicator 180 may include Bluetooth communication functionality (e.g., Bluetooth low energy (BLE)). In these implementations, the location indicator 180 may transmit location signals (e.g., as a Bluetooth beacon) using the Bluetooth communication functionality. MSDs (e.g., a mobile phone, tablet, or a dedicated computing device configured for use in the store) may communicate (e.g., receive transmissions) with the location indicators including Bluetooth functionality to determine location values. FIG. 10B shows an example location indicator 182 that includes an LED 190 for emitting location signal 192. In some implementations, the location indicator 182 (e.g., an LED) that emits light may be included in overhead lighting fixtures (e.g., FIG. 6) that provide lighting to the store. In these implementations, the location indicator 182 may transmit location signals and may also provide the store with lighting. The location signals may be undetectable by the human eye, but may be detected by the MSDs (e.g., a mobile phone, tablet, or a dedicated computing device configured for use in the store). FIG. 10C shows an example location indicator 184 that includes an acoustic device 194 for emitting location signal 196. Although FIGS. 10A-10C illustrate location indicators 180, 182, 184 using an antenna 186, LED 190, and acoustic device 194, it is contemplated that other types of devices may be used to transmit location signals within a store.

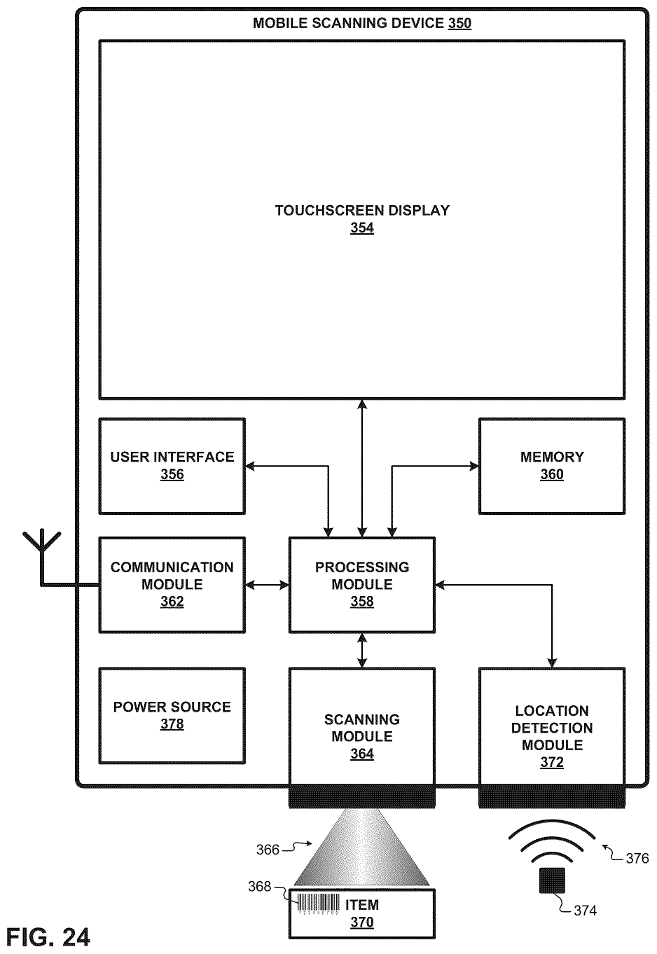

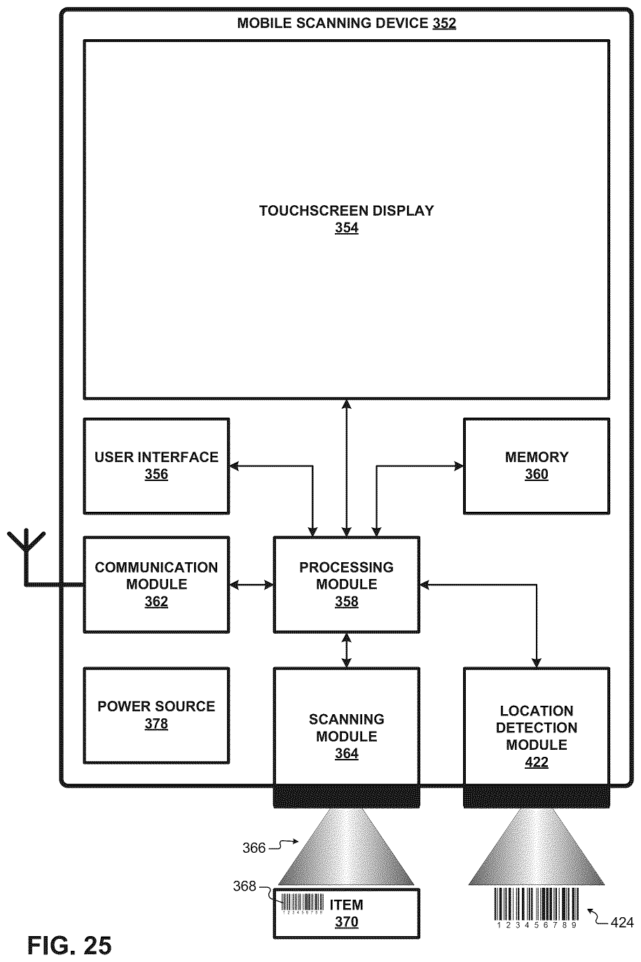

As described herein, MSDs may include location detection modules (e.g., location detection modules 372, 422 of FIGS. 24-25) that are configured to acquire location signals transmitted by location indicators. For example, when location indicators transmit location signals via an antenna, location detection modules of MSDs may include antennas configured to receive the transmitted location signals. As an additional example, when location indicators transmit location signals from an LED, location detection modules of MSDs may include devices configured to detect the transmitted light (e.g., an LED, or other light detection circuit). In still other examples, when location indicators transmit location signals from an acoustic device (e.g., sound waves), location detection modules of MSDs may include devices configured to detect the sound waves (e.g., a sound detection device). Although location indicators may include antennas, light emitting devices, and acoustic devices for transmitting location signals, other types of technologies may be included in location indicators for transmitting location signals. Accordingly, MSDs may include other types of location detection modules that are configured to detect location signals transmitted by other types of technologies used in location indicators.

In some examples, a single type of location indicator technology may be implemented in a store. For example, all location indicators may include light emitting devices (e.g., LEDs) and all MSDs may include light detection devices for detecting location signals. As an additional example, all location indicators may include an antenna for transmitting location signals and all MSDs may include antennas for receiving the transmitted location signals. In other examples, different location indicators may include different technologies within the store. For example, some of the location indicators may include light emitting devices, while other ones of the location indicators may include antennas. In still other examples, some of the location indicators may include multiple different technologies. For example, a location indicator may include both an antenna and a light emitting device.

Location indicators 180, 182, 184 include indicator control modules 198-1, 198-2, 198-3 that are configured to control operation of location indicators 180, 182, 184. In general, indicator control modules 198-1, 198-2, 198-3 may represent electronic hardware and software/firmware included in location indicators 180, 182, 184 that controls the transmission of location signals 188, 192, 196. Location indicators 180, 182, 184 may also include an indicator power module 200 configured to provide power to location indicators 180, 182, 184. Indicator power module 200 may include a variety of different electronic components that provide power to location indicators 180, 182, 184.

In some examples, location indicators 180, 182, 184 may be powered by mains power systems. In these examples, indicator power module 200 may include a connector to receive mains power (e.g., a three pronged plug or other connector) and power supply electronics for receiving mains power and delivering power to the electronics of location indicators 180, 182, 184 (e.g., indicator control modules 198-1, 198-2, 198-3). In other examples, location indicators 180, 182, 184 may be powered by batteries. In these examples, indicator power module 200 may include sockets for holding batteries and/or connectors for receiving battery power via wires. Additionally, in these examples, indicator power module 200 may include electronics for receiving power from batteries and delivering power to electronics of location indicators 180, 182, 184 (e.g., indicator control modules 198-1, 198-2, 198-3). In other examples, indicator power module 200 may include other power sources such as solar panels or a capacitor used for energy storage. In other examples, location indicators may receive power from MSDs. For example, a location indicator (e.g., an RFID tag) may include an antenna that receives energy transmitted by an MSD.

FIG. 10A shows an example location indicator 180 that includes an antenna 186. Indicator control module 198-1 may transmit location signal 188 via antenna 186. It is contemplated that antenna 186 may be implemented using a variety of different antenna structures. In some examples, antenna 186 may include a metal wire (e.g., monopole antenna, dipole antenna, a helical antenna, etc.) mounted to a printed circuit board (PCB) of location indicator 180. In other examples, antenna 186 may be included on traces of the PCB of location indicator 180. Although a single antenna is illustrated in FIG. 10A, it is contemplated that location indicators described herein may include more than one antenna in some examples.

As described above, location indicator 180 includes an indicator control module 198-1 (e.g., electronic hardware, firmware, and/or software) configured to transmit location signal 188 via antenna 186. Indicator control module 198-1 may also include memory that includes instructions that, when executed by indicator control module 198-1, cause indicator control module 198-1 to perform various functions attributed to indicator control module 198-1 described herein. Memory of indicator control module 198-1 may store programs and other operating parameters that define properties (e.g., codes, frequency parameters, etc.) of location signal 188.

The components of location indicator 180 may be enclosed in a housing. For example, the housing may enclose a PCB, antenna 186, indicator control module 198-1, and indicator power module 200, along with other components. The housing may have a variety of different form factors, depending on where location indicator 180 is to be located within a store. For example, the housing may be configured for resting or mounting on a shelf or wall, mounting on the floor, mounting on the ceiling, or embedding in the floor.

Location indicator 180 may encode location signal 188 in a variety of different formats. For example, location signal 188 may include one or more frequency components over a range of frequencies from approximately DC frequencies up to GHz frequencies. In some examples, indicator control module 198-1 may be configured to transmit one or more waveforms via antenna 188, such as on/off signals, sine waves, triangle waves, square waves, etc. In some examples, indicator control module 198-1 may be configured to generate carrier signals and modulate the carrier signal using analog modulation techniques (e.g., amplitude modulation) and/or digital modulation techniques (e.g., amplitude-shift keying). In some examples, indicator control module 198-1 may encode digital data (e.g., multiple bits) using modulation techniques.

MSDs may be configured to receive location signal 188 (e.g., via an antenna) and differentiate location signal 188 from location signals transmitted by other location indicators. For example, MSDs may be configured to detect parameters (e.g., frequency content) of location signal 188 and/or the digital data encoded by location signal 188. As described hereinafter, MSDs may detect location signal 188 and determine a location value based on location signal 188. In some examples, the location values may be unique. In other examples, some location values determined throughout the store may be the same.

Location indicator 180 of FIG. 10A may represent an RFID tag in some examples, such as an active RFID tag, a passive RFID tag, or other type of RFID tag. If location indicator 180 is an RFID tag, antenna 186 may represent one or more antennas of the RFID tag that transmit signals to an MSD and/or wirelessly receives energy from an MSD. Indicator power module 200 may include circuits that receive energy via an antenna in some examples. In other examples, indicator power module 200 may represent a battery included in the RFID tag. Indicator control module 198-1 may represent circuits that transmit RFID data via antenna 186. For example, indicator control module 198-1 may include an identification number that is transmitted via antenna 186 when the RFID tag is interrogated by an MSD. In some examples, an RFID tag may include a power source and be configured to transmit location signal 188. In other examples, an RFID tag may be “awoken” by an MSD and may transmit a location signal in response to being awoken by the MSD. In examples where RFID tags harvest power from MSDs, the location indicators may not require mains or battery power.

FIG. 10B shows an example location indicator 182 that includes a light emitting device 190 (e.g., one or more LEDs or other photonic devices). Location indicator 182 includes an indicator control module 198-2 (e.g., electronic hardware, software, and/or firmware) configured to transmit location signal 192 via light emitting device 190. Indicator control module 198-2 may also include memory that includes instructions that cause indicator control module 198-2 to perform various functions attributed to indicator control module 198-2 described herein. Memory of indicator control module 198-2 may store programs and other operating parameters that define properties (e.g., codes, frequency parameters, etc.) of location signal 192.

The components of location indicator 182 may be enclosed in a housing. For example, the housing may enclose a PCB, light emitting device 190, indicator control module 198-2, and indicator power module 200, along with other components. The housing may have a variety of different form factors, depending on where location indicator 182 is to be located within a store. For example, the housing may be configured for resting or mounting on a shelf or wall, mounting on the floor, mounting on the ceiling, or embedding in the floor.

Location indicator 182 may encode location signal 182 in a variety of different formats. For example, location signal 192 may include one or more frequency components over a range of frequencies from approximately DC frequencies up to GHz frequencies. In some examples, indicator control module 198-2 may be configured to transmit one or more waveforms via light emitting device 190, such as sine waves, triangle waves, square waves, etc. In some examples, indicator control module 198-2 may be configured to generate carrier signals and modulate the carrier signal using analog modulation techniques (e.g., amplitude modulation) and/or digital modulation techniques (e.g., amplitude-shift keying). In some examples, indicator control module 198-2 may encode digital data (e.g., multiple bits) using modulation techniques.

MSDs may be configured to receive location signal 192 (e.g., via a light detection device such as a photodiode, phototransistor, or other device) and differentiate location signal 192 from location signals transmitted by other location indicators. For example, MSDs may be configured to detect parameters (e.g., frequency content) of location signal 192 and/or the digital data encoded by location signal 192. As described hereinafter, MSDs may detect location signal 192 and determine a location value based on location signal 192.

FIG. 10C shows an example location indicator 184 that includes an acoustic device 194 that transmits location signal 196 by transmitting sound waves. Location indicator 184 includes an indicator control module 198-3 (e.g., electronic hardware, software, and/or firmware) configured to transmit location signal 196 via acoustic device 194. Indicator control module 198-3 may also include memory that includes instructions that cause indicator control module 198-3 to perform various functions attributed to indicator control module 198-3 described herein. Memory of indicator control module 198-3 may store programs and other operating parameters that define properties (e.g., codes, frequency parameters, etc.) of location signal 196.

The components of location indicator 184 may be enclosed in a housing. For example, the housing may enclose a PCB, acoustic device 194, indicator control module 198-3, and indicator power module 200, along with other components. The housing may have a variety of different form factors, depending on where location indicator 184 is to be located within a store. For example, the housing may be configured for resting or mounting on a shelf or wall, mounting on the floor, mounting on the ceiling, or embedding in the floor.

Location indicator 184 may encode location signal 196 in a variety of different formats. For example, location signal 196 may include one or more frequency components over a range of frequencies (e.g., audible to inaudible frequencies). In some examples, indicator control module 198-3 may be configured to transmit one or more waveforms via acoustic device 194, such as sine waves, triangle waves, square waves, etc. In some examples, indicator control module 198-3 may be configured to generate carrier signals and modulate the carrier signal using analog modulation techniques (e.g., amplitude modulation) and/or digital modulation techniques (e.g., amplitude-shift keying). In some examples, indicator control module 198-3 may encode digital data (e.g., multiple bits) using modulation techniques.

MSDs may be configured to receive location signal 196 (e.g., via an acoustic detection device) and differentiate location signal 196 from location signals transmitted by other location indicators. For example, MSDs may be configured to detect parameters (e.g., frequency content) of location signal 196 and/or the digital data encoded by location signal 196. As described hereinafter, MSDs may detect location signal 196 and determine a location value based on location signal 196.

In some examples, location indicators may include readable codes. For example, the readable codes may be printed onto objects (e.g., labels) and attached to shelves, walls, the floor, etc. FIGS. 11A-11C show different example readable codes which may be used as location indicators. FIG. 11A shows a location indicator 202 that includes a bar code (e.g., a UPC-A barcode) attached to a label 204. Label 204 may be a paper label including an adhesive for attaching label 204 to shelves, walls, etc. In other examples, label 204 may be a metal tab that may be attached to shelves, walls, etc. FIG. 11B shows a location indicator 206 that includes a different type of readable code (e.g., a PDF417) attached to a label 208. FIG. 11C shows a location indicator 210 that includes a different type of readable code (e.g., a QR code) attached to a label 212.

Readable codes on location indicators (e.g., 202, 206, 210) may encode a variety of different data. For example, the readable codes may represent alphanumeric codes. Different location indicators in a store may have different codes. In examples where location indicators include readable codes, each location indicator within a store may have a different readable code. MSDs may scan the readable codes on the location indicators to determine a location within the store. Since each location indicator may have a different readable code, the MSDs may uniquely identify a location within the store based on the readable code that is scanned from the location indicator.

MSDs (e.g., MSDs 114 of FIG. 1) may be configured to determine a location value based on one or more received location signals (e.g., location signals 128 of FIG. 1) and/or scanned readable codes (e.g., readable codes 174-1, 174-2, 174-3). In general, a location value may refer to any value or plurality of values (e.g., alphanumeric values) determined by an MSD that indicate a location of the MSD within, or outside of, a store. The location values determined by MSDs may depend on the types of location indicators used in a store. In examples where location indicators transmit location signals, MSDs may determine a location value based on one or more received location signals. In examples where location indicators include readable codes (e.g., barcodes), MSDs may scan the readable codes and determine a location value based on the scanned readable codes.

As describe above, a location value may refer to any value or plurality of values that indicate a location of the MSD within, or outside of, a store. In some examples, an MSD may determine a location value based on a location signal that was transmitted by a location indicator in proximity to the MSD. In other examples, an MSD may determine a location value by scanning a location indicator (e.g., a readable code) in proximity to the MSD. Accordingly, an MSD may determine a location value in an area of the store in proximity to the location indicator that indicates that location value. In a sense, an area in a store adjacent to a location indicator may be associated with that location indicator and the location value associated with that location indicator. An area of a store (e.g., the floor space) associated with a location value may also be referred to herein as a “zone” of the store.

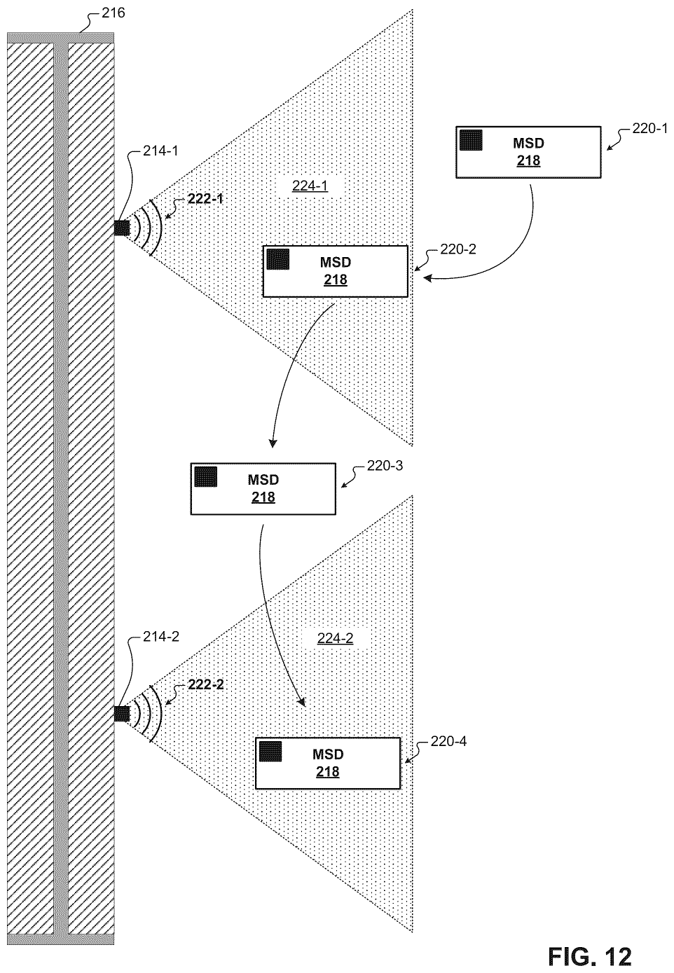

FIGS. 12-18 illustrate example arrangements of location indicators and associated location values that are associated with different areas of a store. Referring now to FIG. 12, location indicators 214-1, 214-2 are connected to rack 216. MSD 218 is moved along rack 216. The movement of MSD 218 is indicated by callouts 220-1, 220-2, 220-3, 220-4. As described hereinafter, MSD 218 includes a location detection module that is configured to acquire location signals 222-1, 222-2. The location detection module of MSD 218 is represented as a black box on MSD 218 in FIG. 12.

Initially, MSD 218 is located at position 220-1. At position 220-1, MSD 218 is outside of the range of location signal 222-1. Accordingly, MSD 218 may not be detecting a location signal at position 220-1. As described herein, an area in which an MSD does not acquire a location signal may be referred to as a “dead zone.” The areas covered by location signals 222-1, 222-2 are illustrated in FIG. 12 as shaded areas (e.g., shaded triangular areas). MSDs may acquire location signals within the areas covered by the location signals. In another example, the areas covered by location signals are illustrated as dotted rectangles (e.g., in FIG. 17).

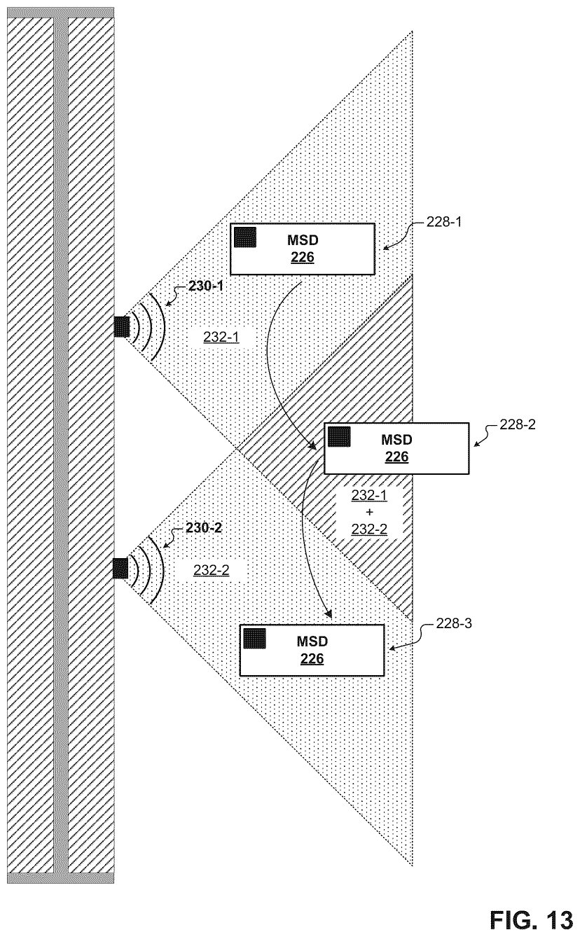

MSD 218 is moved from position 220-1 to position 220-2. MSD 218 begins acquiring location signal 222-1 as MSD 218 is moved to position 220-2. MSD 218 may determine a location value of 224-1 based on received location signal 222-1. A convention used herein is to assign the same reference numbers for location values and the areas in which MSDs determine the location values. For example, in FIG. 12, MSD 218 receives location signal 222-1 and determines a location value 224-1 in area 224-1 (i.e., zone 224-1). Similarly, MSD 218 receives location signal 222-2 and determines location value 224-2 in area 224-2 (i.e., zone 224-2) in FIG. 12. As an additional example, MSD 226 receives location signals 230-1, 230-2 and determines location value “232-1+232-2” in area “232-1+232-2” in FIG. 13.

Referring back to FIG. 12, MSD 218 is moved from position 220-2 to position 220-3. MSD 218 does not detect a location signal at position 220-3 (i.e., position 220-3 is a “dead zone”). Accordingly, when moving from position 220-2 to position 220-3, MSD 218 moves from a position in which a location signal is detected to a position in which location signals are not detected. MSD 218 is then moved from position 220-3 to position 220-4. MSD 218 acquires location signal 222-2 in position 220-4. MSD 218 may determine a location value of 224-2 in area 224-2 based on received location signal 222-2.

FIG. 13 shows an example in which an MSD is moved through a portion of a store in which location signals overlap in some regions. Initially, MSD 226 is located at position 228-1. MSD 226 detects location signal 230-1 at position 228-1. MSD 226 may determine a location value of 232-1 in area 232-1 based on detected location signal 230-1. MSD 226 is then moved from position 228-1 to position 228-2. When moving from position 228-1 to position 228-2, MSD 226 moves from a position in which a single location signal is detected to a position in which multiple location signals are detected.

Location signal 230-1 overlaps with location signal 230-2 at position 228-2 (as indicated by the triangular hashed region). Put another way, location signals 230-1, 230-2 cover the same area such that MSD 226 may detect multiple location signals at position 228-2. In areas where MSDs detect multiple location signals, the location values and the areas are illustrated in the figures and described in the text as a sum of values within quotes. For example, at position 228-2, MSD 226 may detect location signals 230-1, 230-2 and determine a location value of “232-1+232-2” in area “232-1+232-2” based on detected location signals 230-1, 230-2. MSD 226 is then moved from position 228-2 to position 228-3. MSD 226 acquires location signal 230-2 in position 228-3. MSD 226 may determine a location value of 232-2 in area 232-2 based on received location signal 230-2.

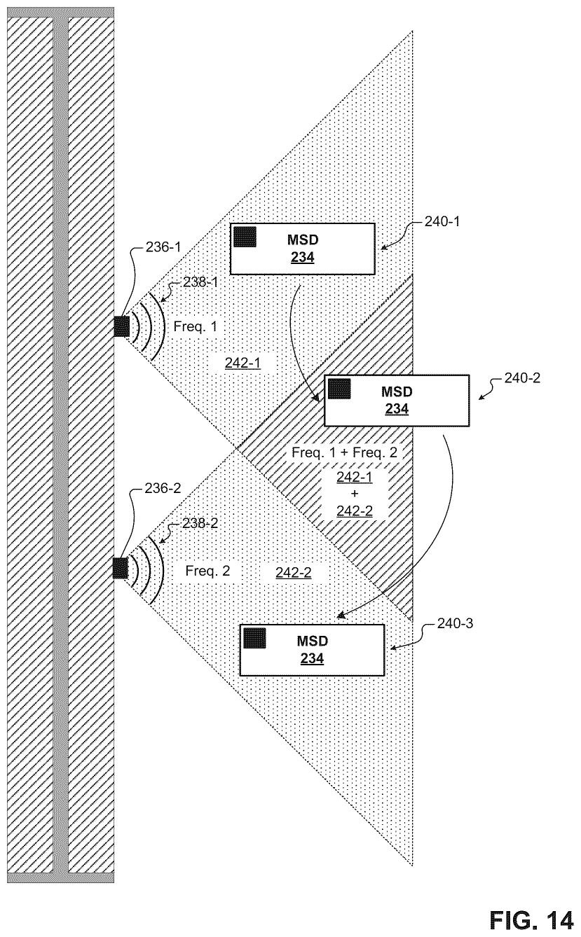

FIG. 14 shows an example in which an MSD 234 is moved through a portion of a store in which location indicators 236-1, 236-2 transmit location signals 238-1, 238-2 having different frequency content. For example, location indicator 236-1 may transmit a location signal 238-1 having a first frequency component (“Freq. 1” in FIG. 14) that is different from a frequency component included in location signal 238-2. Similarly, location indicator 236-2 may transmit a location signal 238-2 having a second frequency component (“Freq. 2” in FIG. 14) that is different from a frequency component included in location signal 238-1.

In one example, location signal 238-1 and location signal 238-2 may be sine wave signals having first and second frequencies, respectively. In this example, the first frequency may be different than the second frequency. For example, location signal 238-1 may be a sine wave having a frequency of 1 kHz and location signal 238-2 may be a sine wave having a frequency of 2 kHz. MSD 238 may detect the different frequencies and differentiate between location signals 238-1, 238-2 based on the different frequencies. In examples where a store includes an additional plurality of location indicators, each of the location indicators may transmit sine waves having different frequencies. In these examples, MSD 234 be configured to detect the different frequencies and differentiate between the different frequencies of sine waves transmitted by the additional location indicators.

Initially, MSD 234 is located at position 240-1. MSD 234 detects location signal 238-1 having a first frequency component at position 240-1. MSD 234 may determine a location value of 242-1 in area 242-1 based on detected location signal 238-1 having the first frequency component. MSD 234 is then moved from position 240-1 to position 240-2. When moving from position 240-1 to position 240-2, MSD 234 moves from a position in which only a first frequency component is detected to a position in which first and second frequency components are detected.

Location signal 238-1 overlaps with location signal 238-2 at position 240-2 such that MSD 234 may detect first and second frequency components at position 240-2. Accordingly, at position 240-2, MSD 234 may detect first and second frequency components of location signals 238-1, 238-2 and determine a location value of “242-1+242-2” in area “242-1+242-2” based on the detected frequency components of location signals 238-1, 238-2. MSD 234 is then moved from position 240-2 to position 240-3. MSD 234 acquires the second frequency component of location signal 238-2 in position 240-3, but may not detect the first frequency component of location signal 238-1. Accordingly, MSD 234 may determine a location value of 242-2 in area 242-2 based on the detected second frequency component of location signal 238-2.

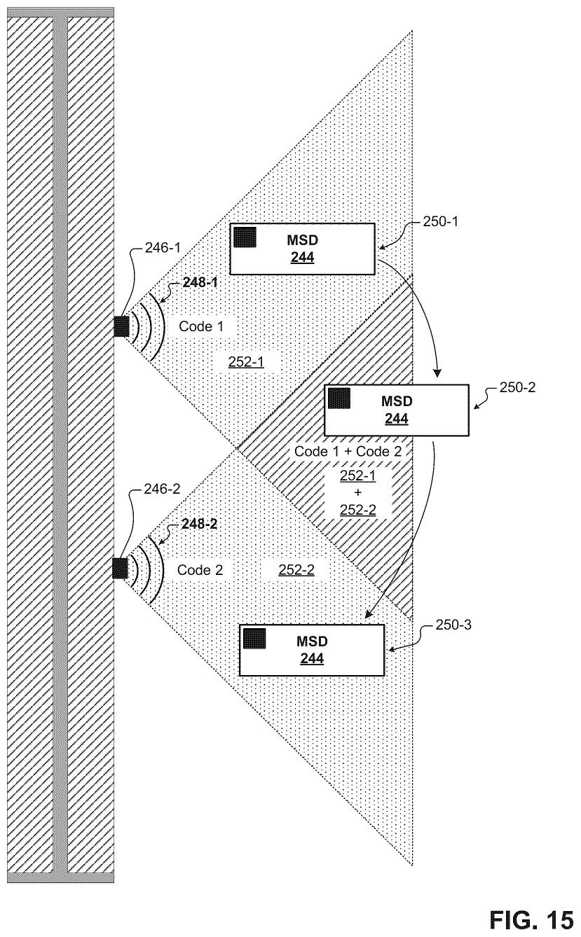

FIG. 15 shows an example in which an MSD 244 is moved through a portion of a store in which location indicators 246-1, 246-2 transmit location signals 248-1, 248-2 including different coded values. For example, location indicator 246-1 may transmit a location signal 248-1 including a first code (“Code 1” in FIG. 15) that is different from a second code included in location signal 248-2. Similarly, location indicator 246-2 may transmit a location signal 248-2 having a second code (“Code 2” in FIG. 15) that is different from the first code included in location signal 248-1. The codes transmitted by location indicators 246-1, 246-2 may be digital codes (e.g., alphanumeric codes) in some examples.

MSD 244 may detect the different codes and differentiate between location signals 248-1, 248-2 based on the different codes. In examples where a store includes an additional plurality of location indicators, each of the location indicators may transmit different codes. In these examples, MSD 244 may be configured to detect the different codes and differentiate between the different codes transmitted by the additional location indicators.

Initially, MSD 244 is located at position 250-1. MSD 244 detects location signal 248-1 including a first code at position 250-1. MSD 244 may determine a location value of 252-1 in area 252-1 based on detected location signal 248-1 having the first code. MSD 244 is then moved from position 250-1 to position 250-2. When moving from position 250-1 to position 250-2, MSD 244 moves from a position in which only the first code is detected to a position in which first and second codes are detected.

Location signal 248-1 overlaps with location signal 248-2 at position 250-2 such that MSD 244 may detect first and second codes at position 250-2. Accordingly, at position 250-2, MSD 244 may detect first and second codes and determine a location value of “252-1+252-2” in area “252-1+252-2” based on the detected codes of location signals 248-1, 248-2. MSD 244 is then moved from position 250-2 to position 250-3. MSD 244 acquires the second code in position 250-3, but may not detect the first code. Accordingly, MSD 244 may determine a location value of 252-2 in area 252-2 based on the detected second code.

As described herein, location values may be associated with stocked items. For example, each stocked item in the store may be associated with a location value. Each location value may be associated with multiple different stocked items. In general, a stocked item may be associated with a location value that may be determined by an MSD in proximity to that stocked item. In the case where a first location indicator generates a first location signal including a first location value, items in proximity to the first location signal may be associated with the first location value. In the case where a first location indicator includes a first readable code including a first location value, items in proximity to the first location indicator including the readable code may be associated with the first location value. The associations between location values and items may be generated manually by a user in some examples. In other examples, the associations between location values and items may be generated automatically (e.g., by one or more MSDs and/or the CCS). The associations between location values and stocked items may be stored in one or more MSDs and/or the CCS.

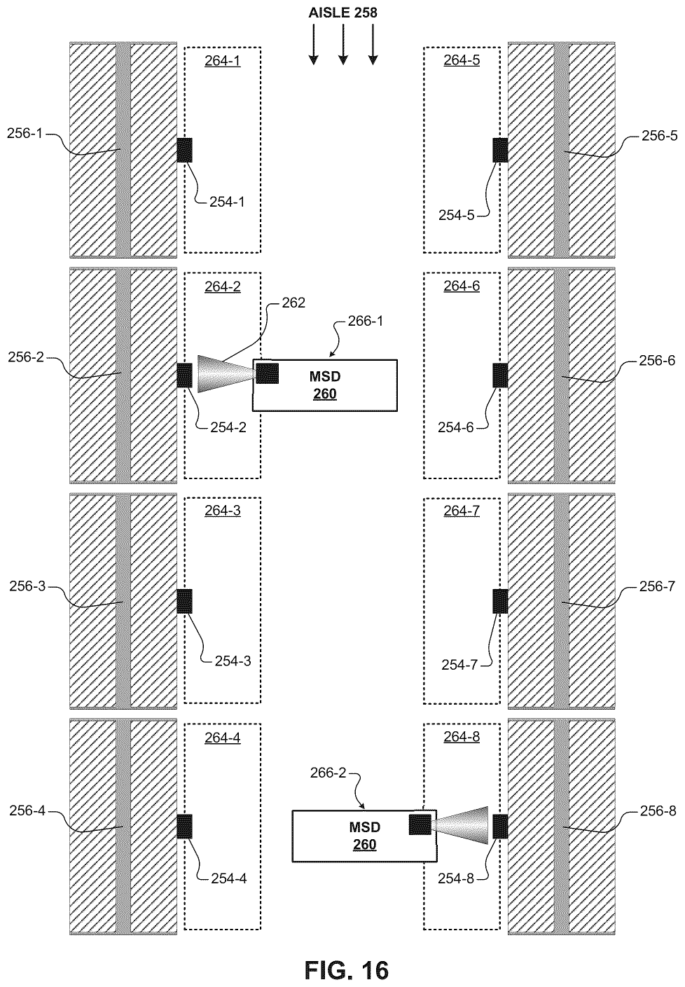

FIG. 16 illustrates example arrangements of location indicators and associated location values that are associated with different areas of a store. Location indicators 254-1, 254-2, . . . , 254-8 (hereinafter “location indicators 254”) may include readable codes. For example, location indicators 254 may be readable codes printed onto objects (e.g., labels) and attached to racks 256-1, 256-2, . . . , 256-8 along aisle 258. The readable codes may represent a variety of different data, such as alphanumeric codes.

MSD 260 may scan readable codes on location indicators 254 to determine location values associated with location indicators 254. As described hereinafter, MSD 260 includes a location detection module (e.g., location detection module 422 of FIG. 25) that is configured to scan readable codes of location indicators 254. Scanning by MSD 260 is illustrated as a shaded cone 262. Each of location indicators 254 may have different readable codes such that MSD 260 determines different location values for each of location indicators 254. Since each of location indicators 254 may have a different readable codes, MSD 260 may uniquely identify a location within the store based on the readable code that is scanned from the location indicator.

The area of the store associated with a location value of a readable code may be the area of the store in proximity to the readable code. For example, in FIG. 16, each of racks 256 includes a single location indicator (e.g., a single location value) that may be associated with the areas in front of racks 256. The areas associated with location indicators 254 are illustrated as dotted rectangles in FIG. 16. In one example, MSD 260 may scan location indicator 254-1 to determine location value 264-1 for area 264-1. Similarly, MSD 260 may scan location indicator 254-7 to determine location value 264-7 for area 264-7.

Initially, MSD 260 is located at position 266-1. At position 266-1, MSD 260 scans location indicator 254-2 and determines location value 264-2 in area 264-2. MSD 260 is moved from position 266-1 to position 266-2. At position 266-2, MSD 260 scans location indicator 254-8 and determines location value 264-8 in area 264-8. As described hereinafter, location value 264-2 may be associated with items on rack 256-2 that may be accessible in area 264-2. Similarly, location value 264-8 may be associated with items on rack 256-8 that may be accessible in area 264-8.

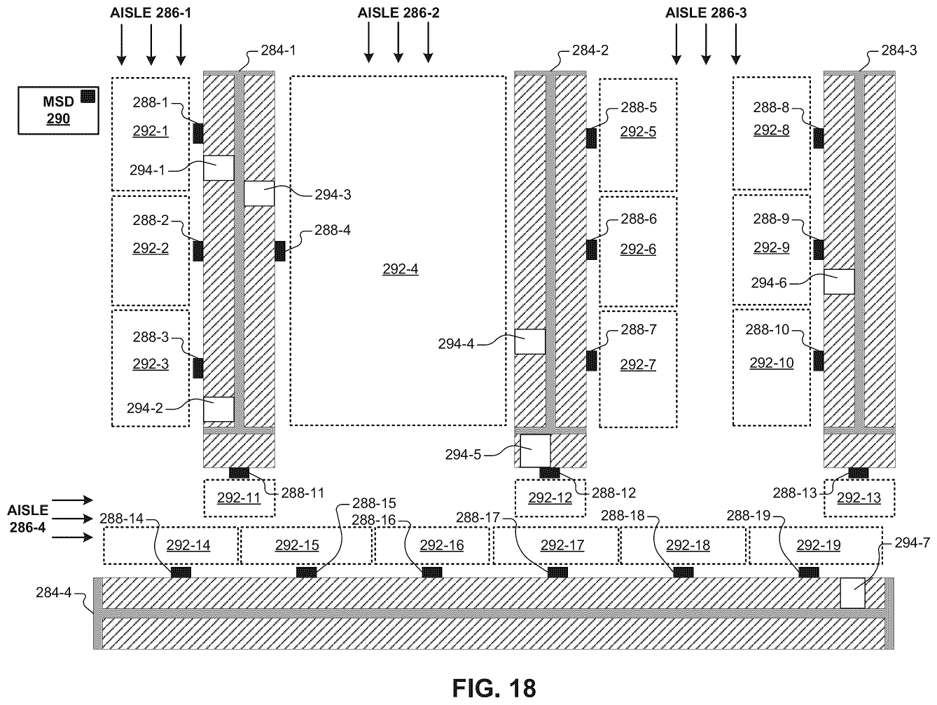

FIGS. 17-18 show example store layouts including a variety of location indicators and items. As described herein, items may be associated with location values. For example, the CCS, MSDs, and/or other computing devices may store associations between items and location values. In general, when the MSD determines a location value, items associated with that location value may be in proximity to the MSD. Put another way, an item may be associated with a location value that would be determined by an MSD in proximity to that item. In some examples, the associations between the items and the location values may be entered manually by a user. In other examples, the associations between the items and the location values may be automatically generated.

FIG. 17 shows a store layout including four racks 268-1, 268-2, 268-3, 268-4 (collectively “racks 268”) that define four aisles 270-1, 270-2, 270-3, 270-4 (collectively “aisles 274”). The store of FIG. 17 includes location indicators 276-1, 276-2, . . . , 276-10 (collectively “location indicators 276”) that transmit location signals. MSD 278 may determine location values 280-1, 280-2, . . . , 280-10, “280-5+280-6”, “280-9+280-10” (collectively “location values 280”) based on detected location signals. The areas covered by location signals are illustrated in FIG. 17 as dotted rectangles. Areas in which multiple location signals are detected are illustrated as shaded rectangles in FIG. 17. The store of FIG. 17 also includes dead zones 281-1, 281-2, 281-3.

The store of FIG. 17 includes items 282-1, 282-2, . . . , 282-9 (collectively “items 282”). Items 282 are associated with location values 280 (i.e., areas) of the store. The associations between items 282 and location values 280 may be stored in the CCS, one or more MSDs, and/or other computing devices. In general, items are associated with location signals (i.e., areas) in proximity to the items. For example, item 282-1 may be associated with location value 280-1. Items 282-3, 282-4, 282-5 may be associated with location value 280-4. Item 282-6 may be associated with location value “280-5+280-6”. Item 282-7 and item 282-9 may be associated with location value 280-10 and location value 280-9, respectively. Item 282-8 may be associated with location value “280-9+280-10”.

In FIG. 17, it may be assumed that MSD 278 has received a customer order including items 282. As described hereinafter in greater detail, MSD 278 may include a display that displays some, or all, of items 282 to a user. MSD 278 may arrange the displayed items based on which of location signals are detected. In general, MSD 278 may arrange the displayed items such that the items in proximity to MSD 278 (i.e., in proximity to the user) are viewable by the user on the display. In one example, MSD 278 may arrange items on the display such that those items in proximity to the user are more prominently displayed than those items that are farther away from MSD 278. For example, MSD 278 may display items in the current area at the top of the display. Additionally, or alternatively, MSD 278 may display the items in bold and/or colored text to indicate those items that are in proximity to the user. Displaying of items based on the currently determined location value is described hereinafter in greater detail.

FIG. 18 shows a store layout including four racks 284-1, 284-2, 284-3, 284-4 (collectively “racks 284”) that define four aisles 286-1, 286-2, 286-3, 286-4 (collectively “aisles 286”). The store of FIG. 18 includes location indicators 288-1, 288-2, . . . , 288-19 (collectively “location indicators 288”) that include readable codes. MSD 290 may scan location indicators 288 to determine location values 292-1, 292-2, . . . , 292-19 in areas 292-1, 292-2, . . . , 292-19 (collectively “areas 292”). Areas 292 in proximity to location indicators 288 are illustrated as dotted rectangles. For example, MSD 290 may scan location indicator 288-1 to determine location value 292-1 for area 292-1. Similarly, MSD 290 may scan location indicator 288-19 to determine location value 292-19 for area 292-19.

The store of FIG. 18 includes items 294-1, 294-2, . . . , 294-7 (collectively “items 294”). Items 294 are associated with location values 292 (i.e., areas) of the store. The associations between items 294 and location values 292 may be stored in the CCS, one or more MSDs, and/or other computing devices. In general, items are associated with location values (i.e., areas) in proximity to the items. For example, item 294-1 and item 294-2 may be associated with location value 292-1 and location value 292-3, respectively. Similarly, items 294-3, 294-4 may be associated with location value 292-4. As another example, item 294-5 may be associated with location value 292-12.

In FIG. 18, it may be assumed that MSD 290 has received a customer order including items 294. As described hereinafter in greater detail, MSD 290 may include a display that displays some, or all, of items 294 to a user. MSD 290 may arrange the displayed items based on which of location values 292 are determined. In general, MSD 290 may arrange the displayed items such that the items in proximity to MSD 290 (i.e., in proximity to the user) are viewable by the user on the display. In one example, MSD 290 may arrange items on the display such that those items in proximity to the user are more prominently displayed than those items that are farther away from MSD 290. For example, MSD 290 may display items in the current area at the top of the display. Additionally, or alternatively, MSD 290 may display the items in bold and/or colored text to indicate those items that are in proximity to the user.

One or more computing devices may store a location map that defines the spatial relationships between different areas of the store. For example, a location map may define the relative distances between different areas of the store. In some examples, two areas may be adjacent to one another. For example, the two areas may be touching one another. In other examples, two areas may not be adjacent to one another. Instead, one or more additional areas may be located between the two areas.

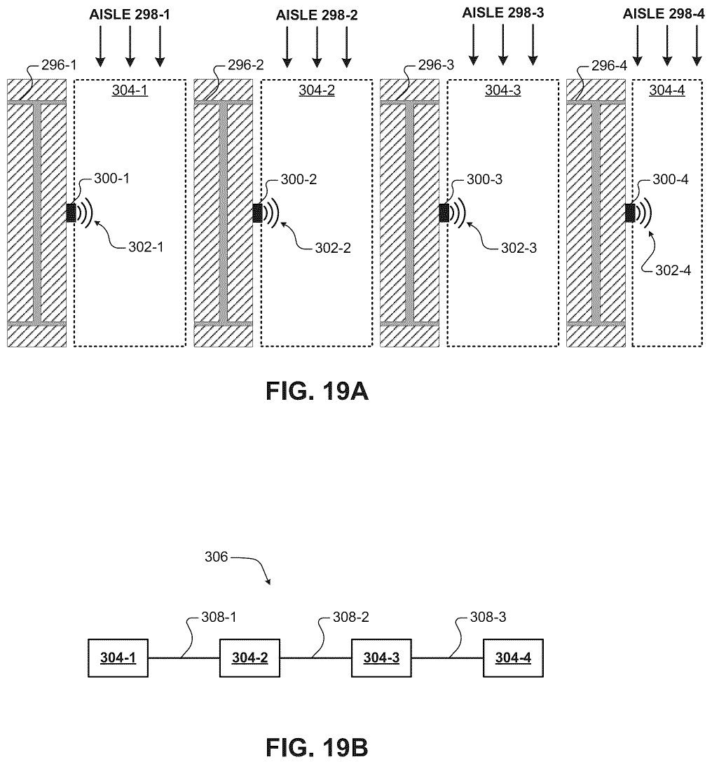

Example location maps are illustrated and described with respect to FIGS. 19A-22B. Location maps are graphically represented herein using boxes to represent different areas in the store. The boxes are connected to one another using one or more junctions (e.g., 308-1, 308-2 of FIG. 19B). The areas that are adjacent to one another may be connected using a single junction. For example, in FIG. 19B, area 304-1 is connected to area 304-2 by junction 308-1. Areas that are separated from one another (e.g., by another junction) may be connected via one or more junctions. For example, area 304-1 is connected to area 304-3 via junction 308-1 and junction 308-2 in FIG. 19B because area 304-2 is located between area 304-1 and area 304-3 in FIG. 19A. Location maps may be generated manually by a user in some examples. In other examples, the location maps may be generated automatically (e.g., by one or more MSDs and/or the CCS). The location maps may be stored in one or more MSDs and/or the CCS.

In general, location maps may define the spatial relationships between different areas of the store. In examples where location indicators transmit location signals, the location map may define how the areas of the store covered by the location signals are arranged relative to one another. For example, the location map may define the distances between the areas of the store covered by the location signals. In examples where the location indicators include readable codes, the location map may define the location of each of the location indicators (i.e., readable codes) relative to one another. For example, the location map may define the distances between different readable codes.

Since items may be associated with location values, and the location map may indicate the distance between areas in which the location values are determined by an MSD, an MSD may determine the distance between items using the location map. After an MSD determines the distance between ordered items using the location map, the MSD may arrange the items on the display based on the distance of each of the items from the current location of the MSD (i.e., the user).

Referring now to FIGS. 19A-19B, the store of FIG. 19A includes four racks 296-1, 296-2, 296-3, 296-4 (collectively “racks 296”) that define four aisles 298-1, 298-2, 298-3, 298-4 (collectively “aisles 298”). The store of FIG. 19A includes location indicators 300-1, 300-2, 300-3, 300-4 (collectively “location indicators 300”) that transmit location signals 302-1, 302-2, 302-3, 302-4 (collectively “location signals 302”). An MSD may determine location values 304-1, 304-2, 304-3, 304-4 based on detected location signals 302-1, 302-2, 302-3, 302-4, respectively. Areas 304-1, 304-2, 304-3, 304-4 (collectively “areas 304”) covered by location signals 302 are illustrated in FIG. 19A as dotted rectangles.

In FIG. 19A, area 304-1 is adjacent to area 304-2. Area 304-2 is adjacent to area 304-1 and area 304-3. Area 304-3 is adjacent to area 304-2 and area 304-4. Area 304-4 is adjacent to area 304-3. Location map 306 of FIG. 19B may represent the relative distances between areas 304. For example, area 304-1 is connected to area 304-2 by a single junction 308-1 to represent that area 304-1 is adjacent to area 304-2. Similarly, area 304-2 is connected to area 304-3 by a single junction 308-2 to represent that area 304-2 is adjacent to area 304-3. Area 304-1 and area 304-4 are the areas of FIG. 19A that are farthest apart. The distance between area 304-1 and area 304-4 may be represented by the three junctions 308-1, 308-2, 308-3 that separate area 304-1 and area 304-4 in location map 306.

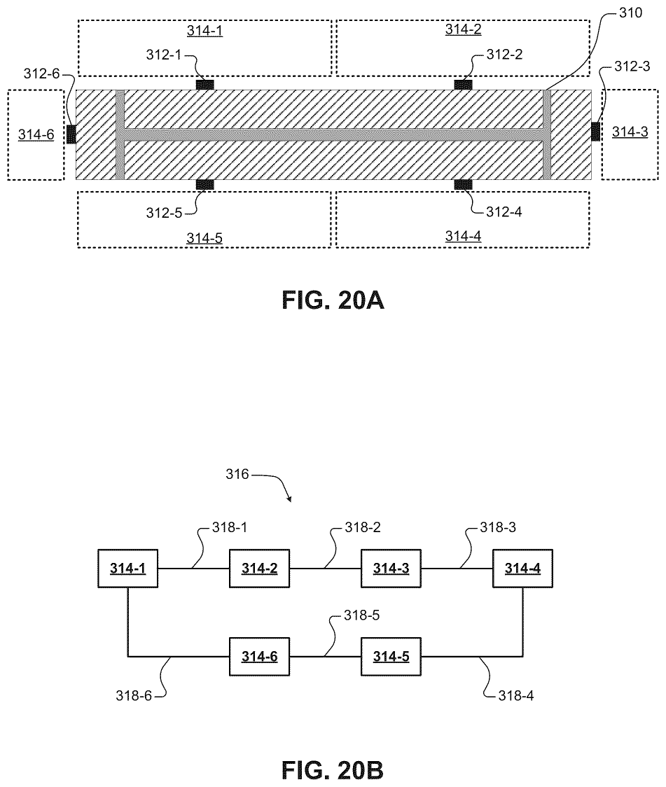

FIGS. 20A-20B show another example location indicator layout. FIG. 20A includes rack 310 that may be accessed from all sides. Rack 310 includes location indicators 312-1, 312-2, . . . , 312-6 (collectively “location indicators 312”) having readable codes. A MSD may scan location indicators 312 to determine location values 314-1, 314-2, . . . , 314-6. Areas 314-1, 314-2, . . . , 314-6 (collectively “areas 314”) surround rack 310 such that the location indicator layout in FIG. 20A results in a location map 316 in which each of areas 314 are adjacent to two other areas.

Junctions 318-1, 318-2, . . . , 318-6 may represent the relative distances between areas 314. For example, area 314-1 is connected to area 314-2 by a single junction 318-1 to represent that area 314-1 is adjacent to area 314-2. Similarly, area 314-2 is connected to area 314-3 by a single junction 318-2 to represent that area 314-2 is adjacent to area 314-3. The distance between area 314-1 and area 314-4, which are not adjacent, may be represented by the three junctions 318-1, 318-2, 318-3 that separate area 314-1 and area 314-4 in location map 316. Similarly, the distance between area 314-3 and area 314-6 may be represented by the three junctions 318-3, 318-4, 318-5 that separate area 314-3 and area 314-6 in location map 316. Alternatively, a user may travel from area 314-3 to area 314-6 via areas 314-1, 314-2. The distance between area 314-3 and area 314-6 via areas 314-1, 314-2 may be represented by three junctions 318-1, 318-2, 318-6 that separate area 314-3 and area 314-6.

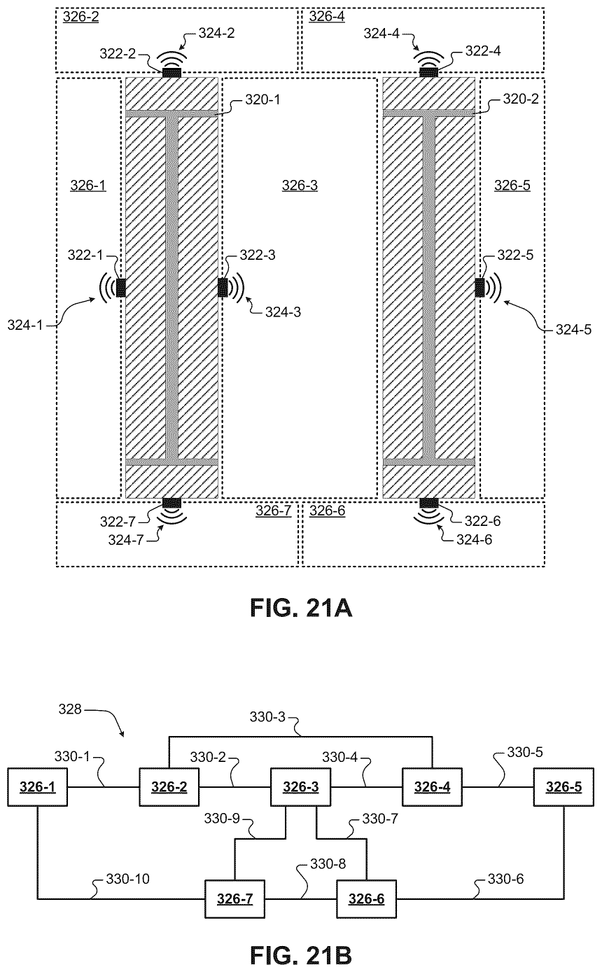

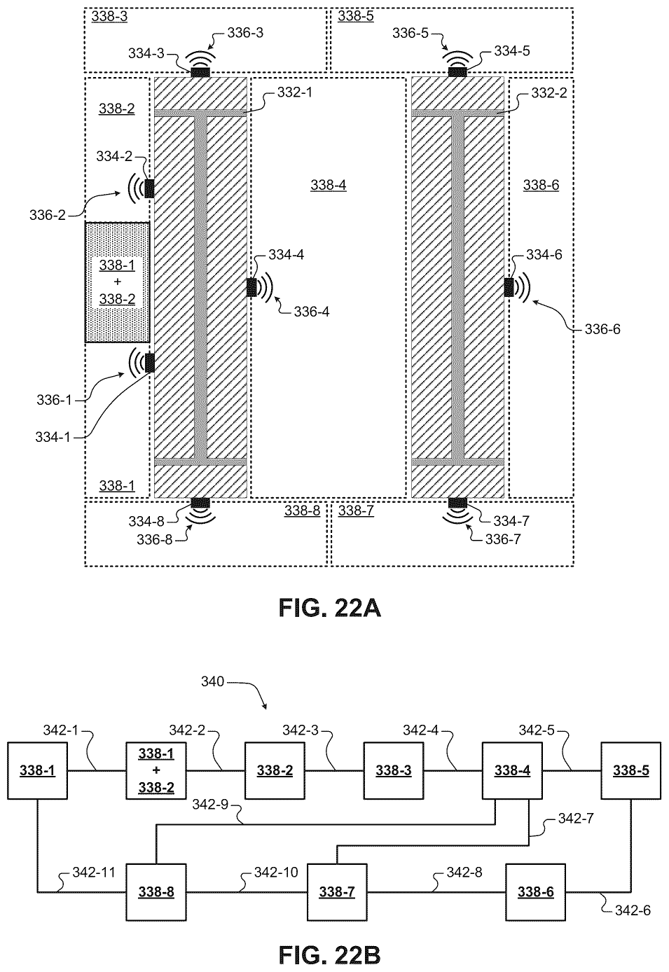

FIGS. 21A-22B illustrate location indicator layouts which are more elaborate than those layouts illustrated in FIGS. 19A-20B. The store of FIG. 21A includes racks 320-1, 320-2. The store of FIG. 21A includes location indicators 322-1, 322-2, . . . , 322-7 (collectively “location indicators 322”) that transmit location signals 324-1, 324-2, . . . , 324-7 (collectively “location signals 324”). An MSD may determine location values 326-1, 326-2, . . . , 326-7 based on detected location signals 324 in areas 326-1, 326-2, . . . , 326-7 (collectively “areas 326”).

The layout of location indicators in FIG. 21A may be considered to be more elaborate than the layout of location indicators in FIGS. 19A-20B in that the store of FIG. 21A includes a greater number of areas. Furthermore, areas 326 in FIG. 21A may be adjacent to up to four other areas. For example, area 326-3 is adjacent to areas 326-2, 326-4, 326-6, 326-7. Multiple other areas are also adjacent to three other areas. For example, area 326-2 is adjacent to areas 326-1, 326-3, 326-4.

Location map 328 includes junctions 330-1, 330-2, . . . , 330-10 (collectively “junctions 330”). Junctions 330 may represent distances between areas 326. For example, adjacent areas (i.e., those connected by one junction) may be closer to one another than non-adjacent areas. However, since areas 322 are not all of equal size, all of junctions 330 may not represent equal distances. For example, areas 326-1, 326-3, 326-5 are slightly larger than areas 326-2, 326-4, 326-6, 326-7. Therefore, any path through location map 328 including areas 326-1, 326-3, 326-5 may represent a slightly longer distance than paths that do not include areas 326-1, 326-3, 326-5. For example, a path from area 326-6 to area 326-4 via area 326-5 (i.e., via junctions 330-6, 330-5) may represent a slightly greater distance than a path from area 326-5 to area 326-7 via area 326-6 (i.e., via junctions 330-6, 330-8).

As described above with respect to FIGS. 21A-21B, the number of junctions between areas may generally represent the distance between areas. However, in some examples, the distance represented by a junction may vary depending on the amount of area covered by a location indicator. Accordingly, it follows that the arrangement of location indicators and the areas covered by location signals may be adjusted in order to adjust the information conveyed by a location map stored within a computing device. For example, when location indicators are arranged at approximately equal distances from one another, the junctions of a location map may represent approximately equal distances between different areas of the store.

FIGS. 22A-22B illustrate a location indicator layout in which two location signals overlap to form an area of the store in which an MSD detects multiple location signals. The store of FIG. 22A includes racks 332-1, 332-2. The store of FIG. 22A includes location indicators 334-1, 334-2, . . . , 334-8 (collectively “location indicators 334”) that transmit location signals 336-1, 336-2, . . . , 336-8 (collectively “location signals 336”). An MSD may determine location values 338-1, 338-2, . . . , 338-8, and “338-1+338-2” based on detected location signals 336 in areas 338-1, 338-2, . . . , 338-8, and “338-1+338-2” (collectively “areas 338”). Note that location map 340 of FIG. 22B includes an area “338-1+338-2” in which two location signals 336-1, 336-2 are detected by an MSD. In this example, area “338-1+338-2” is mapped as an area that is adjacent to area 338-1 and area 338-2. Location map 340 includes junctions 342-1, 342-2, . . . , 342-11 (collectively “junctions 342”). Junctions 342 may represent distances between areas 338. Each of junctions 342 may not represent equal distances, as described above with respect to FIGS. 21A-21B.

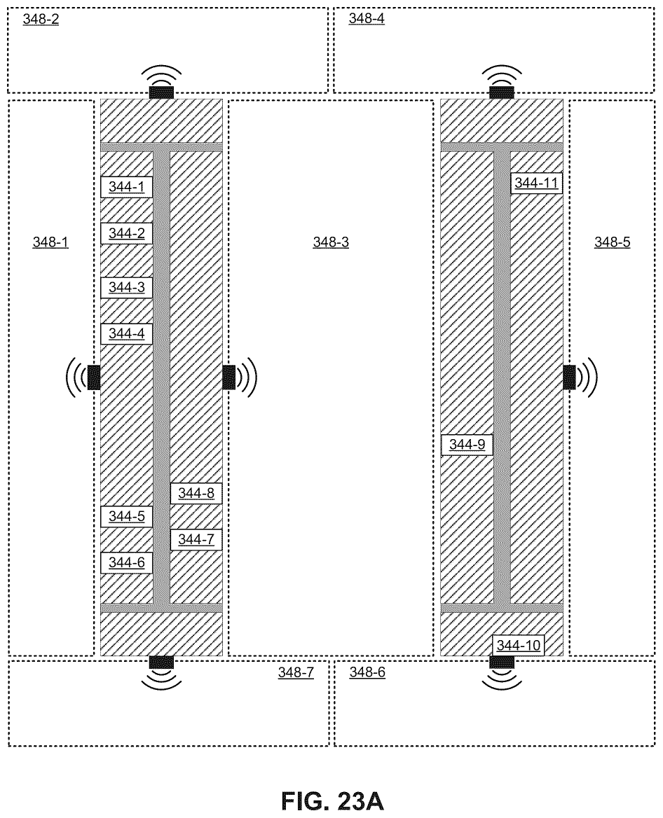

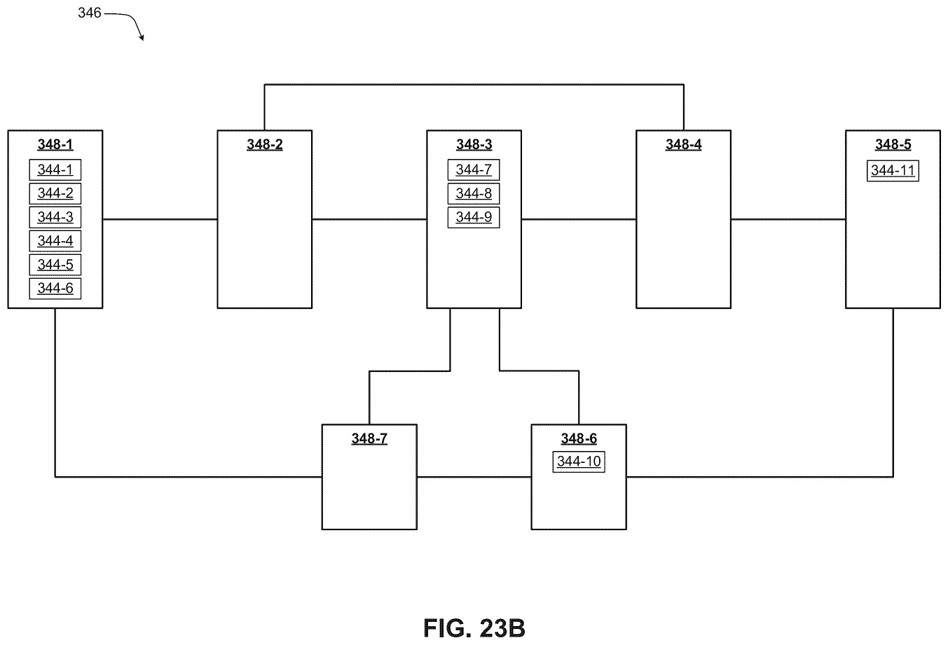

FIG. 23A shows an example store including items 344-1, 344-2, . . . , 344-11 (collectively “items 344”). FIG. 23B shows a location map 346 including items 344. Location map 346 illustrates the association between location values 348 and items 344. Note that the layout of the location indicators and the location map 346 of FIGS. 23A-23B have been described with reference to FIGS. 21A-21B.

Each of items 344 is associated with a location value. For example, items 344-1, 344-2, . . . , 344-6 are proximate to area 348-1 and associated with location value 348-1. Items 344-7, 344-8, 344-9 are proximate to area 348-3 and associated with location value 348-3. Item 344-10 is proximate to area 348-6 and associated with location value 348-6. Item 344-11 is proximate to area 348-5 and associated with location value 348-5. As described hereinafter, items may be displayed on an MSD based on a location map and a currently determined location value. For example, an MSD may include a location map which the MSD may use to arrange ordered items on the display of the MSD.

FIGS. 24-25 show functional block diagrams of example MSDs. MSD 350 of FIG. 24 is configured to receive location signals and determine location values based on received location signals. MSD 352 of FIG. 25 is configured to scan location indicators that include readable objects and determine location values based on the scanned readable objects. MSDs 350, 352 may be implemented using a variety of different form factors.

Referring now to FIG. 24, MSD 350 includes a touchscreen display 354 and a user interface 356. Touchscreen display 354 may include a combination display (e.g., an LCD or OLED display) and a touchscreen. Touchscreen display 354 may display information (e.g., ordered items) to a user. Touchscreen display 354 may also receive user touch input, such as tapping, swiping, and multi-finger input. Although MSDs 350, 352 include touchscreen display 354, in other examples, the display of an MSD may not include touchscreen capabilities.

User interface 356 may represent user interface components, other than touchscreen display 354, which may provide a user interface experience. A user may interact with MSD 350 using user interface 356. User interface 356 may include input components which a user may use to input information into MSD 350, such as touch controls (e.g., capacitive touch buttons, a touchpad, and/or a touch wheel), a keypad (e.g., alphanumeric keys), buttons, a directional pad, an analog stick, switches, a scroll wheel, a track ball, accelerometers, a microphone, or other user interface components. User interface 356 may also include one or more feedback components that provide feedback to a user. Feedback components may include a speaker that provides audible feedback, a vibrating device that provides tactile feedback, and/or visual feedback devices (e.g., LEDs).

A user may interact with MSD 350 using touchscreen display 354 and/or user interface 356. For example, a user may view items included in customer orders along with other information on touchscreen display 354. A user may also swipe their finger across touchscreen display 354 to scroll through the items displayed on touchscreen display 354. As described herein, the items displayed on touchscreen display 354 may be arranged based on a current location of MSD 350.

MSD 350 includes a processing module 358 and memory 360. Processing module 358 may take the form of one or more microprocessors, microcontrollers, digital signal processors (DSPs), application-specific integrated circuits (ASICs), field-programmable gate arrays (FPGAs), programmable logic circuitry, or the like. The functions attributed to processing module 358 herein may be embodied as hardware, firmware, software or any combination thereof. Processing module 358 may provide any of the functionality ascribed herein to MSD 350, or otherwise perform any of the methods described herein.

Memory 360 may store instructions that cause processing module 358 to provide the functionality ascribed to MSD 350 herein. Memory 360 may include any fixed or removable media. For example, memory 360 may include magnetic or electrical media, such as RAM, ROM, magnetic disks, EEPROM, or the like. Memory 360 may also include a removable memory portion that may be used to provide memory updates or increases in memory capacities.

MSD 350 includes a communication module 362 that may provide wireless communication functionality. MSD 350 may communicate with other computing devices using communication module 362, which may be coupled to an internal antenna or an external antenna. For example, MSD 350 may send data to other computing devices using communication module 362. Additionally, MSD 350 may receive data from other computing devices using communication module 362. Examples of wireless communication techniques that may be employed to facilitate communication between MSD 350 and other computing devices using communication module 362 may include communication according to 802.11 or Bluetooth specification sets, infrared communication (e.g., according to the IrDA standard), near-field communication (NFC), cellular communication, or other standard or proprietary communication protocols.

In some examples, MSD 350 may communicate directly with other MSDs. For example, MSD 350 may transmit data from communication module 362 to a communication module of another MSD. Similarly, MSD 350 may receive data from one or more MSDs via communication module 362. In other examples, MSD 350 may communicate with other MSDs via a communication system of a store (e.g., communication system 112 of FIG. 1). In these examples, MSD 350 may transmit data to the communication system from communication module 362. The transmitted data may then be sent from the communication system to other MSDs.

In some examples, MSD 350 may communicate with a CCS of a store (e.g., CCS 104 of FIG. 1) via a communication system (e.g., communication system 112 of FIG. 1) of the store. For example, MSD 350 may transmit data from communication module 362 to the communication system. The communication system may then send the data to the CCS. MSD 350 may also receive data from the communication system. For example, the CCS may send data to the communication system which then wirelessly transmits the data to communication module 362.

MSD 350 includes a scanning module 364 that may represent any devices (e.g., electronic hardware, software/firmware) configured to scan item ID codes. For example, scanning module 364 may be configured to scan printed codes, such as barcodes (e.g., linear, 2D, or QR barcodes). Scanning module 364 may include one or more types of technology for scanning item ID codes. In some examples, scanning module 364 may include one or more photodiodes and associated electronics/software for reading light and dark portions of an item ID code on the item. In some examples, scanning module 364 may include one or more lasers and associated electronics/software for scanning back and forth across an item ID code to read the item ID code. In some examples, scanning module 364 may include one or more charge-coupled device readers (“CCD readers”) and associated electronics/software for reading light and dark portions of an item ID code on the item. In some examples, scanning module 364 may include a small camera (e.g., CCD readers or CMOS imaging) and associated image processing electronics/software for interpreting the item ID code. Shading 366 included in FIGS. 24-25 is meant to illustrate the scanning of item ID code 368 (e.g., a barcode) on item 370 (e.g., using a photodiode, one or more lasers, or other technology).

Scanning module 364 may be configured to scan item ID codes in response to user input. For example, a user may press a key (e.g., pull a trigger) on user interface 356 to cause scanning module 364 to scan an item ID code. Example form factors of MSD 350 including a key (e.g., a trigger) which may be pressed by a user to initiate an item scan are illustrated in FIGS. 26A, 26B, 26D, 26F. In other examples, scanning module 364 may not require user input to operate. Instead, scanning module 364 may constantly operate. In these examples, a laser, or other technology included in scanning module 364 may constantly operate and may scan an item ID code when the user places the item including the item ID code in front of scanning module 364.

In some examples, item ID codes may not be included on items as printed codes. Instead, items may include RFID tags that include the item ID codes. It is contemplated that scanning module 364 may include an RFID tag reader in addition to, or instead of, optical scanning technology in order to allow scanning module 364 to scan RFID tags. Accordingly, scanning module 364 may also represent RFID reader electronics/software for scanning RFID tags.

MSD 350 includes a location detection module 372 that receives a location signal and determines a location value based on the received location signal. A location indicator 374 that transmits location signal 376 is included in FIG. 24 to indicate that location detection module 372 is configured to receive location signals. Location detection module 372 may generally represent any devices (e.g., electronic hardware and software) capable of receiving location signals and generating location values described herein. In some examples, location detection module 372 may include an antenna for receiving location signals transmitted by antennas included on location indicators. In other examples, location detection module 372 may include a light detection device for receiving location signals transmitted by light emitting devices (e.g., LEDs or other photonic devices). In other examples, location detection module 372 may include an acoustic device for receiving location signals (e.g., sound waves) transmitted by an acoustic device. In other examples, where location indicators in the store include RFID tags, location detection module 372 may be configured to scan the RFID tags and determine a location value based on the data retrieved from the RFID tags. Additionally, in some examples, location detection module 372 may be configured to transmit energy to energize RFID tags so that the RFID tags may transmit data to location detection module 372.

MSD 350 includes a power source 378 that delivers operating power to the components of MSD 350. Power source 378 may include a fixed or removable battery in some examples. In some examples, power source 378 may include an adapter for charging the battery.

Processing module 358 may receive input and data from various components of MSD 350. For example, processing module 358 may receive user input from user interface 356 and touchscreen display 354. Additionally, processing module 358 may receive data from communication module 362 (e.g., received wireless data and customer orders), scanning module 364 (e.g., item IDs), and location detection module 372 (e.g., location values). Processing module 358 may also receive data from memory 360 (e.g., a location map and associations between items and location values).

Processing module 358 may also send data to components of MSD 350. For example, processing module 358 may store a list of items in memory 360 from the customer orders that have been placed. Processing module 358 may store the items of customer orders in memory 360 as follows. When a customer order is placed, a communication system (e.g., communication system 112) may transmit the customer order to communication module 362. Processing module 358 may then store the received customer order in memory 360. Processing module 358 may then update the customer orders in memory 360 as new customer orders are placed.

Processing module 358 may also control components of MSD 350, such as touchscreen display 354 and scanning module 364. For example, processing module 358 may control the image (e.g., the ordered items) displayed on touchscreen display 354. Additionally, processing module 358 may control when scanning module 364 scans an item. For example, when processing module 358 detects a user pushing a scan button (e.g., a trigger) of user interface 356, processing module 358 may instruct scanning module 364 to scan an item ID code. After scanning module 364 scans an item ID code, scanning module 364 may send the item ID code to processing module 358. As described hereinafter, processing module 358 may keep track of which items have been scanned by MSD 350 and other MSDs. For example, processing module 358 may remove the item ID code from the list of currently ordered items in memory 360 after the item has been scanned.

Although the MSDs are illustrated in FIGS. 24-25 as rectangular, MSD 350 may be configured into a variety of different form factors. In general, MSD 350 may have a form factor that may be transported by a user throughout the store. In some examples, MSD 350 may have a handheld form factor. In other examples, MSD 350 may be configured to be placed in, or attached to, a cart and moved around the store by a user.

In some examples, components of MSD 350 may be included in a single housing (e.g., a molded plastic housing). For example, touchscreen display 354, user interface 356, memory 360, communication module 362, processing module 358, scanning module 364, location detection module 372, and power source 378 may be housed in a single housing. When housed in the single housing, in some examples, MSD 350 may be embodied as a handheld computing device that a user may easily transport throughout the store.

Although the MSDs in FIGS. 24-25 are illustrated as included in a single rectangular housing, it is contemplated that components of MSDs may be housed in multiple different housings. In these examples, the different components of MSDs may be wired together or may wirelessly communicate with one another. Example MSD form factors are illustrated in FIGS. 26A-26I.

FIG. 26A shows an example from factor 380 in which an MSD of the present disclosure may be implemented. The example device pictured in FIG. 26A is an XG100 W mobile computer available from Janam Technologies. Form factor 380 includes a display 382, keypad 384, and an example scanning module 386 (e.g., barcode reader). Although not shown in FIG. 26A, form factor 380 may be configured to include an internal communication module, memory, processing module, and power source according to the present disclosure. In examples where a store includes location indicators that have readable codes, scanning module 386 may also act as a location detection module. In examples where location indicators transmit location signals, additional components may be added to form factor 380 so that form factor 380 is configured to receive transmitted location signals. For example, an antenna, a light detection device, an acoustic device, and/or an RFID reader may be added to the form factor to receive transmitted location signals.

FIG. 26B shows an example from factor 388 in which an MSD of the present disclosure may be implemented. The example device of FIG. 26B is an Alien ALH-9000 handheld RFID reader available from Alien Technology. Form factor 388 includes a display 390, keypad 392, an example location detection module 394 (e.g., an RFID reader), and an example scanning module 396 (e.g., a barcode reader). Although not shown in FIG. 26B, form factor 388 may be configured to include an internal communication module, memory, processing module, and power source according to the present disclosure.

FIG. 26C shows an example from factor 398 in which an MSD of the present disclosure may be implemented. The example device of FIG. 26C is an MC55A0 handheld terminal available from Motorola. Form factor 398 includes a display 400, keypad 402, and an example scanning module (not shown) (e.g., barcode reader). Although not shown in FIG. 26C, form factor 398 may be configured to include an internal communication module, memory, processing module, and power source according to the present disclosure. In examples where a store includes location indicators that have readable codes, the scanning module may also act as a location detection module. In examples where location indicators transmit location signals, additional components may be added to form factor 398 so that form factor 398 is configured to receive transmitted location signals. For example, an antenna, a light detection device, an acoustic device, and/or an RFID reader may be added to the form factor to receive transmitted location signals.

FIG. 26D shows an example from factor 404 in which an MSD of the present disclosure may be implemented. The example device of FIG. 26D is a WT4090 wearable terminal available from Motorola. Form factor 404 includes a display 406, keypad 408, and an example scanning module 410 (e.g., barcode reader). Although not shown in FIG. 26D, form factor 404 may be configured to include an internal communication module, memory, processing module, and power source according to the present disclosure. In examples where a store includes location indicators that have readable codes, scanning module 410 may also act as a location detection module. In examples where location indicators transmit location signals, additional components may be added to form factor 404 so that form factor 404 is configured to receive transmitted location signals. For example, an antenna, a light detection device, an acoustic device, and/or an RFID reader may be added to the form factor to receive transmitted location signals.

FIGS. 26E-26I show example components that may be included in MSDs according to the present disclosure. FIGS. 26E-26F show example scanning modules 412, 414 (e.g., barcode scanners) that may be included in an MSD. For example, scanning modules 412, 414 may be connected to (e.g., wired/wirelessly) other components of an MSD of the present disclosure. The example devices of FIG. 26E-26F represent typical barcode scanners.

FIG. 26G shows an example touchscreen display 416 that may be included in an MSD. For example, such a touchscreen display 416 may be connected to (e.g., wired/wirelessly) other components of a MSD of the present disclosure. The example device of FIG. 26G is an iPad mini available from Apple. FIG. 26H shows an example display 418 (e.g., an electrophoretic display) that may be included in an MSD. For example, such a display 418 may be connected to (e.g., wired/wirelessly) other components of an MSD of the present disclosure. The example device of FIG. 26H is a Kindle available from Amazon. FIG. 26I shows another example display 420 that may be included in an MSD. Display 420 is a heads-up display that may be worn on a user's head (e.g., as a pair of glasses). Display 420 may be connected to (e.g., wired/wirelessly) other components of an MSD of the present disclosure. The example device of FIG. 26I is a Google Glass device available from Google. Although not illustrated in FIGS. 26A-26I, MSDs may also include other computing devices, such as smart phones (e.g., cell phones). Smart phones may include components that provide functionality attributed to the MSDs described herein. For example, smartphones may detect location signals, such as Bluetooth-based location signals, light transmissions from LEDs (e.g., using a camera), and acoustic location signals (e.g., using a microphone). Additionally, smartphones may include a camera or other device that can be used to scan an item ID code (e.g., a barcode). Accordingly, in some implementations, the customers may use their own smart phone devices to pick their own orders according to the present disclosure. Additionally, third-party pickers may also use their smart phones (or devices provided by the third-party to the pickers) to pick orders.

FIG. 25 shows another example MSD 352. MSD 352 of FIG. 25 is similar to MSD 350 of FIG. 24, except that location detection module 422 of FIG. 25 is different than location detection module 372 of FIG. 24. Location detection module 422 is configured to scan location indicators that include readable codes (e.g., location indicator 424) and determine a location value based on the scanned readable code. In some examples, the scanning functionality of scanning module 364 and location detection module 422 may be combined. For example, if location indicators include barcodes, MSD 352 may include barcode scanning hardware/software that may scan barcodes included on items and scan barcodes included on location indicators.

Location detection module 422 may represent any devices (e.g., electronic hardware, software/firmware) configured to scan readable codes. For example, location detection module 422 may be configured to scan readable codes (e.g., FIGS. 11A-11C) such as barcodes (e.g., linear, 2D, or QR barcodes). Location detection module 422 may include one or more types of technology for scanning readable codes. In some examples, location detection module 422 may include one or more photodiodes and associated electronics/software for reading light and dark portions of a readable code. In some examples, location detection module 422 may include one or more lasers and associated electronics/software for scanning back and forth across readable codes to read the readable codes. In some examples, location detection module 422 may include one or more CCD readers and associated electronics/software for reading light and dark portions of a readable code. In some examples, location detection module 422 may include a camera (e.g., CCD readers or CMOS imaging) and associated image processing electronics/software for interpreting the readable code. For example, location detection module 422 may acquire an image and identify a readable code in the image, even when the image includes other objects, such as items.

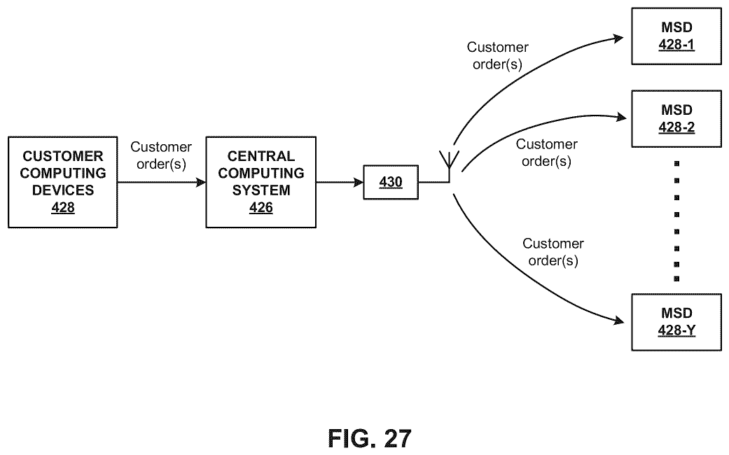

As described above, customers may place customer orders with a CCS. FIG. 27 shows the placement of customer orders with CCS 426 using CCDs 428. In FIG. 27, CCS 426 is configured to wirelessly transmit customer orders to MSDs 428-1, 428-2, . . . , 428-Y (collectively “MSDs 428”) via communication system 430. Each of MSDs 428 may receive the customer orders. Each of MSDs 428 may store the received customer orders in their respective memories.

Each of MSDs 428 may also display at least some of the ordered items on their respective displays. The arrangement of items displayed on each of MSDs 428 may depend on the locations of the MSDs. Arrangement of items on an MSD is described in further detail herein.

Although multiple MSDs 428 are illustrated in FIG. 27, in some examples, a store may include only a single MSD. For example, a store may include only MSD 428-1. In this example, CCS 426 may wirelessly transmit customer orders to MSD 428-1. MSD 428-1 may store the received customer orders in memory. Additionally, MSD 428-1 may determine a location value based a received location signal (or scanned readable code) and arrange the items (e.g., some of the items) of customer orders on the display according to the determined location value.

A store may include any number of MSDs. As described above, a store may include a single MSD in some examples. In other examples, a store may include two or more MSDs. For example, a store may include 10 or more MSDs in some examples.

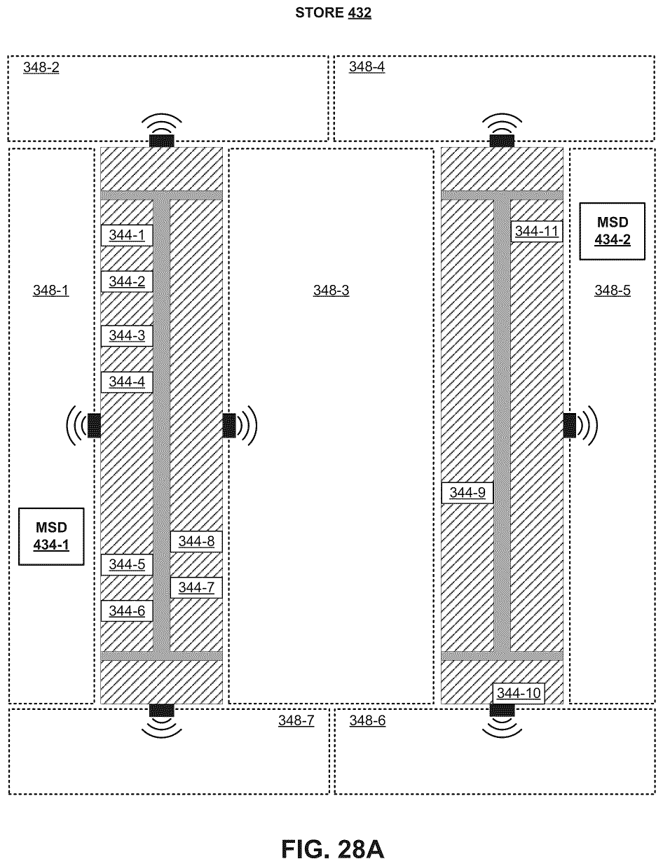

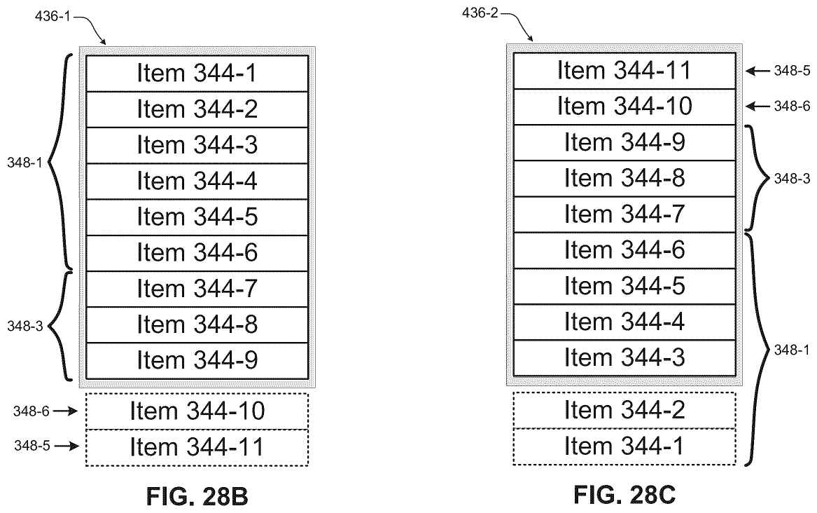

FIGS. 28A-C show how multiple MSDs may display customer orders to users. In FIG. 28A, store 432 includes two MSDs 434-1, 434-2. It can be assumed that each of MSDs 434-1, 434-2 has received one or more customer orders including items 344-1, 344-2, . . . , 344-11 (collectively “items 344”) from a communication system. For example, a single customer order may have included all items 344. As another example, a first customer order may have included items 344-1, 344-2, and a second customer order may have included the remaining items 344-3, 344-4, . . . , 344-11. It may also be assumed that each of the memories of MSDs 434-1, 434-2 include items 344, a location map of store 432, and associations between items 344 and location values 348. The location map 346 of store 432 including items 344 is illustrated in FIG. 23B.

As shown in FIG. 28A, MSD 434-1 is in zone 348-1 which includes items 344-1, 344-2, . . . , 344-6. Accordingly, MSD 434-1 is likely to be nearest to items 344-1, 344-2, . . . , 344-6. According to location map 346, MSD 434-1 is near zone 348-3 including items 344-7, 344-8, 344-9. The next nearest zones including items of customer orders are zones 348-6, 348-5, which include items 344-10, 344-11. Based on the proximity of the zones described above with respect to location map 346, it may be most efficient for a user of MSD 434-1 to pick items from zone 348-1, then zone 348-3, then zone 348-6 and zone 348-5.

MSD 434-2 is in zone 348-5, which includes item 344-11. Accordingly, MSD 434-2 is likely to be nearest to item 344-11. According to location map 346, MSD 434-2 is near zone 348-6 including item 344-10. The next nearest zones including items of customer orders are zone 348-3 and zone 348-1, which include items 344-7, 344-8, 344-9 and items 344-1, 344-2, . . . , 344-6, respectively. Based on the proximity of the zones described above with respect to location map 346, it may be most efficient for a user of MSD 434-2 to pick items from zone 348-5, then zone 348-6, zone 348-3, and zone 348-1.

FIG. 28B shows an example display 436-1 of MSD 434-1 before MSD 434-1 has picked any of items 344. FIG. 28C shows an example display 436-2 of MSD 434-2 before MSD 434-2 has picked any of items 344. In FIG. 28B, display 436-1 of MSD 434-1 has items 344 arranged such that the items nearest to MSD 434-1 are located at the top of display 436-1. In FIG. 28C, display 436-2 of MSD 434-2 has items 344 arranged such that the items nearest to MSD 436-2 are located at the top of display 436-2. The zones that include each of the items are indicated next to displays 436-1, 436-2. Items in dotted boxes under displays 436-1, 436-2 represent those items that may not fit onto displays 436-1, 436-2. Items in dotted boxes may appear on displays 436-1, 436-2 when MSDs 434-1, 434-2 are moved throughout store 432 and/or MSDs 434-1, 434-2 scan one or more of items 344. In some examples, a user may swipe displays 436-1, 436-2 to scroll down the items 344 to reveal those items that are currently not displayed.

It is contemplated that many customer orders (e.g., dozens of orders) may be placed with a store over a relatively short period of time. Each of the customer orders placed may include many items (e.g., dozens of items). Accordingly, the display of an MSD may not be able to sufficiently display all of the items that are currently ordered. Displaying those items which are likely closest to the users of MSDs, as illustrated in FIGS. 28B-28C, may allow the users to easily determine which items to pick. For example, if more than 100 items are currently ordered by customers, each MSD in a store may display 10-20 of the closest items so that the user can focus on picking those 10-20 items. In examples where more items are ordered than may be displayed on a display, the MSDs may determine an order in which to display those ordered items which are not currently displayed. For example, MSDs may arrange the items in memory based on the distances of the items from the MSDs (e.g., using a location map).

As described above, users may scan item IDs of ordered items using MSDs. In general, a user may scan an item ID using an MSD when the user picks the item off a rack. After scanning the item ID code, the user may place the item in a cart and take the item to a collection area of the store where the items of a customer order are put together for customer pickup or delivery. An MSD may communicate to other computing devices that the MSD has scanned an item. For example, an MSD may communicate to the CCS and/or other MSDs that an item ID code has been scanned. Accordingly, the CCS and/or the MSDs may determine which items of the current customer orders have already been picked by other MSDs.

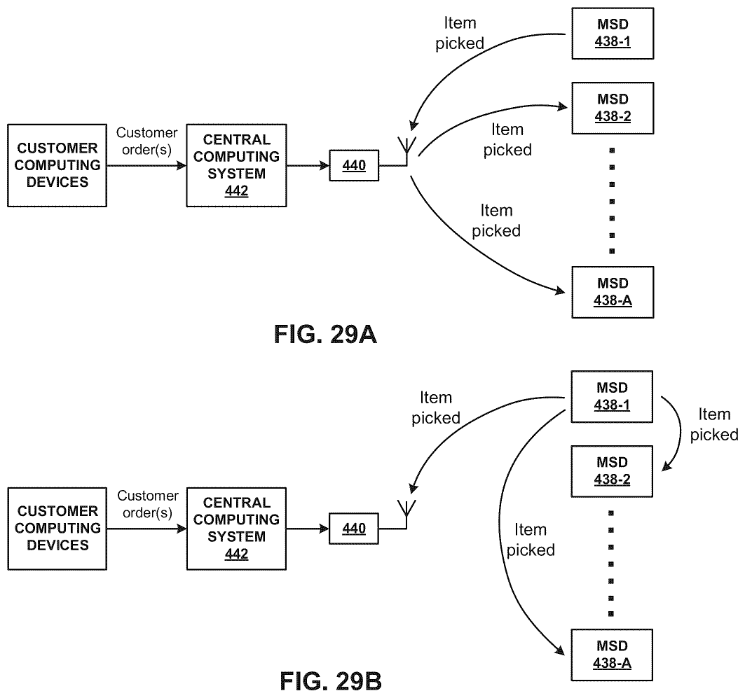

FIGS. 29A-29B show example communications between MSDs and a CCS. In FIGS. 29A-29B, it may be assumed that MSDs 438-1, 438-2, . . . , 438-A (collectively “MSDs 438”) have received customer orders for one or more items. In FIG. 29A, MSD 438-1 scans an item ID code and communicates back to communication system 440 that the item has been picked. Communication system 440 may indicate to CCS 442 that the item has been picked. Based on this information, CCS 442 may update the status of the customer orders in CCS 442 to indicate that the item has been picked. Additionally, or alternatively, CCS 442 may indicate to MSDs 438-2, . . . , 438-A that the item has been picked. MSDs 438 may update their memories to indicate that the item has been picked. For example, MSDs 438 may delete the item from memory and/or remove the items from their displays because users of MSDs 438 no longer need to pick the item.

In FIG. 29B, MSD 438 scans an item ID code and communicates back to communication system 440 and MSDs 438-2, . . . , 438-A that the item has been picked. In FIG. 29B, MSDs 438 are configured to communicate with one another, which may allow any of MSDs 438 to indicate to any other one of MSDs 438 that an item has been picked. MSD 438-1 may also indicate to CCS 442, via communication system 440, that the item has been picked so that CCS 442 may keep track of which items are currently picked. MSDs 438 may update their memories to indicate that the item has been picked. For example, MSDs 438 may delete the item from memory and/or remove the items from their displays because users of MSDs 438 no longer need to pick the item.

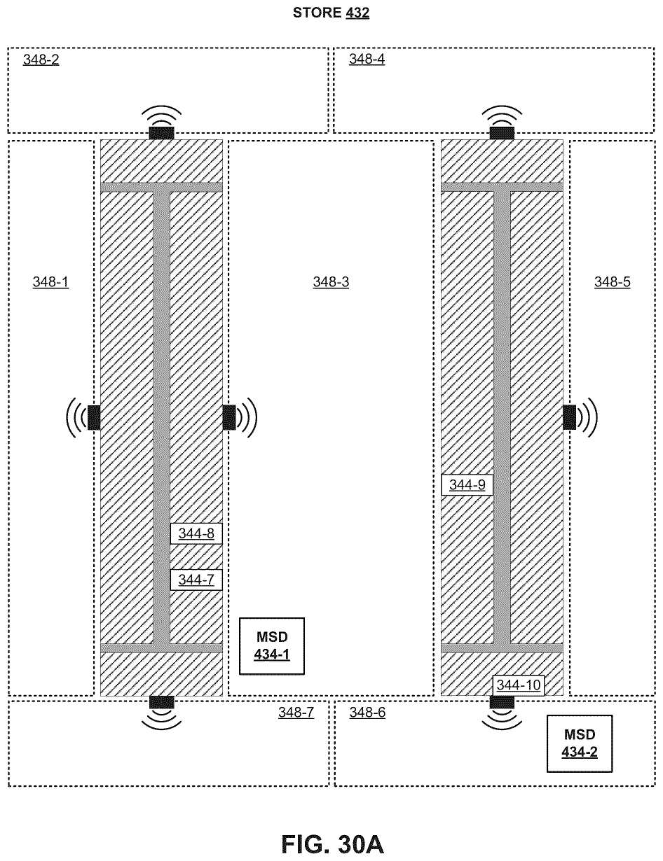

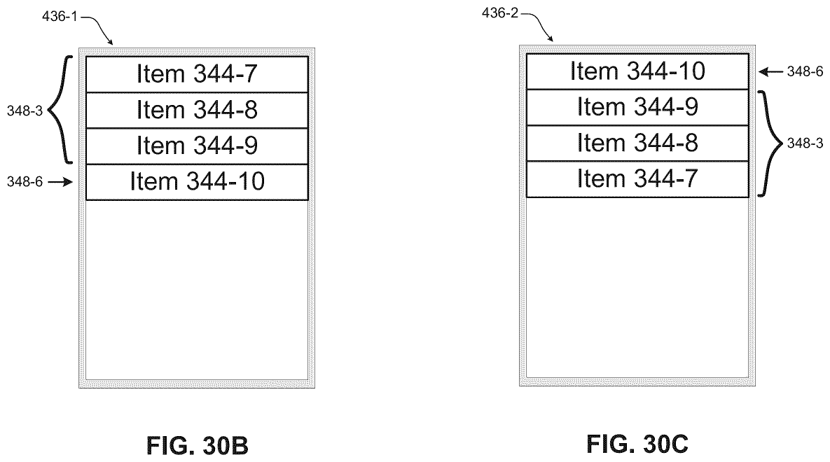

FIGS. 30A-30C show store 432 and MSDs 434-1, 434-2 of FIGS. 28A-28C after MSDs 434-1, 434-2 have moved through store 432 and picked some items. In FIG. 30A, MSD 434-1 has scanned items 344-1, . . . , 344-6 and been moved from zone 348-1 to zone 348-3. In FIG. 30A, MSD 434-2 has scanned item 344-11 and been moved from zone 348-5 to zone 348-6.

As shown in FIG. 30A, MSD 434-1 is in zone 348-3 which includes items 344-7, 344-8, 344-9. Accordingly, MSD 434-1 is likely to be nearest to items 344-7, 344-8, 344-9. According to location map 346, MSD 434-1 is near zone 348-6 including item 344-10. Based on the proximity of the zones described above with respect to location map 346, it may be most efficient for a user of MSD 434-1 to pick items from zone 348-3, then zone 348-6. In FIG. 30B, display 436-1 of MSD 434-1 has items 344-7, 344-8, 344-9, 344-10 arranged such that the items nearest to MSD 434-1 are located at the top of display 436-1, while the items farthest from MSD 434-1 (e.g., item 344-10) are located farther down display 436-1.

As shown in FIG. 30A, MSD 434-2 is in zone 348-6 which includes item 344-10. Accordingly, MSD 434-2 is likely to be near item 344-10. According to location map 346, MSD 434-2 is near zone 348-3 including items 344-7, 344-8, 344-9. Based on the proximity of the zones described above with respect to location map 346, it may be most efficient for a user of MSD 434-2 to pick items from zone 348-6 and then zone 348-3. In FIG. 30C, display 436-2 of MSD 434-2 has items 344-7, 344-8, 344-9, 344-10 arranged such that the items nearest to MSD 434-2 are located at the top of display 436-2, while the items farthest from MSD 434-2 (e.g., item 344-7, 344-8, 344-9) are located farther down the display.

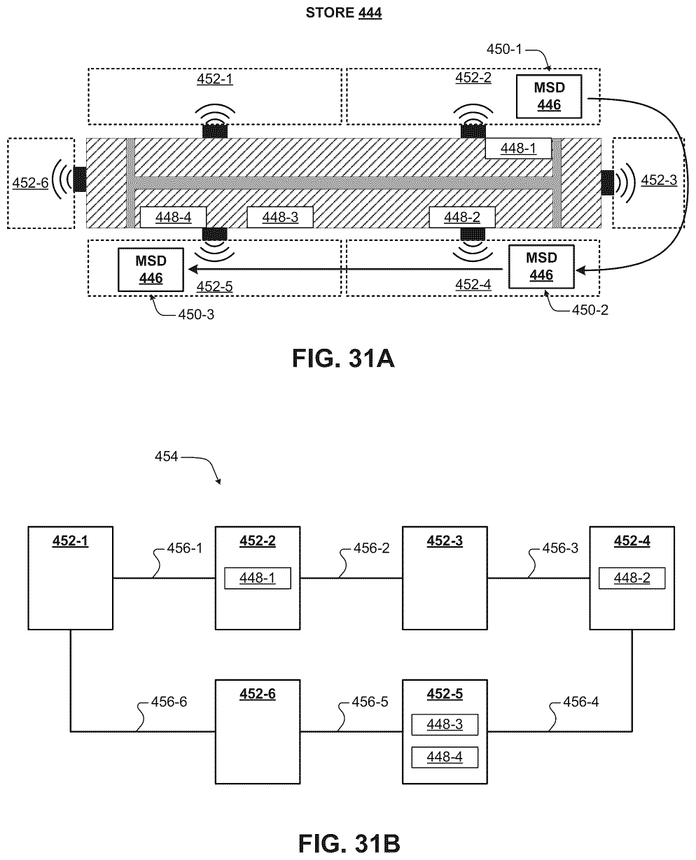

FIGS. 31A-31C show how a display of an MSD may be updated as the MSD is moved throughout a store. FIG. 31A shows a store 444 including an MSD 446. It may be assumed that MSD 446 has received a customer order including items 448-1, 448-2, 448-3, 448-4 (collectively “items 448”). In FIG. 31A, MSD 446 is moved throughout store 444 without picking items 448. Arrows show the path of MSD 446 through store 444. Initially, MSD 446 is at position 450-1 in zone 452-2. MSD 446 then moves to position 450-2 in zone 452-4. Subsequently, MSD 446 moves to position 450-3 in zone 452-5.

FIG. 31B shows a location map 454 of store 444. Location map 454 may be stored in MSD 446 in some examples. Location map 454 includes zones 452-1, 452-2, . . . , 452-6 and junctions 456-1, 456-2, . . . , 456-6. FIG. 31C shows display 458 of MSD 446 at different positions 450-1, 450-2, 450-3 in store 444. MSD 446 may arrange items 448 on display 458 based on location map 454. For example, MSD 446 may arrange items that are nearest to MSD 446 at the top of display 458. MSD 446 may arrange those items that are farther from MSD 446 toward the bottom of display 458. In some circumstances (not illustrated in FIG. 31A), more items may be ordered by customers than could be displayed on display 458. In these circumstances, MSD 446 would include some of the ordered items on display 458 and, as MSD 446 is moved throughout store 444, items that were not originally displayed on display 458 may appear on display 458 as MSD 446 is moved into a zone including those items.

Initially, MSD 446 is located at position 450-1. MSD 446 may determine location value 452-2 in zone 452-2. According to location map 454, item 448-1 is located in zone 452-2. Accordingly, as illustrated in FIG. 31C, MSD 446 may display item 448-1 at the top of display 458. MSD 446 may determine that item 448-2 is the next nearest ordered item since item 448-2 is two junctions 456-2, 456-3 from zone 452-2. Accordingly, item 448-2 may be displayed below item 448-1 on display 458 when MSD 446 is at position 450-1. Items 448-3, 448-4, which are located farthest from zone 452-2 may be displayed at the bottom of the items displayed on display 458 since those items are farthest from zone 452-2.

As illustrated in FIG. 31A, MSD 446 is moved from position 450-1 to position 450-2. MSD 446 may determine location value 452-4 at position 450-2. In zone 452-4, MSD 446 may determine that item 448-2 is nearest to MSD 446. MSD 446 may also determine that items 448-3, 448-4 are the next nearest ordered items because zone 452-5 is adjacent to zone 452-4. Additionally, MSD 446 may determine that item 448-1 is farthest from MSD 446. Accordingly, as illustrated in FIG. 31C, items 448-2, 448-3, 448-4, 448-1 are arranged from the top of display 458 to the bottom of display 458 when MSD 446 is at position 450-2.

As illustrated in FIG. 31A, MSD 446 is moved from position 450-2 to position 450-3. MSD 446 may determine location value 452-5 at position 450-3. In zone 452-5, MSD 446 may determine that items 448-3, 448-4 are nearest to MSD 446. MSD 446 may also determine that item 448-2 is the next nearest ordered item because zone 452-4 is adjacent to zone 452-5. Additionally, MSD 446 may determine that item 448-1 is farthest from MSD 446. Accordingly, as illustrated in FIG. 31C, items 448-3, 448-4, 448-2, 448-1 are arranged from the top of display 458 to the bottom of display 458 when MSD 446 is at position 450-3.

Although an MSD may arrange items nearest to the MSD near the top of the display, the items nearest to the MSD may be indicated on the display in another manner. For example, an MSD may arrange the nearest items near the bottom of the display. In other examples, the MSD may display the nearest items in bold font. In other examples, the MSD may display the nearest items in larger font. In still other examples, the MSD may display the nearest items in different colors.

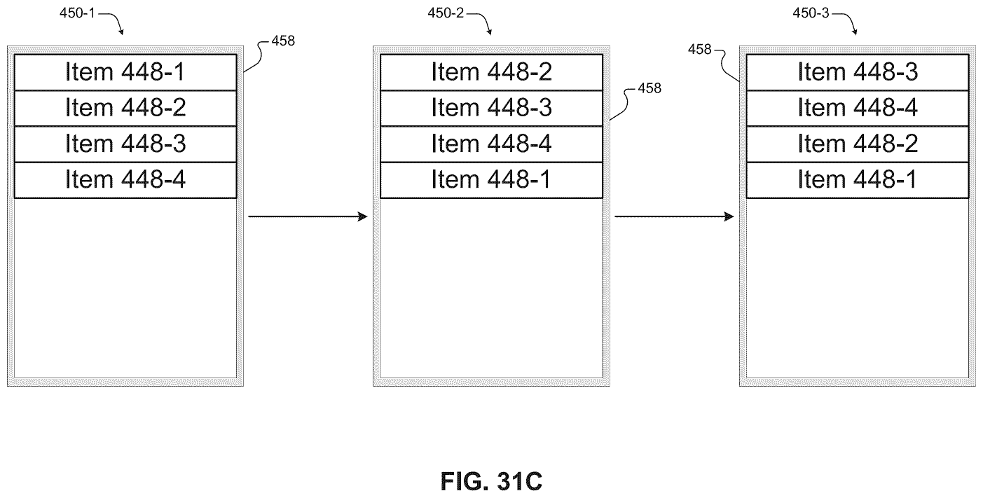

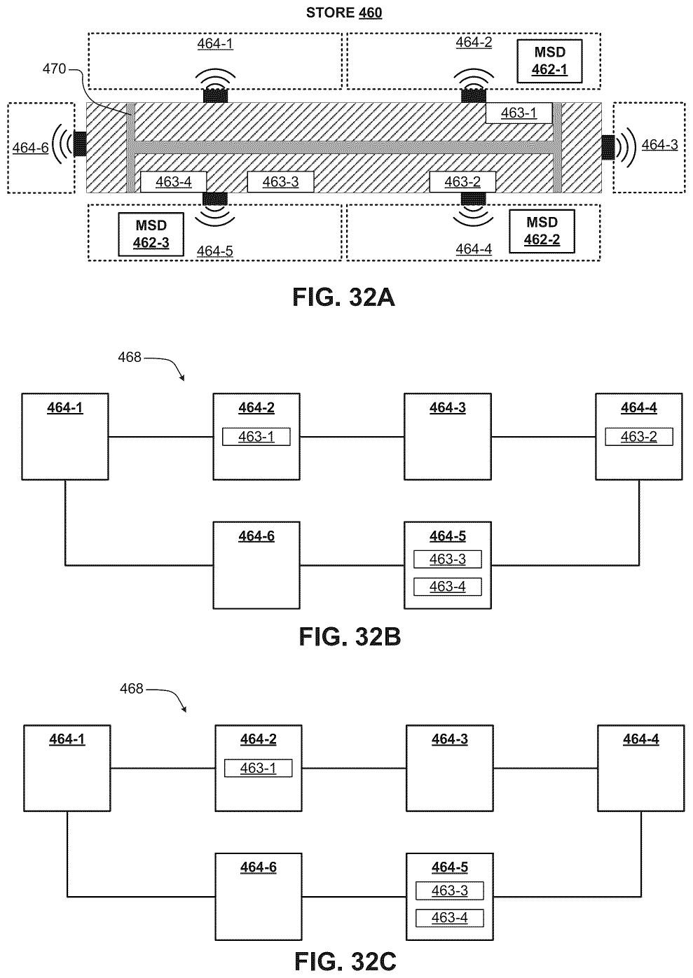

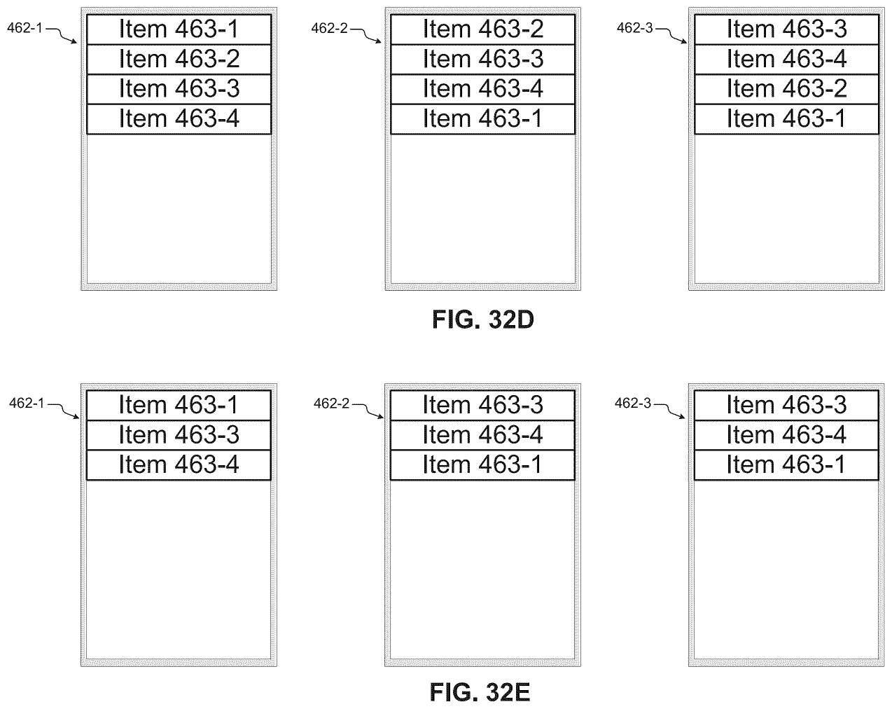

FIGS. 32A-32E show displays of multiple MSDs and how the displays are updated when items are picked. FIG. 32A shows a store 460 including MSDs 462-1, 462-2, 462-3. It may be assumed that MSDs 462-1, 462-2, 462-3 have received a customer order including items 463-1, 463-2, 463-3, 463-4 (collectively “items 463”). In FIGS. 32A-32E, it may be assumed that each of MSDs 462-1, 462-2, 462-3 is maintained in the zones illustrated in FIG. 32A. For example, MSD 462-1 is maintained in zone 464-2. MSD 462-2 is maintained in zone 464-4. MSD 462-3 is maintained in zone 464-5.

FIG. 32B shows a location map 468 before any of items 463 are scanned. FIG. 32D shows displays of each of MSDs 462-1, 462-2, 462-3 before any of items 463 are scanned. Referring back to FIG. 32A, MSD 462-2 may scan the item ID code of item 463-2. For example, a user may pick item 463-2 from rack 470, scan a barcode on item 463-2 using MSD 462-2, and place item 463-2 into a cart. MSD 462-2 may transmit data to other MSDs 462-1, 462-3 indicating that item 463-2 has been picked. For example, MSD 462-2 may transmit an indication to the communication system that item 463-2 has been picked. The communication system may then indicate to MSDs 462-1, 462-3 that item 463-2 has been picked. In response to such an indication, MSDs 462-1, 463-3 may remove item 463-2 from their displays. In examples where MSD 462-2 may directly communicate with MSDs 462-1, 462-3, MSD 462-2 may wirelessly transmit data to other MSDs 462-1, 462-3 indicating that item 463-2 has been picked. In response to such an indication from MSD 462-2, MSDs 462-1, 462-3 may remove item 463-2 from their displays.

FIG. 32C shows an updated location map 468 in which item 463-2 has been removed after item 463-2 has been picked. Location map 468 of FIG. 32C including items 463-1, 463-3, 463-4 may be representative of a location map included in MSDs 462-1, 462-2, 462-3 after MSDs 462-1, 462-3 are notified that item 463-2 has been picked. For example, location map 468 of FIG. 32C may represent the location map of MSD 462-2 after MSD 462-2 scans item 463-2. Similarly, location map 468 of FIG. 32C may represent the location maps of MSDs 462-1, 462-3 after MSDs 462-1, 462-3 have received indications that item 463-2 has been picked. FIG. 32E shows updated displays of MSDs 462-1, 462-2, 462-3 in which MSDs 462-1, 462-2, 462-3 have removed item 463-2 from their displays.

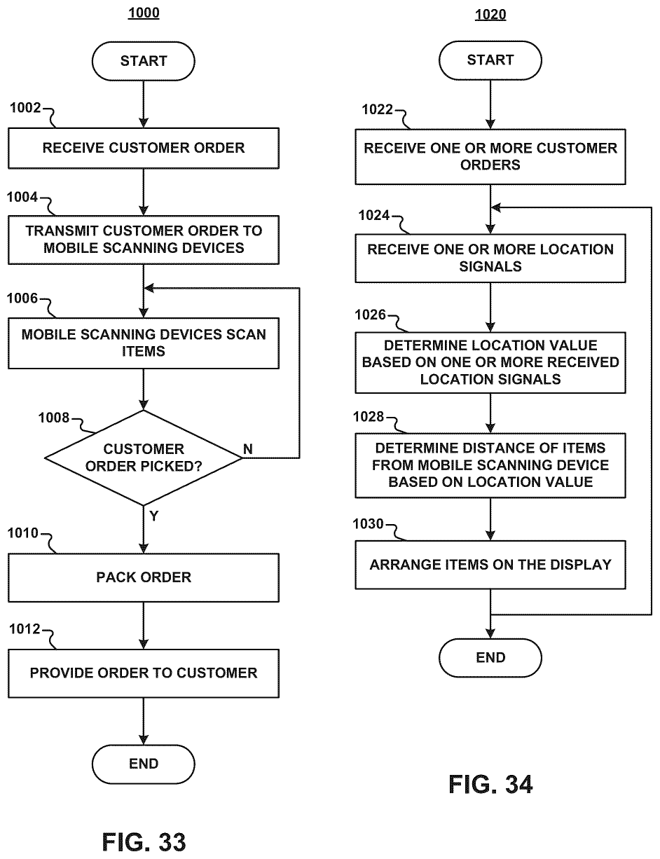

FIGS. 33-36 illustrate methods that describe operations of the OFS. FIG. 33 is a method 1000 that describes operation of an OFS from receipt of a customer order until the order is provided to the customer. The method 1000 of FIG. 33 is now described with reference to FIG. 1. At 1002, the CCS receives a customer order from CCDs. At 1004, the CCS wirelessly transmits the customer order to one or more MSDs via the communication system. At 1006, the MSDs are transported throughout the store 100 by users that scan items of the customer order. The users may pick the items from the racks before scanning the items. The users may place the items in a cart after scanning the items.

If the customer order has not been picked at 1008, the users may continue picking the customer order until the entire customer order is picked. At 1010, the users may assemble the items from the customer order (e.g., in a collection/packing area of the store 100) and pack the items of the customer order (e.g., in grocery bags and/or boxes). In some cases, the users may pack the items for orders as the items are being picked. At 1012, the filled customer order is provided to the customer. For example, the filled customer order may be picked up by the customer at the store 100. In other examples, the filled customer order may be delivered to the customer's home.

FIG. 34 is a method 1020 that describes operation of an MSD configured to receive location signals. At 1022, the MSD receives one or more customer orders via a communication module. At 1024, the MSD receives one or more location signals. For example, the location detection module detects one or more location signals. At 1026, the MSD determines a location value based on the one or more received location signals. For example, the location detection module determines a location value based on the one or more received location signals.

At 1028, the MSD may determine the distance of each of the items from the MSD (i.e., the user). For example, the MSD may determine which items are nearest to the MSD and which items are farthest from the MSD. The MSD may determine the location of items relative to the MSD using a location map of the store and the associations between the items and location values.

At 1030, the MSD arranges the items on the display. In general, the MSD may arrange the displayed items such that the items in proximity to the MSD (i.e., in proximity to the user) are viewable by the user on the display. In one example, the MSD may arrange items on the display such that those items in proximity to the user are more prominently displayed than those items that are farther away from the MSD. For example, the MSD may display items in the current area at the top of the display. Additionally, or alternatively, the MSD may display the items in bold and/or colored text to indicate those items that are in proximity to the user. In some implementations, the MSD may arrange items on the display based on the number of junctions between the user and the items. For example, the MSD may display items more prominently that are separated from the user by a smaller number of junctions. In some implementations, the MSD may arrange items on the display based on the number of junctions between the user and the items along with the number of items in a particular area. For example, the MSD may tend to display items that are closer to the user more prominently, unless many items are located in another direction at a slightly longer distance. In this manner, the MSD may persuade the user to pick the largest number of items in the shortest amount of time. In some implementations, the MSD may generate routes based on the number of items in zones and the distance of the zones from the MSD. For example, an MSD can prefer showing items in zones that are closer and/or associated with more items.

Method 1020 may continue at 1024 as the MSD is moved throughout the store. For example, while picking the one or more received customer orders, the MSD may be moved into areas of the store that receive different location signals. The MSD may determine a new location value based on the different location signals and update the display (e.g., in real-time) to reflect the distance of items from the MSD at the new location.

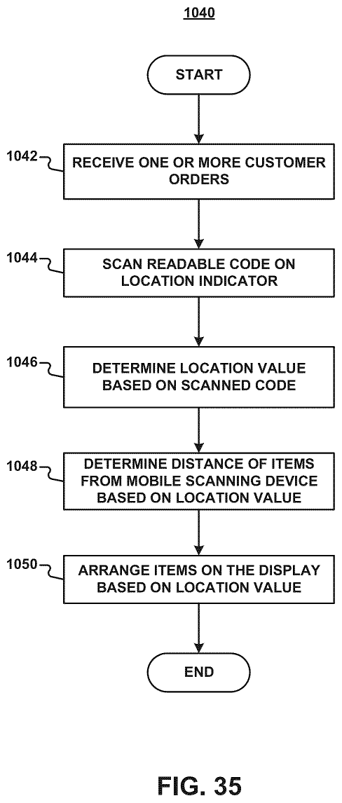

FIG. 35 is a method 1040 that describes operation of an MSD that is configured to determine location values by scanning location indicators that include readable codes. At 1042, the MSD receives one or more customer orders via a communication module. At 1044, the MSD scans a readable code of a location indicator. For example, the location detection module may scan a readable code. At 1046, the MSD determines a location value based on the scanned readable code. For example, the location detection module determines a location value based on the scanned readable code.

At 1048, the MSD may determine the distance of each of the items from the MSD (i.e., the user). For example, the MSD may determine which items are nearest to the MSD and which items are farthest from the MSD. The MSD may determine the location of items relative to the MSD using a location map of the store and the associations between the items and location values.

At 1050, the MSD arranges the items on the display. In general, the MSD may arrange the displayed items such that the items in proximity to the MSD (i.e., in proximity to the user) are viewable by the user on the display. In one example, the MSD may arrange items on the display such that those items in proximity to the user are more prominently displayed than those items that are farther away from the MSD. Method 1040 may continue at 1044 as the MSD is moved throughout the store and new location indicators are scanned. For example, while picking the one or more received customer orders, the MSD may be moved into areas of the store in which the MSD scans different readable codes. The MSD may determine a new location value based on the different readable codes and update the display (e.g., in real-time) to reflect the distance of items from the MSD at the new location.

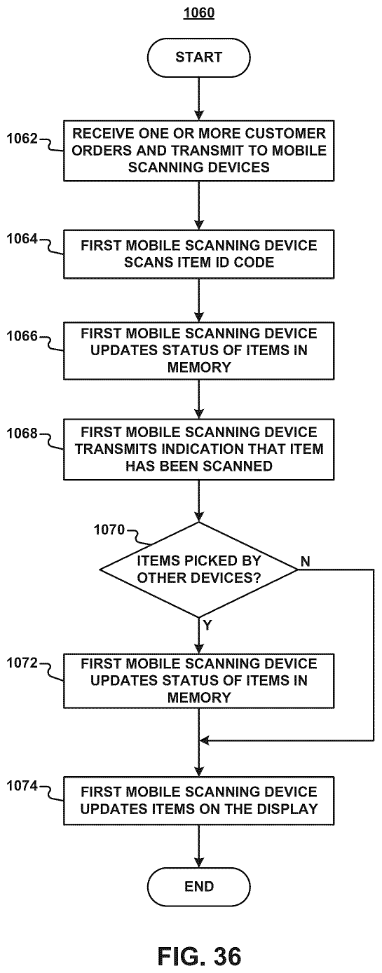

FIG. 36 is a method 1060 that describes operation of an MSD when items are picked by the MSD and other MSDs. The method 1060 of FIG. 36 is now described with reference to FIG. 1. At 1062, the CCS receives one or more customer orders from CCDs and transmits the one or more customer orders to the MSDs via the communication system. At 1064, the first MSD scans an item ID code of one of the items included in the customer orders. At 1066, the first MSD updates the status of the items in memory to indicate that the item has been scanned.

At 1068, the first MSD transmits an indication that the item has been scanned. For example, the first MSD may indicate to the CCS that the item has been scanned. In turn, the CCS may indicate to the second MSD that the item has been scanned so that the second MSD may update the status of items in memory of the second MSD. In other examples, the first MSD may transmit the indication directly to the second MSD.

At 1070, the first MSD determines whether other items have been scanned by the second MSD. The first MSD may determine that other items have been scanned by the second MSD when the first MSD receives an indication (e.g., from the CCS) that the second MSD has scanned other items. If the second MSD has not scanned any other items, method 1060 may continue in block 1074. If the second MSD has scanned other items, the first MSD may update the status of items in memory in block 1072 to indicate that the other items have been picked (e.g., based on indications received from the CCS). At 1074, the first MSD may update the display to indicate which items have been scanned. For example, the first MSD may remove the scanned item(s) from the display.

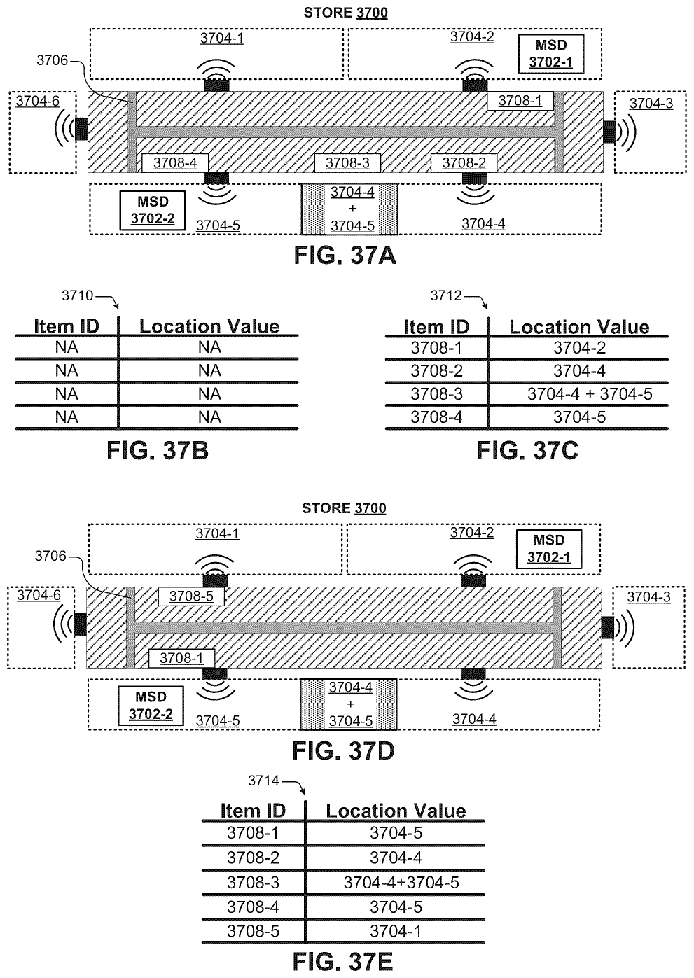

As described above, each of the items in the store may be associated with a location value. The associations between items and location values may be represented herein as an item association table (e.g., item association tables 3710, 3712, 3714 of FIGS. 37B, 37C, 37E). Item association tables (e.g., one or more of the same/similar versions of item association tables) may be stored in memory of the CCS and/or one or more MSDs. In implementations where the CCS stores an item association table, the CCS can transmit the item association table to the one or more MSDs in order to update the item association tables used by the MSDs. In some implementations, the CCS may transmit the item association tables to the MSDs at preselected time intervals (e.g., at periodic intervals). Additionally, or alternatively, the CCS may transmit the item association tables to the MSDs in response to updates to the item association table stored at the CCS. For example, if the CCS updates an item association table (e.g., in response to updates from one or more MSDs), the CCS may transmit the updated item association table to the MSDs in response to the recent update. In some implementations, the MSDs can request the updated item association table from the CCS. For example, the MSDs may be configured to request an up-to-date item association table upon powering up (e.g., from a standby or off state).

In some implementations, an MSD can request the updated item association table from the CCS. The MSD may be configured to receive manual input from the user that causes the MSD to request the item association table. For example, an MSD may receive a user input (e.g., on a touchscreen of the MSD) that instructs the MSD to request the updated item association table. In some examples, the MSD may present the user with an interactive GUI button or other user input (e.g., via a mechanical button) that causes the MSD to request an update of the item association table from the CCS.

In some implementations, the MSD may be configured to automatically request the item association table from the CCS. For example, the MSD may be configured to request the item association table from the CCS at preset times (e.g., periodically or after a threshold amount of time has passed since a most recent update of the item association table stored on the MSD). An MSD may automatically request the item association table in response to other events. For example, an MSD may automatically request an item association table in response to powering on after the MSD has been in an off state or a standby state.

In some cases, the MSDs may not be devices that are owned by the store operator and/or stored at the store. For example, the MSDs used in the store may be brought into the store by third parties and used to pick items for customer orders with the third parties. The third parties may include businesses that provide item delivery services (e.g., grocery delivery services) to customers. These third parties may receive customer orders via the internet, store the customer orders on a TPCS, and transfer the customer orders to the third-party MSDs. Upon entering a store with a third-party MSD, the MSD may be configured to request the item association table from the CCS (e.g., via an internet/cellular connection with the CCS and/or via a local wireless connection). In some cases, the CCS is configured to communicate with a TPCS and may transmit updated item association tables to the TPCS (e.g., in response to requests from the TPCS) so that the TPCS may store an updated version of the store's item association table.

A third-party MSD may request an item association table from the TPCS (e.g., via the internet). Additionally, or alternatively, the third-party MSD may request an item association table from the CCS. The CCS may respond to the request from the third-party MSD (e.g., via the internet or wirelessly in the store) by transmitting an item association table to the third-party MSD. A third-party MSD can make a request for an updated item association table (e.g., from the CCS and/or the third-party computing system) in response to a variety of events. In some implementations, a third-party MSD may make a request automatically in response to the current location of the third-party MSD. For example, a third-party MSD can be configured to request an item association table based on the proximity of the third-party MSD relative to the store. In one example, a third-party MSD may be configured to request an item association table in response to being located within a predetermined distance of the store, such as upon coming within a predetermined distance from the store or entering the store. The third-party MSD may determine location and/or proximity to the store based on a GPS determined location (e.g., from a GPS receiver of the device), based on a wireless connection established in the store (e.g., a WIFI connection between the third-party MSD and the CCS), and/or based on some other form of location determination. In some implementations, the store may include store indicators (e.g., barcodes, QR codes, RFID tags, or other indicators) that may uniquely identify the store to a third-party MSD. Such store indicators may be placed at one or more entry points of the store for example. In these implementations, the third-party MSD can scan the store indicator and then request the item association table for the store corresponding to the store indicator.

In some implementations, the third-party users may manually request the item association table for the store (e.g., using a GUI of the third-party MSD). As another example, a third-party MSD may automatically request an item association table for a store in response to the third-party user selecting the store as the next store from which to pick (e.g., from a group of stores).

In some cases, shoppers at a store (e.g., a grocery store) may use their own devices (referred to herein as “personal scanning devices” or “customer computing devices”) to assist in routing them throughout the store. As described herein, the CCDs can include similar functionality to the MSDs that allows the CCDs to interact with the OFS (e.g., the CCS and the location indicators). For example, the CCDs may include wireless communication functionality (e.g., WiFi or Bluetooth) for communicating with the CCS, location signal detection functionality (e.g., Bluetooth receivers for detecting Bluetooth based location signals and/or light detection functionality such as a camera), and item ID scanning functionality (e.g., a camera). Example CCDs may include computing devices having a variety of different form factors including, but not limited to, smartphones, tablets, and any other handheld or wearable device. A CCD may execute an application (e.g., a native application installed on the CCD) or access a web application that performs similar functionality attributed to the MSDs herein (e.g., the CCD may receive location signals, scan barcodes, determines location values, store a location map, and organize items on the display based on the location of the items relative to the user). The application executing on the CCDs may be provided to the personal scanning devices by the operator of the store (e.g., via a download from an application distribution platform, such as Google Play or Apple iTunes).

As described herein, different parties may use MSDs to pick customer orders. For example, employees of the store may use MSDs to pick customer orders. Additionally, or alternatively, third-party users (e.g., employees of a third party) may use MSDs (e.g., owned by the third parties or the store owners) to pick customer orders. Customers may also use their own devices to pick their own orders. In some implementations of the OFS, any of these parties may pick orders within the same store at the same time, or at different times. In other cases, the OFS may be configured to only allow certain parties to pick items.

As described above, MSDs can request updated item association tables from the CCS or TPCS. As described herein, the MSDs may also request other data from the CCS or TPCS, such as updated location maps and/or item adjacency maps (e.g., at preset times and/or in response to a user command). In some implementations, the CCS may request location maps and/or item adjacency maps from the MSDs (e.g., at preset times). In general, the CCS, TPCS, MSDs, and/or CCDs may transfer data between one another based on any factors described herein, such as the factors described for requesting an item association table above.

In some circumstances, items may not be associated with location values. In one example, items may not yet be associated with location values when the location indicators are initially placed in the store. This example may occur when a store is initially equipped with the OFS (e.g., location indicators, MSDs, and the CCS). In another example, items that have been newly added to the racks of the store may not yet be associated with location values. Similarly, when the OFS is initially set up, item adjacency maps may not be initially completed. Over time, the item adjacency maps may be completed as described herein. A TPCS and/or third-party MSDs may also initially include incomplete item association tables, location maps, and item adjacency maps. A TPCS and/or third-party MSDs may acquire (e.g., download) the tables and maps from the CCS. In some implementations, a TPCS and/or third-party MSDs may download different tables and maps for different stores. In some implementations, at TPCS and/or third-party MSDs may generate their own tables and maps independently from the tables and maps included in the CCS. In some cases, a TPCS and/or third-party MSDs may initially acquire tables and maps for a store from the store CCS, and then update the tables and maps over time in a manner that differs from the initial store tables and maps.

In other circumstances described herein, items may be associated with an incorrect association value. For example, an item may initially be associated with a first location value when the item is placed in a first location in the store. Later, the item may be moved to a different place in the store that is associated with a different location. In these circumstances, the location value associated with an item may be updated. Different ways to associate items with a location value and update the associations are described herein.

Items may be associated with location values using a variety of different techniques. In some examples, associations between items and location values may be entered manually by a user. For example, a user may manually populate an item association table using a computing device, such as a desktop computer, laptop computer, an MSD, etc. Put another way, a computing device (e.g., an MSD or other computing device) may be configured to receive manual input from a user, generate associations between items and location values based on the manual input, and store the associations at the CCS. In some implementations, a user may use a keyboard (e.g., on an MSD or other computing device), a touchscreen computing device, or similar device, to populate the item association table. For example, a user may place location indicators in a store and manually associate items with location values that will be determined in proximity to the items. In a more specific example, when a location indicator includes a readable code, a user may place the location indicator on a rack, and then manually associate each of the items on the rack with the location value that is determined based on the readable code of the location indicator. In another specific example, when a location indicator transmits a location signal, a user may place the location indicator on a rack, and then manually associate each of the items near the area where the location signal will be transmitted to the location value that will be determined based on detection of the location signal.

Generating an item association table manually (e.g., manually entered into a user interface on a computing device) may be a somewhat cumbersome process because a store may include thousands of items. Additionally, a user may be prone to errors when manually generating an item association table. Manual generation of an item association table may also be somewhat inaccurate in examples where location indicators transmit signals because a user may not accurately predict exactly where location signals will be transmitted. Although it is contemplated that item association tables including a large number of items could be manually generated, other techniques for generating item association tables described herein may prove more effective. Although other techniques may prove more effective than manually entering item associations, manually entering some item associations may be effective in cases where a few item associations are to be made.

An item association table may be generated automatically (e.g., using an item association mode and/or during normal picking). In some examples, a user may set the MSD into an “item association mode” causing the MSD to generate the item association table by determining location values and scanning items. In general, an “item association mode” may refer to a state (e.g., a mode of operation) of an MSD which may be selected by a user to generate one or more associations between items and location values. A user may set an MSD into the item association mode using the touchscreen display of the MSD and/or the user interface, for example.

When operating in an item association mode, the MSD may determine a location value and associate that location value with a scanned item. In examples where a store includes location indicators having readable codes, the user may first use the MSD to scan the location indicator to determine a location value. Next, the user may begin using the MSD to scan item ID codes. For example, the user may scan a plurality of item ID codes after scanning the location indicator. The MSD may then associate each of the scanned item ID codes with the location value determined from the location indicator. Generating an item association table in this manner may be faster than manually generating an item association table because a user may quickly scan item ID codes after scanning a single location indicator. Instead of first scanning a location indicator and then scanning item ID codes, in other examples, a user may use the MSD to scan a plurality of item ID codes and then scan an associated location indicator in order to associate the scanned item ID codes with the later scanned location indicator.

When operating in an item association mode in a store that includes location indicators that transmit location signals, the MSD may determine a location value based on one or more received location signals and associate scanned item ID codes with the currently determined location value. Since the MSD may acquire location signals without additional user action, the user may freely walk through the store and scan a plurality of item ID codes to generate an item association table. For example, the MSD may associate scanned item ID codes with a first location value determined in a first location. When the MSD is moved to a second location where the MSD determines a second location value, the MSD may associate scanned item ID codes with the second location value. Generating an item association table in this manner may be faster than manually generating an item association table because a user may quickly scan item ID codes without scanning a location indicator.

In some examples, an MSD may generate and/or update an item association table without the user selecting a specific “item association mode.” Instead, the MSD may generate an item association table while the MSD is being used to pick items of customer orders. For example, if an MSD receives a customer order including a first item that is not associated with a location value, the MSD may generate an entry in an item association table for the first item when the MSD scans the item ID code of the first item. The generated entry in the item association table may include the scanned item ID code and the currently determined location value.

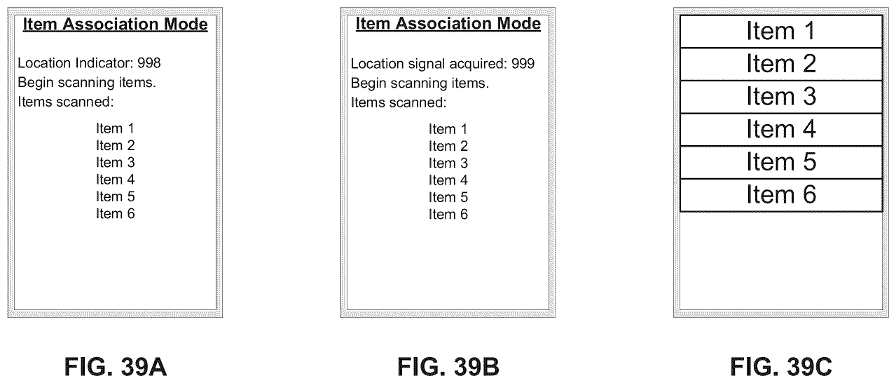

FIGS. 39A-39C illustrate displays of MSDs which may be viewed by a user while generating an item association table. FIGS. 39A-39B illustrate displays of MSDs that are set in an item association mode. The item association modes of the mobile devices of FIGS. 39A-39B may be initiated using the touchscreens and/or user interfaces of the MSDs. In one example, a user may select the “item association mode” from a menu displayed to the user using a touchscreen. In another example, a user may press a dedicated button of the MSD to enter the item association mode. The images on the displays of FIGS. 39A-39B may be displayed to users of MSDs having dedicated item association modes. The image on the display of FIG. 39C may represent an image displayed to a user that is picking items from a store. In FIG. 39C, the MSD may be configured to generate an item association table when the user is picking items. Example operation of MSDs shown in FIGS. 39A-39C are now described. FIGS. 39A-39C are only example images that may be displayed on a display of an MSD. Accordingly, it is contemplated that additional or alternative information may be displayed to a user when generating an item association table.

The image on the display of FIG. 39A may be generated by an MSD used in a store that includes location indicators having readable codes. As indicated on the display, the MSD is operating in an “Item Association Mode.” The user of the MSD may have set the MSD in the item association mode using the touchscreen and/or user interface of the MSD. The display indicates that location indicator 998 has been scanned. After scanning location indicator 998, the display instructs the user to “Begin scanning items.” The display lists the items that have been scanned by the user using the MSD. For example, the display indicates that the user has scanned items 1-6 using the MSD. The MSD may update the display each time a new item is scanned. For example, if an “item 7” was scanned, the display would add “Item 7” under “Item 6” on the display. In FIG. 39A, an item association table would be populated with items 1-6, each of which is associated with the location value 998.

The image on the display of FIG. 39B may be generated by an MSD used in a store that includes location indicators that transmit location signals. As indicated on the display, the MSD is operating in an “Item Association Mode.” The user of the MSD may have set the MSD in the item association mode using the touchscreen and/or user interface of the MSD. The display indicates that the MSD has received a location signal and determined a location value of 999 based on the received location signal. The display instructs the user to “Begin scanning items.” The display lists the items that have been scanned by the user using the MSD. For example, the display indicates that the user has scanned items 1-6 using the MSD. The MSD may update the display each time a new item is scanned. For example, if an “item 7” was scanned, the display would add “Item 7” under “Item 6” on the display. In FIG. 39B, an item association table would be populated with items 1-6, each of which is associated with location value 999.

In some examples, an MSD may generate an item association table without entering a dedicated item association mode. Instead, the MSD may generate an item association table during normal item picking described herein. For example, an MSD may receive a customer order, display the customer order to the user, and generate the item association table as the user picks and scans items of a customer order. The image on the display of FIG. 39C may be an image displayed by an MSD during normal picking of a customer order, as described above.

In FIG. 39C, it may be assumed that a customer order including items 1-6 has been placed with a CCS and that the customer order has been received by the MSD of FIG. 39C. The display displays items 1-6 of the customer order to indicate to the user that items 1-6 should be picked. The MSD may be configured to generate associations in an item association table when the user scans the item ID codes of items 1-6 of the customer order. For example, the MSD may generate an association between item 1 and the currently determined location value (e.g., based on a last scanned readable code or most recently received location signal) when the MSD scans the item ID code of item 1. Similarly, the MSD may generate an association between item 2 and the currently determined location value when the MSD scans the item ID code of item 2. Accordingly, the MSD may have generated associations between items 1-6 and their respective location values after the user has scanned all of items 1-6.

Generating associations in an association table while picking items, as described with reference to FIG. 39C, may provide a positive user experience because the item association table may be generated without the user initiating any additional modes (e.g., an item association mode). Instead, generation of the item association table may happen “in the background,” without burdening the user with the task of actively generating an item association table. In scenarios where most of the items in the store are associated with location values in an item association table, generating updates to the item association table in the manner described with reference to FIG. 39C may also be efficient. For example, items that are moved (e.g., to a different rack) within the store or added to the store may be associated with location values without burdening a user to explicitly update the item association table (e.g., by entering an item association mode).

FIGS. 37A-37E illustrate generation of an item association table and updating of the item association table. Referring now to FIG. 37A, a store 3700 includes location indicators that transmit location signals. MSDs 3702-1, 3702-2 may determine location values 3704-1, 3704-2, . . . , 3704-6, “3704-4+3704-5” in store 3700. Store 3700 includes a rack 3706 that includes items 3708-1, 3708-2, 3708-3, 3708-4. MSDs 3702-1, 3702-2 may be used to generate an item association table including items 3708-1, 3708-2, 3708-3, 3708-4.

FIG. 37B shows an item association table 3710 before any associations are made between items and location values. Item association table 3710 includes an item ID code column and a location value column. Each row of item association table 3710 may be populated to include an association between an item and a location value. Accordingly, the four rows of item association table 3710 may be populated to include four associations. Item association table 3710 of FIG. 37B is filled with “NA” entries indicating that items and location values are in a “non-associated” state. Although item association table 3710 is completely filled with NA entries, in some examples, the table may include item ID codes for items available in the store, with corresponding location values being entered as NA. This may be the case in scenarios where the item association tables are updated to include items in the store, but the items have not yet been associated with location values. Although item association tables 3710, 3712, 3714 illustrated in FIGS. 37B, 37C, and 37E include 4 associations, it is contemplated that an item association table may include thousands of associations or more. In some cases, item association tables may be prefilled with location values, such as a location value in the center of the store, or a location value associated with certain types/categories of products (e.g., frozen food, dry food, etc.).

One or both of MSDs 3702-1, 3702-2 may be used to populate the item association table (e.g., 3710, 3712, 3714). As described above, MSDs 3702-1, 3702-2 may be used to manually enter item associations in some examples. In other examples, the MSDs 3702-1, 3702-2 may automatically generate an item association table for store 3700. In some examples, users may set MSDs 3702-1, 3702-2 into an “item association mode” and generate the item association table, as described above. In other examples described above, MSDs 3702-1, 3702-2 may generate an item association table while MSDs 3702-1, 3702-2 are being used to pick items 3708-1, 3708-2, 3708-3, 3708-4.

FIG. 37C illustrates an item association table 3712 that has been populated to include associations between items 3708 and location values 3704. The associations in item association table 3712 may have been generated by MSD 3702-1 and/or MSD 3702-2. Item association tables may be stored in MSDs 3702 and/or a CCS of store 3700. In one example, MSDs 3702 may be configured to upload associations to the CCS. For example, MSD 3702-1 may generate an association between item ID code 3708-1 and location value 3704-2, and then transmit the association to the CCS. Similarly, MSD 3702-2 may generate an association between item ID code 3708-4 and location value 3704-5, and then transmit the association to the CCS. In this manner, the CCS may receive associations from MSDs 3702 and maintain an item association table that includes item associations generated by each of MSDs 3702. The CCS may transmit the complete item association table to MSDs 3702 so that MSDs 3702 may include a complete updated item association table.

As described above, an item association table may be generated by a plurality of different MSDs. For example, each of the MSDs may generate associations and upload the associations to a CCS that generates a complete item association table based on the associations generated by the plurality of MSDs. The CCS may then transmit the completed item association table to each of the plurality of MSDs so that the MSDs include a complete item association table for operation (e.g., to arrange items on displays to users). Although an item association table may be generated by a plurality of different MSDs, in some examples, a single MSD may be used to generate an item association table.

FIG. 37D shows store 3700 after a new item 3708-5 has been added and after item 3708-1 has been moved. FIG. 37E shows an updated item association table 3714 that includes a new association for item 3708-5 and a different location value associated with item 3708-1. In one scenario, item 3708-5 may not have been included in store 3700 during generation of item association table 3712 of FIG. 37C. Accordingly, item 3708-5 is not present in item association table 3712. In another scenario, item 3708-5 may not have been included in item association table 3712 of FIG. 37C because neither of MSDs 3702 had generated an association between item 3708-5 and a location signal. In either scenario, it may be assumed that one of MSDs 3702 has generated an association including item 3708-5 in FIG. 37D. Accordingly, item association table 3714 of FIG. 37E includes an association between item 3708-5 and location value 3704-1.

Item 3708-1 may have been moved after generating item association table 3712 of FIG. 37C. After initially moving item 3708-1, the association including item 3708-1 may have been incorrect. For example, item 3708-1 may have been associated with location value 3704-2 when item 3708-1 should have been associated with location value 3704-5. After moving item 3708-1, one of MSDs 3702 may generate a new association including item 3708-1. For example, one of MSDs 3702 generated an association between item 3708-1 and location value 3704-5, as shown in association table 3714 of FIG. 37E. Note that a new association including item 3708-1 may replace the old association between item 3708-1 and location value 3704-2. Accordingly, item association table 3714 may be an updated item association table that accurately reflects the movement of item 3708-1 and the addition of a new item 3708-5.

The OFS (e.g., the MSDs and/or CCS) may update the item association table in response to a variety of different factors. In some implementations, the OFS may update the item association table for each scan of an item that indicates the item has been moved to a new location. For example, if an item ID code is initially associated with a first location value, then the OFS determines that the item has been scanned in a new location, the system may update the item association table to reflect that the item is located at the new location. Similarly, if a new item is scanned that has not been previously included in the most recent item association table, the system may update the item association table to include the new item the first time the new item ID is scanned.

In some implementations, instead of updating the item association table after a single item scan (e.g., a new item and/or a moved item), the OFS may require that the items be scanned a number of times (e.g., a threshold number) before updating the item association table. For example, the system (e.g., MSD and/or CCS) may be configured to update the location of an item in the item association table in response to determining that the item has been scanned at a location greater than a threshold number of times (e.g., greater than 3 times). In some implementations, the OFS may require that the item be scanned a threshold number of times consecutively. In other implementations, the OFS may update the item association table to include the most detected location value for the item (e.g., the location value in which the item ID code was most scanned). In a similar manner, the OFS may require that a new item be scanned a threshold number of times before being entered into the system. Putting restrictions on updating the item association table (e.g., requiring a number of scans) may help maintain a stable and accurate OFS that rejects outlying item scans (e.g., in scenarios where a user picks up an item and does not scan the item until the item has been moved a great distance throughout the store).

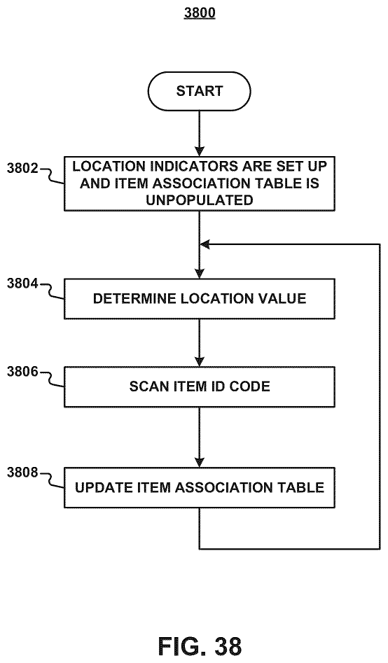

FIG. 38 shows an example method 3800 for generating and updating an item association table. At 3802, location indicators are set up in a store and an item association table for the store is initially unpopulated. For example, the item association table may include NA entries. At 3804, an MSD may determine a location value. For example, the MSD may receive a location signal and determine a location value based on the received location signal.

At 3806, the MSD may scan an item ID code. At 3808, the MSD may generate an association between the currently determined location value and the scanned item ID code. The MSD may then transmit the association to the CCS so that the CCS may maintain an up-to-date item association table, which may be modified by updates from any of a plurality of MSDs in the store. The method 3800 may then return to block 3804. Subsequently, the CCS may again update the item association table based on associations received from one or more MSDs according to method 3800. The method 3800 may be modified according to the disclosure included herein.

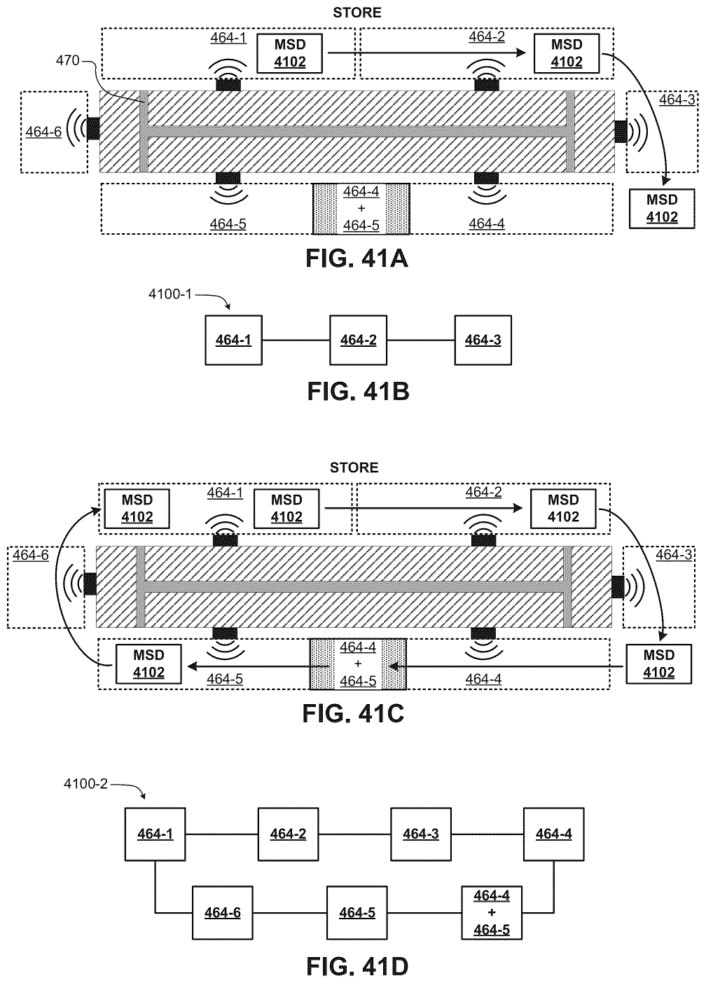

FIGS. 41A-41D illustrate generation of a location map using a single MSD 4102. As described above, one or more computing devices may store a location map that defines the spatial relationships between different areas of a store. For example, a location map may define the relative distances between different areas of the store. In some examples, two areas of the store may be adjacent to one another. In some examples, two adjacent areas may be touching one another. In other examples, two areas may be adjacent to one another when they are separated by a “dead zone.” Two areas may not be adjacent to one another when the shortest path between the two areas includes one or more additional areas. In stores including location indicators that transmit location signals, the location map may define how the areas of the store covered by the location signals are arranged relative to one another. In stores that include location indicators having readable codes, the location map may define how the location indicators (i.e., readable codes) are arranged relative to one another.

A location map may not yet be generated for a store when location indicators are initially placed in the store. This may occur when a store is initially equipped with the OFS (e.g., location indicators, MSDs, and the CCS). The OFS may generate a location map for a store after the location indicators are placed in the store. Location maps may be generated manually by a user in some examples (e.g., using a computing device and uploading the location map to the CCS). In other examples, a location map may be generated automatically (e.g., by one or more MSDs and/or the CCS). The location maps may be stored in one or more MSDs and/or the CCS.

Location maps may be generated using a variety of different techniques. In some examples, location maps may be entered manually by a user. For example, a user may manually generate a location map using a computing device, such as a desktop computer, laptop computer, an MSD, etc. In this example, a user may use a keyboard, or similar device, to generate the location map. For example, a user may place location indicators in a store and manually generate the location map based on where the location indicators are placed. In some examples, the user may generate the location map first, and then place the location indicators according to the generated location map.

Instead of manually generating a location map, a location map may be generated automatically. In stores including location indicators that transmit location signals, a user may transport an MSD throughout the store to generate a location map automatically. In one example, a user may set an MSD into a “location map generation mode” and transport the MSD throughout the store to generate a location map for the store. In other examples, the OFS may be configured to generate a location map while the user moves the MSD throughout the store picking items of customer orders. For example, the MSDs may maintain a location map locally and then indicate to the CCS when the location map should be updated (e.g., based on the absence of a location signal or one or more newly detected location signals).

Generation of location maps in stores including location indicators that transmit signals is illustrated and described with respect to FIGS. 41A-44B. It may be assumed that the MSDs may automatically generate the location maps while a user is picking items of a customer order displayed on the MSDs and/or using a “location map generation mode” of the MSDs.

When location indicators are initially placed in a store, the location map may be incomplete. A location map that is incomplete may not include each of the areas of the store in a proper arrangement. A location map that is incomplete may be referred to herein as an “incomplete location map.” A location map may be incomplete in a variety of different ways described hereinafter. In some examples, a location map may be incomplete when the location map for the store does not include all of the areas of the store. In another example, the location map may be incomplete when the location map does not include all of the junctions between different areas. In still other examples, the location map may be incomplete when the location map includes too many areas. This may occur when a location indicator breaks and fails to transmit location signals.

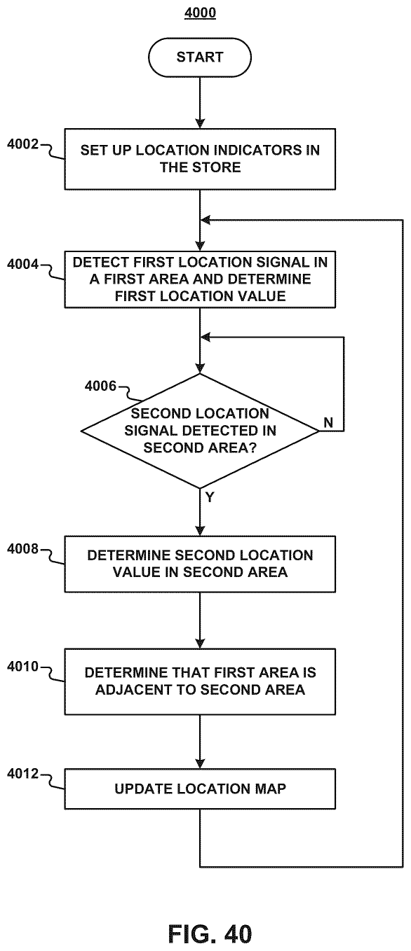

FIG. 40 illustrates an example method 4000 for generating a location map in stores including location indicators that transmit location signals. It may be assumed that location indicators have not been set up in the store at the start of method 4000. At 4002, location indicators that transmit location signals are set up in the store. At 4004, an MSD detects a first location signal in a first area of the store. The MSD determines a first location value based on the received first location signal. At 4006, the MSD determines whether a second location signal is detected. If a second location signal is not detected, method 4000 may continue in block 4006. Accordingly, the MSD may wait until a second location signal is detected in block 4006.

Method 4000 may continue in block 4008 when the MSD detects the second location signal in the second area. The MSD determines a second location value based on the detected second location signal. The MSD may then determine that the first area is adjacent to the second area in block 4010. In some examples, the MSD may determine that the first and second areas are adjacent to one another when the MSD determines that one or more location adjacency criteria are met.

In general, location adjacency criteria may include parameters that the MSD uses to determine the proximity of two different areas in a store. The MSD may determine that two different areas are adjacent to one another (e.g., connected by a single junction) when one or more location adjacency criteria are met. In general, different areas of a store may be adjacent in three different ways. In one example, two different areas of a store may be adjacent when location signals defining the two different areas abut one another. Abutting areas are described with respect to FIG. 17. In FIG. 17, aisle 270-3 includes multiple areas that abut one another. In one example, area 280-5 abuts area “280-5+280-6.” In this example, areas 280-5 and “280-5+280-6” are not separated by any dead zone because location signals overlap at the intersection of the two areas. In another example, area 280-6 abuts area 280-7. In this example, areas 280-6 and 280-7 are separated by a short dead zone in which location signals may not be present at detectable levels.

The size of a dead zone between two adjacent areas may vary. In one example, with respect to FIG. 17, area 280-6 and area 280-7 are separated by a short dead zone. In another example, area 280-1 and 280-2 are separated by a larger dead zone. As another example, the dead zone between area 280-3 and 280-10 is smaller than that between areas 280-1, 280-2, but larger than that between areas 280-6, 280-7. Accordingly, adjacent areas of a store may abut one another or be separated by a dead zone.

As described above, the location adjacency criteria may be used to determine whether two areas are adjacent to one another. In general, two areas may be considered adjacent to one another when the areas abut one another or when the two areas are separated by a relatively short dead zone. Qualitatively, two areas may be considered adjacent when the dead zones between the areas are small or not existent. Two areas are more likely to be considered non-adjacent by the OFS when the two areas are separated by larger dead zones. The location adjacency criteria may be used by the OFS to determine whether two areas are considered adjacent to one another.

A first location adjacency criterion may be based on whether two areas include common location values (e.g., are covered by common location signals). For example, if two areas include a common location value, then those two areas may be adjacent. Such a scenario arises when an area is defined by two overlapping signals. In this scenario, three different areas may be defined by two different location signals that overlap. The area in which the location signals overlap may be adjacent to each of the areas defined only by the single non-overlapping portions of the location signals. An example of three such areas are shown in FIG. 17. For example, in FIG. 17, areas 280-5, “280-5+280-6”, 280-6 are defined by two different location signals that overlap. Area “280-5+280-6” may be adjacent to area 280-5 because location value 280-5 is common to both area 280-5 and “280-5+280-6”. Similarly, area “280-5+280-6” may be adjacent to area 280-6 because location value 280-6 is common to both area 280-6 and “280-5+280-6.” Accordingly, area “280-5+280-6” may be adjacent to both areas 280-5 and 280-6.

Another location adjacency criterion may be an amount of time between detection of two different areas in the store. In general, an MSD may determine that first and second areas are adjacent when the amount of time between detecting the two areas is less than a threshold amount of time. In one example, the MSD may determine that first and second areas are adjacent when the MSD detects the second area within a threshold amount of time after detecting the first area. Similarly, the MSD may determine that first and second areas are adjacent when the MSD detects the first area within a threshold amount of time after detecting the second area.

In examples where an MSD uses a threshold amount of time to determine whether two areas are adjacent, the threshold amount of time may be selectable (e.g., by an operator of the OFS or another user). In general, a smaller threshold amount of time may require two areas to be closer to one another to be considered adjacent. A larger threshold amount of time may allow two areas that are farther apart to be considered adjacent.

In the example of adjacent areas 280-5 and “280-5+280-6” described above, an MSD may detect area 280-5 immediately after detecting area “280-5+280-6”. Similarly, an MSD may detect area “280-5+280-6” immediately after detecting area 280-5. Accordingly, an MSD may determine that area 280-5 and area “280-5+280-6” are adjacent for even small thresholds of time because the MSD may detect area 280-5 immediately after detecting area “280-5+280-6.” Similarly, an MSD may determine that area 280-6 and area “280-5+280-6” are adjacent for even small thresholds of time because the MSD may detect area 280-6 immediately after detecting area “280-5+280-6”.

Although areas may be immediately adjacent (e.g., not separated by a dead zone) as described with respect to areas 280-5 and “280-5+280-6,” in some examples, areas separated by dead zones may be considered adjacent. In examples where two areas are separated by a dead zone, the magnitude of the threshold amount of time may determine the amount of dead zone allowed between two areas that are considered adjacent.

Dead zones of different sizes are illustrated in FIG. 17. The size of the dead zone present between area 280-6 and area 280-7 is negligible. The dead zone present between area 280-6 and area 280-7 may be short enough that an MSD detects area 280-7 immediately upon exiting area 280-6. Put another way, the dead zone present between area 280-6 and area 280-7 may be so small that area 280-6 abuts area 280-7. Similarly, the dead zone present between area 280-7 and area 280-8 may be short enough that an MSD detects area 280-8 immediately upon exiting area 280-7.

A relatively short dead zone 281-1 is located between area 280-1 and area 280-2. Similarly, a relatively short dead zone 281-3 is located between area 280-4 and area “280-9+280-10.” A user may move an MSD from area 280-4 to area “280-9+280-10,” or from area 280-1 to area 280-2, on the order of one or more seconds (e.g., 1-3 seconds). Similarly, a user may move an MSD from area 280-4 to area “280-9+280-10,” or from area 280-1 to area 280-2, on the order of one or more seconds (1-3 seconds). A slightly larger dead zone is illustrated between area 280-1 and area 280-4 (e.g., on the side of rack 268-1 that does not include a location indicator). A user may move an MSD from area 280-1 to area 280-4 on the order of a 3 seconds or more.

An even larger dead zone is illustrated between area 280-1 and area 280-5 (e.g., on the sides of racks 268-1, 268-2 that do not include a location indicator). Movement of an MSD from area 280-1 to area 280-5 may take a greater amount of time than movement from area 280-1 to area 280-4. For example, moving an MSD from area 280-1 to area 280-5 may take approximately twice the amount of time (e.g., 5-10 seconds) as moving from area 280-1 to area 280-4.

As described above, an MSD may be configured to determine that two areas are adjacent when the amount of time between detecting the two areas is less than a threshold amount of time. The threshold amount of time used by the MSD may be a selectable value. In one example, the threshold amount of time may be set to 3 seconds. In this example, the MSD may determine that areas 280-1, 280-2 are adjacent to one another. Additionally, the MSD may determine that areas 280-1, 280-4 are adjacent to one another. An MSD may not determine that areas 280-1, 280-5 are adjacent because the MSD may not be moved between areas 280-1, 280-5 within the 3 second threshold, assuming that movement from area 280-1 to area 280-5 takes approximately 5-10 seconds.

In another example, the threshold amount of time may be set to 1 second. In this example, the MSD may determine that areas 280-1, 280-2 are adjacent to one another because an MSD may be moved between areas 280-1, 280-2 within a second. However, in this example, an MSD may determine that areas 280-1, 280-4 are not adjacent because the MSD may not be moved between areas 280-1, 280-4 within the 1 second threshold, assuming movement from area 280-1 to area 280-4 takes approximately 3 seconds or more.

The structure of a location map (e.g., the junctions) may depend on the placement of location indicators in the store and the number of location indicators in the store. In general, a greater density of location indicators within a store may result in a location map including more junctions (i.e., more adjacencies). For example, placing a greater number of location indicators within a given amount of floor space may generally result in a greater number of adjacent areas because there may be more overlapping signals and a smaller number of dead zones. With respect to the threshold amount of time used by an MSD, using a greater threshold amount of time may result in a location map having more adjacencies (i.e., more junctions) because areas separated by larger dead zones may be considered adjacent.

In summary, an MSD may use location adjacency criteria to determine if two areas are adjacent. In some examples, an MSD may determine that two areas are adjacent when the two areas include common location values. In some examples, an MSD may determine that two areas are adjacent when the amount of time between detection of the two areas is less than a threshold amount of time. The adjacency of areas may depend on the placement of location indicators in the store and the number of location indicators arranged throughout the store. Although location adjacency criteria may include the use of common location values and/or a threshold amount of time, it is contemplated that an MSD may use other adjacency criteria to determine whether two areas are adjacent.

Referring back to method 4000, an MSD may determine whether two areas area adjacent (e.g., using the location adjacency criteria) in block 4010. In block 4012, the mobile device indicates to the CCS that the two areas are adjacent. The CCS may then update the location map to indicate that the two areas are adjacent. The central system may transmit the updated location map to the one or more MSDs in the store. Over time, one or more MSDs in the store may identify additional adjacent areas. The CCS can further update the location map based on these identified adjacent areas. Continuation of the method 4000 in block 4004 after block 4012 represents that the location map may be continually updated over time as new areas (e.g., new location signals) are detected and new adjacencies are determined by the MSD(s).

FIGS. 41A-41D illustrate generation of a location map using a single MSD 4102. FIGS. 41A-41B illustrate generation of a partial location map including areas 464-1, 464-2, and 464-3. The MSD 4102 may generate the location map 4100-1 including the three areas 464-1, 464-2, 464-3 as the MSD 4102 is moved from area 464-1 to area 464-2 and on to 464-3 in FIG. 41A. In FIG. 41C, the MSD 4102 is moved from through areas 464-4, “464-4+464-5,” 464-5, 464-6, and back to area 464-1. The MSD 4102 may generate the location map 4100-2 illustrated in FIG. 41D during the movement in FIG. 41C. The MSD 4102 may transmit the location map 4100-2 to the CCS which may store the location map 4100-2 and transmit the location map to other MSDs in the store.

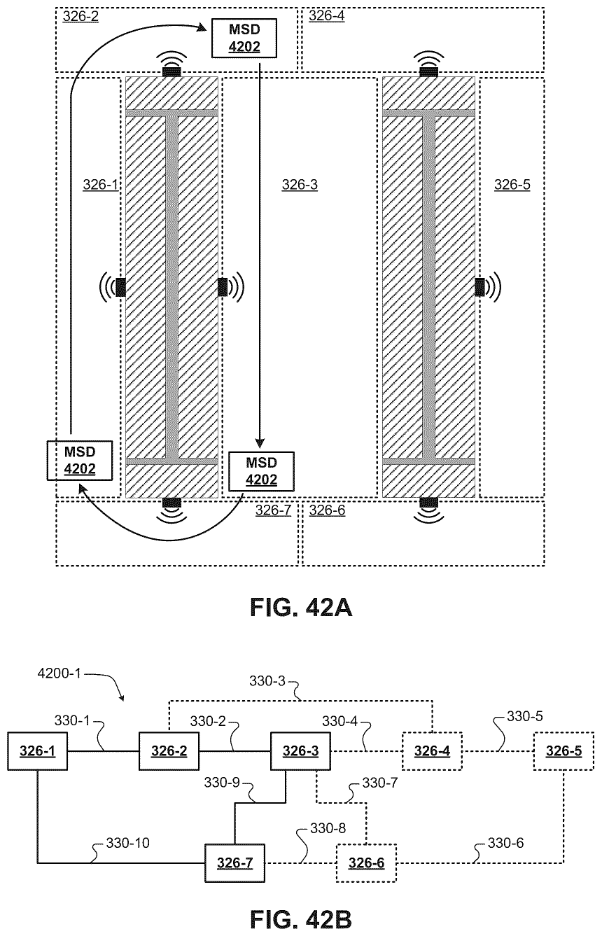

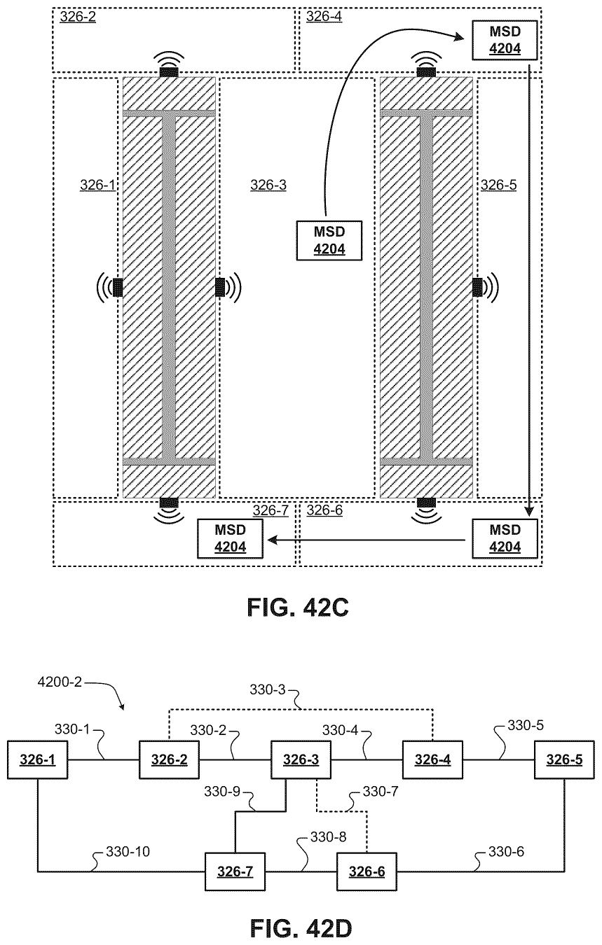

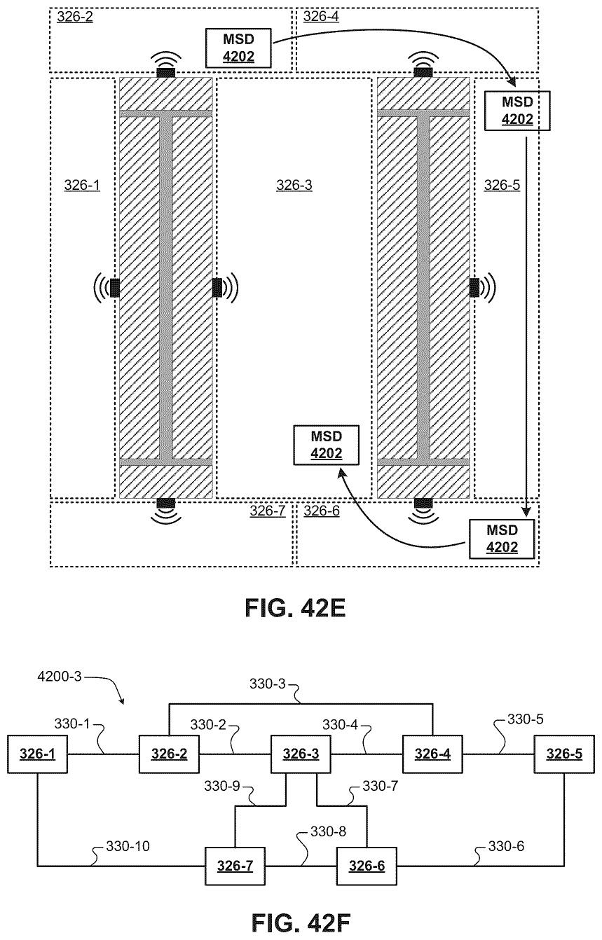

FIGS. 42A-42F illustrate generation of a location map using multiple MSDs. In FIG. 42A, the MSD 4202 is moved from area 326-1 through areas 326-2, 326-3, 326-7, and back to 326-1. The MSD 4202 may generate location map 4200-1 in FIG. 42B based on the movement. The junctions in solid lines indicate the adjacencies determined by the MSD 4200-1. The MSD 4202 may transmit the location map 4200-1 to the CCS which may update the location map stored at the CCS and then transmit the updated location map back out to other MSDs. The broken lines indicate adjacencies that may be determined in the future by MSDs. The broken lines are illustrated to provide context to the reader as to how the OFS may automatically generate a location map. As such, the broken lines may not represent junctions stored in the memory of the MSDs and CCS.

FIGS. 42C-42D illustrate generation of another portion of a location map 4200-2 using a second MSD 4204. In FIGS. 42C, the second MSD 4204 is moved from area 326-3 through 326-4, 236-5, 326-6, and 326-7. The MSD 4202 may update the location map stored on the MSD 4202 to the location map illustrated in FIG. 42 based on detection of location signals in the areas. The MSD 4202 may transmit the updated location map to the CCS which may update the location map stored at the CCS and then transmit the updated location map back out to the other MSDs.

FIGS. 42E-42F illustrate generation of the remaining portions of a location map using the first MSD 4202. In FIG. 42E, the first MSD 4202 is moved from area 326-2 through areas 236-4, 326-5, 326-6 and 326-3. The MSD 4202 may complete the location map 4200-3 for the store based on such movement. The MSD 4202 may transmit the updated location map to the CCS which may update the location map stored at the CCS and then transmit the updated location map back out to the other MSDs.

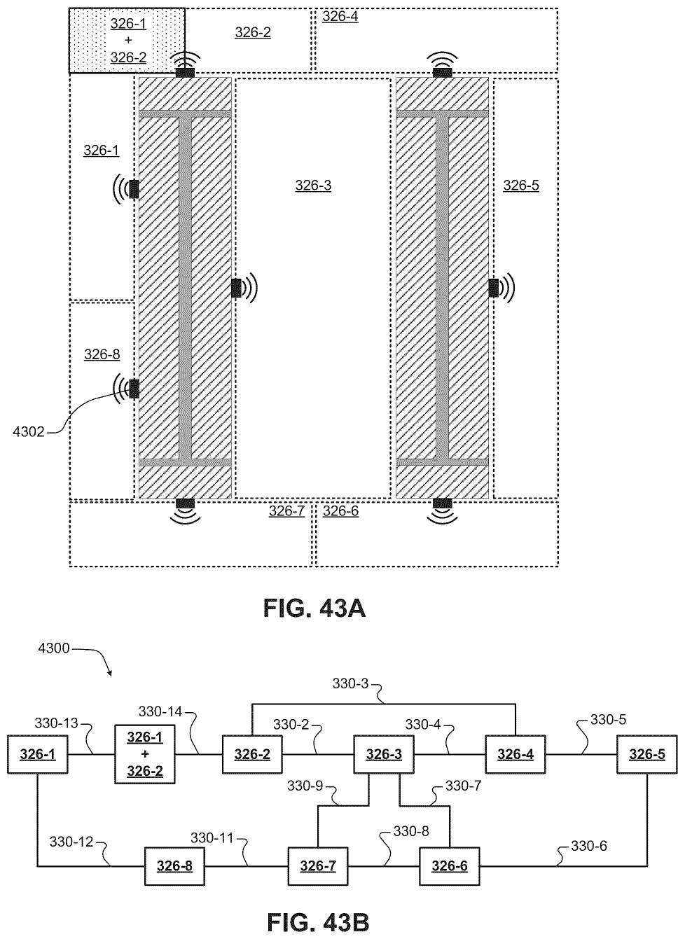

FIGS. 43A-43B illustrate an example updated location indicator layout and an example updated location map 4300 generated based on the updated location indicator layout. Relative to FIG. 42A, the store illustrated in FIG. 43A has had the location indicators updated to included two location indicators 4302, 4304 in the same aisle. Specifically, the location indicator for area 326-1 may have been moved closer to area 326-2, causing an overlap in areas 326-1 and 326-2. Additionally, the new location indicator 4302 has been added to the aisle adjacent to the location indicator for area 326-2. Modification of the location indicator layout cased the formation of 2 new areas 326-8, “326-1+326-2.” One or more MSDs and the CCS may identify the new areas and generate new adjacencies as illustrated in the location map 4300 of FIG. 43B. The MSDs and/or the CCS may then update the item association table based on the updated location map, as described above.

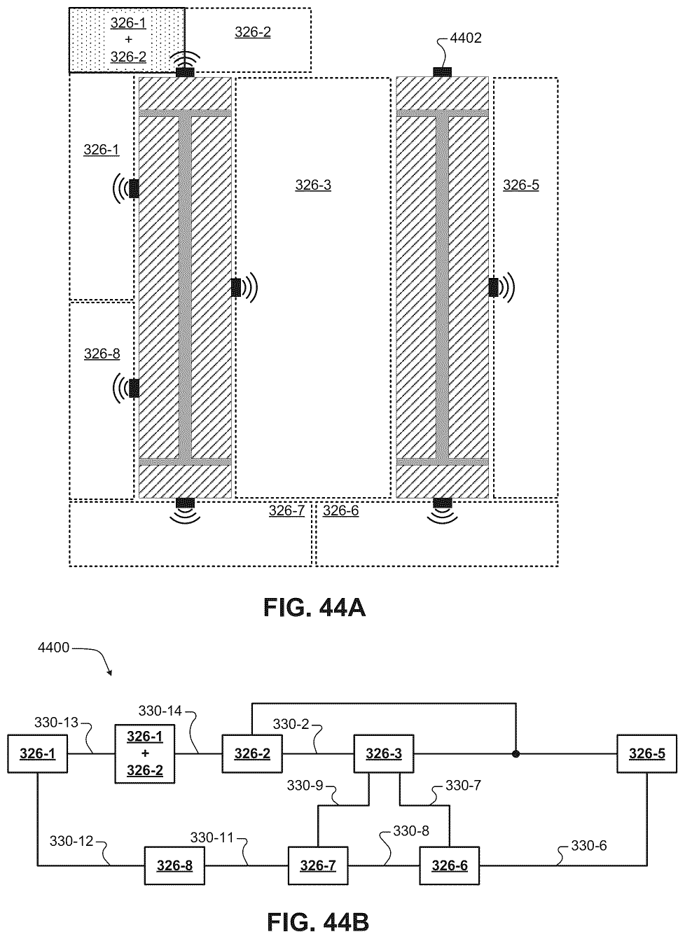

FIGS. 44A-44B illustrate an example location indicator layout similar to FIG. 43A, except that the location indicator 4402 for area 326-4 is not functioning properly. In some examples, the location indicator 4402 may be out of power, broken, or malfunctioning for another reason. In this example, one or more MSDs and the CCS may automatically update the location map 4400 to remove area 326-4, as illustrated in FIG. 44B. In some implementations, the MSDs and/or the CCS may be configured to remove an area from the store in response to detecting the absence of location signals that otherwise were detected in the past. For example, the MSDs and/or CCS may remove the area from the location map after determining that the location signal has not been detected for a threshold amount of time. Upon removing an area from the location map, the MSDs and/or the CCS may initially update the item association table by assigning item ID codes to adjacent areas. Subsequently, over time, the MSDs and/or the CCS may update the item association table based on the updated location map, as described above.

Although generation/update of location maps is described above with respect to location indicators that emit location signals, the OFS may also generate/update location maps in stores that include location indicators having readable codes (e.g., barcodes). For example, MSDs can automatically scan for location indicators (e.g., using a barcode reader or camera) including readable codes and automatically update the location map in a manner similar to that described with respect to FIGS. 41A-44B. Specifically, over time, the MSDs may add areas and/or remove areas associated with location indicators having readable codes, as described above with respect to FIGS. 41A-44B.

In some implementations, the location map updating may be accomplished while the users are picking items from the racks for customer orders. In other examples, the user may set the MSD into a “location mapping mode” and walk through the store with the MSD while the MSD is acquiring location signals and automatically generating the location map based on the acquired location signals. In a store that includes location indicators having readable codes, the user may walk throughout the store and scan the location indicators to generate the location map. In other examples, the MSD may be configured to automatically read the readable codes. For example, the MSD may be configured to rest in a cart pushed throughout the store and scan the racks or other areas for the readable codes. In this example, the MSD may automatically pick up the readable codes as the cart is pushed throughout the store (e.g., using a camera or other barcode scanning device), as described herein with respect to using the MSDs for picking.

The MSDs may be configured to scan the item indicators, or detect the item signals transmitted from the item indicators, and perform various operations in response to scanning the item indicators or detecting the item signals. In one sense, an item indicator that is scanned or an item signal that is received by an MSD may be thought of as indicating a particular location of a corresponding item within the store. For example, a first location (e.g., on a shelf of a rack within an aisle) in the store may include a first item indicator that is scanned by an MSD, or which transmits a first item signal to an MSD. Similarly, a second location may include a second item indicator that is scanned by an MSD, or which transmits a second item signal to an MSD. As a result, an MSD may determine that the MSD is located in the first or second location when the MSD scans the first or second item indicator or detects the first or second item signal, respectively. Additionally, the item indicators or the corresponding item signals scanned or detected by an MSD at a particular time may also be thought of as indicating which of the items available in the store are in proximity to the MSD at that specific time. For example, since each of the items in the store may be associated with one or more item indicators and/or item signals, an MSD may, upon scanning an item indicator or detecting an item signal, determine which one or more of the items are in the vicinity of the MSD at that particular time.

Using the techniques described herein, an MSD may determine a location within the store and/or proximity of the MSD to one or more of the items included in the store. In some examples, the MSD may determine the location based on scanned item indicators or detected item signals. For example, the location may be represented as a location value, which may generally refer to any value or plurality of values (e.g., alphanumeric values) determined by the MSD that indicate a location of the MSD within the store. In some implementations, the MSD may further determine the location and the location value based on scanned location indicators or detected location signals. In general, the location values determined by the MSDs may depend on the types of item indicators/signals and location indicators/signals used in the store. A variety of example item and location indicators and item and location signals are described herein. In examples where the item and location indicators transmit item or location signals, an MSD may determine locations and corresponding location values based on one or more of the signals. In examples where the item and location indicators do not transmit item or location signals, an MSD may determine locations and corresponding location values in a different manner. For example, when item indicators and location indicators are readable objects (e.g., barcodes), an MSD may determine a location within the store and a corresponding location value based on a code included on the readable object.

An MSD may scan item indicators or acquire item signals as the MSD is transported throughout the store by a user. The item indicators may be set up throughout the store in a variety of different configurations. In some examples, the item indicators may be set up in the store such that the MSD may scan an item indicator or pick up an item signal near any given item located within the store. In these examples, the item indicators may be set up such that the item indicators, or item signals generated by the item indicators, overlap to varying degrees such that an MSD may scan multiple item indicators or acquire multiple item signals simultaneously in some locations. Additionally, or alternatively, the item indicators may be arranged such that the item indicators or associated item signals do not quite overlap, but, instead, abut one another or are separated by a short distance such that an MSD may scan a first item indicator or detect a first item signal in a first location, and then abruptly scan a second item indicator or detect a second item signal upon moving out of range of the first item indicator or first item signal. In other examples, the item indicators may be set up such that an MSD may not scan item indicators or pick up item signals at some locations within the store. In these examples, there may be so-called “dead zones” in which an MSD may not scan item indicators or acquire item signals because item indicators or item signals may be absent in that location, or not be sufficiently strong in that location. Various configurations of item indicators within a store are illustrated and described herein.

An MSD may perform a variety of different operations based on a location (e.g., a corresponding location value) and item proximity determined by the MSD. As described herein, the MSD may receive a customer order from the CCS outside of the store or as the MSD is being transported throughout the store by a user. In some examples, the MSD may be configured to display items of the received customer order on a display of the MSD based on a currently determined location, as indicated by a corresponding location value, and based on proximity of the items to the location and to each other, as indicated by an item adjacency map. For example, the MSD may be configured to arrange (e.g., order within a list) the items that are in proximity to the user (i.e., the MSD) at the top of the display for the user to view (e.g., at the top of the list). The MSD may be further configured to arrange the items that are farther from the user lower on the display (e.g., at the bottom of the list). In examples where a large number of items are displayed (e.g., ordered within a list), the items that are more distant from the user may be omitted from the display. Accordingly, in some examples, the items that are in closer proximity to the user may be displayed at the top of the display, while those items that are more distant from the user may be placed at the bottom of the display or not included on the display. Such an arrangement of items on an MSD display may prompt the user to pick items from the racks that are closest to the user. This may speed up the picking process by prompting a user to pick those items that may be picked the quickest and preventing the user from walking by items that are currently ordered by a customer.

The display of an MSD may be updated in real-time as the MSD is moved throughout the store. For example, the arrangement of the items on the display (e.g., within the list) may be updated as the user moves the MSD from a first location where a first item indicator is scanned or a first item signal is detected by the MSD to a second location where a second item indicator is scanned or a second item signal is detected by the MSD. In this example, the items originally arranged on the display may be further rearranged in real-time to reflect which of the items are currently in proximity to the user after the user has moved to the second location. Since the arrangement of the items may vary based on the location of the MSD, it follows that, in some examples, different MSDs present in different locations within the store may display different arrangements of the same items to their respective users.

In some examples, the display of an MSD may also be updated in real-time when new customer orders are received. For example, if a newly-received customer order includes items that are present in the store at the current location of an MSD, the display of that MSD may be updated to include the items of the newly-received order at or near the top of the display of the MSD. This may prevent a user from walking past an item that has just been ordered (e.g., ordered within the past few seconds).

In some examples, the display of an MSD may also be updated in real-time when items are scanned by the MSD. For example, an item may be removed from the display of the MSD when the MSD scans the item. In some examples, the displays of multiple MSDs may be updated in real-time when items are scanned by any one of the multiple MSDs. For example, when an item is scanned by any one of the multiple MSDs, the item may be removed from the displays of all of the MSDs in the store. In these examples, all of the MSDs may be updated each time any of the MSDs in the store scans an ordered item. This may allow multiple users located throughout the store to scan and pick different items of a single customer order. In some circumstances, this may allow customer orders to be picked more quickly than if a single user was picking the entire order.

One or more of the MSDs and/or the CCS may generate an item adjacency map that includes multiple items and indicates whether any two or more of the items are adjacent to one another (e.g., whether the items are located close to one another in the store). Adjacent items may be relatively close to one another in the store, such that the adjacent items may be picked one after another efficiently (e.g., without excessive movement). The distance between adjacent items may be configurable, depending on the item adjacency criteria used (e.g., depending on threshold times). As such, the meaning of adjacency (e.g., in terms of distance/time) may be configurable by the store operator. In a specific example, if the OFS is configured to set items as adjacent that are scanned within less than a few seconds of one another, adjacent items in the store may be very close to one another (e.g., within reach of one another). In general, increasing the amount of scan time allowed between adjacent items may allow for adjacent items to be farther apart from one another.

The MSDs and/or CCS may determine two or more scan times associated with two or more of the items (e.g., any two or more items that are currently displayed to a user of an MSD at the MSD display). The MSDs and/or CCS may determine whether the scan times satisfy an item adjacency criterion (e.g., a predetermined threshold amount of time) and, if so, determine that the items corresponding to the scan times are adjacent to one another. Subsequently, the MSDs and/or CCS may update the item adjacency map to indicate this determination. Alternatively, in the event the MSDs and/or CCS determine that the scan times do not satisfy the item adjacency criterion, the MSDs and/or CCS may determine that the two or more items are not adjacent to one another (or have undetermined adjacency). In some examples, the MSDs and/or CCS may further update the item adjacency map to indicate that the two or more items are not adjacent (e.g., by removing an indication of adjacency).

In some implementations, the item adjacency map may be generated based on scan times associated with picked customer items. Although the item adjacency map may be generated based on picked customer items, in some implementations, an MSD may include an “item adjacency mapping mode” that a user can use to generate some/all of the item adjacency map. For example, the user may set the MSD into the item adjacency mapping mode and scan items (e.g., not included in customer orders) while walking through the store. In some implementations, the item adjacency map may be created based on scans of items that are not included in customer orders, such as item scans that occur passively while a user is picking items.

The item association tables, location maps, and item adjacency maps described herein may also be generated based on data (e.g., location signal detection and scan times) acquired from CCDs used for mapping/picking, third-party MSDs used for mapping/picking, and/or other devices (e.g., robotic scanning devices) used for mapping/picking. The TPCS and CCS may store the item association tables, location maps, and adjacency maps for a single store. In some implementations, the TPCS may acquire the tables and maps from the CCS. In other implementations, the TPCS may generate and store their own tables and maps for the store. In some implementations, the CCS may retrieve tables and maps from the TPCS.

An MSD may receive a customer order including one or more items in the store (e.g., from the CCS) and retrieve the item adjacency map described above. For example, the item adjacency map may be stored at the CCS and transmitted to the MSD and/or the item adjacency map may already be stored at the MSD at the time the customer order is received. The item adjacency map may include multiple items within the store, including items that are in the customer order, and indicate whether any two or more of the items are adjacent. The MSD may display the items in the customer order based on data included in the item adjacency map. In some cases, the MSD may select an initial one of the items in the customer order and then display the items included in the customer order based on the initially selected item and based on the item adjacency map. For example, the MSD may arrange adjacent items (e.g., nearby items) at the top of the display for picking. In this example, the MSD may arrange items that are farther away (e.g., adjacent to currently adjacent items) farther down the display. In one example, the MSD may determine (e.g., estimate) a distance and/or a time required for a user to move between the initial item and one or more other items included in the customer order based on the item adjacency map (e.g., previous scan times). The MSD may then arrange some (or all) of the items of the customer order on the MSD display based on the determined distance and/or time. For example, the MSD may display the initial item at the top of a list. The MSD may further display other items lower within the same list based on the relative distances and/or times associated with the items and the initial item. In a specific example, the MSD may display an item that is closer to the initial item higher within the list compared to an item that is farther from the initial item. In some examples, the MSD arranges all items in the customer order on the display. In other examples, the MSD arranges a subset of the items, with the remaining items accessible to the user by scrolling down the list. In some examples, the MSD may arrange the currently adjacent items in a group near the top of the display and arrange other items farther down the display. In some examples, the MSD arranges the items in the order of closest to farthest with respect to the user (e.g., the MSD). In other examples, the MSD displays the items that are closest to the user at that particular time. In still other examples, the MSD indicates that a specific one of the items is currently adjacent to the user.

Although an MSD may display items based on a determined distance or time, in some implementations, an item adjacency map may not include distance or time data. In these implementations, the item adjacency map may just indicate that items are adjacent, without accompanying time/distance data. In these implementations, the MSD may display items that are determined to be adjacent to a current item/location higher on the display (e.g., for more immediate picking). The MSD may display items that are not adjacent farther down the display (e.g., for subsequent picking). In some cases, the MSD may display the currently non-adjacent items according to whether the currently non-adjacent items are adjacent to items which are currently near the user. For example, the MSD may display items farther down the display (e.g., for subsequent picking) that are adjacent to items which are adjacent to a current item/location. In a similar manner, the MSD may display subsequently adjacent items farther down the list. In some cases, the MSD may arrange an entire order based on adjacency. In other cases, the MSD may be configured to arrange a subset of the items in the list, and then arrange the remaining items that are farther away after the user has started picking the subset of items. In this manner, the MSD may present a list to the user that indicates which items are currently nearby and should be picked.

In some implementations, the OFS may make use of location indicators and/or location signals in conjunction with the item indicators, item signals, location maps and/or an item adjacency maps. As described herein, an MSD may perform a variety of different operations based on a location and a corresponding location value determined by the MSD, irrespective of whether the location and location value are determined using location indicators/signals alone or in conjunction with item indicators/signals. For example, an MSD may be configured to receive a customer order from the CCS while the MSD is being transported throughout the store. The MSD may be further configured to determine a location value associated with a current location of the MSD using one or more location indicators and/or location signals. The MSD may be further configured to display items of the received customer order on an MSD based on the determined location value and an item adjacency map. For example, the MSD may be configured to initially use the location value to orient the MSD as to the MSD's current location within the store and subsequently use the item adjacency map to determine the relative locations of the items in the customer order with respect to that location. For example, the MSD may first determine an initial one of the items included in the customer order that is located closest to (e.g., within) the location associated with the location value. The MSD may then use the item adjacency map to determine the locations of the remaining items of the customer order relative to the location of the initial item. As a result, the techniques of this disclosure may, in some examples, enable more accurate determination of relative locations of items in areas of the store (e.g., aisles) that include many items in close proximity to one another. The techniques of the disclosure may also allow for more efficient item picking.

In some implementations, one or more of the MSDs and/or the CCS may be configured to determine that two items are located adjacent to one another upon an MSD scanning the items and determining that the corresponding scan times are within a predetermined threshold amount of time. In some implementations, one or more of the MSDs and/or the CCS may be configured to determine that two items are located adjacent to one another upon an MSD scanning the items and determining that the corresponding scan times are within a predetermined threshold amount of time N number of times (e.g., a threshold number of times). In other words, in some examples, the techniques of this disclosure include determining that two items are adjacent upon scanning the items within a predetermined threshold amount of time in multiple instances. Similarly, in some examples, the techniques may include determining that two items are not adjacent upon scanning the items outside of a predetermined threshold amount of time in multiple instances. As a result of using data from multiple scans, the techniques may allow determining that the items are likely adjacent and decrease the chance of erroneous adjacency determinations (e.g., using so-called “outlier” scan times).

In some implementations, one or more of the MSDs and/or the CCS may be configured to determine adjacency of groups, or so-called “clusters,” of multiple items. For instance, in some examples, the techniques of this disclosure include grouping multiple items scanned by one or more of the MSDs into each of a first group and a second group. For instance, for any of the first and second groups, a plurality of the items scanned by the MSDs may be included in a particular group based on a number of the items (e.g., N of the items) and/or based on a threshold amount or duration of time during which the items were scanned. The techniques further include determining whether the first group includes one or more items that are the same as, or “overlap with,” one or more items included in the second group. The techniques also include, upon determining that the first and second group include one or more of the same items, determining that the first and second groups are adjacent. This may enable more accurately determining relative locations of the items within a store by grouping the items into groups and determining common items within the groups. In some examples, adjacency among any two of the items may be referred to as primary, or “first-tier,” adjacency. Adjacency among any two groups of items may be referred to as secondary, or “second-tier,” adjacency.

In some implementations, one or more of the MSDs and/or the CCS may be further configured to, upon generating an item adjacency map that indicates adjacency of a plurality of items, also include an indication of time (e.g., estimated time) and/or distance (e.g., estimated distance) required for a user to move (e.g., walk) between two or more of the items in the item adjacency map. In these examples, the MSDs and/or CCS may arrange multiple items on a display of an MSD in the manner described herein based on relative times and/or distances associated with two or more of the items using the item adjacency map including such indication of time and/or distance. In some implementations, the time and/or distance indications in the item adjacency map may be values that indicate relative time and/or distance between items, but not indicate actual time units (e.g., seconds) and/or distance units (e.g., meters). Instead, the time and/or distance indications may be dimensionless (e.g., without units). In other implementations, the time and/or distance indications may include time and/or distance units.

In some implementations, to generate an item adjacency map, one or more of the MSDs and/or the CCS may be configured to process the scan times associated with the items as the scan times are acquired (e.g., in real-time). Alternatively, the MSDs and/or the CCS may be configured to process a scan log including the scan times at a later point in time. The scan log may include data that indicates an MSD that scanned an item, a time when the item was scanned, and other data described herein. For example, a scan log may indicate a location value for the scan, where the location value may be determined based on a location indicator (e.g., a last/next scanned indicator or detected location signal) or other location technology (e.g., GPS, WIFI, etc.).

In some implementations, one or more of the MSDs and/or the CCS may be further configured to perform a calibration of the predetermined threshold amount of time described herein based on user speed (e.g., based on the scan times included in the scan log). For example, the MSDs and/or CCS may be configured to determine the predetermined threshold amount of time by determining user speed and scanning time, and then adjusting the predetermined threshold amount of time based on the user speed. In a specific example, users that pick items at a faster/slower rate may have their threshold scan times decreased/increased for determining adjacency.

In some implementations, one or more of the MSDs and/or the CCS may be configured to infer item adjacency between two items based on determined item adjacency between two or more intervening items. In other words, in some examples, the MSDs and/or CCS may be configured to, upon determining that a first item is adjacent to a second one or more items, and that the second one or more items are adjacent to a third item, further determine that the first and third items are also adjacent.

In some implementations, one or more of the MSDs and/or the CCS may be configured to infer item adjacency between multiple items based on corresponding scan times being within a predetermined threshold amount of time and/or based on sequential scanning of the items. For example, the MSDs and/or the CCS may determine that multiple items are all adjacent to one another upon determining that each of the multiple items was scanned by an MSD within a predetermined threshold amount of time. Additionally, or alternatively, the MSDs and/or the CCS may determine that the multiple items are all adjacent to one another upon determining that the items were scanned in a sequence (e.g., one item directly after another).

In some implementations, one or more of the MSDs may be configured to display multiple items in the manner described herein based on relative numbers of intervening items located between any two of the items, as indicated by an item adjacency map. For example, the MSD may display an initial item at the top of a list and one or more other items lower within the list in the order of how many intervening items are located between each such item and the initial item. In these implementations, the MSDs and/or CCS may generate an item adjacency map to indicate adjacency of a plurality of items using numbers of intervening items as metrics for adjacency. Also, in these implementations, the MSDs and/or CCS may omit any time or distance metrics previously described from the item adjacency map and retain sequence data indicating one or more sequences or orders in which the items in the store are arranged.

In some implementations, an MSD may be configured to display items such that a user of the MSD is directed to keep moving the MSD from a particular group of items to another group of items. For example, the MSD may be configured to, after scanning an item included in a first group of items, display an item included in a different group of items. In other words, the MSD may be configured to display an item that is adjacent to items in the first group, but which is not included in the first group. For example, the MSD may display items from the first group on the display along with another item from the second group of items to move the user in the direction of the second group.

In some implementations, one or more of the MSDs and/or the CCS may be configured to generate an item adjacency map that indicates adjacency of a plurality of items as well as scan directionality, or a scanning order, associated with the items in the item adjacency map. For example, the item adjacency map may indicate a temporal order in which the items in the item adjacency map were scanned by an MSD, in some examples indicating a time at which each item was scanned. The MSD may arrange items on the display based on the known temporal order in which items were scanned and determined as adjacent. Using a known temporal order of adjacency may provide directionality to the user while picking, which may reduce an amount of back-and-forth movement of the user while picking adjacent items. Additionally, the temporal order of adjacency may help the MSD put together a longer and more efficient picking route for one or more customer orders. For example, the temporal order of adjacency may indicate a direction of motion in which the user should pick single items and/or groups of items. In some cases, the historical scanning of intervening items between first and last picked items may provide an indication of direction in which the items may be picked efficiently.

In some implementations, an MSD may display items included in a customer order to a user and receive an input (e.g., a touchscreen tap) from the user selecting one of the items. In these implementations, one or more of the MSDs and/or the CCS may be configured to, upon receiving the input, designate the corresponding item as the next item to be picked by the user. For example, the MSD and/or the CCS may use the corresponding item as a “seed” or a “re-seed” item and determine one or more other items included in the customer order that are adjacent to that item using an item adjacency map (or other table/map). In this manner, each of multiple users of the MSDs may pick the items included in the customer order by selecting an item closest to the user and updating the items on the corresponding MSD to reflect one or more of the items that are adjacent to the user. As a result, multiple users of the MSDs may dynamically enter and exit the process of picking the items included in the customer order described herein. In some implementations, the MSD and/or CCS may “seed” an item in response to a scan of the item. For example, the MSD may assume that the user is in the location of the scanned item in response to the user scanning the item. The seeded item, whether manually selected or scanned, may be used to arrange items based on the item adjacency map and/or the location map and item associations.

In some implementations, one or more of the MSDs and/or the CCS may be configured to arrange items included in a customer order based on one or more location indicators. For example, an MSD may prioritize (e.g., move up a list) items that are located in a zone corresponding to a current location of the MSD, as indicated by an associated location indicator present in that zone.

In some implementations, one or more of the MSDs and/or the CCS may be configured to generate an adjacency map that is represented using any of a variety of other data structures other than those depicted in the figures of this disclosure, such as those indicating a number of item “hops” (e.g., a number of items) between any two items, an amount of time needed for a user to move between any two items, and so forth.

In some implementations, one or more of the MSDs and/or the CCS may be configured to use metadata indicating a type/category (e.g., produce, dairy, meat products) associated with an item included in a customer order to group (e.g., cluster) the item with one or more other items that are also included in the customer order, adjacent to the item, and associated with the same type. In this manner, the MSDs and/or CCS may group or cluster multiple adjacent items in the manner described herein based on item type shared by, or associated with the items, rather than on a number of the items. In some implementations, the MSDs and/or CCS may group items by type in an item adjacency map and then indicate which items are adjacent to one another within the item type group. For example, the item adjacency map may group dairy products together based on type and/or aisle location (e.g., aisle number). The item adjacency map may then further define the location of the items within the group (e.g., item type and/or aisle) using item adjacency or other location indicator mapping described herein. In additional implementations, the MSDs and/or CCS may include multiple items in a group or cluster and then infer that the items share a common item type.

In some implementations, one or more of the MSDs and/or the CCS may be configured to identify a first item included in a first group and identify a second, different item, that is adjacent to the first item but not included in the first group. The MSDs and/or the CCS may be configured to identify one or more additional items that are adjacent to the second item and also not included in the first group and include the second item and the additional items in a second, different group.

In some implementations, one or more of the MSDs and/or the CCS may be configured to generate a cluster map that indicates one or more items that are included in one or more groups (e.g., clusters). The MSDs and/or the CCS may be configured to use the cluster map in a similar manner as described herein with reference to an item adjacency map. For example, the MSDs and/or CCS may be configured to identify an item included in a cluster and use the cluster map to identify and indicate one or more additional items that are also included in the same cluster and are therefore adjacent to the item. In some implementations, one or more of the MSDs and/or the CCS may be configured to use a cluster map to determine a location of one or more items included in a store and/or a location in a store. The cluster maps may be used alone, or with other maps, such as other item adjacency maps and/or location maps. In some implementations, the cluster maps may be used as an alternative to location maps and/or when a location indicator has not been detected and/or is faulty, missing, or outdated (e.g., moved to another location).

In some implementations, one or more of the MSDs and/or the CCS may be configured to determine that two items are adjacent upon scanning the items within a predetermined threshold amount of time after several instances of scanning the items outside of the predetermined threshold amount of time. In this manner, a single scan instance indicating adjacency among the items may negate or remove several prior scan instances indicating non-adjacency among the items. In further examples, non-adjacency among items may be used to fill in missing information in an adjacency map. For example, an MSD may display items that are determined non-adjacent to a current item when adjacent items are missing or not known.

In some implementations, one or more of the MSDs and/or the CCS may be configured to use an item adjacency map in conjunction with one or more location indicators. For example, in these implementations, a store may include one or more zones, each associated with a location indicator. In each such zone, one or more areas associated with one or more items included in the zone may be organized based on adjacency among the items. For example, the item adjacency map may indicate to an MSD and/or the CCS where within the zone the items are located based on the adjacency among the items. In some implementations, the location map and/or item adjacency map may indicate an aisle number and/or a portion of the aisle (e.g., middle, end, etc.).

In various implementations, the MSDs and/or CCS may be configured to identify a first item (e.g., an anchor item) included in a particular zone associated with a location indicator, and then determine relative locations of one or more different items also included in the zone with respect to the first item using an adjacency map. In this manner, the MSDs and/or CCS may add granularity to, or enhance resolution of, relative locations of the items included in the zone. In some examples, one or more of the different items previously not displayed on an MSD (e.g., displayed off-screen) may be displayed upon determining the items are adjacent to the first item. Alternatively, one or more previously displayed items may be removed from being displayed upon determining the items are not adjacent to the first item.

In various implementations, one or more of the MSDs and/or CCS may be configured to make use of items (e.g., an anchor item) included in zones and MSDs transitioning from one zone to another zone. For example, the MSDs and/or the CCS may determine that an item included in a first zone is proximate to an item included in a second zone upon an MSD scanning the two items within a predetermined threshold amount of time when the MSD transitions between the two zones, thereby defining edges of the zones. In various implementations, the items scanned by the MSD in this manner may be referred to as edge items. Identifying edge items and a sequence of items between edge items in a zone may assist the CCS and/or MSDs in determining how to arrange items on the display. For example, if the MSD is about to traverse a zone, the MSD may display items at the entry edge of the zone, and then display sequential items in the zone farther down the list until the items on the opposite edge are reached. Displaying items in this manner may provide for efficient picking in a store that is laid out in long aisles, where most aisles have two ways to enter/leave. In a specific example, if an aisle has one or more zones in a line, the arrangement of items for picking may be organized in a linear fashion down the aisle from zone to zone based on the edge items and sequential items between the edge items.

In some implementations, an MSD may be configured to display a subset of the items included in a customer order (e.g., items that are located proximate to the MSD at that time). In some implementations, the MSD may randomly insert one or more other items included in the customer order into a list of displayed items, such as items that are not adjacent to the MSD or for which adjacency is not known (e.g., to fill a screen). In this manner, the MSD may indicate to a user where the user is ultimately expected to go to fill the customer order and/or enable the user to determine (e.g., refresh) adjacency of the items included in the customer order by prompting the user to move toward items for which adjacency is not known.

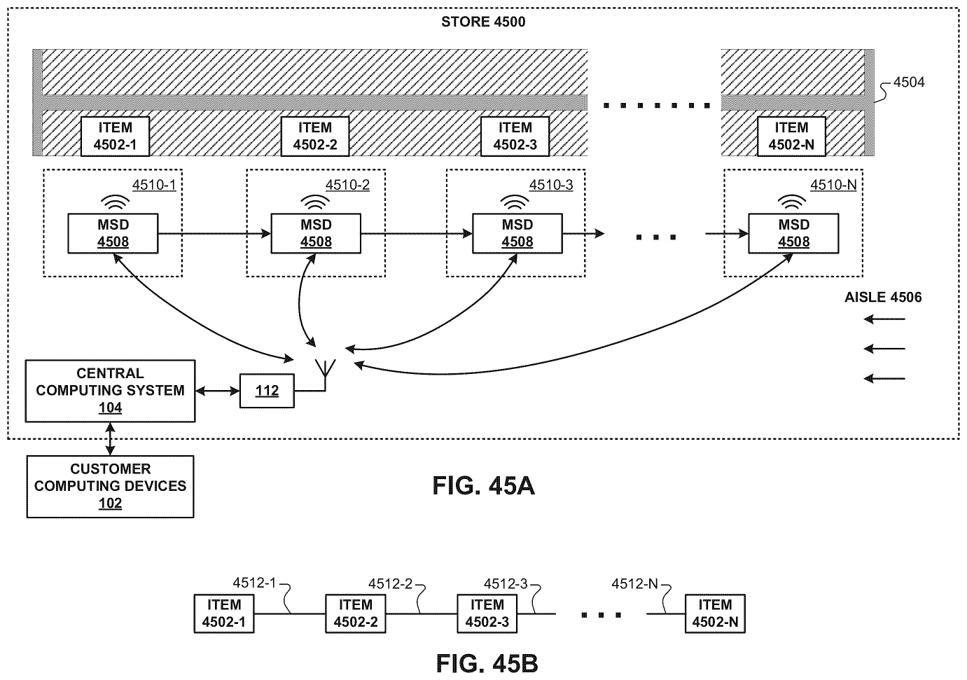

FIG. 45A illustrates an example store 4500 including a plurality of items 4502-1 . . . 4502-N placed on a rack 4504. Example store 4500 also includes an aisle 4506 formed along (e.g., located adjacent to) rack 4504. Items 4502-1 . . . 4502-N include item indicators (e.g., barcodes/RFIDs) that may be associated with item IDs. The items, item indicators, and item IDs may be referred to using the same callouts. Item indicators 4502-1 . . . 4502-N may each identify a corresponding one of items 4502-1 . . . 4502-N to a particular one of MSDs, namely MSD 4508, when MSD 4508 is located proximate to the item. Store 4500 includes CCS 104 that communicates with the one or more MSDs, including MSD 4508, and with one or more CCDs 102, via communication system 112. The broken line boxes labeled 4510 may indicate different scan times for the items (e.g., not necessarily sequential). Although the items are illustrated as being arranged along a straight line on a single rack, item adjacency may be applicable to items in any arrangement on any number of racks throughout the store.

FIG. 45B depicts an example graphical representation of adjacency among items 4502-1 . . . 4502-N described with reference to FIG. 45A. The graphical representation of adjacency indicates that item 4502-1 is adjacent to item 4502-2, item 4502-2 is adjacent to item 4502-3, and so forth. The graphical representation of adjacency depicted in FIG. 45B may correspond to any data structure, including information represented as one or more alphanumeric characters, binary data, or other human- and/or machine-readable information. In the example of FIG. 45B, the graphical representation of adjacency among items 4502-1 . . . 4502-N indicates a substantially linear adjacency relationship between items 4502-1 . . . 4502-N. In other examples, the graphical representation of adjacency among items 4502-1 . . . 4502-N, or other items, may be non-linear, branched, circular, or have other relationships. The junctions 4512 between items 4502 may represent adjacency between the items. In some implementations, the junctions may represent an item adjacency value that indicates the proximity between the items (e.g., a scan time difference between the items).

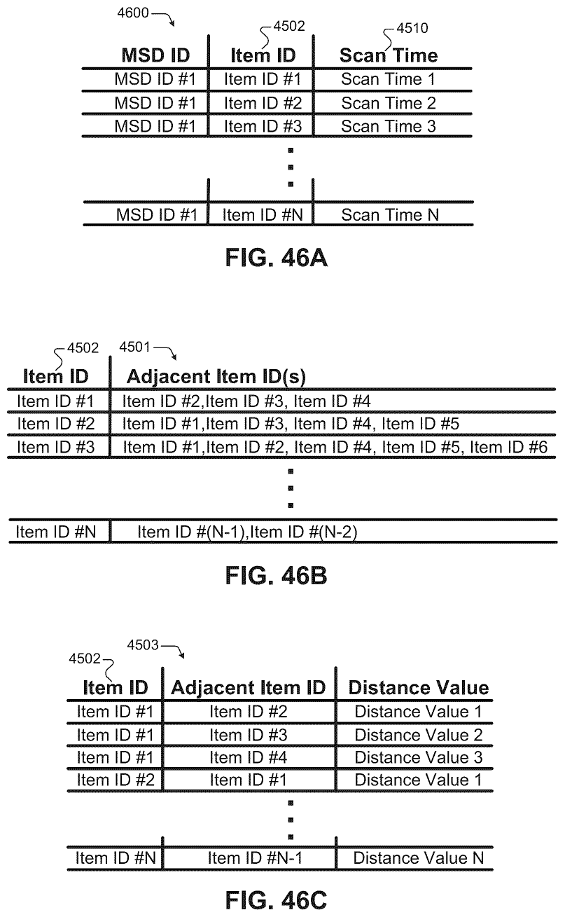

FIG. 46A depicts example item scan time data 4600 associated with the plurality of items 4502 described with reference to FIGS. 45A-45B. As shown in FIG. 46A, item scan time data 4600 includes a table indicating each of the plurality of items 4502. Specifically, item scan time data 4600 includes, for each of the plurality of items 4502, an item identification (ID) number that identifies the item and a scan time associated with the item. As described with reference to FIGS. 46A-46B, the scan time associated with each of the plurality of items 4502 may be determined by scanning the item on a rack of a store using MSD 4508. As shown in FIG. 46A, in some implementations, a scan time associated with each of the plurality of items is represented in numeric form (e.g., hours, minutes, and/or seconds) or other form. As also shown in FIG. 46A, in some implementations, item scan time data 4600 further includes, for each of the plurality of items, an MSD ID number that identifies an MSD 4508 used to acquire the scan time associated with the item.

FIGS. 46B-46C depict example item adjacency maps 4501 and 4503 generated based on the item scan time data 4600 described with reference to FIG. 46A. As shown in FIG. 46B, item adjacency map 4501 includes a table indicating each of the plurality of items 4502 described with reference to FIGS. 45A-45B. In particular, item adjacency map 4501 includes, for each of the plurality of items 4502, an item ID number that identifies the item. Item adjacency map 4501 further includes a list of adjacent items for each of the plurality of items 4502. As shown in FIG. 46C, in some implementations, item adjacency map 4503 further includes estimated relative distances between adjacent items, such as distance values estimated based on scan times between items (e.g., average/median scan times). The item adjacency map 4503 may include scan times and/or distance values, depending on the implementation.

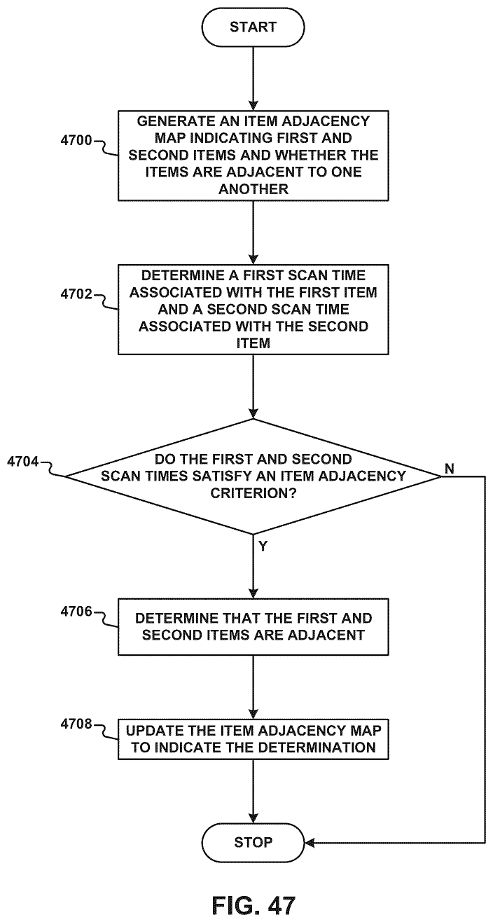

FIG. 47 depicts a method describing operation of an MSD configured to generate an item adjacency map indicating adjacency of a plurality of items. In block 4700, an MSD and/or the CCS initially generates an initial item adjacency map that indicates a plurality of items located on one or more racks included in a store and whether the items are adjacent to one another. Upon initial creation of the item adjacency map, the item adjacency map may include a plurality of items, but may not indicate whether the items are adjacent or not. For example, adjacency between the items may be labeled as undetermined (e.g., N/A). In some implementations, the MSD may initially generate the item adjacency map to partially, or preliminarily, indicate whether the items are adjacent to one another. In other words, the MSD may generate the adjacency map to indicate the plurality of items, as well as indications of whether the items are adjacent to one another.

The adjacency map may be subsequently updated based on scan times associated with the items. For example, an indication of whether two of the items are adjacent to one another may be determined and/or reinforced based on relatively temporally close scan times associated with the items, indicating that the items are adjacent to one another. Alternatively, the indication of whether the two of the items are adjacent to one another may be removed based on relatively temporally distant scan times associated with the items, indicating that the items are not adjacent to one another. Specifically, in block 4700, the MSD generates the item adjacency map to indicate at least first and second items and whether the items are adjacent to one another (or undetermined). As described herein, the MSD may further update the item adjacency map to include one or more additional items and whether each of the additional items is adjacent to each of another one or more items also included in the item adjacency map.

In block 4702, the MSD determines a first scan time associated with the first item and a second scan time associated with the second item. In some implementations, the MSD determines the first and second scan times by scanning the first and second items, as described herein. For example, the MSD may scan the first and second items in a temporally sequential manner automatically as the MSD passes the first and second items while the items are located on one or more racks. As another example, an MSD may determine the first and second scan times when a user manually operates the MSD to scan the items while picking a customer order.

In block 4704, the MSD determines whether the first and second scan times satisfy an item adjacency criterion (e.g., a predetermined threshold amount of time). In some implementations, the MSD determines whether the first and second scan times are sufficiency temporally close to one another, indicating that the first and second items are adjacent to one another. For example, the MSD may determine whether a difference between values associated with the first and second scan times is sufficiency small (e.g., within a predetermined threshold amount of time). In other implementations, the MSD determines whether the first and second scan times satisfy an item adjacency criterion using other techniques/criteria, such as a criterion that may be satisfied by having two or more independent users (e.g., MSDs) scan the items in less than a threshold amount of time.

In some implementations, the MSDs may reject scan times between items that are outliers from other scan times, as such outliers may not be representative of an accurate distance between items. An outlier scan time difference between two items may be a scan time difference that varies by greater than a threshold amount from a typical range (e.g., average or median) of scan times between specific items. For example, if two items are typically scanned within tens of seconds of one another, the MSDs may reject scan time differences of minutes or seconds, as such outlier scan times may indicate an atypical scenario. An atypical scenario may occur when a user holds on to an item for a long period of time and then scans it. This scenario may result in an atypically long scan time between the recently scanned item and a previous item. Another atypical scenario may occur when a user holds on to a first item for a long period of time and then scans the first item just before scanning the second item. This scenario may result in an atypically short scan time between the held first item and the subsequent second item.

In block 4706, in the event the MSD determines that the first and second scan times satisfy the item adjacency criterion, the MSD determines that the first and second items are adjacent to one another. Subsequently, in block 4708, the MSD updates the item adjacency map to indicate this determination. For example, as described herein, the MSD may reinforce an existing indication included in the item adjacency map that indicates that the first and second items are adjacent. In other examples, the MSD may create a new indication that the first and second items are adjacent and include the indication in the item adjacency map. Reinforcing a determination of adjacency may include updating data associated with the adjacent items that indicates the scan times between items have satisfied item adjacency criterion multiple times. For example, the MSD and/or CCS may update the item adjacency map to include, for each pair of adjacent items, a reinforcement indicator value that indicates the number of times the two items have been considered adjacent. The item adjacency map may also include, for each pair of adjacent items, the history of scan times associated with the pair of adjacent items.

In the event the MSD determines that the first and second scan times do not satisfy the item adjacency criterion (“NO” branch of block 4704), the MSD may make a variety of determinations. In some implementations, the MSD may determine that the adjacency status of the first and second items remains undetermined. In these implementations, the item adjacency map may include data that indicates when items are adjacent or whether the status of the adjacency is undetermined.

In some implementations, the item adjacency map may include data that indicates when items are not adjacent. In these implementations, the MSD may determine that the first and second items are not adjacent to one another based on one or more scan times associated with the two items that indicate they are not adjacent. For example, the items may be determined to be non-adjacent when the scan times between the items are large (e.g., sufficiently greater than a threshold value). In some examples, the MSD may further update the item adjacency map to indicate that the first and second items are not adjacent, in a similar manner as described with reference to block 4708. For example, as described herein, the MSD may remove an existing indication included in the item adjacency map that indicates that the first and second items are adjacent. Alternatively, the MSD may explicitly indicate that two items are not adjacent in some cases.

In some implementations, the item adjacency map is generated by a combination of the MSD and the CCS 104. In some examples, the CCS 104 generates the item adjacency map in a similar manner as described herein with reference to the MSD, and transmits the item adjacency map to the MSD. For example, the MSD may transmit, to the CCS 104, information indicating that the first and second items are adjacent and/or the first and second scan times. In this example, the CCS 104 may generate the item adjacency map based on the first and second scan times. In other examples, the CCS 104 and the MSD jointly generate the item adjacency map based on the first and second scan times. In these examples, upon generating and/or receiving the item adjacency map, the MSD uses the map to display a list of items located on racks of a store.

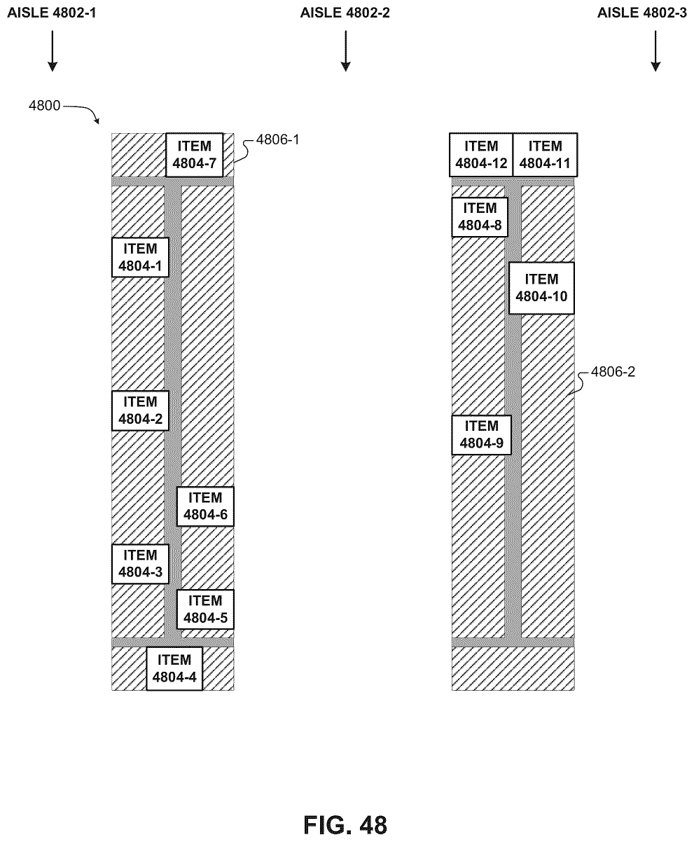

FIG. 48 depicts an example store 4800 including a plurality of items 4804 (e.g., including item indicators 4804) placed on racks 4806. Example store 4800 also includes aisles 4802. In FIG. 48, one or more of the MSDs and/or the CCS have generated an item adjacency map including items 4804. The MSDs and/or the CCS have also determined scan times between items 4804 and determined whether the scan times satisfy an item adjacency criterion (e.g., a predetermined threshold amount of time). In the event the scan times satisfied the item adjacency criterion, the MSDs and/or CCS have further determined that the items are adjacent to one another and have updated the item adjacency map to indicate this determination.

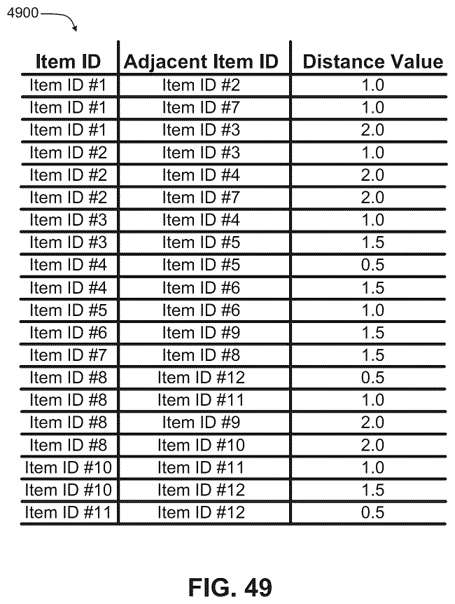

FIG. 49 depicts an example item adjacency map 4900 generated based on item scan times acquired for items 4804 in FIG. 48. As shown in FIG. 49, item adjacency map 4900 includes a table including items 4804-1 to 4804-12. The item adjacency map 4900 includes, for each of the plurality of items 4804, an item identification (ID) number that identifies the item. The item adjacency map 4900 also indicates, for each item, which other items are adjacent to the item. The item adjacency map 4900 also includes, for each item, an indication of a distance between the item and the adjacent item. As shown in FIG. 49, in some implementations, an indication of a distance between adjacent items is represented in numeric form (e.g., in a nominal or real value). In other implementations, the item adjacency map may indicate an amount of time between adjacent items (e.g., an average scan time). The item adjacency map in FIG. 49 may be updated over time to include additional adjacencies, remove existing adjacencies, and/or modify distance values and scan times. The item adjacency map of FIG. 49 is only one example item adjacency map that may be generated for the items of FIG. 48.

An MSD may use the item adjacency map of FIG. 49 in order to pick the items of FIG. 48. In some cases, the MSD may have the item adjacency map included in memory. In other cases, the MSD may retrieve the item adjacency map from the CCS. The MSD may select an initial item included in the customer order using any of a variety of techniques described herein. The MSD may display items in the customer order based on the selected initial item and the item adjacency map. In some examples, the MSD determines a distance and/or a time required for a user to move between the initial item and one or more other items included in the customer order based on the item adjacency map. In these examples, the MSD then arranges some/all of the items on the display based on the determined distance and/or time. For example, the MSD may display the initial item at the top of a list and display the other items lower on the list based on the relative distances and/or times associated with the items and the initial item. The MSD may further indicate that a specific one of the items is currently adjacent to the user.

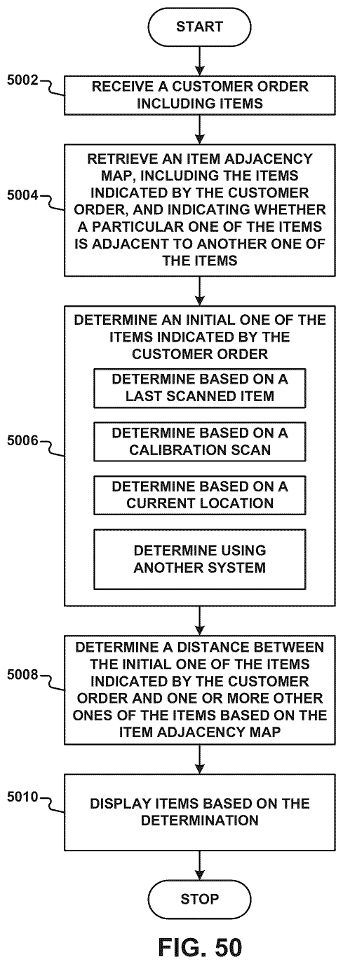

FIG. 50 depicts a method describing operation of an MSD that displays items based on an item adjacency map. In block 5002, the MSD receives a customer order including a plurality of items from the CCS. In block 5004, the MSD retrieves an item adjacency map (e.g., from MSD memory or the CCS) that includes the items of the customer order and indicates whether any items are adjacent to one another.

In block 5006, the MSD selects an initial one of the items in the customer order. In some implementations, the MSD selects the initial one of the items based on a last-scanned item. For example, the MSD may select the item in the customer order that the MSD most recently scanned as the initial one of the items, or items near the last scanned item. In other implementations, the MSD may select one of the items that is most proximate to the item that the MSD most recently scanned as the initial one of the items. For example, the MSD may determine that a particular one of the items included in the customer order is proximate to the item that the MSD most recently scanned using an item adjacency map. In other examples, the MSD may determine that a particular one of the items is proximate to the item that the MSD most recently scanned using one or more received location signals and location values determined based on the received location signals. In still other examples, the MSD may determine that a given one of the items is proximate to the most recently scanned item using other techniques (e.g., GPS/WiFi location information). In other implementations, the MSD determines the initial one of the items based on a calibration scan. For example, the MSD may determine the initial one of the items based on a scan of one or more items located on one or more racks included in the store that are each proximate to the MSD. In other implementations, the MSD determines the initial one of the items based on a current location. For example, the MSD may determine the initial one of the items using one or more received location signals and location values determined based on the received location signals and/or using other techniques (e.g., GPS/WiFi location information), in a similar manner as described herein.

In block 5008, the MSD determines a distance between the initially selected item and the other items in the customer order using the item adjacency map. For example, the MSD may determine whether the initially selected item is closer to a particular item in the customer order based on the item adjacency map. In other words, the MSD may determine a relative distance between the initially selected item and the other items in the customer order using the item adjacency map. In some implementations, the MSD may determine the relative distance based on single distance values and/or a sum of distance values.

In block 5010, the MSD displays the items of the customer order based on the distance determination described with reference to block 5008. As one example, the MSD may display the initially selected item at the top of a list presented to a user. In this example, the MSD may further display additional items lower within the same list based on the relative distances between the items and the initially selected item. In particular, the MSD may arrange items that are relatively closer to the initially selected item higher within the list. In a specific example, with respect to FIG. 48, an MSD near item 4804-5 may display items 4804-3, 4804-4, 4804-5, and 4804-6 higher on the display to prompt the user to pick those items due to their adjacency. Due to the item adjacency map, this may even be the case if items 4804-3 and/or 4804-4 are in different zones (e.g., associated with different location values) than item 4804-5.

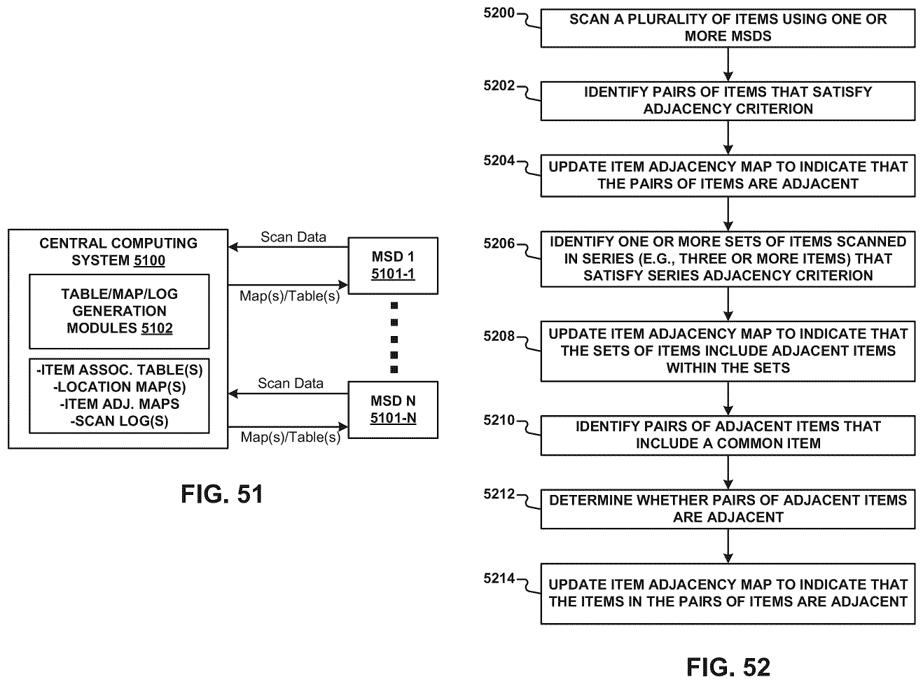

FIG. 51 illustrates an example CCS 5100 that includes data described herein. For example, the CCS 5100 may include one or more item association tables, one or more location maps, one or more item adjacency maps, and one or more scan logs. As described herein, the CCS 5100 may generate the data included in the CCS 5100 based on data (e.g., item IDs, location signals, etc.) acquired from one or more MSDs (e.g., MSDs 5101-1 to 5101-N).

The CCS 5100 may include modules 5102 that generate the tables, maps, and logs stored at the CCS 5100. For example, the CCS 5100 may include table generation modules (e.g., item association table generation modules), map generation modules (e.g., location/adjacency map modules), and/or log generation modules (e.g., scan log generation modules) that generate the tables, maps, and logs stored at the CCS 5100. The modules and data included in the CCS 5100 represent features that may be included in the CCS 5100 of the present disclosure. The modules and data described herein may be embodied by electronic hardware, software, firmware, or any combination thereof.

FIG. 51 illustrates N MSDs 5101 that provide data to the CCS 5100 that may be used to generate the item adjacency maps and scan logs. For example, each of the N MSDs provide scan data to the CCS 5100. The scan data may include, but is not limited to, item IDs, timestamps, and location values. The CCS 5100 may generate and update the scan logs and/or the item adjacency maps based on the received scan data from the N MSDs 5101. The CCS 5100 may also generate and update other data structures described herein based on the scan data, such as item association tables and location maps.

FIG. 52 illustrates an example method that describes multiple ways the CCS may determine that items are adjacent. In block 5200, one or more MSDs scan a plurality of items. For example, the MSDs may scan items for a plurality of customer orders over time (e.g., hours, days, weeks, or more). The method of FIG. 52 may be implemented in real time and/or or may be implemented using item scan data stored in a scan log. In block 5202, the CCS identifies pairs of items that satisfy adjacency criterion (e.g., scanned within a threshold time). In block 5204, the CCS updates the item adjacency map to indicate that the pairs of items are adjacent.

Blocks 5206-5208 are directed to identifying a situation where a series of scanned items are determined to be adjacent to one another. In block 5206, the CCS identifies one or more sets of items that were scanned in series. For example, the CCS may identify a series of items (e.g., 3 or more items) that were scanned in series by a single MSD. Furthermore, in block 5206, the CCS identifies one or more sets of the items scanned in series that satisfy series adjacency criterion. Example series adjacency criterion may include a requirement that the series of items be scanned within less than a threshold period of time (e.g., a series threshold time). In this example, if multiple items (e.g., 3 or more) are scanned in less than the threshold period of time, the multiple items may be considered as adjacent to one another. For example, each of the items may be considered as adjacent to the other items. In block 5208, the CCS updates the item adjacency map to indicate that the items in the sets of items are adjacent to one another. In an example case where a set of items includes three items, the first item may be updated as adjacent to the second item and the third item, the second item may be updated as adjacent to the first and third item, and the third item may be updated as adjacent to the first and second item.

Blocks 5210-5212 are directed to identifying a situation in which items in two pairs of adjacent items that include a common item may be determined to be adjacent. This situation may arise when a single MSD scans the pairs of items at different times (e.g., different times of day, week, etc.) for different customer orders. This situation may also arise when a first MSD scans a first pair of items and a second MSD scans a second pair of items, where the first and second pairs of items include the same item. In block 5210, the CCS identifies pairs of adjacent items that include a common item. In block 5212, the CCS determines whether items in the pairs are adjacent. In one example, the CCS may determine that all items in the two pairs of items are adjacent when the sum of the scan times is less than a threshold value. For example, the CCS may determine that the three items in two pairs of adjacent items are adjacent if the sum of the scan times between the first pair of items and the second pair of items is less than a threshold value. The CCS may make the determination in block 5212 using various scan times associated with the pairs, such as the most recent scan times, average scan times, etc. In block 5214, the CCS updates the item adjacency map to indicate the items in the pairs of items are adjacent if the criteria in block 5212 are satisfied.

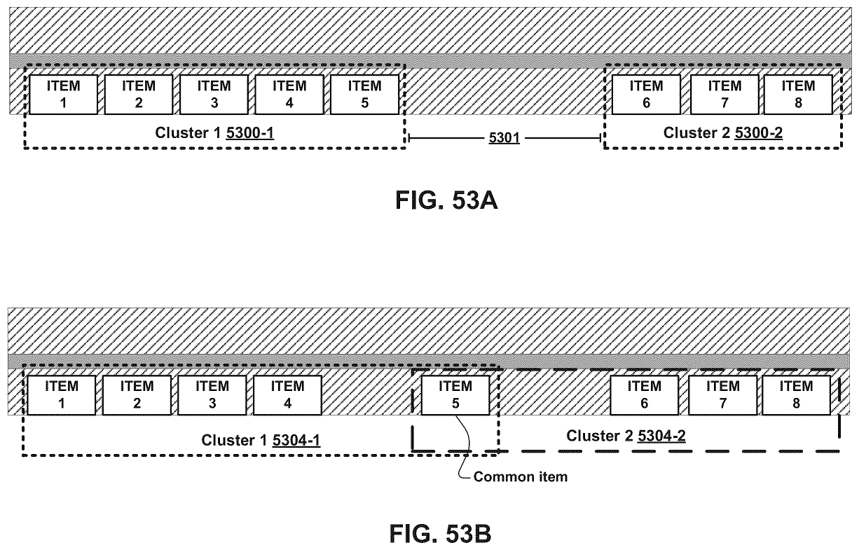

FIGS. 53A-53B illustrate example clusters of adjacent items. FIG. 53A includes a first cluster 5300-1 and a second cluster 5300-2. The first cluster 5300-1 includes five adjacent items. The second cluster 5300-2 includes three adjacent items. The two clusters 5300 are separated by some distance indicated at 5301. In some cases, the two clusters 5300 may not be considered as adjacent. In other cases, the two clusters 5300 may be considered adjacent if one of the items from the second cluster 5300-2 is scanned within a threshold amount of time after scanning an item from the first cluster 5300-1. In this case, an item adjacency map may be updated to indicate that the two clusters are adjacent (e.g., cluster identifiers may be indicated as adjacent). In some cases, when two clusters are adjacent, each item from both clusters may be considered as adjacent to one another (e.g., in a single combined cluster).

FIG. 53B illustrates an example in which two clusters 5304-1, 5304-2 include a common item (e.g., item 5). The inclusion of a common item in two clusters may indicate that the two clusters are adjacent. This scenario may arise when two previously separate clusters each add the common item at a later time. The CCS may leave the two clusters as separate data structures in some cases, but indicate that the two clusters are adjacent based on the common item. In other cases, the CCS may combine the clusters and consider the items in the clusters as being adjacent to one another (e.g., in a single cluster).

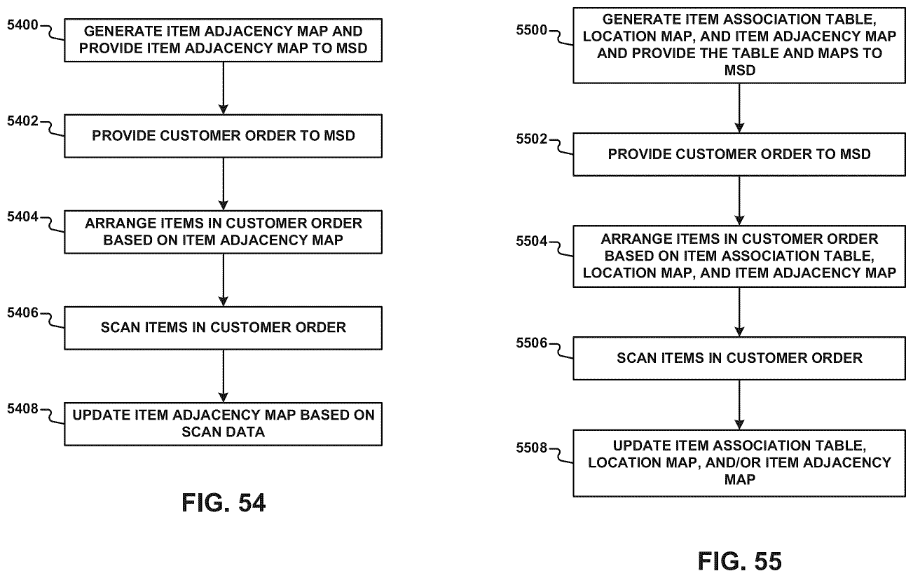

FIG. 54 illustrates a method that describes using an item adjacency map for mapping and picking items from the store. In block 5400, the CCS generates an item adjacency map for the store and provides the item adjacency map to an MSD. In block 5402, the CCS provides a customer order to the MSD for picking.

In block 5404, the MSD arranges the items in the customer order on the display based on the item adjacency map. For example, the MSD may arrange the items in a picking order that minimizes picking time by generating the picking sequence for the items based on the items' location relative to one another. In a specific example, the MSD may arrange the items so the user is mostly picking items that are subsequently adjacent to one another until the order is picked.

In some implementations, the MSD may initially arrange the items based on an assumed starting point for picking. For example, the MSD may arrange items relative to a specific/general picking starting point, such as the entry to the store, a first aisle location, or other location. In these implementations, the MSD may rearrange the items as the user moves throughout the store and/or scans items. In other cases, the MSD may not rearrange the items. Instead, the MSD may maintain the initial arrangement of items on the display, such that the customer order is presented as a fixed sequential list of items. The MSD may also initially arrange and/or rearrange items based on a determined location.

In block 5406, the user moves through the store picking and scanning items in the customer order. In block 5408, the CCS may update the item adjacency map based on scan data received from the MSD. In some cases, the MSD or other scanning device may scan items on the shelf that are not included in the customer order. For example, an MSD or other scanning device (e.g., robotic, attached to the cart or user, etc.) may scan items, scan readable location indicators, and/or pick up location signals for the purposes of updating the item association table, location map, and/or item adjacency map.

FIG. 55 illustrates a method that describes using an item association table, location map, and item adjacency map for mapping and picking items from the store. In block 5500, the CCS generates an item association table, location map, and item adjacency map for the store, and then provides the table and maps to an MSD. In block 5502, the CCS provides a customer order to the MSD for picking.

In block 5504, the MSD arranges the items in the customer order on the display based on the item association table, location map, and item adjacency map. In some implementations, the MSD may be configured to determine an initial arrangement of items based on the user's location, as determined by the location map and/or item association table. The MSD may then further arrange the items within the location using the item adjacency map. The additional arrangement based on item adjacency may arrange the items for more efficient picking in the case that a location indicator/signal covers a large number of items. For example, if a location indicator covers an entire aisle of items, the item adjacency map may define more granular arrangements of items on the display. Alternatively, in some cases, the MSD may arrange items based on item adjacency first and then based on location.

In block 5506, the user moves through the store picking and scanning items in the customer order. In block 5508, the CCS may update the item association table, the location map, and/or the item adjacency map based on scan data received from the MSD. As described herein, an MSD may generate an initial arrangement of items for one or more customer orders upon receiving the one or more customer orders. Subsequently, the MSD may rearrange the items on the display based on user movement/picking. Although an MSD may rearrange items based on a current location (or other data), in some implementations, the MSD may maintain the initial arrangement of items on the display (e.g., not rearrange the items). For example, the MSD may present the customer orders as a fixed sequential list of items.

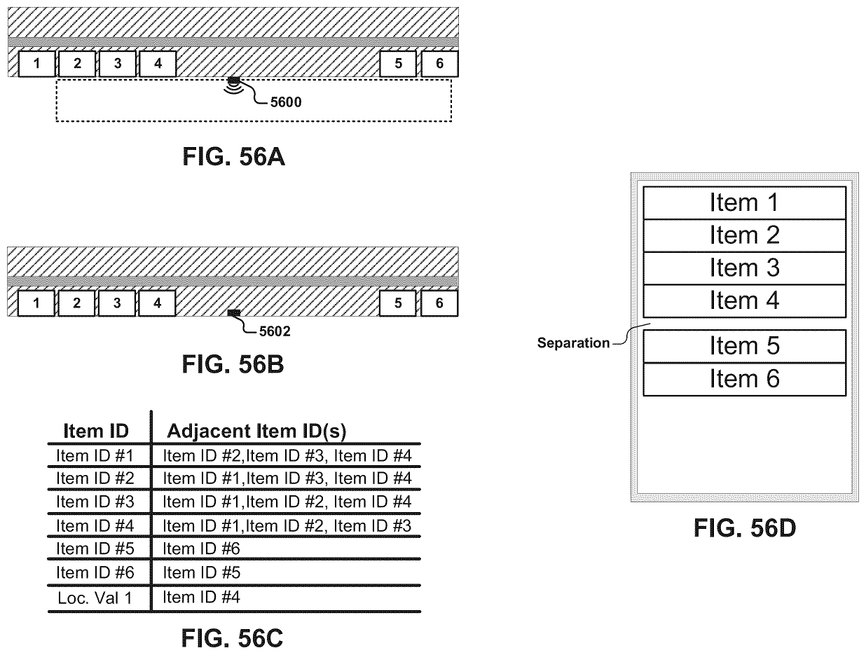

FIGS. 56A-56D illustrate examples of a store that implements both location indicators and item adjacency mapping. FIGS. 56A-56B both include six items (e.g., items 1-6). FIG. 56C illustrates an item adjacency map that indicates items 1-4 are adjacent to one another and items 5-6 are adjacent to each other. The item adjacency map also includes a location value (Loc. Val 1) associated with a location indicator 5600 that emits a location signal (e.g., FIG. 56A) or a readable location indicator 5602 (e.g., FIG. 56B).

FIG. 56A illustrates how location indicators and item adjacency may be implemented to better arrange items for picking. In FIG. 56A, the location indicator 5600 emits a location signal that covers items 2-6, but not item 1. Accordingly, item 1 may not be associated with a location value in some cases. However, if item adjacency is used, the MSD may determine that item 1 is near items 2-4. Also, using item adjacency, the MSD may determine that items 1-4 are grouped together and items 5-6 are grouped together.

FIG. 56B illustrates how a readable location indicator 5602 and item adjacency may be implemented to better arrange items for picking. In FIG. 56B, the readable location indicator 5602 may be associated with items 1-6, or some of items 1-6. In this case, however, if item adjacency is used, the MSD may also determine that items 1-4 are grouped together and that items 5-6 are grouped together.

FIG. 56D illustrates how item adjacency can be used to arrange customer items on a display. The MSD displays adjacent items as being grouped. For example, items 1-4 and items 5-6 are grouped. The groups of items are also separated on the display to indicate that the physical groups of items are separated from one another (e.g., determined based on adjacency). The separation is illustrated as a gap between the item groups. In some implementations, the MSD may display the groupings in a different manner. For example, the groupings may be rendered in different colors, text (e.g., font/bold/underlining), etc. In cases where item adjacency is not used, the MSD may group items together that are associated with the same locations.

Note that the item adjacency map of FIG. 56C includes data that indicates the adjacency of a location indicator (e.g., location value) to an item. The adjacency of a location indicator relative to items may be determined in a variety of ways, depending on the type of location indicator used. With respect to readable location indicators, the CCS may generate the item association table by treating the readable location indicator as though the readable location indicator is an item ID for purposes of the item adjacency map. With respect to a location indicator that emits a location signal, the MSD may generate the adjacency map based on a location of the location indicator relative to the items. The MSD may make the determination of proximity to the location indicator in a variety of ways, depending on the type of location indicator. In some implementations, the MSD may determine the proximity based on the strength of the location signal.

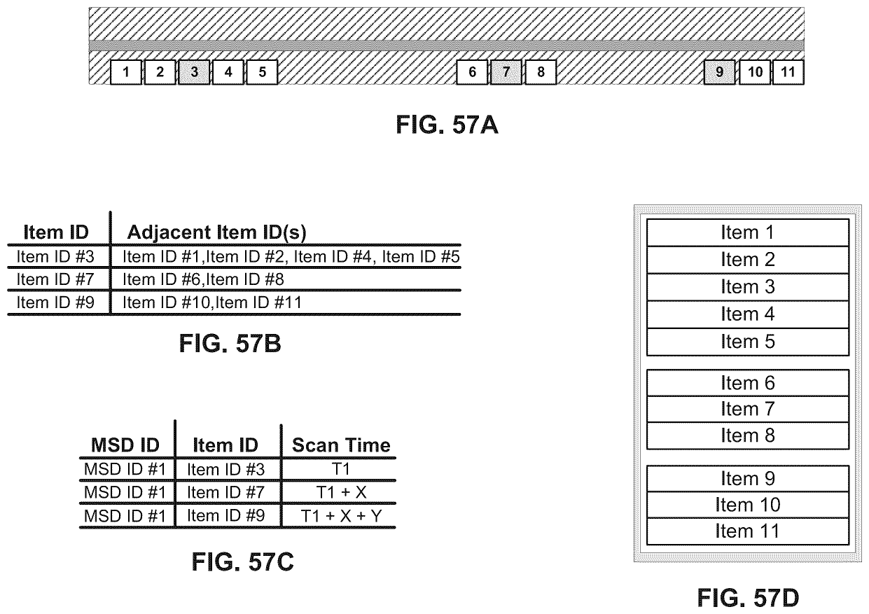

FIGS. 57A-57D illustrate the use of a scan log to determine item adjacency and directionality in a store. The item adjacency and directionality may be used to map items in a store. The maps based on item adjacency and directionality may allow the MSD to provide the user with a more efficient picking route. In FIG. 57A, items 1-5 are adjacent, items 6-8 are adjacent, and items 9-11 are adjacent. The three separate clusters in FIG. 57A are not adjacent to one another. The adjacency between the items may have been determined based on scan logs provided by one or more MSDs that picked one or more customer orders. FIG. 57B illustrates a partial item adjacency map that indicates the adjacencies in FIG. 57A.

FIG. 57C illustrates example scan log data that indicates a single MSD had scanned items 3, 7, and 9 in sequence. Specifically, the items were scanned at time T1, subsequent time T1+X (e.g., X seconds after T1), and further subsequent time T1+X+Y (e.g., Y seconds after T1+X). Although the sequential scan of items 3, 7, and 9 may not indicate adjacency of the items, the sequential scan times may indicate a physical location (e.g., arrangement) of items 3, 7, and 9 relative to one another. For example, the sequential scan times may indicate that items 3, 7, and 9 may be picked in a sequence (e.g., a linear sequence where item 7 is in the middle). Although a sequence of only 3 items are shown in the scan log, a scan log may include a much longer sequence of items (e.g., greater than 3 items) that indicate the relative location of a sequence of items to one another. Note that items 3, 7, and 9 are shaded for illustration purposes in FIG. 57A.

In FIG. 57D, it may be assumed that the MSD has received a customer order including items 1-11 of FIG. 57A. The MSD groups the adjacent items into different groups on the display based on adjacency. Additionally, the MSD arranges the groups of items based on the sequence data, with the items adjacent to item 7 displayed in the middle of the groups. The arrangement of the groups in FIG. 57D may be determined based on an assumed or determined starting point of the picker (e.g., near items 1-5) in a variety of ways described herein. If the picker were to start picking from the group of items 9-11, the groups may be rearranged on the display such that the bottom group of items 9-11 is switched with the top group of items 1-5.

Although the data used to generate the item association tables, location maps, and item adjacency maps may be acquired from MSDs, in some implementations, the data may be acquired by other computing devices, such as an automatic scanning and/or picking device (e.g., a robotic device that moves throughout the store). For example, a robotic device may scan items, acquire location signals, and/or scan location indicators. In some implementations, the robotic device may send the acquired data to the CCS for processing. The robotic device and/or the CCS may generate the tables and maps described herein based on the acquired data. The maps may then be used to arrange items for picking by MSDs and/or CCDs.

The CCS may include one or more store maps. The CCS may generate different types of maps in a variety of different ways. In some implementations, the CCS may generate a location map that includes a plurality of zones that are associated with location indicators, such as readable location indicators and/or location indicators that transmit location signals. In some implementations, the CCS may generate item adjacency maps that include a list of items and indicate which items are adjacent to one another.

In some implementations, the CCS may generate store maps based on images acquired by one or more image capture devices (e.g., cameras). For example, the CCS may generate store maps based on images acquired by cameras that are included on, or interface with, store MSDs, third-party MSDs, and/or CCDs. The cameras may also be included on other objects, such as shopping carts, baskets, or other item carriers. Additionally, or alternatively, the CCS may generate store maps based on images acquired from robotic devices that are configured to move throughout the store and acquire images.

In some implementations, as described above, the CCS may generate store maps based on images including readable codes (e.g., readable location indicators). For example, the MSDs may include a camera and associated image processing electronics/software for interpreting the readable codes. In this example, the CCS/MSDs may acquire images and identify one or more readable codes in the images. The CCS may generate a store map based on the location of the readable codes relative to one another. Example store maps including readable codes are included in FIGS. 20A-20B.

In some implementations, the CCS may generate item adjacency maps based on images captured by MSDs and/or other devices. For example, the CCS may identify items in the images based on item IDs (e.g., barcodes) on the items and/or by identifying other item properties in the images, such as text, size, shape, colors, etc.

In some implementations, the CCS may generate maps that include store objects or other acquired image data. Example store objects may include, but are not limited to, signs, text, racks, floor patterns, etc. In these implementations, the CCS may generate maps that indicate the location of store objects in the store. For example, a map may indicate the relative locations of different store objects to one another and/or other location indicators/items. In some implementations, maps generated using images may be referred to herein as “image-based maps.”

In some implementations, the CCS may generate maps that include GPS location values (e.g., GPS coordinates). For example, MSDs/CCDs may include GPS receivers that determine a current GPS location associated with the MSD/CCD. As another example, the CCS may generate maps that include WiFi-based location values determined by the MSD/CCD (e.g., a WiFi radio receiver) based on WiFi signals acquired inside/outside the store.

The CCS may generate one or more maps based on any of the mapping technologies described herein. In some implementations, the CCS may generate and use different types of maps that each include different types of locations. For example, the CCS may generate and use different types of maps independently from one another. In a specific example, a CCS may include separate maps for readable location indicators, location indicators that transmit signals, and store objects. In some implementations, the CCS may generate one or more maps that include a mix of different location types. For example, the CCS may merge one or more maps. In a specific example, the CCS may include a map that includes locations based on readable locations indicators, location indicators that transmit signals, and store objects. In another specific example, item adjacency maps based on item scan times may be merged with item adjacency maps generated based on images.

The CCS may store item association data (e.g., item association tables) that associates items with locations (e.g., items with nearby locations). For example, an item association table may include items and their associated zones determined based on readable location indicators. As another example, an item association table may include items and their associated zones determined based on location indicators that transmit location signals. As another example, an item association table may include items and one or more associated store objects.

In some implementations, the CCS may store different item association tables for different types of mapping technologies. For example, the CCS may store different item association tables for item associations between readable location indicators and store objects. In some implementations, the CCS may merge item association data for different mapping technologies. For example, an item association table may include each location associated with an item. In a specific example, for a single item, an item association table may include location values for a readable location indicator associated with the single item and a store object associated with a single item.

The maps described herein may indicate a physical layout of the store with respect to the mapping technology used by the store. For example, a map may indicate the relative location of different location indicators, store objects, and/or items (e.g., item adjacencies). The item association data may indicate a location of an item relative to a map location (e.g., a location indicator, store object, etc.). For example, an item association table may indicate a location of an item relative to one or more location indicators and/or one or more store objects.

In some implementations, the item association data may be separate from map data. Although the maps and item association data may be described as separate data structures, in some implementations, the item association data may be merged with map data to different extents. Using different types of map data and/or item association data acquired in a variety of different manners may provide the CCS with a more complete picture of the store layout and/or item locations. For example, using one or more maps and one or more item association tables, the CCS may determine the location of items relative to one or more locations and/or one or more other items.

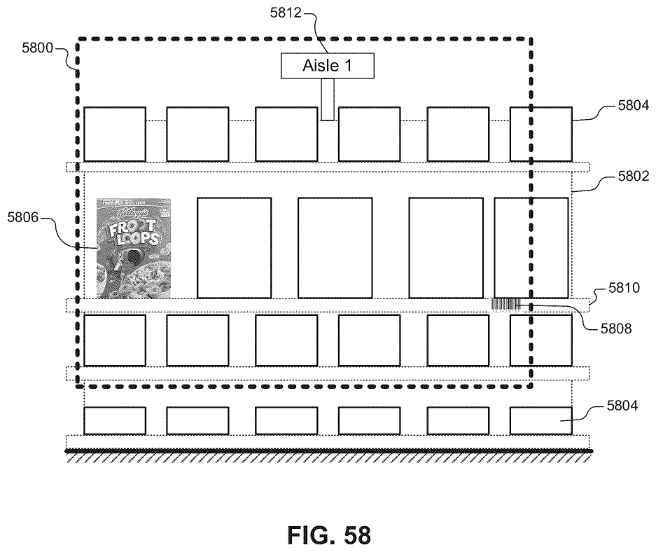

FIGS. 58-70C describe acquiring images (e.g., using one or more MSDs), processing the images (e.g., at the MSDs and/or the CCS), and using the images in a variety of ways, such as mapping the store, assisting a user/customer in picking items using MSD(s), generating store inventory, and/or generating advertisements to customers. In some implementations, the systems and methods of FIGS. 58-68B can be used to strengthen other types of location mapping (e.g., using location indicators) and/or item adjacency mapping. In some implementations, the systems and methods of FIGS. 58-68B may be used in place of other types of location mapping and item adjacency mapping. For example, the OFS may generate maps based on the images (e.g., image-based maps) and use the generated maps for subsequent picking.

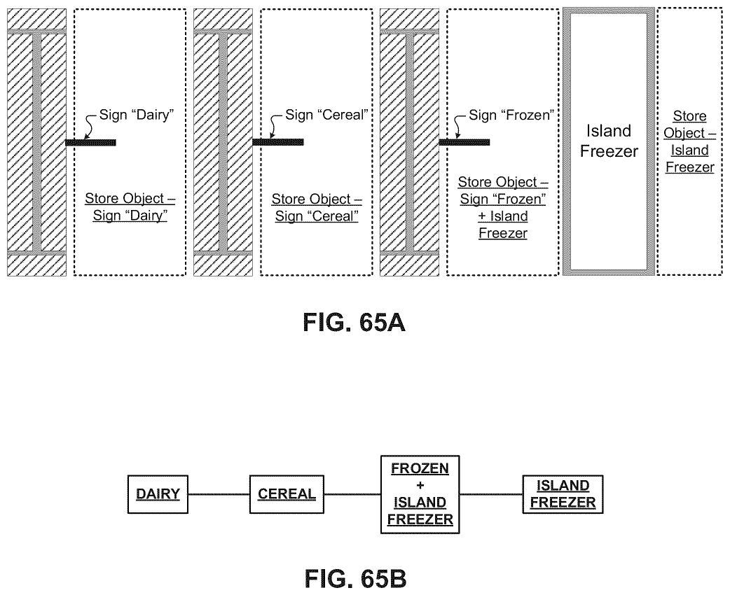

Images may include readable location indicators, item indicators, items (e.g., text/graphics on item packages), and store objects (e.g., signs, racks, aisles, checkout areas, etc.) that may be detected by the OFS. Using the images, the OFS of the present disclosure can generate and/or update tables/maps, such as item association tables, location maps, and item adjacency maps. Additionally, the OFS of the present disclosure can generate image-based maps/tables. Image-based maps may include similar data as other tables/maps described above, although the data for the maps may be acquired in a different manner (e.g., using image analysis). Additionally, or alternatively, image-based maps may include maps based on the location of store objects relative to items (e.g., see FIG. 58 and FIG. 65A).

The maps generated by the OFS can be used for arranging items during picking. For example, the MSDs may use the tables/maps described above for arranging items (e.g., according to distance from the MSD). In some implementations, an MSD may acquire images during picking and arrange items on the display based on the acquired images. For example, an MSD may acquire an image including item/location indicators and/or store objects, determine a location based on the image (e.g., a current location), and arrange items on the display based on the determined location. In some implementations, the MSD or CCS may arrange the items on the display based on the determined location and the locations of the items relative to the determined location.

In some implementations, a store can be mapped using only image-based maps. In these cases, the MSDs may arrange items during picking based on images acquired by the MSDs, location indicators, and/or other technologies described herein. In some implementations, a store can be mapped using image-based maps and other maps/tables. In these cases, MSDs may arrange items during picking based on images acquired by the MSDs, location indicators, and/or other technologies described herein. In some implementations, maps and tables described herein may include similar information regarding the locations of items relative to one another and relative to other location indicators, store objects, etc. As such, in some implementations, one or more maps and tables described herein may be generated based on data included in one or more other maps and tables.

An MSD (or other device) may include and/or interface with one or more image capture devices, referred to herein as cameras. The cameras may acquire images/video inside or outside of the store. In some implementations, a video may include a time series of images that may be analyzed (e.g., frame-by-frame or at different points in time) as described herein.

In some implementations, an MSD can include one or more cameras. For example, cameras can be included as part of the MSD (e.g., enclosed within or fixed to the MSD housing). Additionally, or alternatively, the cameras can be connected to the MSD in another manner, such as connected via a cord (e.g., a cord that provides communication with other components of the MSD). In some implementations, the one or more cameras may be separate from the MSDs. In these implementations, the cameras may be in wireless communication with the MSD (e.g., via WiFi or Bluetooth) and/or the CCS.

In some implementations, the MSDs may process the images locally. Additionally, or alternatively, the MSDs may transmit images/videos to the CCS for processing. In some implementations, the cameras (e.g., separate from the MSD) can send images/video to the CCS for processing. Processing the images may include a variety of operations, including, but not limited to, identifying items in images (e.g., text, graphics, colors, etc.), identifying readable location indicators, and/or identifying store objects. The CCS and/or MSDs can update one or more maps based on the processed images. The CCS and/or MSDs may also determine their location in the store based on the processed images.

The acquired images/video along with additional data associated with the images/video may be referred to herein generally as “image data.” Image data can include images/video along with additional data (e.g., image metadata). Example additional data may include image timing data indicating when the image/video was acquired. For example, image timing data may include a timestamp indicating a time when the image was captured and/or may indicate a relative time that indicates a time when the image was captured in relation to other images captured by the camera over a logical period of time (e.g., during a pick). Additional data may also include image location data that indicates a location where the image/video was acquired, such as a location of the camera and/or MSD when the image was acquired. Example image location data may include a GPS location, WiFi location (e.g., triangulated location), location indicator values, and/or a list of nearby items. Additional data may also include image orientation data that indicates the orientation of the camera that acquired the image/video, such as the height of the camera and/or the angle of the camera (e.g., relative to the floor/ground). The additional data may also include image identification data, such as an MSD identifier (i.e., MSD ID) (e.g., that uniquely identifies the MSD) and/or a camera ID (e.g., that uniquely identifies the camera). Note that an MSD may include one or more cameras. As such, a single MSD ID may be associated with multiple camera IDs. In some implementations, cameras may be operated independently from MSDs. For example, cameras may be included on shopping carts, a robotic mapping device (e.g., a robot that roams the store and maps the store by taking images), or in fixed locations. In these implementations, the camera IDs may not be associated with MSD IDs.

Image data may also include data generated as a result of processing the image/video. For example, image data may include a list of one or more items included in the image/video (e.g., items that are captured/depicted in the image/video). As another example, the image data may include data associated with items, such as data extracted from images of the items, such as text on a box, graphics on a box, barcodes on a box, etc. As another example, the image data may include one or more store objects and associated store object names (e.g., depicted in an image). For example, the image data may indicate a store object type (e.g., sign, cooler, and/or floor pattern) and associated data (e.g., a sign name, cooler type, and/or floor pattern color/material). In some implementations, the store image data may also include a store object ID number determined for, or associated with, the store object. The image data may include relative item location data in the image, such as whether the item is next to another item (e.g., left/right/above/below). In some implementations, the images and/or additional image data may be stored along with image-based maps and item association tables generated based on the images.

In some implementations, the MSDs/cameras may transmit image data to the CCS for processing. For example, the MSDs may transmit images to the CCS, which may then identify items, item indicators, store objects, etc., in the images. In some implementations the MSDs may process images and send image data to the CCS for further processing and/or storage.

FIG. 58 illustrates an example of an image 5800 taken of a rack 5802 that includes a plurality of items 5804. The image may have been acquired by a camera in any manner described herein (e.g., attached to an MSD, cart, robotic device, or other object). The captured image is illustrated as a rectangular broken line. The captured image depicts a plurality of items 5804 (e.g., boxes) that are included on a rack 5802. For example, the image depicts, inter alia, a box of Froot Loops 5806, a location indicator 5808 (e.g., a barcode) attached to a shelf 5810, and an aisle sign 5812 including text (e.g., an aisle name and/or number). The example aisle sign text in FIG. 58 is “Aisle 1.” In some implementations, the CCS/MSD may identify the aisle sign and/or text as a store object for mapping and/or location determination. For example, the CCS/MSD may process the image to identify the aisle sign and may further process the sign text to determine that the image was captured in “Aisle 1.” In this example, the CCS/MSD may then associate the image with Aisle 1 and may further associate a location of the cereal box with the location of “Aisle 1.” Although the aisle sign 5812 is illustrated as above the rack 5802 and facing across an aisle, the aisle sign may be located in a variety of locations (e.g., overhanging the aisle, in the aisle, at the end cap of the aisle, etc.) and oriented in a variety of other orientations (e.g., facing down the aisle).

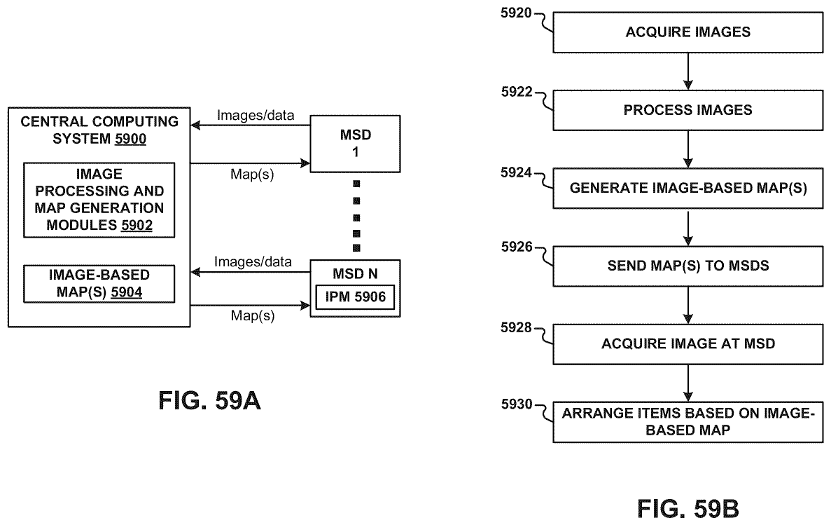

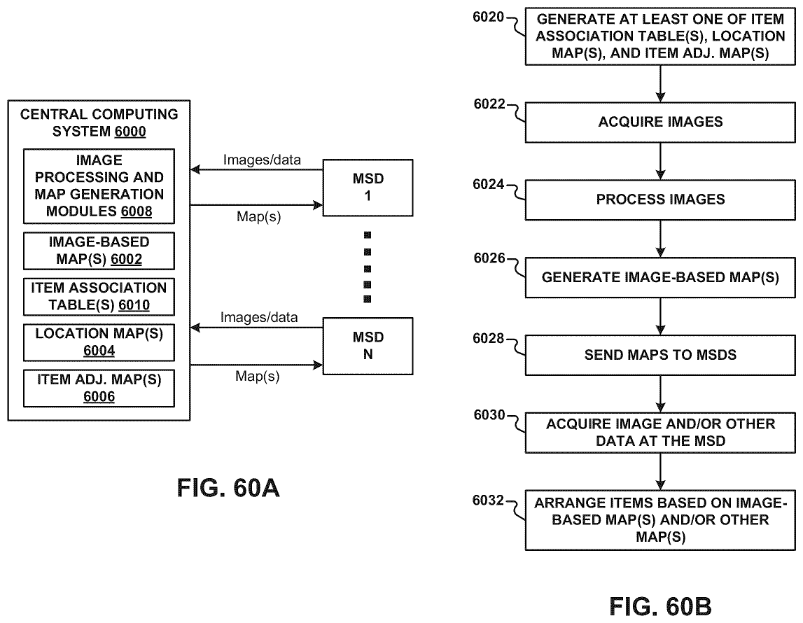

FIGS. 59A-60B describe communication between MSDs and the CCS with respect to generating image-based maps and/or picking items based on acquired images, according to some implementations of the present disclosure. In the example implementation of FIG. 59A, a plurality of MSDs (1-N) may acquire and, in some implementations, may process images. The MSDs transmit the images and/or image data to the CCS 5900. The CCS 5900 may include an image processing system, which may include image processing and map generation modules 5902 that generate the image-based maps 5904. The CCS 5900 may then transmit the image-based map(s) to the MSDs for use in picking. Although a CCS may include an image processing system, the image processing system may be operated by other parties as a service to the CCS (e.g., as a remote server).

In the example of FIG. 59A, an image processing module 5902 may receive an image and may execute one or more image processing techniques to identify and classify one or more objects depicted in the image. In some implementations, an image processing module 5902 may identify one or more blobs (which may or may not be specific shapes) in the image and may extract a set of features of the extracted blobs from the image. The image processing module 5902 may feed the set of features to one or more machine-learned image classification models, which respectively output a classification of the blob based on the set of features. In some implementations, the image classification models may be trained in a supervised, unsupervised, or semi-supervised manner. In some implementations, the machine-learned image classification models may be trained using labeled training images of items (e.g., images that are used to depict an available inventory on a consumer facing application that is accessed using a CCD) or other objects that appear in a store. In these implementations, the images may include one or more labels that respectively indicate items and/or objects depicted in the image. Additionally, or alternatively, a human user may capture images of a store and may apply labels to any items or other objects that are identified in the image. For example, the user may be prompted to apply a label to an object that is identified in an image and/or may be prompted to confirm or deny a classification of the object. In these example implementations, the image classification model(s) may be trained to classify objects that appear in store settings, such as items that are sold in stores, location indicators (e.g., bar codes or QR-codes), and/or store objects commonly seen in stores (e.g., freezers, aisle signs, deli counters, and the like). Image classification models may be trained in additional or alternative manners.

In some implementations, a machine learned image classification model may be trained to identify objects in images regardless of the store or environment in which images are captured. For example, image classification models may be trained to identify specific types or brands of items in a store and/or other commonly observed objects in different stores. Additionally, or alternatively, image classification models may be trained to identify objects in a specific store or set of stores. For example, image classification models may be trained to classify specific signages that appear in a store or set of stores, items that are only stocked in the specific store or set of stores (e.g., generic store brands), or the like.

In some implementations, MSDs/CCDs may include image processing modules (e.g., IPM 5906) that process images. An image processing module of an MSD (or of a CCS processing an image on behalf of an MSD) may leverage store-specific image classification models and/or store-agnostic image classification models to classify objects depicted in one or more images when operating in a mapping mode and/or a picking/scanning mode. For example, in some implementations an image processing module 5902, 5906 may receive a captured image and may identify one or more objects in the image (e.g., using blob detection techniques). The image processing module 5902, 5906 may then extract features of the detected object(s) and may attempt to obtain a classification of the object(s) based on the features thereof. Assuming the image processing module classifies at least one object (e.g., with a sufficient confidence score in a classification of the object), the image classifications of the one or more objects may be output to a mapping module 5904, depending on whether the image processing module is being used in connection with a mapping mode or a picking/scanning mode.

In some implementations, the image processing module 5902, 5906 may be configured to perform optical character recognition (OCR). In these implementations, the image processing module may identify objects of interest containing text, such as signs or stocked items, and may be perform OCR on the image in the objects of interest.

In some implementations, the image processing module may be configured to process an image to identify scannable location indicators (e.g., bar codes and/or QR codes). In these implementations, the image processing module may identify and classify a scannable location indicator. In response to classifying a scannable location indicator, the image processing module may read the scannable location indicator, which may be used to determine an approximate location of the MSD (e.g., as described above).

In some implementations, a map generation module 5902 receives one or more classifications of one or more respective items identified in an image and/or additional image data (or “image metadata”) and generates/updates an image-based map 5904 based on the image classifications. In some implementations, the additional image data includes location data that indicates a location at which the image was captured. For example, the location data may include geocoordinates (e.g., GPS coordinates) of the MSD when the image was captured or a relative location defined with respect to the store in which the image was captured. In the latter scenarios, the location data may be determined by the MSD using any suitable techniques. For example, in some implementations, the MSD may detect one or more location indicators (e.g., RFID signals, Bluetooth signals, barcodes, QR-codes, or the like) that are in the vicinity of the MSD when the image was captured and may determine the location data based on the location indicators that were detected by the MSD when the image was captured. In response to receiving the image classification(s) and/or the corresponding location data, the map generation module 5902 may associate the image classification(s) with a location indicated by the location data in an image-based map. In some implementations, the map generation module 5902 may generate the image-based map to indicate locations of items and/or store objects with respect to one another. For example, if a first brand of cereal and a second brand of cereal are classified in the same image (e.g., they are both on the same rack), the map generation module may indicate an adjacency between the first and second brand of cereal in the image-based map. In this example, the next image captured by the MSD may include an image of the second brand of cereal and a third brand of cereal, but not the first brand. In this example, the map generation module may indicate an adjacency between the second and third brand of cereal and may further infer that the second brand of cereal is found in between the first and third brand of cereal.

In some implementations, an MSD may include an image processing module 5906 that classifies images. In these implementations, the MSD may implement a set of machine-learned image classification models stored thereon that the MSD uses to perform image classification. In these implementations, the MSD may classify objects depicted in images captured by the MSD without any input from the CCS. In these implementations, the MSD may capture an image and may identify and classify one or more objects in the image based on the image classification model(s). The MSD may then determine a relative location of the MSD in the store based on the identified object and a map of the store. In some implementations, the image classification models may be occasionally updated (e.g., by the CCS). For example, the image classification model(s) of an MSD may be updated when new items or objects are identified. In some implementations, the image classification models used by the MSD when the MSD is in a “picking” mode may be trained to identify a reduced subset of the items in the store. For example, instead of being trained to classify all different brands of cereal boxes, the MSD may receive one or more image classification models that are trained to identify four or five bands of cereal boxes. Similarly, instead of being trained to classify all fruits and vegetables, the MSD may receive one or more image classification models that are trained to identify certain objects in the fruits and vegetable section of a store. In these examples, the locations of the reduced subset of items may be defined in a location index (e.g., a map and/or an item association table).

In some implementations, the user of the MSD is assigned to pick items in a certain area or section of the store. In some of these implementations, the MSD may receive one or more image classification models that are trained to classify objects appearing in the certain area or section, rather than image classification models that collectively classify objects appearing across the entire store. In some of these implementations, the image classification models may be partitioned according to areas/sections of the store (e.g., according to a layout of the store), such that an image processing module of the MSD only receives and/or leverages partitions of an image classification model corresponding to the area/section of the store in which the user is picking. For example, in some implementations, an MSD may request an image classification model from the CCS that indicates a section of a store in which the MSD is used to pick items, such that the request may indicate one or more sections of the store and/or a set of items that are to be picked using the MSD. In these example implementations, the CCS may identify the partitions of the image classification model corresponding to the sections of the store indicated by the request and may provide the retrieved partitions of the image classification model (or identifiers thereof) to the requesting MSD, such that the requesting MSD uses the partitions of the image classification model to perform image-based location services with respect to the store while picking the set of items that are to be picked. In this way, the computational resources required to perform image classification may be reduced, as image classification that leverages only some partitions of an image classification model requires fewer processing operations than image classification that leverages the entire image classification model. As the MSD may perform image classification many times during a pick, this reduction in computational resources may extend the battery life of the MSDs.

In some implementations, an MSD does not include image classification capabilities. In these implementations, the MSD may capture an image and may transmit the image and any suitable metadata to the CCS. In response, the CCS may perform the image classification on behalf of the MSD to classify the object(s) appearing in the image. In some implementations, the CCS may provide the MSD with an updated map of a store. For example, the CCS may provide an updated map when the location of one or more items is changed and/or when a new item is added to the map.

FIG. 59B illustrates an example method that describes the generation and usage of image-based maps. It is appreciated that in different implementations, the method may be performed by the CCS, one or more MSDs, or a combination thereof. Although the method includes both generation of image-based maps and usage of image-based maps (e.g., for picking), in some implementations, image-maps may be generated and used at separate times and by separate parties (e.g., customers, third-party pickers, etc.).

In block 5920, one or more MSDs acquire images in the store. In some implementations, the MSDs may be configured to operate in a mapping mode, whereby the MSDs are capturing images specifically for purposes of generating image-based maps. In block 5922, the one or more MSDs and/or the CCS process the images. In block 5924, the CCS generates one or more image-based maps. In block 5926, the CCS sends the image-based map(s) to the MSDs. In block 5928, an MSD used to pick orders acquires an image in the store. In block 5930, the MSD arranges ordered items on the display based on the acquired image and the image-based map(s). As described above, the acquisition of images and generation of maps in blocks 5920-5924 may be implemented while the MSDs are in a mapping-specific mode and/or while picking items for customer orders.

FIGS. 60A-60B illustrate a CCS 6000 that generates image-based maps 6002 along with other types of maps 6004, 6006. In FIG. 60A, the MSDs (1-N) may acquire and process images. Although not illustrated, the MSDs may also acquire other data used to generate tables/maps described herein. The MSDs transmit the images and/or image data to the CCS. The CCS may include image processing and map generation modules 6008 that generate the maps/tables described herein, such as image-based maps 6002, item association tables 6010, location maps 6004, and item adjacency maps 6006. The CCS 6000 sends the generated maps/tables to the MSDs for picking or other operations.

FIG. 60B illustrates an example method that describes the generation and usage of a plurality of maps. In block 6020, the CCS generates one or more item association tables, one or more location maps, and one or more item adjacency maps (e.g., based on data received from a plurality of MSDs). In block 6022, one or more MSDs acquire images in the store. In block 6024, the one or more MSDs and/or the CCS process the images. In block 6026, the CCS generates one or more image-based maps. In block 6028, the CCS sends the generated maps to the MSDs. In block 6030, an MSD picking items acquires an image and/or other data (e.g., location signals, recently scanned items, etc.) that may be used to identify a location in any of the maps/tables. In block 6032, the MSD arranges ordered items on the display based on one or more image-based maps and/or other maps.

The MSD may have a handheld form factor. In some implementations, the user can carry the MSD and/or wear the MSD. In some implementations, the user can carry and/or wear the cameras that are additional to the MSD. In these implementations, the MSD may include multiple separate components (e.g., cameras separated from the display and other components). In the case of a wearable device, such as a head mounted display, the camera can capture images in the direction the user is looking.

The one or more cameras can acquire images while being moved throughout the store. In some cases, the cameras can automatically acquire images (e.g., constantly, intermittently, or upon detecting movement via GPS, acceleration, or other detected parameter). In some implementations, the cameras may be configured to capture images/video in response to user input, such as a user powering on the camera and/or interacting with a manual input (e.g., on/off button or trigger) to acquire the images/video.

In some implementations, the MSD and/or the camera(s) can be connected to a cart (e.g., shopping cart or other type of cart) and moved around the store by the user (e.g., an employee or customer). For example, if the camera(s) are included as part of the MSD, the MSD and cameras may be attached to the cart as a single unit. In some implementations, the MSD/cameras may be attachable and removable from the cart. For example, the MSD may clamp to the cart or hang on the cart. In these implementations, the user may attach/remove the MSD from the cart by hand (e.g., by manipulating a mechanism, such as a clamp or set screw).

In other implementations, the MSD and camera(s) may be more permanently attached to the cart. For example, the MSD and/or cameras may be screwed/bolted to the cart and/or integrated into portions of the cart. In these implementations, the MSD and/or cameras may not be easily removable by hand. In some implementations, the user may carry a portion of the MSD/camera(s) and a portion of the MSD/camera(s) may be attached to the cart. For example, the user may carry a portion of the MSD including a display and item scanner (e.g., scanning module), while one or more cameras and other portions of the MSD (e.g., a location detection module) are attached to the cart. Accordingly, as described herein, the user may carry/wear the MSD/camera(s) and/or attach the MSD/camera(s) to the cart in a variety of different configurations. In some implementations, cameras may be attached to carts that are moved throughout the store by store customers. In these implementations, the CCS may acquire image data while customers shop.

The camera properties can be selected and configured for operation in the appropriate environment (e.g., a grocery store, factory, warehouse, etc.). For example, the camera field of view, focus/autofocus, resolution, and image capture rate (e.g., framerate) can be selected according to the environment. If the cameras are implemented in a store, the cameras can be configured to capture images of items in a store with a field of view and focus/autofocus that captures items on the racks. For example, the cameras can be configured to capture images including multiple shelves of racks at a usual distance from the racks (e.g., on the order of inches or feet). In some implementations, cameras can include distance determination features, such as software distance detection (e.g., based on location indicator sizes) and/or range finding hardware (e.g., Lidar) for determining the distance of cameras from items/racks/location indicators. The distance detection can be used for focus and/or to determine whether the user is close to the items/racks in the image. The cameras may have similar functionality (e.g., field of view, resolution) or different functionality. In some implementations, cameras may be configured to capture one or more spectrums of light (e.g., the visible spectrum, infrared spectrum, etc.). In some implementations, cameras may scan an area (e.g., by rotating on one or more axis, such as 180-360 degrees).

The cameras can be configured to acquire images of the items on the racks. The one or more cameras can be configured to acquire images in one or more directions. For example, the cameras can be arranged to acquire images at different angles around the user and cart, such as to the left, right, and/or front of the user/cart. As another example, the cameras may be arranged to acquire images at different angles relative to the floor/cart, such as toward the floor, parallel to the floor, and/or away from the floor (e.g., toward the ceiling). In some implementations, some cameras can be configured to have overlapping fields of view so that portions of images from each camera include similar items. In some implementations, some cameras can be configured to have fields of view that do not overlap (e.g., do not include the same items at the same time). For example, the cameras attached to the MSD, user, and/or the cart can be pointed outward toward the items as the user moves throughout the store. In a specific example, if the MSD is attached to the cart, the display may face the user while the camera(s) point toward items when the cart is being pushed around the store. In this specific example, the camera(s) may point away from the user and toward the items, such as to the left/right/front of the cart as the cart is being pushed throughout the store.

Although the cameras may be configured to point towards items and location indicators on racks, the cameras may be pointed in different directions at different portions of the store, such as the floor and/or the ceiling. In these implementations, the cameras may capture location indicators on the floor, above the items, and/or positioned above the users (e.g., attached to the ceiling). The cameras may also capture images of store objects.

A camera can be configured to acquire distinct images (e.g., separated in time) and/or acquire images from a video feed. The timing between distinct images/captures may be set or configured by the MSD operator. In implementations where multiple cameras are used, the multiple cameras may be configured to acquire images at the same time, or at different times. Images can be taken in sequence as a video and/or with set time divisions (e.g., fractions of a second up to seconds).

As described herein, in some implementations, the MSDs can include one or more components (“MSD components”) that may be attached to a cart and/or carried/worn by the user. In some implementations, carts may include hardware/software for mapping stores and/or determining locations. For example, carts may include location signal detection components, one or more barcode scanners for scanning item IDs and location indicators, and/or one or more cameras. The carts may also include communication components, such as wired (e.g., USB) and/or wireless communication components (e.g., Bluetooth) that may communicate with various computing devices. For example, the components included on the cart may communicate with MSDs used by store employees and/or third-party pickers. In these cases, the carried/worn MSDs may include components other than those on the cart (e.g., a display, user interface, etc.). The employee can use the MSD in communication with the cart components to map the store and/or pick items. In another example, a user (e.g., customer) may bring their computing device (e.g., phone, tablet, wearable, or laptop) into the store. The user device can communicate with the cart to determine the user's location. In this case, a user can use their user device to pick orders and receive advertisements, as described herein (e.g., based on location). Also, the MSD components on the cart can monitor user movement, user traffic (e.g., density of users), and map the store while the user is pushing the cart around the store.

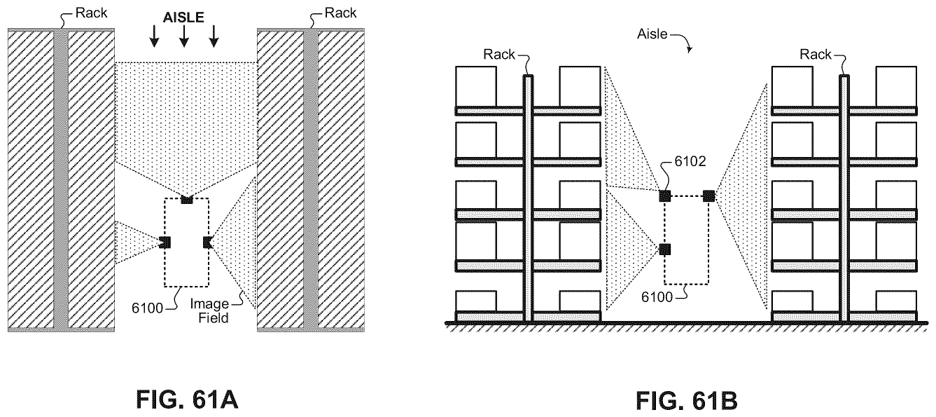

FIGS. 61A-61B illustrate example camera directions, orientations, and fields of view. FIG. 61A illustrates a top down view of multiple example cameras 6102 aimed in different directions and having different field of views. The cameras are illustrated as attached to a cart 6100 (broken outline), although the cameras may be attached to or included in another object, or included in an MSD carried by the user. The illustration of multiple cameras in a single figure illustrates how one or more cameras having different properties may be implemented in the OFS. In FIG. 61A, a front camera captures an image down the aisle along with items on both sides of the aisle. In FIG. 61A, two other cameras having different fields of view capture images on opposite sides of the cart.

FIG. 61B illustrates a view down the aisle, such as from a user's perspective. The cameras are illustrated as being aimed in different directions and having different fields of view. The cameras are illustrated as attached to a cart, although the cameras may be attached to or included in another object, or included in an MSD carried by the user. In FIG. 61B, two cameras capture the left side of the aisle, while a wider field of view camera captures images of the right side of the aisle. If the cart were moved to the right side of the aisle, the two cameras on the same side of the cart would begin to acquire images having overlapping items.

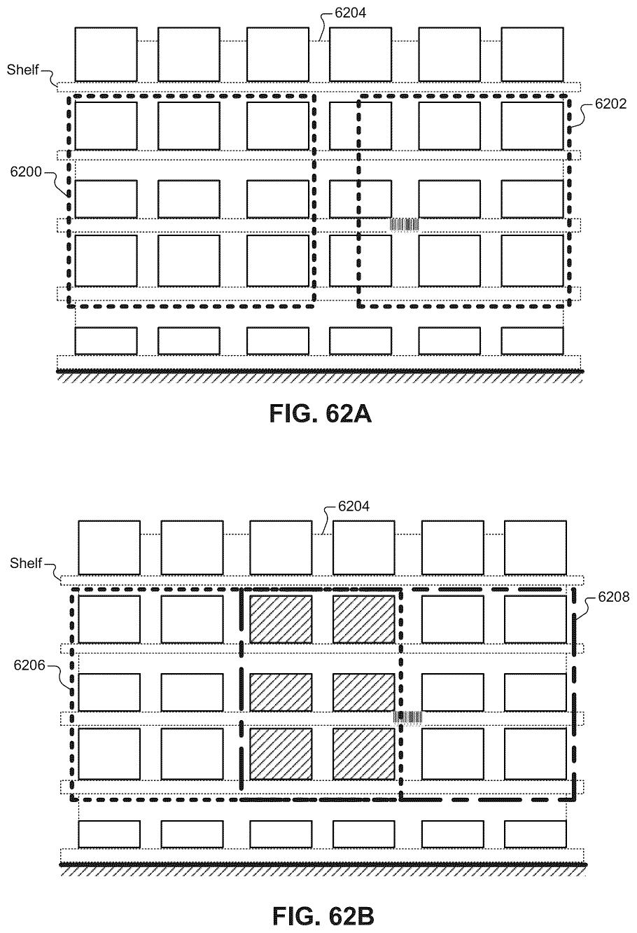

FIGS. 62A-62B illustrate examples of multiple images taken of items on the same rack. FIG. 62A illustrates images 6200, 6202 that include different portions of the rack 6204 and different items. FIG. 62B illustrates images 6206, 6208 that overlap and include the same portion of the rack 6204 and some of the same items. In the example of FIG. 62A, the first image 6200 and the second image 6202 may have been acquired at the same time by two separate cameras. Alternatively, the images 6200, 6202 may have been acquired at different times by the same camera. For example, the same camera may have acquired the first image 6200, and then acquired the second image 6202 at a later time (e.g., after the cart was moved). The acquisition of items in subsequent images (e.g., in less than a threshold time) may indicate that the items are adjacent.

In the example of FIG. 62B, the first image 6206 and the second image 6208 overlap. The first image 6206 is represented by a bold broken-line rectangle. The second image 6208 is illustrated by a bold rectangle with fewer breaks. As described with respect to FIG. 62A, the first image 6206 and the second image 6208 may have been acquired at the same time by two separate cameras. Alternatively, the images may have been acquired at different times by the same camera. For example, the same camera may have acquired the first image, and then acquired the second image at a later time (e.g., after the cart was moved). The two images in FIG. 62B include 6 of the same items, illustrated as shaded boxes. The acquisition of images including common items may indicate that the items in both images are adjacent to one another. Further generation of tables and maps according to the capture of simultaneous/subsequent images is described herein.

The MSDs and/or the CCS can process the images to determine the content of the images. For example, the MSD and/or the CCS can process the images in real-time as the images are acquired and/or process the images at a later time (e.g., in a batch of stored images). In some implementations, the MSDs can transmit images to the CCS (e.g., wirelessly) for remote processing and remote decision making (e.g., map generation and item arrangement for picking).

Images can include a variety of content. For example, the images may include one or more items, one or more location indicators (e.g., readable location indicators), and other store objects. Store objects may refer to objects in the store other than the items. For example, store objects may include movable objects and immovable portions of the store (e.g., signs, refrigerators, rafters, and floor tiles). Images can include any arrangement of items, location indicators, and store objects. For example, in some cases, a single image can include one or more items and no location indicators or store objects. In other cases, a single image can include multiple items and one or more location indicators. In other cases, a single image may include store objects without location indicators or items.

In some implementations, a single camera may capture a sequence of images, each of which may include different arrangements of items, location indicators, and store objects. In some implementations, multiple images may be taken at the same time by different cameras. For example, the cameras may acquire images in opposite directions or in other orientations. The multiple images from different cameras may also be taken at different times (e.g., asynchronously).

In some implementations, the MSD and/or CCS can timestamp the images to indicate when the images were captured. The MSD and/or the CCS can determine which images were acquired at the same time and/or in sequence based on the timestamps and/or MSD/camera IDs associated with the images. In some implementations, the images may include data that indicates the relative locations and/or orientations of the images. The location/orientation data can be used to determine the relative location of items, location indicators, and store objects in the images. The images may also include MSD IDs and/or camera IDs that indicate the MSD/camera that acquired the images.

The MSDs and/or CCS can identify readable location indicators in the acquired images. For example, the MSDs and/or CCS can identify barcodes or other readable location indicators described above. The readable location indicators may be located in a variety of locations described herein.

The MSDs and/or CCS can identify items in the acquired images. The MSDs and/or the CCS can identify items in a variety of ways. For example, the MSDs and/or CCS can identify items based on an item indicator associated with the item (e.g., a product barcode on a box or sticker on an item). As another example, the MSDs and/or CCS can identify packaging associated with the item. For example, the MSDs and/or CCS can identify an item by identifying words on the packaging, graphics (e.g., logos) on the packaging, the shape/size of the packaging, the color of the packaging, and other packaging properties. Example words that identify an item may include brand names, product names, and descriptive text. In some cases, the MSDs and/or CCS may identify items without packaging, such a fruits and vegetables. The CCS and/or MSDs may use a variety of image processing techniques to identify the items, such as text recognition (e.g., OCR), object detection, object classification, etc.

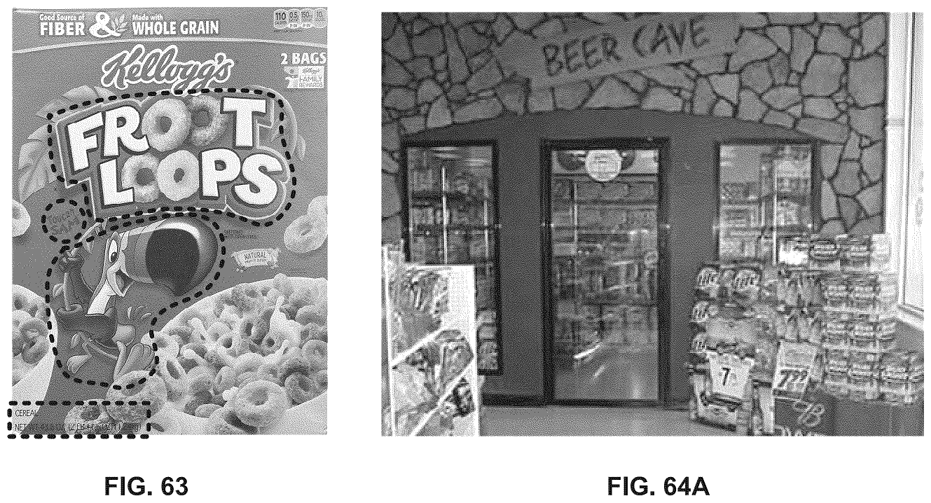

FIG. 63 illustrates an image (or a portion of an image) depicting a box of Kellog's® Froot Loops® cereal. In some cases, the image of the cereal box may be identified in a larger image (e.g., using object detection techniques) and may be further processed to classify the identified object. Portions of the package that may be used to identify the item are surrounded by bold broken lines. For example, any of the following, either alone or in combination, may be used to uniquely identify the item: 1) the name “Froot Loops”, 2) the “Toucan Sam” text, 3) the graphic of Toucan Sam, and 4) the listed weight (e.g., 43.6 OZ). A barcode on the item is not shown, although the barcode may also uniquely identify the product. It is appreciated that image/object classification can be performed in a number of different manners, as discussed throughout the disclosure. For example, image/object classification techniques may include object detection, feature extraction, and classification processes. Furthermore, image classification models (e.g., machine learned models, neural networks, or the like) may be used to classify identified objects.

In some implementations, the CCS and/or the MSDs may be configured to identify objects other than readable location indicators and items in the store. The other types of objects may be referred to as store objects. For example, store objects may include numbers, words, and symbols in the store, such as words on aisle signs (e.g., including aisle numbers, categories, products, etc.), words and symbols on bathroom signs, words on the wall (e.g., department signs and advertisements), words on support beams, and words on racks. Store objects may also include racks, such as open freezers, freezer/cooler doors, and merchandising displays with products. Store objects may also include portions of the floor, such as floor materials and patterns (e.g., concrete, tile, mats). Store objects may also include portions of the ceiling, such as different types of lighting, rafters, sprinklers, and piping.

In one example, the CCS and/or MSDs can identify one or more words in the store. For example, the CCS and/or MSDs can identify text on signs and posters, such as aisle signs that indicate item categories or other item information. In a specific example, the CCS and/or MSDs can identify text on aisle signs that indicate an aisle number and/or item category/type, such as frozen food, frozen pizzas, frozen dinners, etc. In another specific example, the CCS and/or MSDs can identify words included on advertisements, floor displays, pillars, the ceiling, and walls in the store. Similarly, the CCS and/or MSDs can identify images (e.g., line drawings, graphics, logos, etc.) included on signs, floor displays, pillars, the ceiling, and walls in the store. In some implementations, the CCS and/or MSDs may also identify the store object that includes the words, numbers, and/or symbols. For example, the CCS and/or MSDs may identify that the words are included on an aisle sign, the wall, support beam, or rack.

In some implementations, the CCS and/or MSDs can identify other store objects in images, such as racks described herein. For example, the racks may include freezers, refrigeration units, and/or shelving associated with a specific area of the store. In some implementations, the CCS and/or MSDs may identify flooring properties, such as floor materials (e.g., carpet or tile) and floor patterns/transitions (e.g., carpet/tile patterns) that indicate specific areas in the store. In some implementations, the CCS and/or MSDs may identify ceiling properties, such as ceiling rafters, ceiling colors, and ceiling materials/transitions (e.g., insulation, metals, etc.) that indicate specific areas in the store. In some implementations, the CCS and/or MSDs may identify wall properties, such as wall colors, wall materials, and transitions in the wall patterns (e.g., tile to drywall) that indicate specific areas in the store.

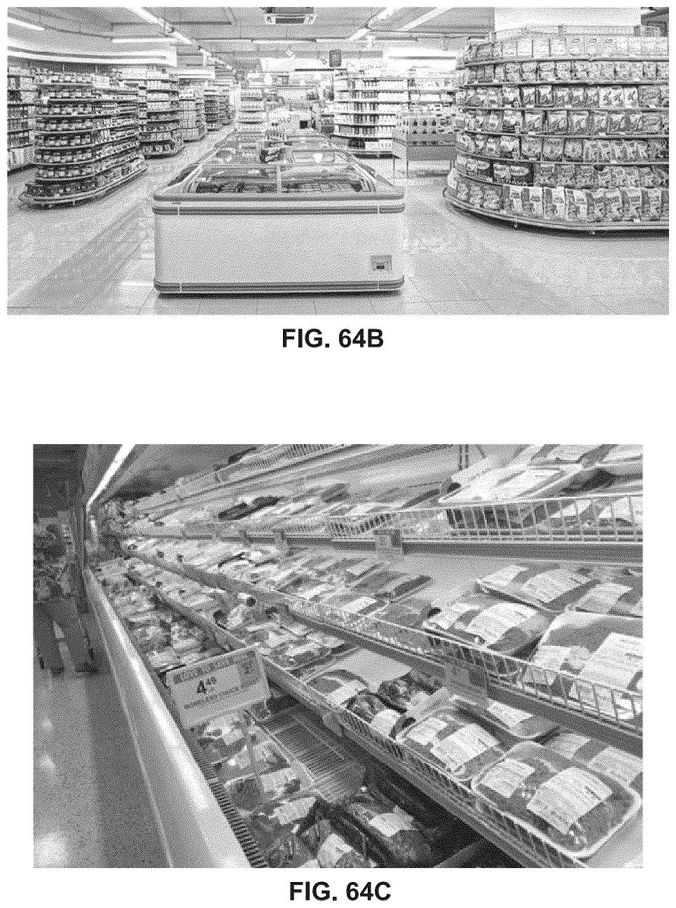

FIGS. 64A-64C shows example store objects that the CCS and/or MSDs may identify. For example, FIG. 64A shows a sign that includes the name “BEER CAVE.” Additionally, FIG. 64A includes a cooler door in combination with a stone patterned wall that may be unique to the store (i.e., indicate a unique location). FIGS. 64B-64C show example refrigeration units that may indicate a specific area of the store. For example, specific products may be associated with the areas. In FIG. 64B, specific frozen/chilled foods may be stored in the floor refrigeration unit. In FIG. 64B, the cooler type may be associated with packaged meats. Additionally, in FIG. 64C, the color of the products (e.g., red) may indicate that the location of the store is in the meat department, especially when the red color is combined with the cooler.

In some cases, some acquired images may not include any identified items, location indicators, or store objects. For example, some acquired images may be obscured (e.g., by people, the cart, or other objects). In these cases, the CCS and/or MSDs may discard the images or rely on other images for generating maps and determining a user's location. Multiple cameras, cameras with wider fields of view, and more frequent image acquisition may help ensure acquisition of images that include items, location indicators, and/or store objects.

The MSDs and/or the CCS can generate and/or update various data structures based on the acquired images. For example, the MSDs and/or the CCS can generate/update the location map, item association table, and/or the item adjacency map based on the images. As another example, the MSDs and/or the CCS can generate and update one or more image-based maps based on the acquired images.

As described above, in some implementations, the CCS and/or MSDs can generate/update a location map based on readable codes identified in the images. For example, the CCS and/or MSDs can generate/update a location map to indicate that two zones are adjacent if readable codes associated with the zones are in the same image from a single camera. In another example, the CCS and/or MSDs can generate/update a location map to indicate that two zones are adjacent if readable codes associated with the zones are in different images from different cameras that captured the images at approximately the same time (e.g., within a threshold period of time).

In some implementations, the CCS and/or MSDs can generate/update a location map to indicate that two zones are adjacent if the readable codes associated with the zones are in separate images from the same camera. For example, two zones may be considered adjacent if the readable codes are in two images (e.g., from one or more cameras) that are captured close in time (e.g., within a threshold period of time) or close in distance (e.g., as judged by similar items in the images or other location determination techniques, such as GPS).

The CCS and/or MSDs can generate an item association table and/or update an item association table based on the acquired images. For example, if an MSD acquires an image including one or more items while also detecting a location signal (e.g., contemporaneously or within a short period of time), the CCS and/or the MSD can update the item association table by associating the detected items with the detected location signal. As another example described above, if the image includes a readable location indicator along with one or more identified items, the CCS and/or the MSD can update the item association table by associating the detected items with the readable location indicator. Additionally, if item images are acquired shortly before/after (e.g., less than a threshold period of time) detecting a location indicator, the items may be associated with the detected location indicator (e.g., readable location indicator and/or location signal). In some cases, the CCS and/or MSDs can generate/update an item association table by adding items to a location value if the items are adjacent to one or more items associated with the location value.

The CCS and/or the MSDs can generate and/or update an item adjacency map based on acquired images. In some implementations, the CCS and/or MSDs can set items as adjacent when the items are included in the same image. Items in sequential images can be set as adjacent if the sequential images include one or more of the same items (e.g., a threshold number of common items) (e.g., see FIG. 62B). In some implementations, items in sequential images may also be set as adjacent if the images are acquired in less than a threshold amount of time and/or the items are a threshold distance from one another (e.g., based on MSD location and/or rate of movement). In some implementations, items may be set as adjacent if the items are separated by fewer than a threshold number of intervening items.

In implementations using multiple cameras, items in separate camera images that are captured contemporaneously (e.g., at the same time or within a threshold amount of time) can be set as adjacent. For example, if two images are captured contemporaneously and the orientation of the cameras with respect to one another is known (e.g., side-by-side or opposite facing), then adjacencies between items may be determined based on classified items captured in the respective images and the orientation of the cameras with respect to one another. Additionally, items in separate camera images that are sequential images may be set as adjacent if the separate images are acquired in less than a threshold amount of time and/or the items are a threshold distance from one another (e.g., based on location and/or rate of movement). In these examples, two images captured sequentially and a first item classified in a first captured image and a second item classified in a second captured image can be related as being adjacent based on the respective order in which the items were captured.

In some implementations, the CCS and/or MSDs may generate image-based maps based on the acquired images. For example, the image-based maps/tables may be generated as described above. In some implementations, the image-based maps may be generated and used in addition to, or as an alternative to, the other maps described above (e.g., location maps and item adjacency maps). Accordingly, the image-based maps may be used as stand-alone maps for arranging items or as additional maps that can be used in addition to other maps for arranging items. Example image-based maps may include an image-based adjacency map, an image-based location map, and/or a store object map.

In some implementations, the CCS and/or MSDs can generate the image-based item-association tables and image-based location maps using location indicators, as described above. The CCS and/or MSDs can also generate image-based item adjacency maps based on acquired images, as described above. The image-based item association tables, image-based location maps, store object maps, and image-based adjacency maps can be used together/independently for arranging items during picking. Accordingly, the CCS and/or MSDs may generate and use any combination of tables/maps including, but not limited to, location maps, item adjacency maps, item association tables, image-based location maps, image-based adjacency maps, image-based item association tables, and store object maps. In some implementations, the maps and item association tables for each mapping technique may be separate. In other implementations, the maps and item association tables may be combined (e.g., so that items may be mapped to one or more location signals, readable location signals, and store objects).

In some implementations, the CCS and/or MSDs can generate image-based maps that include object-based zones/areas (hereinafter object-based zones). The object-based zones may refer to zones that are associated with store objects that may be acquired in images. The CCS and/or MSDs can assign a unique identifier to a zone associated with an identified store object. The unique identifier assigned to the zone may uniquely identify the zone. The unique identifier assigned to a zone may be referred to as an object-based ID. An object-based ID may include numbers, letters, symbols and/or punctuation marks that uniquely identify a zone.

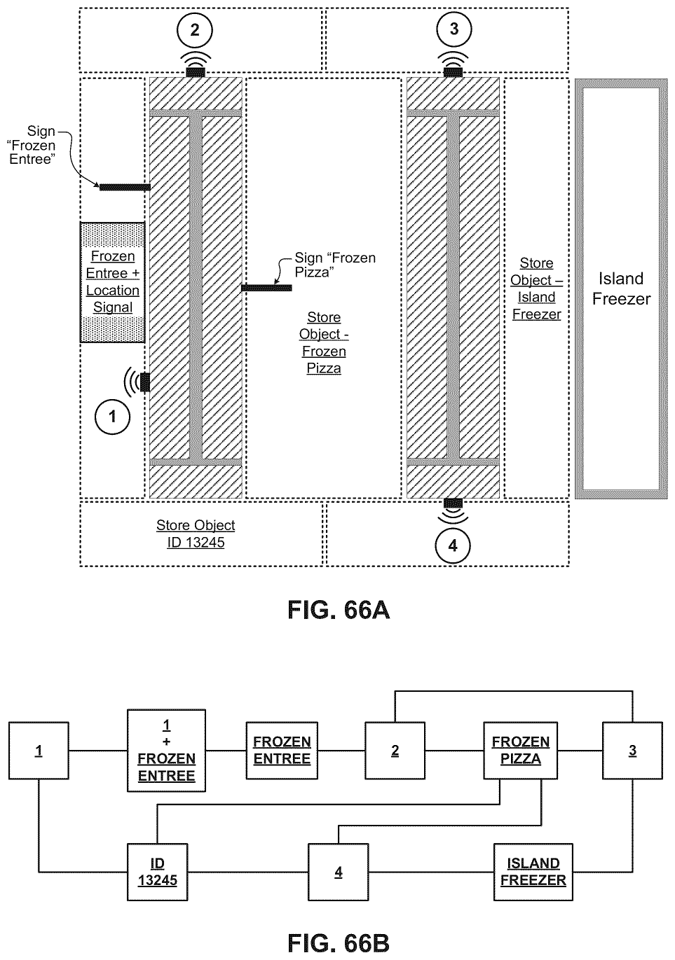

FIGS. 65A-66B illustrate portions of stores that include object-based zones. FIG. 65A illustrates a portion of a store that includes only object-based zones. FIG. 66A illustrates a portion of a store that includes object-based zones and other zones defined by location signals. In some implementations, a store may be mapped using only object-based zones. In other implementations, a store may be mapped using a mix of object-based zones and other mappings technologies, including mapping using location indicators and/or item adjacency mapping.

Referring to FIG. 65A, four different zones are each defined by one or more store objects. In FIG. 65A, two zones are defined by words included on signs. For example, the leftmost zone may be associated with the term “Dairy” that may be detected on a sign (e.g., a food category sign). The object-based ID may be the term “Dairy,” which may be combined in the ID with an indicator that the term “Dairy” is included on a sign. In some implementations, the object-based ID associated with the zone may be a random ID associated with the Dairy sign. The cereal aisle may also be identified and assigned a unique object-based ID as well.

FIG. 65A includes a zone that is defined by the identification of an island freezer (e.g., a floor reach-in freezer). FIG. 65A also includes a zone defined by the combination of the island freezer and a sign included in an aisle. FIG. 65B illustrates an example image-based map that may be generated based on the detection of store objects.

FIG. 66A illustrates a store that includes location indicators that emit location signals. The CCS and/or MSDs may also map the store using detected store objects. In FIG. 66A, the location indicators/signals define zones 1, 2, 3, and 4. Other zones are defined by the store objects detected in the zones. For example, two signs including the terms “Frozen Entree” and “Frozen Pizza” define two zones. Another zone is defined by detection of an island freezer. Another zone, defined by a store object number 13245 (e.g., randomly assigned), may be assigned based on detection of a rack or other store object in an image. One zone is defined by both a location signal and a detected store object. Specifically, one zone is defined by an area in which location signal 1 can be detected along with the sign including the text “Frozen Entree.” FIG. 66B illustrates an example map that includes zones defined by store objects and/or location signals. The map in FIG. 66B is similar to the map illustrated in FIG. 22B. Although the store in FIG. 66A includes location indicators that transmit location signals, the store may additionally/alternatively include readable location indicators that define locations.

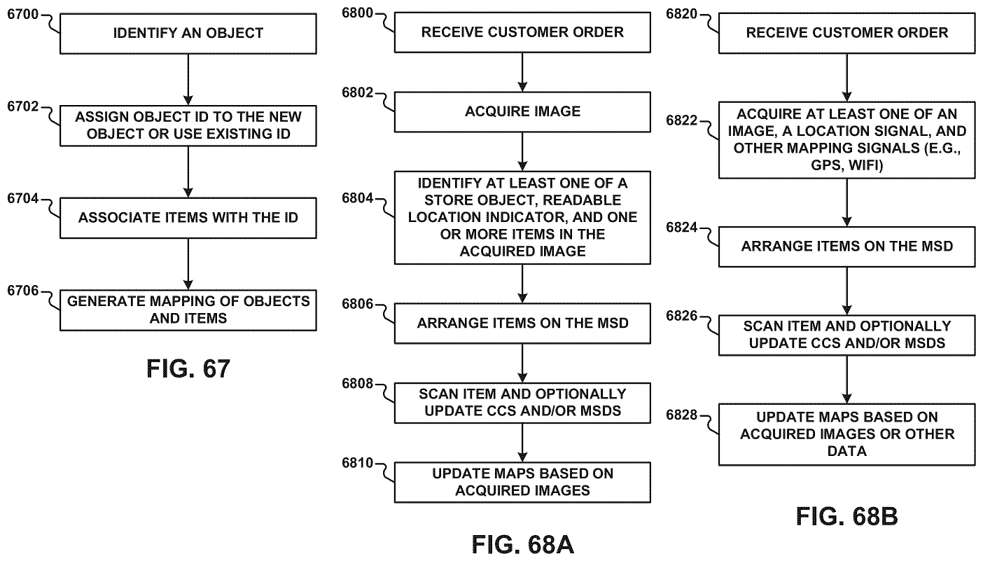

FIG. 67 illustrates an example method for making maps including object-based zones. In FIG. 67, the method includes: 1) identifying an object (e.g., block 6700), 2) assigning an object ID to a new object or using an existing ID (e.g., block 6702), 3) associating items with the ID (e.g., block 6704), and 4) generating a mapping of objects and items (e.g., block 6706). The method of FIG. 67 is described with respect to a single MSD, although multiple MSDs may be used to generate the store maps and/or item association tables.

Initially, in block 6700, the MSD and/or CCS identifies a store object in an image. Different store objects may be identified in different ways. For example, objects including text (e.g., aisle signs) may be identified based on identification of the text. In some cases, the object including the text may also be identified. For example, the CCS and/or MSD may determine that the text is attached to a hanging sign or a wall. As another example, a refrigerator unit including text (e.g., a brand name and/or model number) can be identified based on the text.

In some cases, the identified store object in block 6700 may be a store object that has already been identified previously and included as part of a map (e.g., an object-based map). If the store object had been previously identified, the object-based ID may already be associated with items. Additionally, the object-based zone may already be part of a map of the store zones. In some cases, the identified store object may be a newly identified store object.

In block 6702, the CCS and/or the MSD may assign an object-based ID to the identified store object if the store object is a newly identified store object. Otherwise, the MSD and/or CCS may identify the already existing object-based ID associated with the store object. The IDs can be automatically generated in some cases, such as randomly or in sequence of a next available ID (e.g., by incrementing values). In some cases, the system can assign an ID based on the text acquired in an image, such as assigning a sign name to a zone. In some cases, a human may manually assign object-based IDs (e.g., in a user interface on an MSD and/or another computing device).

In some implementations, the object-based IDs may be human readable descriptors, such as descriptors that are descriptive of the object-based zone. Such human readable descriptors may be assigned automatically (e.g., based on text acquired in one or more images) or manually. In one example, a human readable descriptor may include “frozen entrees” for a zone in which an image is acquired of a sign including the text “frozen entrees.” In another example, a user (e.g., employee/manager) can assign a descriptor “frozen pizzas” to a zone in which frozen pizzas are stocked and/or a sign indicates “frozen pizzas.”

Although readable descriptors may be assigned to object-based zones, in some implementations, location descriptors can be assigned to other zones, such as one or more zones associated with location indicators or any other mapping technology described herein. For example, aisle numbers may be assigned to some location values. As another example, department names may be assigned to one or more location values. One or more descriptors may be assigned to a zone. For example, a zone near frozen pizzas may be associated with descriptors “grocery,” “frozen foods,” and “frozen pizzas,” which may indicate that the zone is included in a grocery department in the store, in a frozen foods section of the grocery department, and near the frozen pizzas on the racks. In some implementations, the types of items detected along with the assigned IDs may be configured by the owner/operator of the OFS (e.g., using a GUI).

In block 6704, the MSD may scan one or more items and the MSD and/or CCS may associate the one or more scanned items with the recently determined object-based ID. For example, the MSD and/or the CCS may generate/update an item association table that associates object-based IDs with items. Although the scanned items may be associated with previously determined object-based IDs, in some cases, the MSD and/or the CCS may be configured to associate a scanned item with a later determined object-based ID, such as when the later determined object-based ID is determined closer in time to the scanned item than a previously determined object-based ID. The association between object-based IDs and items may be updated over time.

In block 6706, the CCS and/or MSD may update an object-based map. The object-based map may indicate the location of object-based zones relative to one another. If the store is mapped using other techniques (e.g., using location indicators) along with object-based zones, the map may include a mix of object-based zones and other zones. The object-based map, or other map, may be similar to maps illustrated in FIGS. 65A-66B. For example, the object-based map, or other map, may include a plurality of zones that are connected with junctions that indicate the relative location of the object-based zones to other zones.

The CCS and/or MSD may update the object-based map, or other map, to include object-based zones according to one or more update criteria. For example, the CCS and/or MSD may indicate that an object-based zone is adjacent to another zone when a store object is detected within a threshold period of time relative to another zone (e.g., detection of a location signal or other store object). In some implementations, as described with respect to location signals, the CCS and/or MSD may generate a map in which a single zone includes multiple identifiers, such as one or more object-based IDs, one or more readable location indicators, and one or more location signals (e.g., see FIGS. 66A-66B).

In some implementations, the CCS and/or MSD may remove object-based zones from the maps. For example, the CCS and/or MSD may remove object-based zones according to removal criteria. In one example, the CCS and/or MSD may remove object-based zones if the store objects associated with the object-based zones have not been detected within a period of time. In another example, the CCS and/or MSD may remove object-based zones if the store objects are not detected along with other location indicators/signals (e.g., a threshold number of times), if such store objects have previously been mapped to the location indicators/signals.

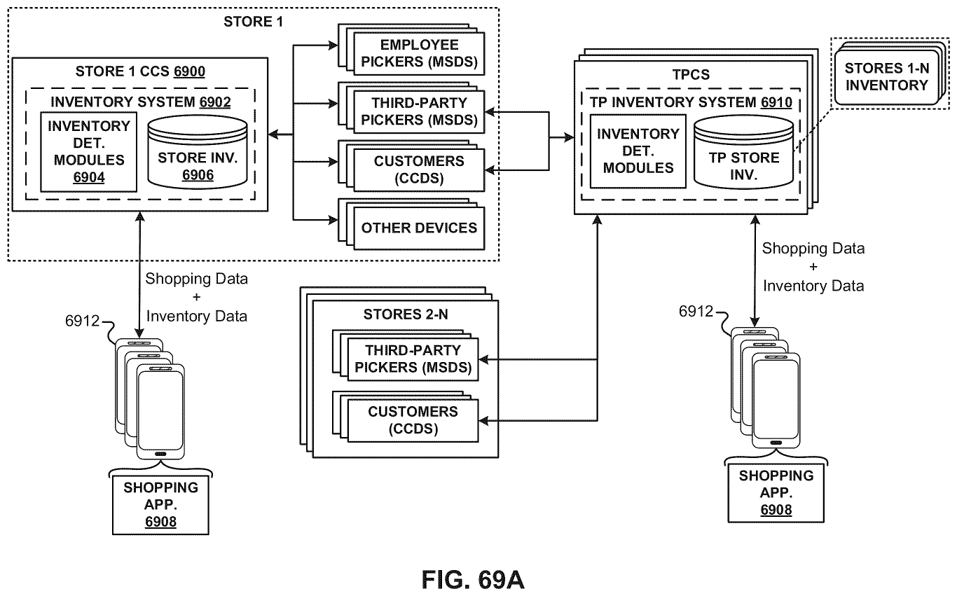

FIG. 68A illustrates an example method for generating maps and picking items. In the method of FIG. 68A, an MSD acquires one or more images used to arrange currently ordered items on the MSD and/or update one or more image-based maps. Initially, in block 6800, the MSD receives a customer order including a plurality of items. In block 6802, the MSD acquires an image. In block 6804, the MSD (or CCS) identifies at least one of a store object, a readable location indicator, and one or more items in the acquired image. In block 6806, the MSD arranges items on the display based on analysis of the image (e.g., a determined zone) and one or more image-based maps. In block 6808, the MSD may scan items and optionally update the CCS and/or other MSDs indicating that the items have been scanned. In block 6810, the MSD and/or CCS may update tables and/or maps based on the acquired image and scanned items.

FIG. 68B illustrates an example method for generating maps and picking items. In the method of FIG. 68B, an MSD acquires one or more images, location signals, and/other mapping signals, and uses the signals to arrange items and/or update one or more maps (e.g., image-based maps and/or other maps). Initially, in block 6820, the MSD receives a customer order including a plurality of items. In block 6822, the MSD acquires at least one of an image, a location signal, and other mapping signals (e.g., GPS, WiFi). In block 6824, the MSD arranges items based on the acquired image/signals and one or more maps/tables (e.g., image-based maps, location maps, item-adjacency maps, etc.). In block 6826, the MSD scans one or more items and may optionally update the CCS and/or MSDs indicating that the items have been scanned. In block 6828, the CCS and/or MSD may update one or more maps/tables (e.g., image-based maps or other maps/tables) based on the acquired image(s), location signals, other signals, and/or scanned items.

MSDs can use any of the generated tables/maps described herein to arrange items from customer orders during picking. In some implementations, the MSDs and/or CCS can determine a location based on a recently scanned item. For example, the MSD and/or CCS can determine the location based on the item association table or other map that associates the recently scanned item to a location and other items. In some implementations, the store may be mapped using a different set of technologies than are used to pick. For example, the store may be mapped using image-based mapping and subsequently picked using other technology for arranging items. In one example, MSDs can use the item association tables, location maps, item adjacency maps, and/or image-based maps to arrange items from customer orders on the MSDs, even if the MSDs do not include cameras for capturing images. Also note that the MSDs and/or CCS may perform mapping while picking and/or perform mapping at a separate time. For example, the MSDs may be set into an image mapping mode in which the MSDs are transported throughout the store to acquire images and generate item association tables and maps.

In some implementations, the MSDs and/or CCS can be configured to use the maps separately. For example, the maps used may depend on the data that is being acquired. In one example, at one time, an MSD may determine location based on a location signal if a location signal is detected. At a later time, the MSD may determine location from an image if no location signal is detected. In these case, different maps may be used to fill in location gaps in the store and improve reliability and usability of the OFS. In some implementations, different location detection techniques may have different priorities. For example, detection of a location signal or location indicator may take priority over an adjacency map. In some implementations, the CCS can fuse data from different maps and location detection techniques to determine the location of items in the store and determine the user's location.

In some implementations, the OFS may include an inventory system that uses the images to determine store inventory. For example, the OFS may determine whether items are in stock based on the images (e.g., whether the items have been detected in the images within a threshold period of time). As another example, the OFS may determine the number of items in stock based on the images.

As described herein, in some implementations, the maps/tables and other hardware and software described herein may be used by customer devices for picking items. Additionally, in some implementations, the maps/tables can be used to advertise to a customer. For example, the OFS may include an advertisement system that determines the location of the customer device and advertises to the customer based on the customer device location. Example advertisements may include text and/or images sent to the customer device in a GUI, such as in a shopping application and/or as a notification (e.g., in an application, as a text message, email, etc.). In some implementations, the advertisement system may advertise based on the items that are nearby a customer. For example, the advertisement system may advertise items near the customer. In a more specific example, the advertisement system may advertise items that are near the customer and also included on a customer's shopping list. In some implementations, the advertisement system may arrange advertisements based on the customer's location. For example, the advertisement system may arrange a list of advertisements for items (e.g., on the customer's list or not) based on the location of the items relative to the customer. For example, the advertisement system may arrange items that are closer to the customer in a priority order (e.g., on the display and/or at the top of the display) to persuade the customer to purchase the items. As another example, the advertisement system may show advertisements to a user that are farther away from the customer in order to persuade the customer to move farther through the store and pick more items.

The technology described herein may be implemented in an automatic scanning and/or picking device, such as a robotic device that moves throughout the store. For example, the robotic device may scan items, acquire location signals, scan location indicators, acquire images, and/or determine a location based on any mapping technologies described herein. In some implementations, the robotic device may send the acquired data to the CCS for processing. The robotic device and/or CCS may generate the maps described herein based on the acquired data. The maps may then be used to arrange items for picking.

In some implementations, the OFS may include an inventory system that determines store inventory. For example, the inventory system may determine store inventory based on images acquired by a plurality of different devices (e.g., MSDs, CCDs, cameras, etc.) that are moved throughout the store by users (e.g., customers, pickers, store employees, etc.). The inventory system may generate inventory data based on the acquired images. Example store inventory data may include, but is not limited to, a list of items (e.g., item IDs) and associated inventory status. Inventory status may indicate whether the item is in-stock (e.g., currently stocked in the store) or out-of-stock (e.g., not currently stocked in the store). In some implementations, the inventory status may indicate a number of items in stock. In addition to image-based inventory acquisition, the inventory system of the present disclosure may acquire inventory in other manners, such as via item scanning with MSDs/CCDs, manual user entry, robotic inventory acquisition, or other inventory generation techniques.

In some implementations, the inventory data may be automatically generated as images are acquired by devices being moved throughout the store. For example, pickers and/or consumers may move devices throughout the store that may acquire images for inventory data generation while the pickers and/or consumers are picking items. In some implementations, the devices may be set into an inventory generation mode that places the devices in a mode for acquiring images used to generate inventory data.

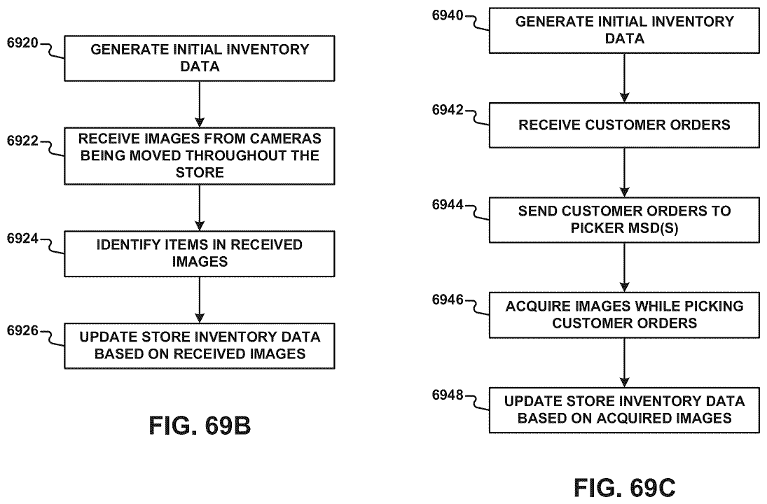

FIG. 69A illustrates an example environment that includes a plurality of stores and third-party computing systems. In FIG. 69A, store 1 includes a CCS 6900. The store 1 CCS 6900 includes an example inventory system 6902. The inventory system 6902 includes inventory determination modules 6904 and an inventory data store 6906. The inventory determination modules 6904 may determine store inventory data based on acquired images. For example, the inventory determination modules 6904 may determine whether items are in stock at the store based on received images. The inventory determination modules 6904 may also determine a number of specific items included in the store. Although the inventory system 6902 is illustrated as included in the CCS 6900, the inventory system 6902 may be a separate system operated by one or more stores or other parties.

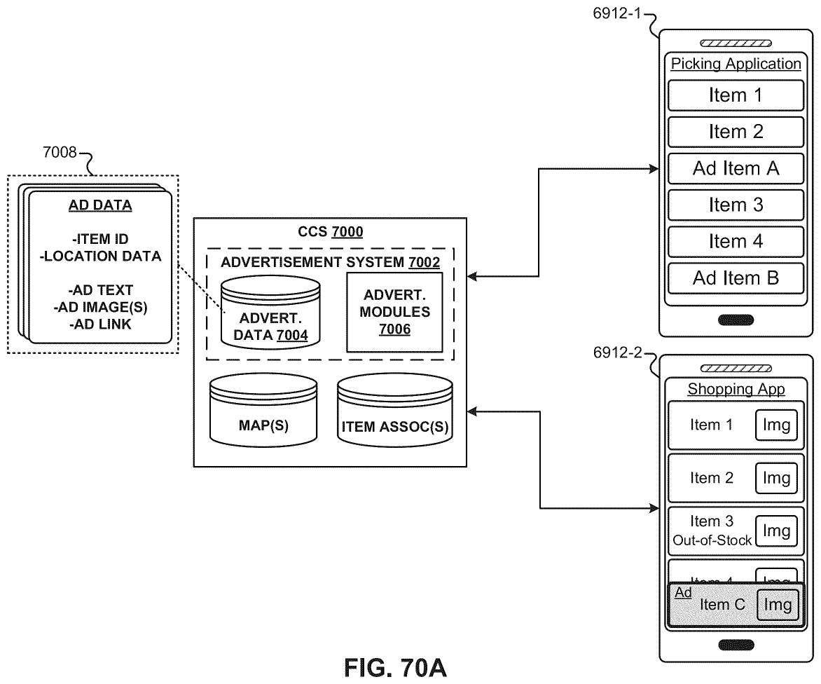

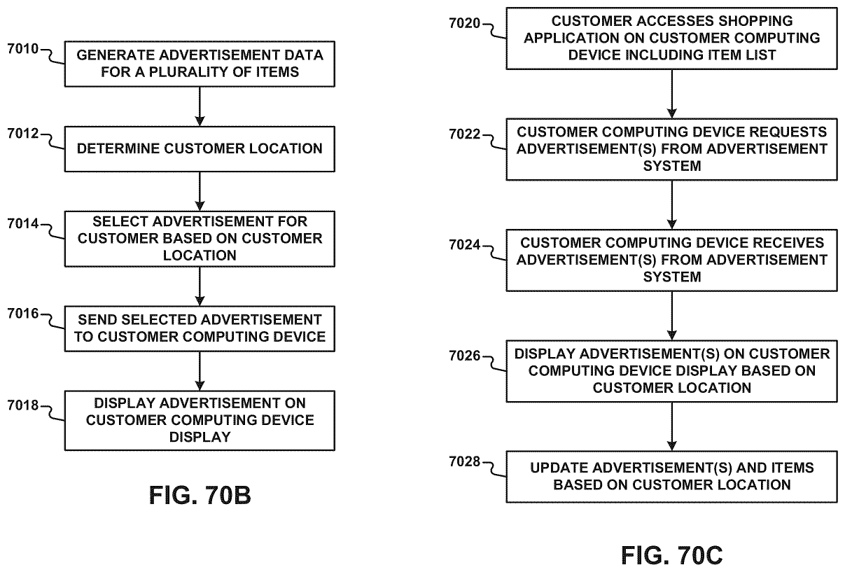

The store inventory data may be stored in an inventory data store 6906. The inventory data may include a list of items (e.g., item IDs) and associated inventory status. The store inventory data may be accessed by a plurality of different devices. For example, inventory data may be used in a shopping application 6908 to indicate whether an item is in-stock and/or a number of items in stock (e.g., FIG. 70A includes an “out-of-stock” indicator for an item in the shopping application). As another example, inventory data may be used in a picking application to indicate whether an item is in-stock or if a substitution/replacement item should be picked for a customer.

In FIG. 69A, store 1 includes a plurality of devices that may be used to map the store and/or pick items from the store. The inventory system 6902 (e.g., inventory determination modules 6904) may determine inventory data based on images and/or other data acquired from the various devices. In some implementations, the CCS 6900 (e.g., inventory determination modules 6904) may process the received images and determine in-stock indicators and/or in-stock numbers based on the processed images. Additionally, or alternatively, the devices (e.g., MSDs) may generate the inventory data locally (e.g., an item ID and associated in-stock indicator/number) and then transmit the inventory data to the CCS.

The inventory system 6902 may generate/update inventory data based on image data and/or other data acquired from one or more sources. For example, the inventory system 6902 may determine inventory data based on images/data acquired by MSDs used by store employees to map the store and/or pick items from the store. As another example, the inventory system 6902 may determine inventory data based on images/data acquired by third-party MSDs used by third-party pickers in the store. As another example, the inventory system 6902 may determine inventory data based on images/data acquired by CCDs used by customers in the store. As another example, the inventory system 6902 may determine inventory based on images/data acquired by other devices (e.g., robotic devices).

The inventory system 6902 may generate and update inventory data based on images acquired from devices over time. For example, the inventory system 6902 may add new items to inventory when the items are detected in one or more images. As another example, the inventory system 6902 may update a number of an item in inventory if the images include multiple detected items of the same type. In some implementations, the inventory data may include time stamps indicating the time at which the inventory data was determined based on images. In these implementations, the inventory system 6902 may determine that an item is currently in stock if the item was acquired in one or more images within less than a threshold period of time from when the one or more images were acquired.

In some implementations, the inventory system 6902 may update the number of a specific item in stock if the number changes in other images (e.g., increase/decrease an in-stock number). In some implementations, the inventory system 6902 may indicate that an item is out-of-stock if the item is not detected in the item's defined location (e.g., over a threshold period of time). In some cases, the inventory system 6902 may indicate an item may be currently out-of-stock when the item has not been detected in an image after a threshold period of time. Put another way, the absence of the item in acquired images may indicate that the item is out of stock.

Store 1 may include an inventory system 6902 that acquires inventory data for store 1. FIG. 69A includes an additional plurality of stores 2-N, each of which may implement their own inventory system in a manner similar to store 1. In some implementations, an inventory system may generate and/or store inventory data for multiple stores. For example, a company that owns/operates multiple stores may include an inventory system that stores inventory data for the multiple stores.

FIG. 69A includes third-party computing systems (TPCSs). A TPCS includes a third-party (TP) inventory system 6910 that may operate in a similar manner as the inventory system described with respect to Store 1. A third-party inventory system 6910 may determine inventory data for one or more stores based on image data and/or other data acquired from one or more sources. For example, the third-party inventory system 6910 may determine inventory data based on images/data acquired by third-party MSDs used by third-party pickers in the store(s). As another example, the third-party inventory system 6910 may determine inventory data based on images/data acquired by customer computing devices (CCDs) used by customers in the store (e.g., while customers are shopping using a third-party shopping application).

In some implementations, the third-party inventory system 6910 may receive inventory data from one or more stores. For example, the third-party inventory system 6910 may request inventory data for the one or more stores. In this example, the third-party company may partner with the owner/operator of the store(s) and receive inventory data as a part of the partnership. In some implementations, the third-party inventory system 6910 may generate inventory data and provide the inventory data to the store inventory system 6902. In these implementations, the store inventory system 6902 may generate and/or update the store inventory data received by one or more third-party inventory systems. The environment of FIG. 69A illustrates a plurality of third-party computing systems that may be operated by different third parties. Each of the TPCSs may operate in a similar manner.

FIG. 69A illustrates a plurality of CCDs 6912 in communication with the store 1 CCS. For example, the CCDs 6912 may include installed shopping applications and/or access web-based shopping sites that allow the customers to purchase items in the store using the CCDs. The CCS 6900 may indicate inventory data (e.g., in-stock/out-of-stock status and/or item numbers) to the CCDs 6912 in the shopping application/website. In some implementations, the shopping application 6908 may provide a shopping GUI that renders the in-stock data and allows the customer to select the item for a customer order if the item is in stock (e.g., see FIG. 70A). The TPCSs may also provide inventory data to their respective shopping applications in a similar manner. The CCS/TPCS may provide inventory data to store MSDs and third-party MSDs in picking applications in a similar manner.

FIG. 69B illustrates a method that describes example inventory data generation operations. In block 6920, the inventory system 6902 generates initial inventory data using one or more techniques, such as using image-based inventory data, item scans, manual user entry, robotic inventory generation, etc. In block 6922, the inventory system 6902 receives images from cameras being moved throughout the store. For example, the cameras may be standalone cameras and/or cameras included in other devices, such as MSDs and/or CCDs. In block 6924, the CCS 6900 (e.g., inventory determination modules 6904) may identify items included in the received images. In block 6926, the CCS 6900 (e.g., inventory determination modules 6904) may update the store inventory data based on the items identified in the images.

FIG. 69C illustrates a method that describes example inventory data generation operations based on images acquired by MSDs being used to pick customer orders. In block 6940, the inventory system 6902 generates initial inventory data using one or more techniques. In block 6942, the CCS 6900 receives customer orders. In block 6944, the CCS 6900 sends customer orders to one or more picker MSDs. In block 6946, the MSDs acquire images in the store (e.g., including stocked items). In block 6948, the CCS 6900 (e.g., inventory determination modules 6904) may identify stocked items in the images and update store inventory data based on the identified stocked items.

FIGS. 70A-70C illustrate and describe advertisement functionality that may be provided by an advertisement system 7002 and a shopping application (e.g., 6908) on a CCD (e.g., a customer's smartphone). In FIG. 70A, a CCS 7000 includes an advertisement system 7002. The advertisement system 7002 includes an advertisement data store 7004 that stores advertisement data for a plurality of items. The advertisement system 7002 includes advertisement modules 7006 (e.g., hardware/software) that provide the advertisement functionality attributed to the advertisement system 7002. For example, the advertisement modules 7006 may determine a customer's location (e.g., inside/outside of the store), select one or more advertisements for a CCD based on the user's location, and send the one or more selected advertisements to the CCD.

Advertisement data 7008 for an item (i.e., item advertisement data) may include data associated with the item and data used to select and render an item advertisement for the item. For example, item advertisement data 7008 may include an item ID and location data. The location data may be in terms of any location technology described herein, such as locations specified relative to location indicators, store objects, and/or one or more other items. In some implementations, the location data may indicate the location of the item to be advertised relative to a location. For example, the location data may indicate a zone that includes the item to be advertised. In some implementations, the location data may indicate a location in which a user should be located in order to select/render an advertisement. For example, if the location data in the advertisement data indicates that the user should be located in a first location, the advertisement system 7002 may select the item advertisement when the user is in the specified first location.

The advertisement data may include rendering data that a shopping application may use to render the item advertisement. Example rendering data may include, but is not limited to, text and/or images (e.g., Img in FIG. 70A) associated with the item. For example, advertisement text may include an item name, an item description, item price, and/or item type. Example images may include images of the item or other images that are descriptive of the item. In some implementations, the advertisement text/images may include text/images indicating that the item is being advertised. For example, advertisement text/images may include a word “Ad” (e.g., see FIG. 70A) and/or include advertisement text promoting the purchase of the item (e.g., “Buy Now!”). In some implementations, the item advertisements may include link data that links to a page of a shopping website/application in which the user can add the item to their digital shopping cart for purchase. In some implementations, a user may scan the advertised item in the store, which may cause the item advertisement to be removed from the GUI.

The advertisement links may be rendered on a user device in a variety of ways. In some implementations, the advertisement links may be rendered as textual/graphical advertisements in the application. In these implementations, the advertisement links may be selectable (e.g., by touching the link). In some implementations, the item advertisements may be overlaid onto application pages or webpages (e.g., as banners over top of an application page or webpage) (e.g., see Item C of FIG. 70A). In some implementations, the item advertisements may be integrated into a list a user is using while picking items (e.g., see Ad Item A and Ad Item B of FIG. 70A).

The advertisement system 7002 may select one or more item advertisements for a CCD. For example, the advertisement system 7002 may select the one or more item advertisements based on a user location. In some implementations, advertisement data for an item may include item location data that indicates the location of the item to be advertised. In these implementations, the advertisement system 7002 may be configured to select the item advertisement when the user is in the location specified in the advertisement data or located within a threshold distance of the item, such as a threshold number of zones and/or a distance defined by item adjacencies. In some implementations, the advertisement data may include location data associated with one or more locations other than the location including the item. In these implementations, the advertisement system 7002 may be configured to advertise to a user when the user is in a location other than where the item is included. In a specific example, the advertisement data may include some item advertisements for common items in locations that are located away from the user's current location, which may cause the user to move to the location in response to the advertisement. The location data used to trigger selection of an item advertisement may be in terms of any of the one or more types of locations described herein, such as areas/zones defined by location indicators, store objects, and/or item adjacencies.

FIG. 70A illustrates two example application GUIs. The upper GUI on CCD 6912-1 illustrates an application that the user may use to pick items from their own customer order. As such, the upper GUI may be referred to as a “picking application.” In the picking application, the user is picking a customer order including items 1, 2, 3, and 4. The picking application also has rendered advertisements for Ad Item A and Ad Item B. Note that the picking application has intermixed the advertised items in with the customer ordered items. As described herein, the items in the customer order may be arranged based on the location of the customer/CCD. In some implementations, the advertised items may also be arranged based on their location relative to the customer/CCD. For example, in FIG. 70A, Items 1-2 may be closest to the customer, followed by advertised Item A and Items 3-4. Advertised item B may be the farthest from the customer at the time the picking application GUI in FIG. 70A was rendered.

In some implementations, the advertisement system 7002 may select item advertisements based on the items included in the customer's current order (e.g., the current list of items being picked). For example, the advertisement system 7002 may select item advertisements for items that are near/within the locations (e.g., zones) including items on the current customer picking list. In a specific example, the advertisement system 7002 may select item advertisements for items that are within locations (e.g., zones) of items on the current customer picking list or within a threshold distance (e.g., threshold number of zones) from items included on the current customer picking list. In some implementations, the advertisement system 7002 may select item advertisements for items based on item adjacency. For example, the advertisement system 7002 may select item advertisements for items that are adjacent to items on the current customer picking list.

In some implementations, the advertisement system 7002 may select item advertisements for items based on the location of the customer/CCD and the items included in the current customer picking list. For example, the advertisement system 7002 may select an item advertisement for an item that is currently near the customer (e.g., less than a threshold distance) and also near one or more other items on the current customer picking list.

In some implementations, the CCD (e.g., picking/shopping application) may send an advertisement request for an advertisement to the advertisement system 7002. The advertisement request may include a variety of data, such as location data indicating the location of the CCD and/or items included in the customer's current list. In response to receiving the advertisement request, the advertisement system 7002 may select one or more item advertisements to send to the CCD as described herein.

In some implementations, the picking application GUI may rearrange the ordered items and/or the advertised items when the customer moves to a new location. For example, the application may rearrange the ordered items and the advertised items based on the location of the items relative to the customer's location. In a specific example, ordered items and advertised items closer to the customer may be arranged closer to the top of the display. In some cases, rearrangement of the ordered items and/or the advertised items may cause some ordered items and/or advertised items to be removed from the display. In these cases, other ordered items and/or advertised items may be displayed to the customer. The previously displayed ordered items and/or advertised items may be placed back on the display as the customer moves throughout the store (e.g., to a previous location) and/or scans items (e.g., thereby removing ads/items).

Scanning ordered items may cause the items to be removed from the GUI. Similarly, scanning advertised items (e.g., using a barcode scanner or other image acquisition device) may cause the advertised items to be removed from the GUI. In some implementations, the advertisements may be removed from the GUI after a threshold period of time has passed. In some implementations, the picking application may remove the advertised items from the list after the user has moved on from the advertised items, such as when the customer passes by the items and/or moves a threshold distance (e.g., number of zones) from the advertised items. In some implementations, the advertisement system 7002 may send additional item advertisements to the CCD for display after the advertised items have been scanned or otherwise removed from the list.

The lower GUI on the CCD 6912-2 in FIG. 70A illustrates an example shopping application interface. A shopping application interface may show items available for purchase, provide item descriptions, and provide item images (e.g., Img in FIG. 70A). A shopping application may also provide a customer interface in which a user may search for items, add the items to their digital shopping cart, and purchase the items. In the shopping application GUI, Item C is advertised to the customer as overlaid on a list of items for purchase in the store. Note that Item 3 has an “Out-of-Stock” indicator that may be generated based on inventory data acquired from the inventory system 6902 of FIG. 69A. Although an item advertisement may be shown in a shopping application (e.g., FIG. 70A), an advertisement may be sent to the customer in another manner. For example, the item advertisement may be shown to the customer while the customer is using a different application or website than the shopping application/website for the store. Additionally, or alternatively, the advertisement system 7002 may send item advertisements to the CCD as a notification or text message (e.g., short message service) that is displayed by the CCD (e.g., on a launcher application screen).

The GUIs illustrated in FIG. 70A are only example GUIs that illustrate different features of an example shopping application. As such, additional/alternative features may be implemented in the shopping application than those explicitly illustrated and described with respect to FIG. 70A. Although the advertisement system 7002 may be implemented locally in the store and/or as a remote advertisement system (e.g., remote server) for the store, the advertisement system 7002 may be operated in other manners. For example, the advertisement system may be implemented for a plurality of stores. In some implementations, a third party (e.g., other than the store owners) or other party may operate the advertisement system. Although a CCD (e.g., smartphone) is illustrated in FIG. 70A, other devices may provide advertisements to customers, such as a shopping cart or basket with an integrated computing device.

FIGS. 70B-70C illustrate example methods that describe operation of the advertisement system 7002 and the shopping application. In FIG. 70B, an advertisement system 7002 provides an item advertisement to a CCD based on customer location. In block 7010, the advertisement system 7002 generates advertisement data for a plurality of items. The advertisement system 7002 may generate the advertisement data in a variety of ways. In some implementations, the advertisement system 7002 may automatically generate advertisements for items based on inventory data. In some implementations, store employees, advertisers, or other parties may generate the advertisements for the advertisement system 7002 using an advertisement generation interface provided by the advertisement system 7002.

In block 7012, the advertisement system 7002 (e.g., the CCS 7000) determines a customer location using any location technique described herein. In block 7014, the advertisement system 7002 selects an item advertisement based on the customer's location. In block 7016, the advertisement system 7002 sends the selected item advertisement to the CCD. In block 7018, the CCD (e.g., shopping/picking application) displays the item advertisement to the customer.

FIG. 70C illustrates a method in which the advertisement system 7002 provides one or more advertisements to a CCD for integration into a shopping/picking application (e.g., into a picking list or as an overlaid advertisement). In block 7020, the customer accesses a shopping application on a CCD including a list of items (e.g., for purchase and/or picking). In block 7022, the CCD requests one or more item advertisements from the advertisement system 7002. The advertisement request may include a customer location and/or items in the picking list. In block 7024, the CCD receives one or more item advertisements from the advertisement system 7002. In block 7026, the CCD displays the advertisement(s) based on customer location. For example, the CCD (e.g., shopping application) may display the advertisements based on the location of the customer relative to the advertised item location. In block 7028, the customer moves throughout the store and the arrangement of the item advertisement(s) and items in the list are updated. For example, the item advertisement(s) and items in the list may be updated based on a new location and/or newly received item advertisement(s).

The shopping/picking application may be provided to the CCDs by a party (e.g., a business) that owns/operates one or more stores, third-party services, or other services. For example, the party may develop the shopping/picking application and upload the application to a digital distribution platform. A customer may download and install the shopping/picking application on the CCD. For example, the customer may download the shopping/picking application from a digital distribution platform, such as the GOOGLE PLAY® digital distribution platform by Google, Inc. or the APP STORE® digital distribution platform by Apple, Inc. The shopping/picking application may include computer-executable instructions that cause a processing unit of a CCD to provide the functionality attributed to the shopping/picking application and the CCD herein.

Although some aspects of the OFS described herein may be implemented based on the location of one or more MSDs, in some implementations, the OFS of the present disclosure may implement features described herein without using the location-based technologies described herein (e.g., location indicators, item adjacency, etc.). For example, the OFS may receive customer orders, assign the customer orders to MSDs, monitor the picking of customer orders, and generate routes for MSDs without regard to the location of one or more MSDs.

Each customer order may be assigned an order ID number. Each item of the customer order can also be associated with the order ID number. Accordingly, each item of a customer order may be defined by a customer order ID number and an item ID code. Associating items of a customer order with a customer order ID number may allow the CCS, MSDs, and/or other computing devices to determine when the items of the customer order have been picked from the racks (e.g., scanned), taken to a collection/packing area, and/or packed. Knowledge of the items that have been picked may allow the CCS and/or MSDs to optimize item picking based on a variety of factors described herein. For example, knowledge of which items have been picked for different orders, and the user(s) that picked the items, may allow routing of MSDs to pick items that will quickly complete pending customer orders (e.g., orders that have not been completely picked). As another example, the CCS may use knowledge of the picked items to determine when customer orders have been completely picked. In this example, the CCS may determine that one or more pickers should return items of a completed customer order to the packing area. Additionally, or alternatively, the CCS may determine that one or more additional customer orders should be generated and/or assigned (e.g., to the picker completing the order) in order to maintain efficient flow of picking/packing customer orders.

Customer orders may be associated with additional customer order data. Additional customer order data may include, but is not limited to, the time the order was placed (e.g., day of week and/or time of day), the time the order should be filled (e.g., day of week and/or time of day), the time a third party picker should pick the order (e.g., for delivery), whether the order is for pickup or delivery, the time a customer intends on picking up the packed order, the time an order should ready to be taken for delivery by a store employee or third party, and the time the order should arrive at a customer's location (e.g., a customer's house or other specified location). Additional customer order data may also include the total number of items in the order (e.g., total number of different items and number of each individual item), the types of items in the order (e.g., frozen, refrigerated, room temperature), a priority level of the order (e.g., indicating whether the order is to be immediately filled for an approaching/waiting customer). The customer order data may change over time for an order in response to a variety of activities. For example, the customer order data may change in response to item picking/packing. As another example, the customer order data may change based on modifications by the customer (e.g., modifications to the order and/or pickup time).

Locations of MSDs and items inside/outside of the store may be defined in a variety of ways. In one example, locations of MSDs and items may be defined in terms of zones that are defined by location indicators, as described above. For example, items may be mapped to zones that are defined by readable location indicators and/or location indicators that emit location signals. As described herein, MSD location may also be defined by readable location indicators and/or location indicators that emit location signals. For example, an MSD may determine its location by reading a readable location indicator and/or acquiring a location signal. As another example, an MSD may determine its location by scanning an item and determining the zone associated with the item (e.g., in an item association table). The MSD may then send its determined location to the CCS.

MSDs may transmit their locations determined based on any of the location determination techniques described herein. For example, MSDs may wirelessly transmit their locations to the CCS and/or MSDs at different times, such as at predetermined times, at predetermined intervals, in response to identifying a new location in any manner described herein, in response to picking a new item, and/or in response to a request for location from the CCS and/or other MSDs. The CCS and/or other MSDs may determine the locations of one or more MSDs in this manner. As described herein, in some implementations, the CCS may determine the location of one or more MSDs in other manners (e.g., other than by receiving a location from an MSD). A TPCS may also determine the locations of third party MSDs/pickers at one or more stores using any of the location determination techniques described herein with respect to the CCS.

In some implementations, locations of MSDs and items may be defined in terms of items, such as locations relative to one or more items. For example, the locations of MSDs and items may be defined using item adjacency. In a specific example, items may be defined relative to one another in an item adjacency map. In another specific example, the location of an MSD may be determined based on a last scanned item. In this specific example, the location of the MSD relative to items may be determined using the item adjacency table by looking up the recently scanned item in the item adjacency table. In some implementations, the MSDs may be configured to scan/identify items (e.g., using a barcode scanner, acquired image, or in another manner) that are not included in the customer order as the MSDs are moved throughout the store. For example, the MSDs may be configured to continuously/intermittently scan for items and/or readable location indicators while being moved throughout the store by the user. In these implementations, an MSD may send its location to the CCS/MSDs as the MSD scans/identifies items and/or location indicators. Additionally, or alternatively, the location of the MSD may be defined by the zone including the recently scanned item.

In some implementations, locations of the MSDs and items may be defined in terms of geolocation values (e.g., lat/long values using GPS). For example, the items may be mapped according to GPS geolocations as described above. In a specific example, each item may be associated with a geolocation value and/or range of geolocation values (e.g., lat/long values), such as a geolocation value and/or range of values associated with an MSD when scanning the item in the past. In some implementations, racks and/or aisles may also be associated with geolocation values and/or ranges of geolocation values that allow the CCS/MSDs to determine a location (e.g., an aisle/rack location) with respect to different portions of the store. The MSDs may include a geolocation receiver (e.g., GPS receiver) that determines the current geolocation of the MSD, which may be transmitted to the CCS. In some implementations, the maps may indicate the geo-location of the zones (e.g., the size/length of the zones) and/or the locations of the zones relative to one another (e.g., a distance between zones).

In some implementations, locations of the MSDs and items may be defined using WiFi-based positioning systems, or similar positioning systems. For example, the items may be mapped according to WiFi-based positions. In a specific example, each item may be associated with a WiFi-based position determined by the MSD and/or CCS when scanning the items. In some implementations, the MSDs may transmit their WiFi-based position to the CCS. In some implementations, racks and/or aisles may also be associated with WiFi-based positions/ranges that allow the CCS/MSD to determine a location (e.g., an aisle/rack location) with respect to different portions of the store.

In some implementations, the location of the MSDs may be determined based on motion data associated with the MSDs. For example, the MSDs may include motion sensors, such as one or more accelerometers and/or gyros that determine an amount of motion associated with the MSDs. Using one or more motion sensors may provide the MSD with motion information that the MSD can use to determine movement/location of the MSD. For example, the CCS/MSDs may determine an amount of movement (e.g., distance moved) since a location has been detected and/or an item has been scanned. In these examples, the CCS/MSDs may use the motion sensor data to determine location of the MSD relative to one or more items/zones in the store.

In some implementations, the locations of the items and the MSDs can be defined using store location descriptors (e.g., associated with store objects). The location descriptors may be assigned by the store employees (e.g., store managers) in some cases. In other cases, the location descriptors may be automatically assigned (e.g., automatically assigned to zones) based on image analysis/mapping. In some implementations, location indicators may be configured to transmit location descriptor data. For example, a location indicator may transmit a location signal that also includes location descriptor data (e.g., an aisle name, department name, item type, etc.). In some implementations, a readable location indicator may also include location descriptor data in the readable code. Example location descriptors may include aisle names and/or numbers. Additional example location descriptors may also include aisle descriptors, such as first/second aisle ends, aisle middle, and/or shelf location (e.g., bottom shelf, top shelf). Additional example location descriptors may include store department names and/or item types that describe the items in the store department (e.g., one or more aisles of the store). Example store department names may include, but are not limited to, grocery, dried goods, frozen foods, pharmacy, toys, and clothes.

In some implementations, the store employees, or other party, may manually associate items with the store location descriptors. In other implementations, the CCS/MSDs may associate items with the store location descriptors. For example, the CCS/MSDs may acquire images of the store including store location descriptors (e.g., aisle numbers and/or department names) and associate items with store location descriptors based on the proximity of items to location descriptors and/or where the images were acquired. In some implementations, the CCS/MSDs may determine a location in terms of a store location descriptor based on the item type of a detected item (e.g., a scanned item). In this manner, items/zones can be manually/automatically associated with location descriptors. The location descriptors can also be associated with other types of locations described herein, such as locations defined by location indicators, item adjacency, geolocation, and/or WiFi positioning. The CCS may determine the location of the MSDs in terms of store location descriptors. For example, the MSDs may transmit their current location to the CCS in terms of store location descriptors, or the CCS can determine the location of the MSDs in terms of store location descriptors based on other types of locations and/or using other techniques described herein.

In some implementations, the store may include other technologies that determine the location of the MSDs without communication from the MSDs. For example, in some implementations, the CCS may determine the location of MSDs. In one example, the store may be instrumented with cameras that identify the location of users inside/outside of the store. In these implementations, the CCS may identify store employees based on store uniforms, facial recognition, or other image processing techniques. In some cases, MSDs may transmit location signals to the central computing system. In other cases, the CCS may passively pick up the location of the handhelds, such as by using sensors (e.g., antenna, light-based, and/or sound-based sensors) in the store that pick up signals emitted by the handhelds. In some implementations, a user may wear a device (e.g., a tag) and/or an MSD may include a device (e.g., a tag) that transmits signals that indicate the location of the device. Accordingly, although the MSDs may report their locations to the CCS, the store/users may include additional/alternative location detection/reporting devices that report the location of the MSDs (e.g., based on images, RFID, WiFi, light, or other techniques). In some cases, the CCS can determine the location of MSDs based on the location of the last item(s) scanned. The OFS may use the CCS determined locations for mapping the store, picking items, and routing as described herein.

The store can be mapped using one or more of the location technologies described herein. The CCS/MSDs may also use any of these location technologies to determine location of the MSDs within the store (e.g., their locations relative to items/zones) when picking items. Accordingly, any of the location technologies described herein may be used to arrange items for picking and for routing.

This disclosure describes a variety of ways to determine the location of MSDs, users, and/or items inside and outside of a store. For example, the CCS/MSDs may determine the areas/zones in which the MSDs, items, and/or employees are located. A location of an MSD (e.g., an area/zone) may be generally referred to herein as a “location,” an “MSD location,” or zone. Similarly, a location of an item/user (e.g., an area/zone) may be generally referred to herein as a “location,” an “item/user location,” or zone. Although the CCS/MSDs may use various technologies for mapping, picking, and routing, some features of the OFS do not require the use the MSD/user/item locations.

The CCS/MSDs may generate routes described herein using any of the location technologies described herein. For example, the CCS/MSDs may generate routes using location maps, adjacency maps, and/or image-based maps. As another example, the CCS/MSDs may generate routes using other location technologies described herein, such as geolocation mapping and store location descriptor mapping. For example, using location descriptor mapping, the CCS/MSDs may generate routes using department names, aisle names/numbers, and/or specific aisle locations (e.g., ends or middle of the aisle).

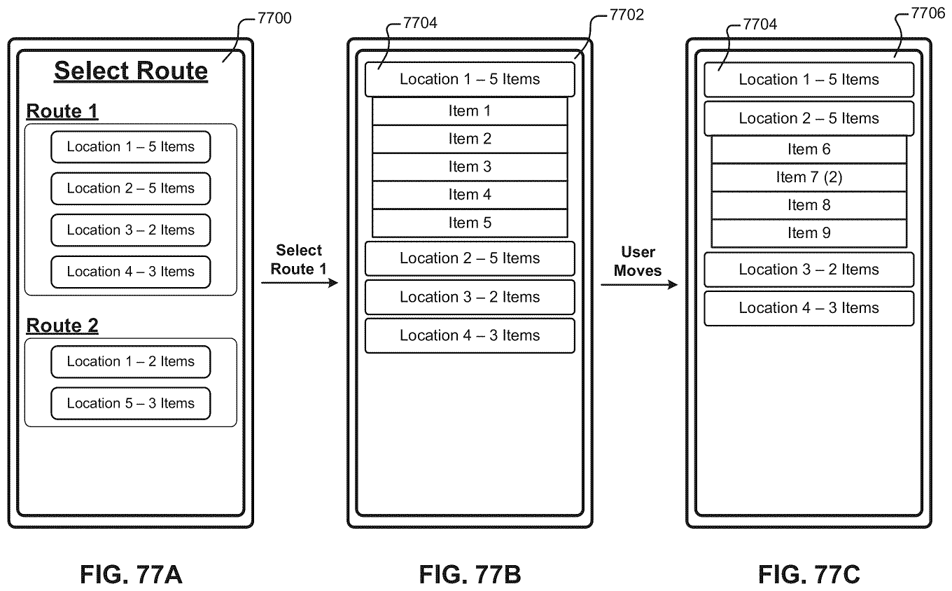

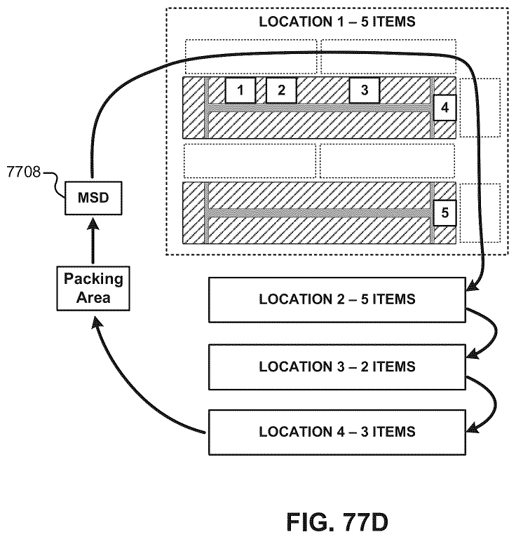

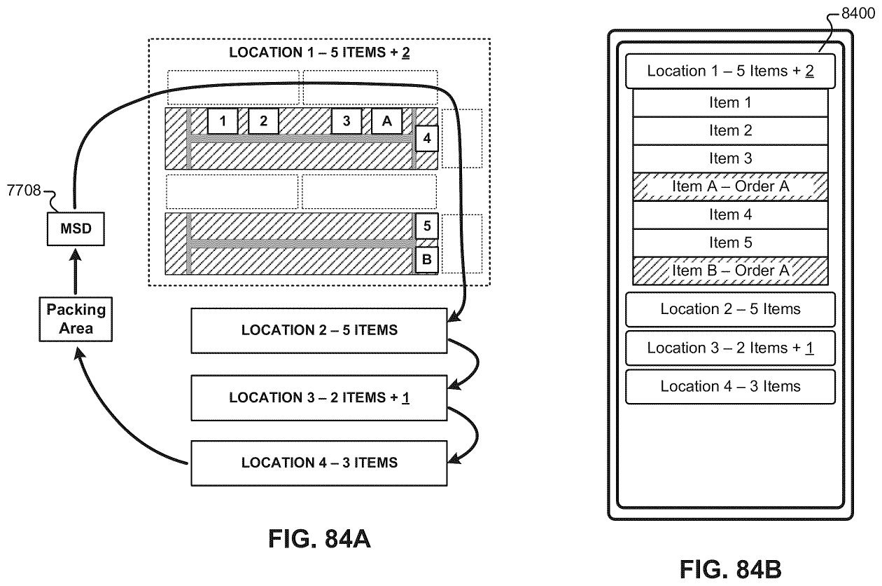

The CCS/MSDs may generate routes that include a series of locations defined by location descriptors. The locations defined by location descriptors may include one or more zones associated with the location descriptors. For example, a plurality of zones may each be associated with a single store department or aisle (e.g., see FIG. 77D). In this case, a route may include a series of locations defined by store location descriptors (e.g., store departments or aisles), where each location defined by a store location descriptor includes a plurality of zones through which the route may be traversed. FIG. 77D and FIG. 84A illustrate example zones associated with locations that may be defined by location descriptors, such as store department location descriptors (e.g., frozen department, meat department, produce department, etc.), aisle name/number descriptors, aisle location descriptors (e.g., end or middle), and/or item type descriptors associated with the zones (e.g., frozen, cereal, meat, seafood, etc.). In FIG. 77D and FIG. 84A, the route defines a series of locations in terms of store descriptors and zones associated with the store descriptors. In these examples, the zones may be viewed as groups of zones (e.g., groups of sub-zones), each group being under a common location descriptor. For example, in FIG. 77D and FIG. 84A, Location 1 (e.g., a store department name) includes 6 illustrated zones (e.g., illustrated by broken line rectangles).

In some cases, the CCS may be described herein as generating the routes for the one or more MSDs. Although the CCS may be described and illustrated herein as generating routes, the routes may be generated by one or more MSDs (e.g., store MSDs, third party MSDs, customer devices, etc.), a TPCS, and/or other computing devices.

The CCS/MSDs may store data that identifies the users and MSDs. For example, the MSDs may be associated with a user ID that identifies the user using the MSD. In some implementations, the user may enter their user ID (e.g., a name, number, login, etc.) into an MSD before picking with the MSD. The user IDs may allow the CCS/MSDs to know the picking and movement history of the user. The CCS/MSDs may also know the picking and movement history associated with the MSDs based on the associated MSD IDs. In some implementations, the CCS may generate routes for MSDs based on the user (e.g., user ID) that is using the MSD. In some implementations, the CCS may generate routes for MSDs based on the MSD being used. For example, in some cases, a store may use the same MSDs for picking in the same locations. In a specific example, a store may have specific MSDs for picking specific departments and/or item types. MSDs may be associated with specific locations, departments, and/or item types in response to user input (e.g., selection of locations/departments/item types in a menu) and/or the MSDs may have preprogrammed associations (e.g., programmed before being used to pick new customer orders).

The CCS/MSDs may store current data and historical data associated with ordered items, picked items, and movement of the MSDs. For example, the CCS/MSDs may determine current picking data and current location data. The current picking data may include outstanding order/item data, such as a list of items currently out for picking and a list of one or more MSDs assigned to the pick the items. The current picking data may also indicate a total number of items to be picked and the total number of outstanding orders. The current picking data may also include a current picking rate (e.g., number of items picked over time) for each MSD and/or all MSDs. The current picking data may also indicate the total number of items being transported by the user based on the number of items scanned by the MSD prior to drop off at a collection/packing area or transfer to another user (e.g., to another user's cart). The total number of held items by a user may be used for determining a route for the user (e.g., to prevent assigning too many items to a user). In a specific example, the CCS may be configured to generate routes that cause a picker to pick fewer than a maximum threshold number of items (e.g., to prevent overburdening the user). Additionally, or alternatively, the CCS may be configured to generate routes that cause a picker to pick greater than a minimum threshold number of items (e.g., to sufficiently utilize the picker).

The current location data may indicate the current location of the MSDs. The current location data may also indicate the distance between the MSDs in terms of physical distances and/or number of zones. The current location data may also indicate the movement rate of the MSDs in terms of physical distances and/or in terms of zones (e.g., zones per minute). The CCS/MSDs may use the current picking data and current location data to trigger/generate/update/stop routes, along with other operations described herein.

The CCS/MSDs can store historical picking data, such as logs of the items picked by different users and MSDs over time. The historical picking data may include items picked, timestamps of when the items were picked, MSD IDs associated with the picked items, and/or user IDs associated with the picked items. In some examples, historical user picking data may include user/MSD specific historical data that indicates the items picked by the user and the time at which the items were picked. Historical user picking data may also include processed data, such as the number of each item picked, the frequency at which items were picked, and the sequence in which the items were picked. The CCS/MSDs may also store historical aggregate picking data related to picking of items by a plurality of users/MSDs. The aggregate picking data used for routing may include a summation of data from current active pickers in some cases.

The CCS/MSDs may also store historical user/MSD location data, such as logs of the user/MSD location over time. The historical user/MSD location data may indicate the user/MSD location in the store over time, such as time spent in zones, zone traversal patterns for users, and which routes were followed by the users. The historical user/MSD location data may use any of the location technologies described herein. For example, the historical user/MSD location data may define locations in terms of location values, location descriptors, and/or other location definitions. The CCS/MSDs may also store historical aggregate location data related to a plurality of user/MSD locations, such as where users/MSDs are located over time.

The CCS/MSDs may learn how one or more users pick items and move throughout the store based on the historical picking data and historical movement data. For example, the CCS/MSDs may learn which items the users pick and/or which areas of the store the users pick from. For example, the CCS/MSDs may learn that some users may typically be assigned to specific locations in the store. As another example, the CCS/MSDs may learn that once a user picks a set of items within a set of locations, the user may tend to be assigned to the area for picking. In a specific example, the CCS/MSDs may determine that users picking frozen items are assigned to a frozen foods department, which may be used by the CCS/MSDs to assign items at a later time to the users (e.g., the CCS may assign items that are typically picked by the users). The CCS/MSDs may also determine metrics for different users, such as their movement rate and picking rate (e.g., items per minute) to determine how efficient they are at filling orders. Knowledge of a user's picking rate and movement rate may be used to intelligently assign items to users in various locations of the store (e.g., the CCS may assign more items to a user that has a higher picking rate).

The CCS and/or MSDs may generate routes for MSDs to follow through the store. A route for an MSD may indicate a path through the store for the MSD. In some implementations, a route for an MSD may indicate zones through which the user should travel when picking items. In some implementations, a route may indicate items for the user to pick. The items assigned in a route may be selected from one or more customer orders. For example, the items may be for a single complete customer order, multiple complete customer orders, a portion of one or more customer orders, or one or more complete orders and one or more portions of other orders.

A route for a specific MSD may be referred to as an MSD route, an MSD routing plan, or an MSD-specific route. In some implementations, the CCS may generate a global routing plan that includes a plurality of individual MSD routes. The individual MSD routes and global routing plan may be stored by the CCS and/or the MSDs. The CCS and/or MSDs can generate and update the routes over time in response to a variety of factors. An update may be a small modification to items/zones in the route or may be an entirely different route with new items and/or zones. Routing one or more MSDs in the store may optimize picking in a variety of ways described herein. For example, routing may reduce order picking time, optimize the assignment of items to pickers, and minimize the amount of picker movement (e.g., based on the location of MSDs/items).

The MSD routes and global routing plan can be generated in a variety of manners, depending on the type of mapping technology used in the store. In some implementations, the MSD routes may be defined in terms of store zones (e.g., using location indicators). In some implementations, the MSD routes may be defined in terms of items (e.g., using item adjacency). In some implementations, the MSD routes may be defined in terms of other mapping technologies, such as GPS, WiFi, or other technology. The MSD routes may also be defined as a combination of any of the above described mapping technologies.

A route may include a data structure that includes a set of zones through which the user should move and/or a set of items for the user to pick. As such, routes may be implemented to direct the movement of users and/or picking of items. Directing the movement of users and/or picking of items via a single MSD route and/or global routing plan may help ensure that user movement and/or picking time are reduced.

An MSD may have an MSD route that is assigned by the CCS, determined by the MSD, and/or assigned by another MSD (e.g., a primary/manager MSD may assign routes to secondary/employee MSDs). In some cases, an MSD may not have an MSD route. In these cases, the MSD may be in a free-roaming mode (i.e., an un-routed mode or roaming mode). In the free-roaming mode, a user may move the MSD throughout the store without a route. For example, the user may move the MSD throughout the store and the ordered items may be arranged on the MSD display without regard to a route (e.g., without regard to a fixed sequence of items/locations for picking).

The CCS may generate and assign routes (e.g., locations/items) to MSDs. Generation of a route may refer to generating a route data structure that includes one or more locations and/or one or more items to be assigned to an MSD. Assignment of a route to an MSD may refer to determining which MSD should be used to pick the route and/or sending the generated route to an MSD for picking according to the route. In some cases, the CCS may generate a route and store the route at the CCS prior to assigning the route to an MSD. For example, the CCS may generate a queue of routes that may be assigned to MSDs at a later time. In some cases, the MSD may receive a route and immediately begin implementing the route (e.g., adding items to the display for picking). In some cases, an MSD may store a queue of routes and implement the routes in sequence. For example, the MSD may display a first route that requires completion before beginning a second route.

A single MSD may operate in a roaming mode or operate according to a route. For example, an MSD may operate in a roaming mode until the MSD receives a route from the CCS, another MSD, or generates its own route. As another example, an MSD may allow a user to select whether the MSD operates according to a route (e.g., using a GUI selection menu button). In this example, a user may request a route from the CCS (e.g., using a GUI route request button), another MSD, or the generation of a route locally on the MSD. In some implementations, in the roaming mode, an MSD may not be explicitly instructed to pick specific items and/or traverse specific locations. Instead, in the roaming mode, a user may roam throughout the store and pick items in a flexible manner. In the roaming mode, items (e.g., all or any subset of currently ordered items) may be rearranged on the display as the user moves throughout the store. In some implementations, an MSD GUI may separate items that are on a route and items that may be picked while roaming. In some implementations, an MSD GUI may show items in a route until the route is completely picked, and then display items that may be picked while roaming (e.g., while heading to the packing area).

An MSD may operate according to a route in response to a variety of triggers, such as the satisfaction of route generation conditions/criteria (e.g., a small subset of items are near the MSD) detected by the MSD/CCS and/or in response to receiving a route from another computing device, such as the CCS or another MSD. The MSD may transition to a roaming mode after the route has been completed (e.g., according to route completion criteria, such as the picking of all items and/or the traversing of all zones). In another example, an MSD may allow a user to transition the device to a roaming mode (e.g., via selection of a GUI element). Transitioning an MSD between a roaming mode and a route may allow the user to be flexible in their picking. For example, it may allow the user to select whether they would like a route or whether they would benefit from flexibility not provided by a route.

In the case where multiple MSDs are being used to pick in a store, the MSDs may be in roaming mode and/or picking according to routes. For example, some of the multiple MSDs may be in the roaming mode while one or more other MSDs may be picking according to routes. As another example, all of the MSDs may be picking according to routes.

The number of zones and items included in one or more routes may vary. In some cases, different MSDs may be assigned routes (e.g., different routes or the same routes), such that each of the zones in the store and/or items in the customer orders are covered. In these cases, after picking according to the routes, all items of a customer order may have been picked. In some cases, a subset of zones and/or items may be covered by routes. In these cases, after picking according to the routes, some items may not have been picked. The remaining items may be picked with additionally assigned routes or by the roaming MSDs.

In some implementations, routes may include set zones and/or items, and may not be modified until completed. In other implementations, routes may be updated over time. For example, new items for picking according to new customer orders may cause modification of the routes. In a specific example, the CCS may update a route to include one or more items from newly received customer orders. As another example, deviation of an MSD from a route may cause updating of one or more of the routes. In a specific example, the CCS may update a route to include additional/alternative locations and/or sequences of locations in response to a user deviating from a route. In general, modification of routes may include addition/removal of items, addition/removal of zones, and/or modification of the sequence in which zones and/or items are to be picked.

The CCS/MSDs or other computing devices may generate the routes described herein. In some implementations, the CCS can generate the routes and assign the routes to one or more MSDs. In some implementations, an MSD may generate its own route. The MSD may communicate its generated route with the CCS and/or other MSDs. If multiple MSDs are used in the OFS, the other MSDs may determine their own routes (e.g., based on already generated routes) and communicate their routes with the CCS and/or one another.

In some implementations, an MSD may display items on the MSD route. For example, the items displayed on the MSD may be limited to those items on the MSD route. In this example, the route may cause a user to focus on picking the items on the route in the sequence (e.g., zone or item sequence) specified by the route. In these examples, certain items for the route may be sent to the MSDs from the CCS for picking, while other currently ordered items are not shown to the user on the MSD. In this case, the items that are not on the route may be unviewable by the user on the MSD. In some examples, the MSD may display additional items that are not on the route, but may still give preference to showing items that are on the route (e.g., arranging items off-route lower on the display). In this case, items that are not on the route may still be displayed for picking if the user deviates from the route (e.g., based on location). In some examples, items that are not included in an MSD route may be removed from the MSD display, thereby focusing a picker on the specific items in the route. The CCS/MSDs can arrange the items according to the route through the zones (e.g., closer zones have items that show higher/first on the display).

In some implementations, the MSD may start a route off in a set sequence of items and/or zones that are optimized (e.g., by the CCS), but then diverge from the route as the user moves. In these cases, the zones/items may be rearranged relative to the user's location, as described herein (e.g., closer items higher on the display).

The route(s) can be generated based on any item that is not yet picked, regardless of which items belong to the same customer orders. For example, the CCS/MSDs may generate a route that includes any of the items that have not yet been picked, whether those items are included in the same customer order or in different customer orders.

The route(s) may be generated on a customer order basis in which entire customer orders are assigned to each route. For example, each route may be assigned a single customer order. In some implementations, a single route may include multiple customer orders.

The route(s) may include any of the store's zones in any order. For example, a route may include all of the zones. As another example, different routes for different MSDs may include different subsets of zones. As another example, an MSD may receive different routes in sequence, where each of the assigned routes may include different sets of zones.

The CCS/MSDs may generate one or more routes that may be assigned to multiple MSDs (e.g., in parallel or in sequence to one or more MSDs). In some cases, different routes may include the same items (e.g., the same items from different orders). In some cases, different routes may include the same set of items (e.g., from the same orders), such as when multiple MSDs pick the same customer order. In other cases, different routes may include some items that are the same (e.g., from the same or different orders) and some items that are different. In other cases, different routes may be assigned different items that do not overlap with one another. The CCS/MSDs may be configured to generate routes with any amount of overlap in items, or no overlap at all.

Even though the arrangement of items/zones may be specified by a route, in some implementations, items may be rearranged on the MSDs based on the location of the MSD and/or the location of the items. For example, a subset of the items on the route may be rearranged on the MSD display based on the location of the MSD and/or the items. In a specific example, if a user moves through a zone on a route, the items within the zone may be rearranged on the MSD based on the proximity of the items to the user (e.g., based on adjacency), as described herein.

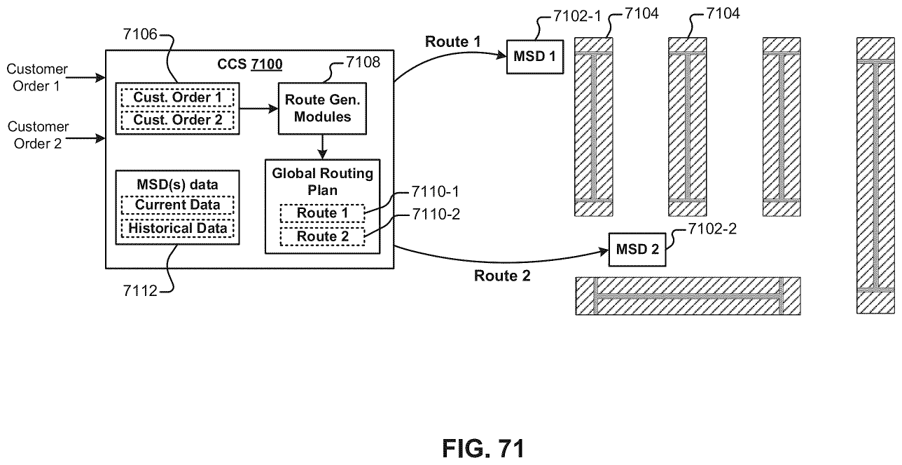

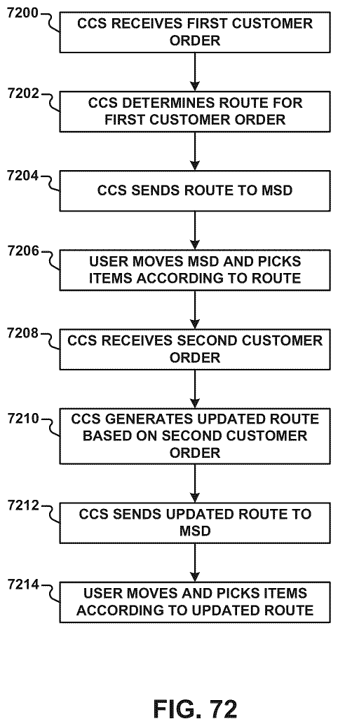

FIG. 71 illustrates an example CCS 7100, two MSDs 7102-1, 7102-2, and a portion of a store (e.g., a plurality of racks 7104). In FIG. 71, the CCS 7100 receives two customer orders, illustrated as customer order 1 and customer order 2. The CCS 7100 may store customer orders (e.g., in a customer order queue 7106). The CCS 7100 includes route generation modules 7108 that may generate one or more routes based on received customer orders. In FIG. 72, the CCS 7100 generates two routes 7110-1, 7110-2 (route 1 and route 2) based on the received customer orders. In some implementations, the CCS 7100 may generate routes based on historical and current MSD data 7112. The CCS 7100 sends the routes 7110 to the two MSDs 7102. Specifically, the CCS 7100 sends route 1 and route 2 to MSD 1 and MSD 2, respectively. As described herein, the routes may include any mix of items from the two customer orders.

The route generation modules 7108 may represent components of the CCS 7100 that implement some features attributed to the CCS 7100 herein. For example, the route generation modules 7108 may include computing devices/components (e.g., hardware/software) that implement some features attributed to the CCS 7100 herein. In one example, the route generation modules 7108 may generate routes for one or more MSDs, monitor the MSDs, and provide route updates. Although the CCS 7100 may implement the various features attributed to the route generation modules 7108 (e.g., route generation, route updates, etc.), in some implementations, route generation/updating features may be performed by a TPCS or other party. In some implementations, a TPCS may generate routes for third party MSDs, monitor third party MSDs, update routes for third party MSDs, and perform other routing functionality described herein. In these implementations, the TPCS may generate/update routes for a plurality of MSDs in a plurality of different stores.

As described herein, the CCS 7100 (e.g., route generation modules 7108) may implement a variety of different algorithms to generate/update routes. For example, the CCS 7100 may generate routes using rule-based operations, such as a set of one or more rules to follow when generating a route (e.g., rules indicating which route generation factors to use). In some implementations, the CCS/MSDs may also implement one or more traversal algorithms in which the location maps (e.g., zones) or other maps are traversed according to various rules in order to determine routes (e.g., sufficient/optimal routes). In a specific example, the CCS/MSDs may implement tree/graph traversal algorithms on the location maps to determine routes. The CCS 7100 may also use optimization techniques that may be subject to constraints described herein. In some implementations, the CCS 7100 may implement scoring models to generate the routes, where one or more routes may be scored in order to identify the optimal route. In some implementations, the CCS 7100 may implement machine learning algorithms in order to identify routes. The route generation and update techniques described herein are only example techniques. As such, additional/alternative techniques may be implemented by the CCS to generate the routes.

FIG. 72 illustrates an example method that describes operation of the OFS in response to receipt of sequential customer orders. In the method of FIG. 72, the OFS includes a CCS and a single MSD. The method of FIG. 72 describes a scenario in which the MSD receives an initial route and then subsequently receives an update to the route based on a newly received customer order. In block 7200, the CCS receives a first customer order. In block 7202, the CCS determines a route for the first customer order. In block 7204, the CCS transmits (e.g., assigns) the route to the MSD. In block 7206, a user moves the MSD throughout the store and picks items according to the route. In block 7208, the CCS receives a second customer order (e.g., while the user is picking the first customer order). In block 7210, the CCS generates an updated route based on the second customer order. For example, the CCS may generate the updated route based on the second customer order, currently unpicked items from the first customer (e.g., unpicked items that are currently assigned to the first route), and/or other parameters described herein. In block 7212, the CCS sends (e.g., assigns) the updated route to the MSD. In block 7214, the MSD receives the route and the user may move throughout the store and pick items according to the route. The update to the route may include any types of updates described herein, such as a modification to zones and/or items on the route. For example, the updated route may include modification of the included zones/items and sequence of zones/items. In some implementations, the CCS may send the additional items/locations (e.g., modifications to the route) to the MSD for integration into the existing route. In some implementations, the CCS may generate a completely new route data structure (e.g., including already assigned items and new items) that the MSD may use as a replacement for the existing route. Although the route can be updated in real time when a second customer order is received, in some implementations, the CCS may hold the second customer order and assign the newly received order after the first route is completed (e.g., after all items of the first customer order are picked).

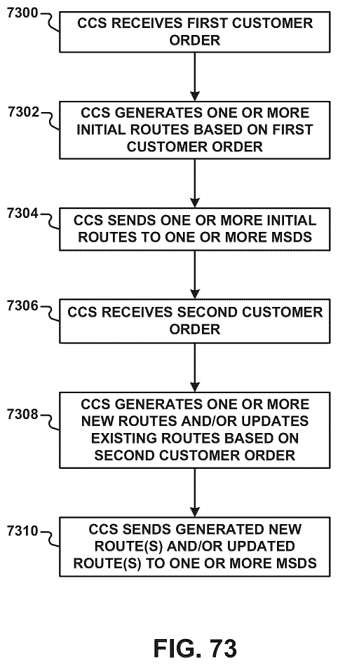

FIG. 73 illustrates an example method that describes operation of the OFS in response to receipt of sequential orders. In the method of FIG. 73, the OFS includes a CCS and two MSDs. In block 7300, the CCS receives a first customer order. In block 7302, the CCS generates one or more initial routes based on the first customer order. In one example, the CCS may generate one route including all items from the customer order. In another example, the CCS may generate two routes, each of which includes all items from the customer order. In another example, the CCS may generate two routes, each of which includes a subset (e.g., less than all) of the items from the first customer order. In block 7304, the CCS sends the one or more initial routes to one or more MSDs. In block 7306, the CCS receives a second customer order. In block 7308, the CCS generates one or more new routes and/or updates existing routes based on the second customer order. For example, the CCS may generate a new route for later assignment to one or more of the MSDs. As another example, the CCS may update routes for the MSDs. In block 7310, the CCS sends the generated new routes and/or updated routes to one or more MSDs.

An MSD route data structure may be implemented in a variety of ways. In some implementations, an MSD route may define one or more zones through which a user should move. In the case an MSD route includes a single zone, the zone may be a zone that the user is currently within, an adjacent zone, or another zone in the store. In the case an MSD route includes multiple zones, the zones may be contiguous or may include separations. For example, an MSD route that includes contiguous zones may include a route through a plurality of zones that are sequentially adjacent to one another. As another example, an MSD route that includes separations may include zones that are not adjacent to one another. In some cases, a route may include zones that are contiguous zones (e.g., adjacent) along with some zones that are separated.

In some examples, the plurality of zones may be ordered in a manner that causes the user to move according to the route. For example, the MSD route may include directional data that indicates a recommended or set direction through the zones. In a specific example, a route data structure may include numbers indicating the order through which the zones should be traversed. In another specific example data structure, the order of the zones in the data structure may imply the order through which the zones should be traversed.

In some implementations, an MSD route may indicate a zone at which to start. Similarly, an MSD route may indicate a zone at which to end. In one example, the MSD route may start at a user's current location. In another example, the starting zone may be adjacent to the user's location or farther away.

In some implementations, the routes may be fixed routes (i.e., set routes). Fixed routes may include a fixed set of zones to be traversed in order. In these examples, the items associated with the zones may be set in order for the user to pick. Additionally, in these examples, movement of the user in a direction that is out of order may not cause a change in the arrangement of items on the display. In some implementations, the routes may be recommended (e.g., suggested) routes. If the route is a recommended route, the user may deviate from the route and cause the items on the display to be updated according to their location (e.g., near items may be arranged higher on the display). In some cases, the items that are arranged on a display for a recommended route may be those items that are included on the recommended route. In these cases, the items on the recommended route may be rearranged on the display. In other cases, items other than those on the recommended route may be displayed based on their location from the user when the user deviates from the recommended route. In some implementations, some zones may be required to be traversed in sequence, while other zones may not be required to be traversed in sequence. For example, a final set of zones may be set, while the earlier zones may not be in a set sequence.

The CCS/MSDs may choose the starting location of a route in a variety of ways. For example, the starting location may be set to a fixed location in the store, such as near the entry of the store, near a shopping cart corral, near the packing area, or other location that the store has configured for starting a route. As another example, the starting location may be set to the picker's current location (e.g., a current MSD location). As another example, the starting location may be another location, such as a location of a first item of a route. As another example, a starting point may be set to a zone that is currently near a user.

The CCS/MSDs may choose the stopping location (i.e., ending location) of a route in a variety of ways. For example, the stopping location may be set to a fixed location in the store, such as near/in a collection/packing area for the items, near a checkout register, near a customer pickup area, or other location that the store has configured for stopping a route. As another example, the stopping location may be set to a location of the final item on the route. As another example, the stopping location may be set to a zone that includes the final item of the route. As another example, the stopping location may be based on the number of items picked (e.g., a predetermined number of items causes a stop in the route generation).

The CCS/MSDs may choose the locations between the starting location and the stopping location in a variety of ways described herein. In some implementations, the routes may include set locations to traverse between the starting and stopping locations. The set locations may be in a fixed order or the user may have flexibility in the route. For example, a user may have flexibility in the route where the route includes a set of zones for traversal, but allows for traversal in more than one way.

A route may include any number of zones. In some cases, a route may include a single zone (e.g., including the user, adjacent to the user, or any distance from the user). In other cases, a route may include a plurality of zones, such as a starting zone to a stopping zone (e.g., in a packing zone). In some cases, a route may be a short burst of zones (e.g., a few zones) that are near the user. After picking items from the route, the user may continue to pick in a roaming mode or receive another route, as described herein.

In some implementations, an MSD may be configured to display a variety of information associated with routing a user. In some implementations, an MSD may display the current route to a user. For example, the MSD may display racks, items, and/or zones on the display. The MSD may render the route based on the mapping data along with other maps that describe the locations of the racks in the store. In some implementations, items that are to be picked for the route may be indicated in a GUI (e.g., using text, a symbol, color, and/or a label). In these implementations, the CCS may restrict the picker to picking the indicated items on the route before receiving another route. The GUI may also notify a user when the MSD has scanned an item that deviates from an item assigned on the route. In some implementations, the GUI may indicate to the user when the user has deviated from a route. For example, the GUI may indicate (e.g., using text, color, symbols) when the user has traversed through zones out of sequence and/or when the user has moved to a zone that is not included in the route.

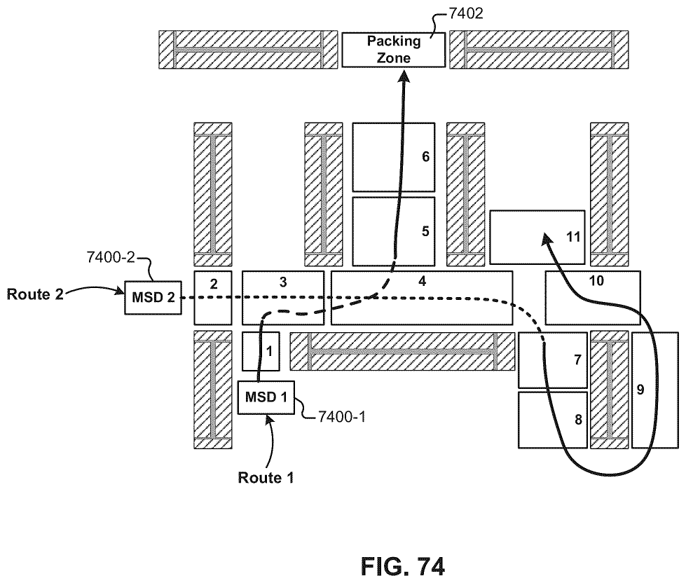

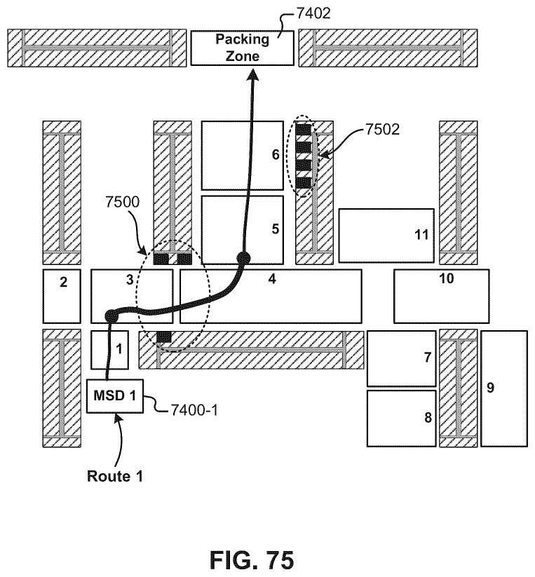

FIGS. 74-75 illustrate an example store that includes 2 MSDs 7400-1, 7400-2 that each pick according to different routes. For example, in FIG. 74, MSD 1 7400-1 and MSD 2 7400-2 pick according to received route 1 and route 2, respectively. The locations (e.g., zones) are illustrated as numbered rectangles (e.g., zones 1-11). The store in FIGS. 74-75 include a packing zone 7402, which may be a zone in which store employees pack items that are picked by the users. For example, pickers using MSDs to pick orders, or other users, may pack items in the packing zone 7402 for customer pickup or delivery. Although 11 zones and a packing zone 7402 are illustrated, the store may include other zones. Although the store may include a “packing zone,” in some cases, the users may be packing the items as they are picked. In this case, the zone may refer to a location in the store in which items are collected for pickup/delivery. Note that the location at which items may be packed and/or collected for pickup/delivery may be described herein generally as a packing/collection location. The packing/collection location may also be referred to as a “packing/collection area” or a “packing/collection zone.” The packing/collection area may be defined using any of the location mapping technologies described herein.

In FIG. 74, MSD 1 7400-1 receives route 1 from the CCS. Route 1 starts in zone 1, which is adjacent to MSD 1 7400-1 when route 1 was assigned. Route 1 includes zones 5-6 and terminates at the packing zone. An example path taken by MSD 1 7400-1 is illustrated by a line that is partially solid and partially broken. The solid line may indicate assigned zones that may include items for picking by the user of MSD 1 7400-1. The broken line may indicate a path taken by MSD 1 on the way to zone 5. As described herein, the CCS may generate a route for MSD 1 including zone 1 due to the proximity of MSD 1 to zone 1. The CCS may also generate a stopping point for MSD 1 as the packing zone so that the user of MSD 1 can drop off the picked items. Zones 5-6 may have been assigned to MSD 1 due to the location of the zones 5-6 between a starting zone 1 and a terminal packing zone.

In FIG. 74, MSD 2 7400-2 receives route 2 from the CCS. Route 2 starts in zone 7, which is distant from MSD 2 7400-2 when route 2 is generated. Route 2 includes zones 7-11. Route 2 terminates in zone 11. In some cases, MSD 2 7400-2 may continue picking (e.g., in a roaming mode) at the end of the route. In other cases, MSD 2 7400-2 may be assigned a new route after the end of the route in zone 11. In other cases, the user may drop the picked items off at the packing zone 7402, even though the packing zone 7402 is not on route 2. In some implementations, route 2 may have been generated after route 1 (e.g., in a case in which the CCS assigns routes sequentially), which may have resulted in route 2 being a route that does not start local to MSD 2 7400-2, as route 1 had been assigned items near MSD 2.

Note that route 1 and route 2 of FIG. 74 illustrates a case in which routes may start near MSDs or distant from MSDs. FIG. 74 also illustrates how some zones in a route may be contiguous, or may be separated. FIG. 74 also illustrates how a route may end at a packing zone or at another zone (e.g., zone 11) that is distant from the packing zone (e.g., not adjacent to the packing zone).

FIG. 75 illustrates example updates received by MSD 1 7400-1 during route 1. MSD 2 and route 2 have been removed to simplify the illustration (e.g., relative to FIG. 74). For example, in FIG. 75, route 1 received an update to include new zones 3-4, as illustrated by the thick line over top of zones 3-4. It may be assumed that MSD 1 7400-1 received the updated route shortly after receiving route 1 illustrated in FIG. 74. For example, MSD 1 7400-1 may have received the updated route while picking in zone 1. The updated route includes new items (dark boxes on racks) 7500 from a new customer order in zones 3-4, which are new zones assigned to the route. The new zones (e.g., a burst of zones) may have been added to the updated route based on the proximity to other zones/items already on route 1. For example, the new zones may have been added to route 1 because the new zones are in between zone 1 and zone 5 such that the zones were on a probable path between existing zones in the route. In the specific example illustrated in FIG. 75, the CCS may have added the new zones because 1) the zones are near other zones on the existing route, 2) the zones were on a probable path to be traversed by the user, and/or 3) the addition of the zones caused the formation of a contiguous path in the route. The new zones may have also been added based on a proximity of MSD 1 7400-1 to the zones. Also note that the updated route includes new items 7502 associated with zone 6, which was already on route 1 before the update. The new items may have been assigned to the updated route based on inclusion of zone 6 in the already assigned route 1.

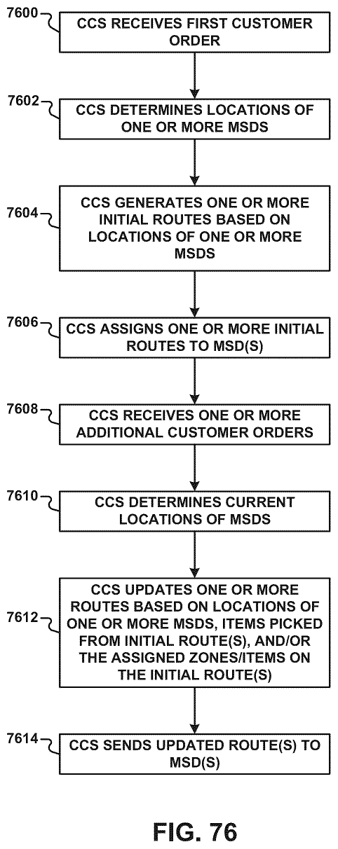

FIG. 76 illustrates an example method for generating and updating routes based on a variety of factors, such as the locations of one or more MSDs, items picked by the MSDs from the initial routes, and/or assigned zones/items in the initial route(s). In block 7600, the CCS receives a first customer order. In block 7602, the CCS determines the locations of one or more MSD(s). In block 7604, the CCS generates one or more initial routes based on the locations of the one or more MSDs. For example, with respect to FIG. 74, the CCS may have generated route 1 based on the initial location of MSD 1 7400-1. In block 7606, the CCS assigns the one or more initial routes to the MSD(s).

In block 7608, the CCS receives one or more additional customer orders. In block 7610, the CCS determines the current locations of the one or more MSDs. In block 7612, the CCS updates one or more routes based on at least one of 1) the locations of the one or more MSDs, 2) items that have been picked from the initial routes, 3) and the zones/items that have been assigned in the initial routes. For example, with respect to FIG. 75, route 1 may have been updated to include additional zones and items based on one or more of the factors in block 7612. In block 7614, the CCS sends the updated route(s) to the MSD(s).

FIGS. 77A-77C illustrate example MSD GUIs. In FIGS. 77A-77C, a user selects a route and then moves throughout the store. The MSD modifies the GUI in response to the user movement. The GUIs illustrated in FIGS. 77A-77C are only example GUIs. As such, the MSDs may generate additional/alternative GUIs than those explicitly illustrated herein.

In FIG. 77A, the CCS has generated route 1 and route 2. The CCS has also provided the routes to the MSD for selection by the user. For example, the GUI 7700 in FIG. 77A prompts the user to select one of two routes. The GUI 7700 includes a summary of the routes including the locations in the routes and the number of items in each location. The summary may also indicate the order of the locations through which the route will traverse. For example, route 1 may proceed from a starting Location 1 to an ending Location 4. The GUI summary information presented to the user may help the user decide which route to select. As described herein, the routes presented to the user for selection may be presented based on user device location (e.g., relative to items/zones), user historical preferences (e.g., for picking items and/or moving in zones), a user request for a set of routes, and/or other factors.

The user may interact with the GUI 7700 to select a route. For example, a user may touch/click a route on a touchscreen display to select the route. In FIG. 77A, the user selects (e.g., touches) route 1. In response to selecting route 1, the MSD may render the GUI 7702 illustrated in FIG. 77B. The GUI 7702 in FIG. 77B may convey a variety of types of route information. The arrangement of the locations (e.g., Location 1-4) from top to bottom may indicate the sequence of locations through which the user will travel while picking items. For example, while picking route 1, the user may travel through Locations 1-4 in sequence. The items associated with a single location (e.g., a location descriptor, such as a store department, aisle number, aisle name, etc.) may be grouped together with a location tab (e.g., 7704) indicating the location (e.g., location descriptor) with which the items are associated. In one example, the locations listed in the location tabs (e.g., location tab 7704) may be location descriptors. For example, Location 1 tab 7704 may be the name of an aisle, department, or other location in the store. In FIGS. 77A-77C, it may be assumed that the listed locations (e.g., Location 1-4) are in terms of location descriptors. Although the GUIs may include groupings of items according to location descriptors, the items may be grouped according to locations using any of the location technologies described herein.

FIG. 77D illustrates an example route (e.g., illustrated by arrows) that may correspond to the route 1 GUIs 7702, 7706 illustrated in FIGS. 77B-77C. For example, FIG. 77D illustrates an MSD 7708 that may have selected route 1 while leaving the packing area (e.g., after dropping off previously picked items). In FIG. 77D, the MSD 7708 follows route 1 through Locations 1-4 and picks items on the route (e.g., items 1-5). After picking all items, route 1 may lead back to the packing area (e.g., a route stopping point) so that the user can drop off the picked items. Such a route as illustrated in FIG. 77D may be used for efficient picking and packing of customer orders because a user may immediately begin picking upon dropping off items and leaving the packing area. Additionally, the user may be routed in a manner that leads them back to the packing area for packing the newly picked route. The CCS may generate such a route by constraining the starting and stopping points to the packing area or other locations near the packing area.

In FIG. 77D, Location 1 and items 1-5 are illustrated in detail. Location 1 (e.g., a store department, aisle number, etc.) may include a plurality of zones, which are illustrated as broken line rectangles. The zones may be defined according to any location technique described herein. In FIG. 77D, each of the Locations 1-4 may include a plurality of zones that may act as “sub-locations” or “sub-zones” in an overall route.

In FIG. 77B, the GUI 7702 includes the items arranged in the route based on the locations associated with the items, as described herein. For example, items 1-5 may be assigned to be picked in order on the route (e.g., see FIG. 77D). In some implementations, the GUI may rearrange the items based on the location of the MSD relative to the items. For example, while maintaining the location tabs as illustrated in FIG. 77B, the GUI may rearrange items 1-5 as the user moves throughout Location 1. In a specific example, with respect to FIG. 77D, if the user moves near item 5, the GUI may rearrange the items to list item 5 at the top of the GUI. In this specific example, the GUI may also rearrange items 4-1 in descending order based on distance from the MSD. Although the GUI may rearrange items within the location tab 7704 as the user moves within Location 1, in some implementations, the GUI may maintain the arrangement of items within the location tab (e.g., as a fixed route) as the user moves within the location.

FIG. 77C illustrates an example GUI 7706 generated based on user movement while picking route 1. In FIG. 77C, the user has moved into Location 2 (e.g., a new store department, store aisle, etc.). In response to entering Location 2 (e.g., a zone in Location 2), the GUI 7706 renders items included on the route in Location 2. Specifically, in FIG. 77C, the GUI renders items 6-9 as a list that may be arranged with the closest items near the top of the list. Item 7 includes a (2) indicator that indicates two of item 7 should be picked on the route. Although the location tabs indicate a total number of items to be picked (e.g., Location 2 has 5 items total), in some implementations, the GUI may indicate a total number of different items to be picked in a location. In these implementations, the GUI (e.g., a location tab) may indicate the number of repeat items in the route. In a specific example of these implementations, the Location 2 tab may indicate “Location 2-4 Items (1)” to indicate that there are 4 different items to pick, where one of the items is to be picked multiple times.

Note that the items for Location 1 may be collapsed back into the Location 1 tab upon a user entering Location 2. In the example of FIGS. 77B-77C, the user may not have picked items from Location 1 prior to entering Location 2, as the Location 1 tab still indicates 5 items are remaining. Although the list of items associated with Location 1 have collapsed in FIG. 77C, the MSD may generate GUIs that do not expand/collapse depending on user location. In these cases, the location tabs and items may be fully listed in the GUI and may or may not rearrange in response to user movement.

Note that the location tabs in FIGS. 77B-77C remain in the same arrangement as the user moves throughout the store. Although the location tabs may be stationary in the GUI during user movement, in some implementations, the MSD may rearrange the location tabs and groups of associated items based on the user's location relative to the Locations 1-4. For example, in other implementations, in FIG. 77C, Location 2 may be rearranged at the top of the display to indicate that the user is closest to Location 2 (e.g., inside Location 2).

The user may interact with the GUIs of FIGS. 77B-77C in a variety of ways. In some implementations, the user may scroll through the locations and items. For example, the user may swipe the display (e.g., a touchscreen) to move the list of locations and items up and down the screen. Swiping the screen to view the locations/items may provide a preview of the route for the user, which may help the user fully understand their future picking strategy. Note that the locations and items illustrated in FIGS. 77B-77C do not fill the screen. As such, swiping may not be required to view all locations/items in the route, whereas a longer list of locations/items may not be completely viewable on the screen without swiping. In some implementations, the user may select (e.g., touch/click) the location tabs to expand/collapse the list of items associated with the location. For example, a user may select (e.g., touch) the Location 1 tab 7704 in FIG. 77B to collapse the items back into the Location 1 tab 7704 (e.g., as illustrated in FIG. 77C). As another example, a user may select (e.g., touch) the collapsed Location 2 tab in FIG. 77B to expand the list of items under the Location 2 tab (e.g., as illustrated in FIG. 77C).

As described herein, the items may be removed from list as the user picks and scans the items. The location tabs may also be removed from the GUI after all items have been scanned for the location. After completion of the route, the GUI may display a route completion GUI element, such as text indicating that “Route 1 is complete.” If route 1 included a complete customer order, upon completion of the route, the GUI may display an order completion GUI element, such as text indicating “Order completed” or “Order completed. Return to packing area.”

Although not illustrated in FIGS. 77B-77C, in some implementations, the GUI may include additional items that a user may pick, such as items that are not on the route and/or items that have not been ordered by a customer (e.g., non-ordered items described herein). The additional items may be rendered as a list under the other items on the route. The additional items may be arranged based on user location in a manner that is similar to the items in FIGS. 77B-77C. In scenarios without an assigned route (e.g., roaming), the MSD may also arrange items as illustrated in FIGS. 77B-77C. For example, if the MSD is operating in a roaming mode (e.g., based on user selection of a roaming GUI element), the items may be arranged by location as illustrated in FIGS. 77B-77C.

In some implementations, the user may choose to quit picking the route. For example, the user may select a route ending GUI element, such as a “Stop Route” GUI button that causes the route to end. In this example, the route may be removed from the GUI. Additionally, the items in the route may be included in another route and reassigned to another user, or the same user at a later time.

In some implementations, an MSD route may define one or more items to be picked by the MSD. For example, the MSD route data structure may include a plurality of items. The MSD route may also indicate an order in which the items should be picked. The items in the route may be associated with zones in some cases, which may allow the items to be rearranged on the display when a user moves through the store and/or rearranged based on item adjacency of user-scanned items or automatically scanned items. In other cases, the item sequence may be set, such that the item arrangement on the screen does not change when a user moves throughout the store. In these cases, the MSD route data structure may include items, but does not require associated zone data. In some implementations, the MSD and/or CCS may arrange the items in the route based on maps or using other techniques.

In some implementations, an MSD route (e.g., route data structure) may specify that some items must be picked before other items and/or that some items may be picked at any time. For example, frozen/cooled items may be associated with a restriction that they are picked last before packing. In this example, the frozen/cooled items may be located farther down on the picking list to promote later picking. In some cases, the items that are required to be picked at a later time may be shown to the user after (e.g., only after) the prior items are picked. For example, the frozen/cooled items may be included in the GUI in response to picking other items that are not frozen/cooled. In some implementations, the MSD may limit the display of items to just the items being picked on the route (e.g., not display other items).

In some implementations, an MSD route may include a fixed set of items. In these implementations, the items included in the MSD route may not change, except to be removed from the display when the user picks the items. In other implementations, an MSD route may add items to the route as new items are received for customer orders. For example, items that are near to the route (e.g., adjacent items and/or items in nearby zones) may be added to the route. As another example, the CCS may assign newly received items to a route that already includes the items. In this example, items that are already on the route may have their numbers incremented in the MSD GUI if new customer orders including the items are received.

In some implementations, an MSD route may indicate an item at which to start picking. Similarly, an MSD route may indicate an item at which to end. For example, the MSD route may start with a nearby item and end with an item that is farther away. In other examples, the starting item may be an item that is farther away (e.g., not adjacent or in the same/adjacent zone). In other examples, such as when a user is leaving a packing zone after dropping off items, the first item(s) may be near the user as they exit the packing zone and the last items on the route may also be near the packing zone (e.g., on the return path to the packing zone). In some cases, the items along the route may be adjacent to one another. In other cases, the items in a route may be farther away from one another (e.g., not adjacent or in the same/adjacent zone). In some implementations, the MSD GUI may indicate the starting and/or stopping items/locations when the route is assigned in order to give the user a sense of the picking path. Similarly, in some implementations, the MSD GUI may indicate the route to the user in a manner that provides the user with the general route in between the start and stop, such as a list of zones and/or items. For example, the MSD GUI may present a selected group of items and/or aisles that will be picked in order to provide the user a sense of the path for picking. In some implementations, the user may scroll down the MSD GUI to preview the entire route items/locations in order to learn the route before starting.

A route may include any number of items. In some cases, a route may include a single item (e.g., near the user or at any distance from the user). In other cases, a route may include a plurality of items, such as a starting item and a stopping item (e.g., near a packing zone). In some cases, a route may be a short burst of items (e.g., a few items) that are near the user. After picking items from the route, the user may continue to pick in a roaming mode or receive another route, as described herein. Although a route may be a short burst of items, in some implementations, the route (e.g., a route modification) may be generated as a short burst of locations (e.g., near the user/route) to which items are added (e.g., items in the short burst of new locations).

In some implementations, an MSD route may be based on a sequence of items for the user to pick. For example, the CCS may generate an MSD route based on a single customer order, which may include all of the items from the customer order or only a subset of the customer order. As another example, the CCS may generate an MSD route based on a plurality of items from different customer orders (e.g., complete customer orders and/or portions of different orders). In some cases, an MSD route may be generated for a specific set of items that the user is supposed to pick without an update. In other cases, items from newly received customer orders may be sent to the MSD as the user is picking according to the route (e.g., new adjacent items or items in the same zones).

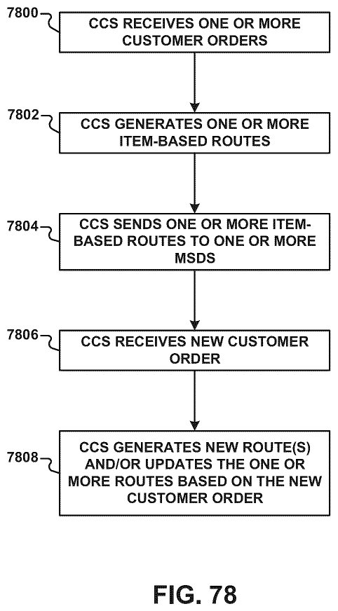

FIG. 78 illustrates an example method that describes generation of one or more routes in which at least some routes are item-based routes in which the sequence of items in the routes may be set. In block 7800, the CCS receives one or more customer orders. In block 7802, the CCS generates one or more item-based routes based on the received customer orders. In some implementations, the item-based routes may include a sequence of items that do not change based on the location of the MSDs. Additionally, the CCS may generate one or more other routes that may be more flexible (e.g., change based on location). In block 7804, the CCS sends the one or more item-based routes and other routes to one or more MSDs. In block 7806, the CCS receives a new customer order. In block 7808, the CCS generates new routes and/or updates the one or more previously sent routes based on the new customer order. In some cases, an item-based route may be updated to include new items, remove items, and/or increment the number of items to be picked in the route.

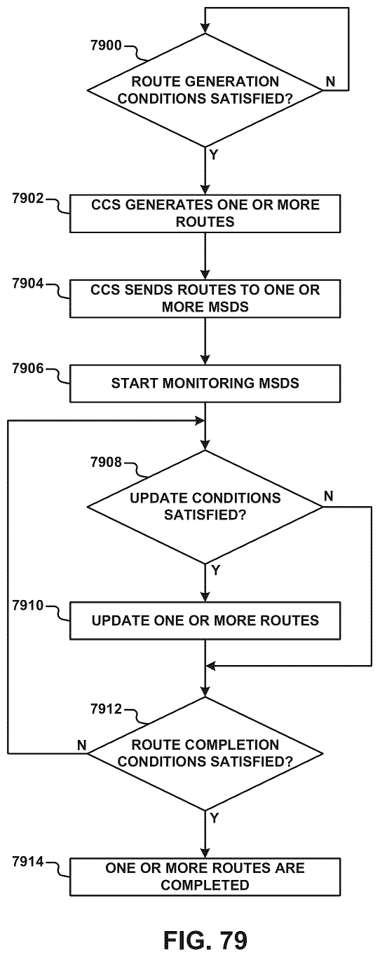

FIG. 79 illustrates an example method that describes operations associated with generating routes, monitoring routes, updating routes, and ending routes. The operations described in FIG. 79 are only example operations that may be performed by the CCS. Although FIG. 79 describes a scenario where the CCS performs the route generation, monitoring, and update operations, one or more MSDs may also perform the operations.

In block 7900, the CCS determines whether route generation conditions are satisfied. Route generation conditions may refer to conditions that, when satisfied, cause the CCS to generate a route for one or more MSDs. Example route generation conditions may include, but are not limited to: 1) receipt of a customer order, 2) receipt of a threshold number of items, 3) request for a route from an MSD, 4) completion of a currently assigned route, and 4) other conditions described herein. In block 7902, the CCS generates one or more routes in response to satisfaction of the route generation conditions. The CCS may generate an MSD route based on a variety of factors described herein.

In block 7904, the CCS sends the generated routes to one or more MSDs. In block 7906, the CCS starts monitoring the routes sent to the MSDs. For example, the CCS may determine the locations of the MSDs and determine which items have been picked by the MSDs. The CCS may also monitor the location and picking by MSDs that do not have assigned routes (e.g., roaming MSDs). The CCS may monitor the MSDs to determine whether it is time to generate/update routes.

In block 7908, the CCS determines whether route update conditions are satisfied for one or more routes. Route update conditions may refer to conditions that, when satisfied, cause the CCS to generate one or more route updates (e.g., route modifications to existing routes). In some cases, the CCS may determine whether route update conditions are satisfied based on monitoring the MSD(s) (e.g., MSD locations and/or items picked). Route update conditions may include other factors, such as receipt of new customer orders.

In block 7910, the CCS generates updates to one or more routes in response to satisfaction of update conditions. If update conditions are not satisfied, the CCS may determine whether route completion conditions (e.g., route ending conditions) are satisfied in block 7912. Route completion conditions may refer to conditions that, when satisfied, indicate that an MSD route has ended, or otherwise is completed. Example route completion conditions for a route may include, but are not limited to, having all items picked in the route, having all zones traversed in the route, and other route completion conditions described herein. In block 7914, the CCS may determine that one or more assigned routes have ended in response to satisfaction of the route completion conditions. After one or more routes are completed, the method may continue in block 7900, where the CCS determines whether to generate one or more new routes. In some cases, the MSD may operate in roaming mode after a route has ended. In other cases, the MSD may be taken offline (e.g., turned off or disconnected from the CCS) or wait for a new route after completion of a route. Although the method of FIG. 79 is illustrated as sequential operations including route generation, monitoring, and updating, the CCS may perform the route generation, monitoring, and updating operations for one or more MSDs in parallel.

Route generation conditions may include conditions associated with receiving a new customer order. For example, the receipt of one or more new customer orders may cause the CCS to generate a new route. In a specific example, each customer order may trigger generation of a single new route. In other cases, a threshold number of customer orders may be required to generate a new route. In some implementations, a route generation condition may indicate that a threshold number of items (e.g., from one or more customer orders) should trigger the generation of a route.

In some implementations, route generation conditions may include conditions associated with activity of the MSD. For example, a route generation condition may be satisfied when a user uses an MSD to indicate that they are picking by turning on the MSD or entering their user credentials (e.g., name/login/employee ID). In some implementations, the MSD may provide a GUI for the user to request a route (e.g., a graphical/manual route request button). In some implementations, the MSD may automatically request a route, such as when the MSD is turned on and/or when the MSD has completed a currently assigned route. For example, completion of an already assigned route (e.g., the picking of items or movement through all zones) can cause another route to be requested by the MSD.

In some implementations, the route generation conditions may include conditions associated with historical/current locations of a user. For example, a route may be generated in response to a user entering, or being near (e.g., within a threshold number of zones), a zone/items associated with an outstanding customer order. In another example, a route may be generated in response to a user moving toward a zone/item associated with an outstanding customer order. In another example, a route may be generated and assigned to an MSD in response to an MSD being located in a specified location, such as a location that indicates that the user is ready to pick a route (e.g., a typical/assigned starting location within the store). In this example, the user may enter the location and have a route assigned automatically.

In some implementations, the route generation conditions may include conditions associated with one or more recently picked items. For example, a route may be generated in response to a user picking one or more items from a current outstanding customer order (e.g., while roaming). In this example, the route may be generated to include items from the customer order. In another example, a route may be generated in response to a user picking items that are near items (e.g., adjacent items) in the customer order. In this example, picking of the items near items in an outstanding customer order (e.g., a newly received order) may cause the CCS to generate a route including items from the outstanding customer order. In another example, if a roaming MSD has picked items that are included in an outstanding customer order, the CCS may generate a route for the MSD to pick remaining items in the customer order (e.g., the complete order).

In some implementations, routes may be generated for a first MSD based on conditions associated with one or more other MSDs. For example, a route may be generated for a first MSD based on the locations of one or more other MSDs. In a specific example, a route generation condition may indicate that a route should be generated for a first MSD when one or more other MSDs are located near a packing zone (e.g., near the end of their routes). As another specific example, a route generation condition may indicate that a route should be generated for a first MSD when one or more other MSDs are already picking their routes, such as when the other MSDs are sufficiently into their routes (e.g., based on the locations/items they have picked).

One or more of any of the route generation conditions, or other conditions, may cause the generation of a route. In some implementations, the route generation conditions described herein may be set by the operator of the OFS. In some implementations, the route generation conditions may also cause an assignment of the generated route. In some implementations, the OFS may also implement separate route assignment conditions, which may include similar/different conditions than the route generation conditions.

Routes can be generated according to a variety of different route generation operations described herein. The route generation operations may generate the routes based on a variety of different route generation factors. Although specific route generation operations/factors are described herein, different route generation operations/factors may be combined in ways not explicitly described herein. In some cases, the CCS and/or MSDs may generate routes using the same route generation operations/factors for each route. In other cases, the CCS and/or MSDs may generate routes using different route generation operations/factors. For example, some routes may be set, while other routes may be generated based on the location of one or more MSDs.

Multiple route generation operations/factors are described herein. In some implementations, routes may be generated based on a single factor (e.g., based on the location of the MSD). In other implementations, routes may be generated based on multiple factors, such as the location of MSDs, the contents of customer orders, the routes assigned to other MSDs, the ability of an MSD to complete a customer order, and other factors. As such, route generation may be a multifactor operation based on any factors described herein. In some implementations, the CCS/MSDs may generate routes using rule-based operations, such as a set of one or more rules to follow when generating a route (e.g., rules indicating which factors to use). In some implementations, the CCS/MSDs may prioritize some factors over other factors (e.g., according to rules). For example, the CCS/MSDs may prioritize the current location of MSDs over the historical location of MSDs when generating routes. In some implementations, the CCS/MSDs may implement a scoring model in which different possible routes for an MSD are scored, and the highest scoring route is assigned (e.g., highest scoring indicates a best route). For example, a scoring module (e.g., in the route generation modules 7108) at the CCS/MSDs may apply different weights and scores to different aspects of a route (e.g., route length, item number, distance from MSD, etc.). In some implementations, the CCS/MSDs may implement a machine learned model for generating routes/scores, where the machine learned model receives different routing factors as inputs. The machine learned model may be trained on historic picking/movement data. In some cases, the CCS can generate multiple possible routes and calculate the optimized route for one or more MSDs before sending out the final routes to the MSDs.

Although routes may be generated based on the location of one or more MSDs, in some implementations, the OFS of the present disclosure may generate routes without knowledge of MSD location. Furthermore, in some implementations, the OFS of the present disclosure may not implement the location-based techniques described herein. As such, some implementations of the OFS may implement techniques described herein without location-based technologies (e.g., location indicators, item adjacency, etc.).

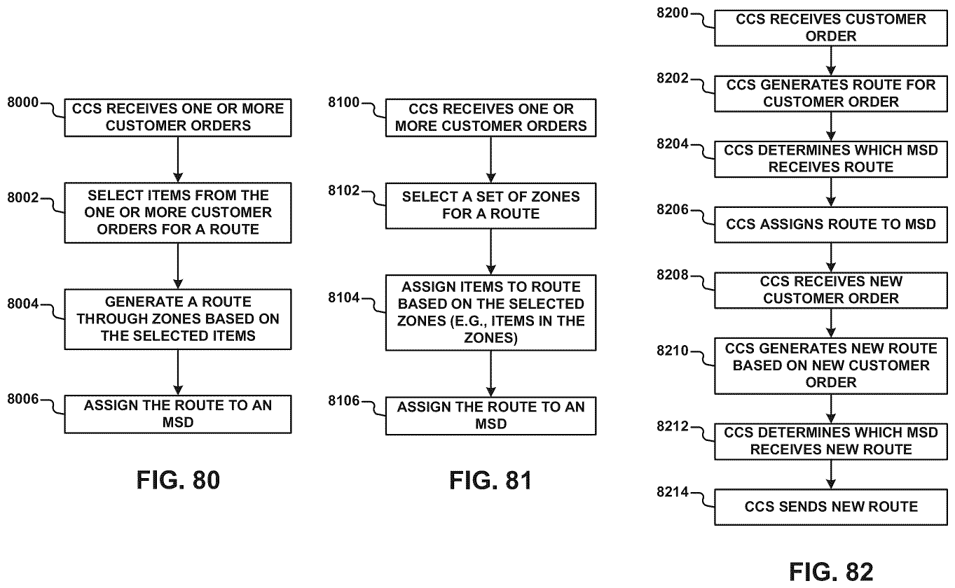

FIG. 80 illustrates an example method for generating a route. The method of FIG. 80 may be referred to as an item-first technique for generating routes. In FIG. 80, the CCS first selects the items to be included in a route (e.g., in one or more customer orders), and then defines locations (e.g., zones and zone sequence) that should be traversed for the user. In some cases, the CCS/MSD generates a list of items for the route (e.g., based on one or more customer orders) and sends the list of items to the MSD without location information, such that the MSD does not use the zone data. For example, the MSD may receive a static list of items that is arranged in a set manner, which may not be modified, unless an update is sent to the MSD and/or the MSD uses item adjacency to arrange the items.

Referring to FIG. 80, in block 8000, the CCS receives one or more customer orders. In block 8002, the CCS selects items from the one or more customer orders for a route. In block 8004, the CCS generates a route through a set of zones based on the selected items. In block 8006, the CCS assigns the route to an MSD. After assigning zones to the route, additional items/zones may be added or removed based on other factors.

FIG. 81 illustrates an example method for generating a route. The method of FIG. 81 may be referred to as a location-first technique for generating routes. In FIG. 81, the CCS first picks the locations (e.g., zones) to be included in a route for the MSD, and then defines the items that should be picked for the route. For example, the CCS may select items for the route that are included in, or near, the selected zones. In the case where location data isn't included in the route, the list of items may just be sent to the MSD as a static list of items, or as a list of items that may be modified/rearranged.

Referring to FIG. 81, in block 8100, the CCS receives one or more customer orders. In block 8102, the CCS selects a set of zones for a route (e.g., one or more zones). For example, the CCS may select a set of zones based on the current location of an MSD, a path for an MSD to the packing zone, and/or based on other MSD locations. In block 8104, the CCS assigns items to a route based on the selected zones. For example, the CCS may select items that are included in the selected zones and/or near the selected zones. In block 8106, the CCS assigns the route to an MSD. Although routes may be generated in an item-first manner or a location-first manner, other route generation techniques described herein may be used.

In some implementations, the CCS may generate routes on a customer order basis. For example, the CCS may be configured to generate a new route for each received customer order. In some implementations, the CCS may be configured to generate updates to one or more assigned routes in response to a newly received customer order. In some cases, the CCS may be configured to wait for an MSD to complete a prior route prior to assigning a new route.

In some implementations, the CCS may assign customer orders to MSDs in a sequence on a per-order basis. For example, the CCS may assign single customer orders to different MSDs (e.g., regardless of item or MSD location). In a specific example, if three customer orders are received and there are three MSDs actively picking items, the CCS may assign one customer order to each device. In some examples, the CCS may assign customer orders to the MSDs according to an assignment sequence that indicates which MSDs are to receive routes before other MSDs.

In some implementations, the CCS may maintain a queue of customer orders and/or routes. For example, if customer orders are received faster than they are fulfilled, customer orders may be placed into a customer order queue. Similarly, if routes are generated faster than routes are completed, then the routes may be placed into a route queue for assignment. In this case, the CCS may store a list of routes and then assign the routes to MSDs (e.g., in an assignment order or other manner).

In some implementations, the CCS may generate and assign routes based on when the customer orders are received. In one example, the CCS may generate a route for each customer order as the customer orders are received. In another example, the CCS may generate a route based on when customer orders are received. For example, the CCS may be configured to generate a route in response to passage of a threshold period of time. In this case, the CCS may generate a single route for a plurality of customer orders if the plurality of customer orders were received within the threshold period of time (e.g., a time window). In some implementations, the CCS may generate and/or assign a route based on when customer orders are due to be picked up by the customer or a delivery driver. For example, the CCS may generate and/or assign a route a period of time prior to the time the customer order is scheduled to be picked up (e.g., an earliest potential pickup time). The period of time may be a set period of time (e.g., an average picking time for a route) or the period of time may be based on the size of the order (e.g., a number of items in the order) or the length of the route (e.g., a number of zones and/or a physical route length).

In some implementations, the CCS may be configured to generate routes based on a number of items. In one example, the CCS may be configured to generate a route when the number of ordered items is greater than a threshold number. In this example, the CCS may generate a route for a single customer order when the single customer order includes greater than a threshold number of items. In another example, the CCS may refrain from generating a route for a customer order that includes less than the threshold number of items. Instead, the CCS may wait to receive one or more additional customer orders, and then generate a route when multiple received customer orders in combination include greater than the threshold number of items. In some implementations, the CCS may refrain from including greater than a maximum number of items in a route in order to limit the total picking burden on a single MSD. Imposing minimum and maximum item counts in a route may help optimize user workload. Similarly, imposing total item picking counts on the MSDs may help optimize user workload.

In some implementations, the CCS may impose timing constraints on route generation. For example, the CCS may be configured to generate a route for customer orders within a period of time (e.g., regardless of item counts). In some implementations, the CCS may be configured to generate and assign routes for customer orders the sequence in which they were received. Forcing the generation of a route based on the age of the customer orders (e.g., regardless of other constraints) may help ensure that customer orders are picked in a timely manner.

In some implementations, the CCS may generate routes based on the number of MSDs. For example, the CCS may split items (e.g., equally) from a single customer order among one or more MSDs if one or more MSDs are not currently picking. The CCS may also split the items of a customer order based on the location of the MSDs. In some implementations, the CCS may split a customer order based on when the order is needed for pickup/delivery. For example, if the order is needed in a short period of time (e.g., immediately for a waiting customer or for an approaching customer to arrive within less than a threshold amount of time), the CCS may split the order among two or more MSDs to increase the rate of picking and decrease customer wait time.

FIG. 82 illustrates an example method that describes assignment of routes to MSDs on a per-customer order basis. In block 8200, the CCS receives a customer order. In block 8202, the CCS generates a route that includes the customer order. In block 8204, the CCS may determine which CCS receives the generated route. For example, the CCS may determine which CCS receives the generated route based on the location of the MSD. In some examples, the CCS may also determine which MSD receives a route based on whether the MSD is currently being used to pick a route. In one specific example, the CCS may choose to assign new routes to MSDs that are not currently picking a route or have the fewest number of routes/items assigned to them. In block 8206, the CCS assigns the route to the selected MSD.

In block 8208, the CCS receives a new customer order. In block 8210, the CCS generates a new route based on the new customer order. In block 8212, the CCS determines which MSD receives the new route. In block 8214, the CCS sends the new route to the selected MSD. For example, if a first MSD received the first route, a second MSD may receive the second route. If only a single MSD is picking, the single MSD may receive both routes and pick them in sequence.

In some implementations, the CCS may include sets of predetermined routes that may be selected and then assigned to the MSDs. A predetermined route may include a sequence of zones through which a user should travel. Additionally, or alternatively, a predetermined route may include a sequence of items that a user should pick, where items in received customer orders are arranged according to the sequence of items. For example, a store may include a sequence of items (e.g., based on adjacency or manually entered) that define how the items in a store are arranged. In one example, the CCS may use item adjacency maps to determine the sequence of items to be picked. In another example, a store may have a defined item sequence (e.g., based on item location in an aisle, aisle arrangement in the store, item type, and other factors) that may be automatically or manually generated. In the case a store includes a sequence of items that defines the layout of the store, items in received customer orders can be mapped to items in the sequence in order to generate a route for the MSD.

Predetermined routes may cover the entire store or portions of the store. As such, the predetermined route may cause a user to traverse the whole store (e.g., all zones) or just one or more portions of the store. In one specific example, a first route may have a user traverse all zones in a certain order, and a second route may have another MSD (or the same MSD) traverse the store in another order, such as an order determined based on factors described herein.

In some implementations, the starting points for the predetermined routes may be set. In some implementations, the stopping points for the predetermined routes may be set (e.g., at the packing zone). For example, a route may include a set starting point (e.g., location/item) and/or a stopping point (e.g., location/item). The route may be predetermined between the start/end points and/or may be modified as described herein.

In some implementations, the predetermined routes may be assigned to the same MSDs/users so that users become accustomed to their routes. In these implementations, the predetermined routes may be generated and/or assigned based on MSD ID and/or user ID. In one example, predetermined routes may be used through one or more store aisles, such as a predetermined sequence of aisles through one or more store departments. In these cases, users may become accustomed to walking the route (e.g., through the same aisles/departments) and picking items on the route. In another example, predetermined routes may be defined at a higher level, such as through predetermined sequences of store departments. In these cases, users may become accustomed to walking through the same departments while picking. One or more MSDs can use predetermined routes, dynamic routes (e.g., generated in any manner described herein), and/or roam at any time or at different times.

In some implementations, the CCS may receive one or more customer orders and generate a plurality of routes in sequence, where later routes may be generated based on previously generated routes. For example, the CCS may initially generate a first route based on the one or more customer orders. The CCS may then generate a second route based on the one or more customer orders and the previously generated first route. The CCS may also generate additional routes based on the one or more customer orders and one or more previously generated routes.

The CCS may generate subsequent routes based on the items included in previous routes. For example, the CCS may be configured to filter out items (e.g., not assign items) in subsequent routes that have been assigned in previous routes. Although already assigned items may be removed from subsequent routes, in some implementations, the CCS may assign the same item(s) to subsequent routes. For example, the CCS may assign the same item(s) a threshold number of times (e.g., to ensure reliable picking of the item(s)). Picking of the item(s) by one user may remove the items from the other routes (e.g., remove the items from the MSD displays). In some implementations, the CCS may update an existing route by incrementing items already on the route, instead of, or in addition to, assigning the items to another.

The CCS may generate subsequent routes based on the locations (e.g., zones) included in previous routes. For example, the CCS may be configured to filter out locations (e.g., not assign zones) in subsequent routes that have been assigned in previous routes. Although already assigned locations (e.g., zones) may be removed from subsequent routes, in some implementations, the CCS may assign the same location(s) to subsequent routes. For example, the CCS may assign the same location(s) a threshold number of times. Assigning different zones to different routes may help ensure that users do not overlap in the same locations. In some implementations, the CCS may assign zones to a route that are not currently assigned. For example, if some zones are not included on previous routes, the CCS may prioritize the generation of a route that includes the zones that are not included on previous routes.

The CCS may generate two sequential routes for a single user in a manner that places a subsequent route starting point at, or near (e.g., within a threshold number of locations and/or distance), the previous route stopping point. In a sense, the subsequent route is “tacked on” to the previous route. In some implementations, the CCS may generate the subsequent route while the user is picking the previous route. For example, the CCS may determine that a subsequent route may be started at the stopping point of the user's previous route, then assign the subsequent route to the user. In some cases, the subsequent route may have been generated independently of the user's previous route, location, and/or items picked. Although the route may have been generated independently of such considerations, in these cases, the CCS may assign the route based on the current location or stopping location of the user, since a tacked-on route may provide an efficient picking path for the user. In other cases, the CCS may generate the subsequent route while the user is picking by using knowledge of the user's stopping point on the route. In these cases, the subsequent route may be tailored to the previous route, and may therefore be optimized for the particular user. The sequential routes may each include single customer orders, or may include items mixed from multiple customer orders. In some cases, the second route may be generated and/or assigned subject to various constraints, such as a total number of items (e.g., maintain less than a maximum number of items in the combined routes) and/or a total length of the route (e.g., maintain less than a maximum number of zones and/or distance in the combined routes).

In some cases where the CCS assigns sequential routes to an MSD, the MSD may store the routes locally and load a new route after completion of a previous route. In these cases, the CCS may not be required to monitor an MSD to determine when to assign a route. As such, handling of the routes may be up to the MSD after assignment by the CCS. Local storage and handling of routes by the MSD may remove some burden from the CCS associated with monitoring one or more MSDs. In some implementations, the MSD may notify the user in a GUI that another route has been received and/or appended to the current route.

The CCS may generate routes based on the current location of one or more MSDs. For example, the CCS may generate a route for an MSD based on the location of ordered items relative to an MSD at the time of route creation. The CCS may then generate an additional route based on the location of another MSD relative to other items (e.g., remaining items). For example, the CCS may generate the additional route based on a number of items near the MSD, the distance of the items from the MSD, and/or the priority level of the items (e.g., priority items may be assigned without regard to location). The CCS may generate one or more additional routes for one or more additional MSDs in this manner.

In some implementations, the CCS may generate a first route for an MSD that includes items close to the MSD (e.g., within a threshold number of zones and/or distance). The CCS may then add items to the first route that lead the MSD to a specific location, such as a last item to be picked and/or the packing zone. The CCS may then generate additional routes to pick the remaining items. In these implementations, the initial selected item(s) may act as seeding items that define a starting point for the route.

In some implementations, the CCS may generate a first route for an MSD that includes a complete customer order. For example, the CCS may generate the first route for an MSD that can most easily pick the customer order. In a specific example, the CCS may generate the first route for an MSD that can pick the customer order by traversing the shortest distance (e.g., fewest zones) before reaching the packing zone. In another specific example, the CCS may generate the first route for an MSD in response to an MSD being within a threshold distance (e.g., number of zones and/or physical distance) of picking an entire customer order.

In some implementations, the CCS may generate a route for an MSD based on the location of the MSD relative to other locations (e.g., zones) within the store. For example, the CCS may generate a route for an MSD based on the locations (e.g., zones) associated with ordered items relative to the location of an MSD at the time of route creation. For example, the CCS may generate a first route for an MSD that includes zones close to the MSD (e.g., zones that seed route creation). The CCS may then add zones to the route that lead the MSD to a specific location, such as a final zone (e.g., the packing zone). The CCS may then generate additional routes to pick the remaining items.

In some implementations, the CCS may generate portions of a route and/or update a route based on the location of items relative to a partially calculated routed and/or an already calculated route. For example, if the CCS has already generated a route, the CCS may add on items and/or locations (e.g., zones) to the route based on the proximity of the items/locations to be added to the route. In a specific example, the CCS may add items to a route that are included in zones that are already part of the route. In another specific example, the CCS may add items to an already created route that are near the already created route (e.g., in adjacent zones or nearby zones within less than a threshold distance).

As described herein, MSDs may operate according to a route or operate in a roaming mode. In some cases, the CCS may generate a route for a user that includes a group of nearby items. For example, based on the user's location, the CCS can generate a route that includes items near the user's location. After picking according to the route, the MSD may enter into a roaming mode. In some implementations, the CCS may generate a route that includes an entire customer order near the user's location (e.g., within a threshold number of zones). In some implementations, the user's location near items and/or complete customer orders may trigger the generation and assignment of the route by the CCS. Such a short burst of items may be assigned as a new route to a roaming MSD and/or assigned as an update to an existing route.

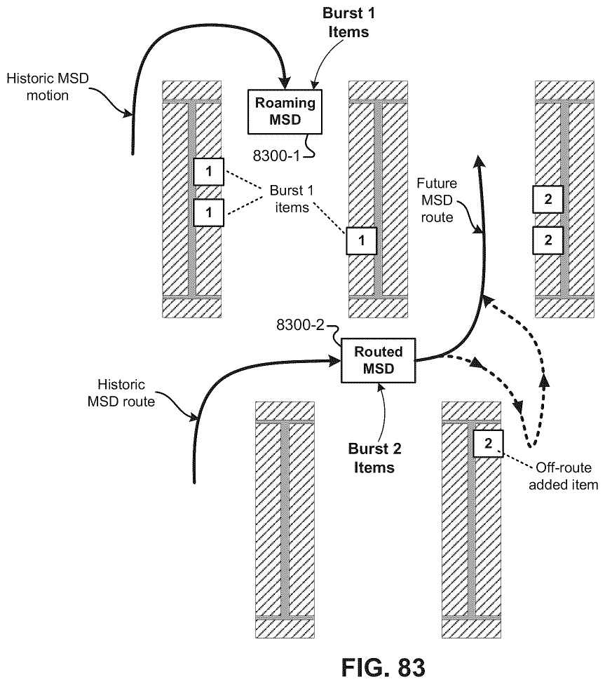

FIG. 83 illustrates an example store that includes two MSDs 8300-1, 8300-2. One MSD 8300-1 is a roaming MSD. The other MSD 8300-2 is picking according to a route. A historic location/motion of the roaming MSD 8300-1 is illustrated. The historic/future portions of the routed MSD are also illustrated. In FIG. 83, the roaming MSD 8300-1 receives a set of items (e.g., a “burst” of items) that the CCS assigned to the roaming MSD 8300-1. The CCS may have assigned the burst of items to the roaming MSD 8300-1 based on the current and/or historic location of the roaming MSD. For example, the CCS may have determined the current location of the roaming MSD and decided to send the burst of items to the roaming MSD based on the proximity of the items to the roaming MSD. As another example, the CCS may have determined the trajectory (e.g., predicted future path) of the roaming MSD based on the current/historic location of the MSD, and then assigned the items to the roaming MSD based on the future path of the roaming MSD. In FIG. 83, the CCS may have purposefully refrained from assigning items in the historic path of the roaming MSD.

In FIG. 83, the routed MSD 8300-2 has picked from the historic route and is currently working toward finishing the future route. While picking the route, the CCS adds a burst of items (Burst 2 items) to the route. For example, the CCS may assign the burst of items based on the historic/current location of the MSD 8300-2 and/or the assumed future location of the routed MSD 8300-2 according to the current route. Two items are added which are on the current route. Additionally, one item is added that is off the route. The CCS may have added the off-route item to the updated route due to the current location of the MSD and/or the proximity of the off-route item to the currently assigned route. The broken line indicates how the routed MSD may be diverted based on the newly generated route. In some cases, the CCS may refrain from adding items that have already been passed on the route (e.g., as determined based on the historical picking/movement of the routed MSD). Adding small local bursts of items to roaming and/or routed MSDs may allow small orders to be completed in as little time as possible.

FIGS. 84A-84B illustrate a scenario in which additional items are added to a route (e.g., from another customer order). FIG. 84A illustrates the example route 1 described with respect to FIG. 77D. In FIG. 84A however, the CCS has assigned three new items to the MSD 7708. The three new items are from another customer order. For example, the items may be part of a small customer order (e.g., customer order A) including only three items (e.g., item A, item B, and another item in Location 3). Although the three items may be the complete additional customer order, in other cases, the items may be just a part of a new customer order. In some cases, the items may be items from multiple new customer orders.

The new items from the new customer order may be added to the route at a variety of times. In some cases, the new items may have been added after the route was generated, but before the route was assigned to the MSD 7708. In some cases, the new items may have been added after route 1 was generated and assigned to the MSD, as is the case in FIGS. 84A-84B. In FIGS. 84A-84B, the new items were assigned to the route prior to the user picking the items on the route (e.g., since items 1-5 are still in the list). In some cases, the CCS may be configured to assign items to the route after the user has begun picking items from the route.

The GUI 8400 may insert the received items into the assigned route. For example, the GUI 8400 may insert the received new items into the route based on the location of the items relative to the MSD 7708 and/or other items, as described herein. In FIGS. 84A-84B, two new items are located in Location 1. For example, new items A and B are located near items 3-4 and 5. In FIG. 84B, the new items are inserted into the list in a corresponding manner relative to items 3, 4, and 5. For example, the items are arranged based on their distance from the MSD 7708. In FIG. 84B, a third new item is not illustrated, as it is collapsed into the Location 3 tab. Note that the location tabs indicate the number of newly added items (e.g., as underlined numbers). For example, the location tabs indicate the number of newly added items separately from the number of items on the original route.

Although the new items may be inserted into an existing list, in other implementations (not illustrated in FIG. 84B), the new items may be added to the GUI in other manners. For example, the new items may be added as a separate list under the original list, such as in the area under Location 4 in FIG. 84B. Similarly, if two sequential routes are assigned to an MSD, the GUI may include the two routes sequentially on the display, such that the first route is located above the second route.

The new items may be rendered in a manner that differentiates the new items from the original items. For example, the new items may include additional text, modified text (e.g., font, size, color, etc.), and/or modified graphical elements (e.g., color, shading, etc.). In FIG. 84B, the new item GUI elements include additional text that indicates that the items are from new “Order A,” whereas the original items do not include an order designation. If new items were included from additional new orders, the items may include additional different order designations (e.g., Order B, Order C, etc.). The new items in the list are also rendered in a manner that is different than the original items. For example, the new items in FIG. 84B are shaded in the list to indicate that the items are newly added from a new order. Different shading and/or coloring may be used to indicate additional items from additional new orders after Order A, if such new orders are placed.

In some implementations, the CCS may generate a route and/or update a route based on whether an MSD has items that have completed an order. For example, if a user has picked items that complete a customer order, the CCS may generate a route that leads the user to a packing zone. In one example, the route may lead the user directly to a packing zone without picking additional items. In another example, the route may include items to be picked before the user enters the packing zone. In some implementations, the MSD may be configured to indicate to the user that they should return to the packing zone because they have items that complete an order. For example, the MSD GUI may indicate that they have completed an order by showing text/graphics to the user (e.g., “Order 1 is completed, return to packing zone.”). In some implementations, the CCS may assign items to the MSD that can be picked on the way back to the packing area after completion of the route. For example, the CCS may assign items included in locations (e.g., zones) that the user will traverse on the way back to the packing area with a completed order. The MSD may assign the items/zones in this case: 1) at the same time the items from the completed order were assigned, 2) while the items from the completed order were being picked, 3) in response to near completion of the order (e.g., within a threshold number of items and/or route distance remaining), or 4) in response to completion of the order.

In some implementations, the CCS may generate a route based on the ability of a user to finish a customer order. For example, the CCS may generate a route that picks items that complete a customer order. In these implementations, the CCS may generate the route when a customer order is nearly completed, such as when less than a threshold number of items are to be picked for a completed customer order. In another example, the CCS may generate the route when the customer order has been out for picking greater than a threshold period of time (e.g., the customer order is a threshold age and/or the customer has been waiting for a threshold amount of time). In one example, the CCS may assign the items of the customer order to an MSD in response to a customer order having been out for picking for greater than a threshold amount of time. In this example, the CCS may also remove the newly assigned items from other MSDs to focus a single picker on the order. Alternatively, the CCS may assign the same items to multiple MSDs to assure that the items are picked as quickly as possible. In some cases, the route for completing a customer order may be generated to lead a user to the packing zone (e.g., via a minimum distance). In some implementations, the presence of items that will complete a customer order (e.g., remaining items or an entire order) may trigger generation and assignment of the items to an MSD. For example, if the items that complete a customer order are near an MSD (e.g., within a threshold number of zones and/or physical distance) or near the MSD route (e.g., within the route or within a threshold distance), the CCS may be triggered to generate and assign the items to the MSD.

In some implementations, the CCS may generate one or more routes based on the current locations and/or future locations of the MSDs relative to one another. For example, the CCS may generate customer routes that diverge from one another. For example, the CCS may generate routes that cause users to separate from one another during picking and/or end at different locations apart from one another. Causing the users to diverge may provide better coverage over the store and more efficient picking in the case additional items are ordered while the users are picking according to the routes. In some implementations, routes for close MSDs (e.g., adjacent MSDs) may be generated to separate the close MSDs by a threshold distance (e.g., a threshold number of zones). In some implementations, the CCS may attempt to maintain a threshold distance between the users during picking and at the end of picking (e.g., a threshold number of zones).

In some implementations, zones may be associated with zone size values that indicate the relative sizes of the zones. In these implementations, the CCS may consider the number of zones traversed in a route and/or the size of the zones being traversed in a route. The inclusion of zone numbers into route calculations may provide data that may be used to generate routes that are optimized based on the distance to be traveled in the route. The zone size may be manually and/or automatically calculated. For example, users may enter the size of the zones manually. As another example, the size of the zones may be determined based on any location technology described herein, such as GPS, WiFi, time to traverse a zone, etc.

In some implementations, the CCS may generate one or more routes that are configured to traverse users through busier locations within the store. For example, the CCS may be configured to take into account the number of items typically picked within locations of the store, determine the locations associated with commonly picked items, and generate routes that traverse locations near the commonly picked items. Commonly picked items may be determined based on the rate at which the items have been ordered/picked (e.g., per hour/day). The commonly picked items may be defined with respect to days of the week (e.g., common weekend items), hours of the day (e.g., common morning/evening items), etc.

In some implementations, the CCS may generate one or more routes based on the amount of customer traffic in the store and/or other traffic in the store (e.g., employee foot traffic and/or vehicle traffic). For example, the CCS may be configured to generate routes that do not pass through currently/historically busier portions of the store. In some implementations, the CCS may determine the amount of traffic in the store based on image analysis of current/historical camera footage of the locations. In other implementations, the CCS may estimate the current/historical traffic in a location based on the number of items purchased/picked in the locations (e.g., items picked by employees and/or customers). In some implementations, the CCS may be configured to minimize a number of total pickers in a busy location in order to minimize crowding. For example, the CCS may assign more items in a busy location (e.g., all currently ordered items in the location) to a single MSD to prevent crowding of the location by employee and/or third-party pickers.

In some implementations, the CCS may generate a route and/or assign an already generated route in response to an MSD entering a location. For example, the location of an MSD may trigger generation of a route, where the route may be based on any of the factors described herein. In one example, an MSD may trigger the generation of a route when the MSD moves near a group of items (e.g., a threshold number of ordered items). In another example, an MSD may trigger generation of a route when the MSD moves to a starting location, such as entering a specified starting location. A specified starting location may be a location where pickers are instructed to move in order to start picking, such as an entry point to a store for a picker/customer or a location near the packing area where pickers leave after dropping off items. In a case where the picking device is a store-owned picking device or customer device, the route can be generated upon entry to the store.

In some implementations, the CCS may generate a route and then wait to assign the route based on the location of an MSD. For example, the CCS may generate a route including one or more customer orders and then send the route to an MSD when the MSD passes a specified location associated with the generated route. In one example, the CCS may generate a route for a group of items that are near one another (e.g., within a threshold number of zones), and then wait to assign the route as a new route or a route update to an MSD when the MSD enters a location near the group of items. Generating and/or assigning routes in response to the location of an MSD may help ensure efficient routing of the MSDs based on the location of the MSDs.

In some implementations, the CCS may be configured to generate a route and/or assign a route based on the location of the customer (or third party picker) relative to the store (e.g., a geolocation relative to the store). For example, the CCS may generate a route for the customer order and/or assign a generated route to one or more MSDs when the customer is on the way to pick up the order or when the customer has arrived to pick up the order. In some implementations, the CCS may trigger route generation/assignment when the customer is within a threshold distance and/or time from arriving at the store. The location of the customer may be automatically acquired (e.g., via a shopping application for the store) or be manually indicated by the customer (e.g., using a shopping application for the store, text message, and/or phone call). In some implementations, the CCS may generate/assign a route for a customer order based on a time the order should be packed and/or delivered. For example, the CCS may generate/assign a route for a customer order a threshold amount of time before the order is scheduled to be picked and/or delivered.

In some implementations, the CCS may estimate a picking time for picking a customer order and/or an entire route. For example, the CCS may estimate the picking time based on the number of items in the order, the location of the items (e.g., distance between items), the location of one or more MSDs that are picking the route, and/or the historical picking speed of the one or more users picking the route(s). In some implementations, time to completion may be determined based on the time that elapsed for picking the same/similar route in the past (e.g., by the same user in some cases). Based on the estimated picking time, the CCS may also estimate when a customer order and/or route will be finished for pick up or delivery.

In some implementations, the CCS may take into account the number of items that should be included in a route when generating a route. For example, in some implementations, the CCS may attempt to assign a number of items that are greater than a threshold minimum number of items in order to prevent routing a user through a store without picking items along the route. In some implementations, the CCS may attempt to assign less than a maximum threshold number of items to prevent a route from being too time consuming to pick (e.g., greater than a threshold estimated time) and/or requiring too much space for the picked items in the user's cart.

In some implementations, the CCS may be configured to calculate routes according to a hierarchy of operations. For example, the CCS may be configured to generate routes by customer order initially. Then, the CCS may be configured to generate/update routes by adding items to existing routes (e.g., if there are no MSDs without routes), as adding items to existing routes may be more efficient than starting completely new routes.

As described herein, items and/or complete customer orders may be merged with existing routes, such as routes that have been generated and assigned to an MSD. The items and/or complete customer order may be merged with the routes prior to the start of picking and/or after picking has commenced on the route(s). In some implementations, if newly ordered items are already part of one or more routes, then the CCS may add the newly ordered items by incrementing the items on the route (e.g., on the MSD display). In some implementations, if newly ordered items are included in locations on current routes, the CCS may add the newly ordered items to the current routes. In some implementations, if newly ordered items are included in locations that are near locations on current routes (e.g., within a threshold number of zones and/or distance), the CCS may add the newly ordered items to the current routes.

In some cases, the CCS/MSD may be configured to merge a complete customer order with an existing route. In some implementations, the new order may be merged based on the number of items in common. For example, the CCS/MSD may merge an order with a route that has the most items in common with the new order. In some implementations, the new order may be merged based on the number of locations in common. For example, the CCS/MSD may merge an order with a route that has the most locations in common. In some implementations, the CCS/MSD may merge an order with a route if the route is diverted less than a threshold amount (e.g., less than a threshold distance or number of zones) by the addition of the order.

In some implementations, the CCS/MSD may be configured to merge a complete order with an existing route based on the minimal amount of deviation that will be caused to an existing route when picking the order. The amount of deviation may be calculated based on the total distance (e.g., number of zones or actual distance) of the route after merging, a number of additional zones to be traversed, or other factors described herein. Any items from one or more orders may be assigned in a similar manner with respect to minimizing deviation. Similarly, any routing decision may be based on such optimizations. For example, any route may be created based on an attempt to minimize user movement, while at the same time maximizing the number of items picked. Such optimizations may also be subject to constraints described herein, such as item maximums, location traversal maximums, and other constraints, filters, and/or optimizations described herein.

Example optimization techniques may include assigning items to an MSD based on the location of the items. For example, the CCS may assign items from different orders in a single zone to a single MSD to minimize movement of the MSD. In some cases, the CCS can assign a first customer order to an MSD and then assign subsequent items that are located in the same/close locations as the items of the first order. In some implementations, the CCS can generate a global routing plan based on the locations of one or more MSDs. For example, the CCS can generate a global routing plan that minimizes the amount of time/movement (e.g., minimize traversed zones) for picking the ordered items by a plurality of MSDs. Additionally, the CCS may generate a global routing plan that attempts to maximize the rate at which items are picked. In some implementations, the CCS can generate a route and/or a global routing plan without regards to the current location of the one or more MSDs.

After sending one or more routes to the MSDs, the CCS may monitor the users' picking and movement progress. For example, with respect to picking, the CCS may be notified by the MSDs as each item is scanned by the MSDs, as described herein. As another example, with respect to a user's movement, the MSDs may notify the CCS of their location and/or the CCS may determine MSD locations using the techniques described herein.

Although the CCS may monitor a user's location and movement progress, in some cases, the CCS may assign one or more routes and not continuously monitor user movement and picking progress. In these cases, the MSDs may store the routes locally. Local storage and handling of routes by the MSD may remove some burden from the CCS associated with monitoring one or more MSDs. In these implementations, the CCS may assign routes without monitoring one or more MSDs and/or the MSDs may notify the CCS when the routes are completed, at which time the CCS may make routing decisions.

The CCS may make routing decisions based on the monitored picking/movement of one or more MSDs, as well as other factors described herein. For example, the CCS may update routes based on the monitoring. A route update may be an update/modification to one or more routes that one or more MSDs are currently using or may be assigned. The updates may modify (e.g., add/subtract) the items and/or locations in the current routes.

In some implementations, the CCS may modify (e.g., update) the items assigned to routes based on the monitoring. For example, the CCS may add new items and/or remove items from the routes based on any factors described herein in response to monitoring the users' location and/or picking. In some implementations, the CCS may modify the locations included in routes and/or the order through which a user should traverse the locations based on the monitoring. For example, the CCS may add new locations, remove locations, and/or change the sequence of locations included in the routes in response to the users' locations and/or picking. In some implementations, the CCS may modify the items assigned to users and also modify the locations.

In some implementations, the CCS may cancel one or more routes based on the monitoring. For example, the CCS may cancel one or more routes based on the picking and/or movement of one or more users. Route cancellation may result in the items being removed from the user's MSD and assigned to other users (e.g., as a route). Route cancellation may also cause the MSD to enter a free roaming mode, without removing items from the MSD. Entry into roaming mode may cause rearrangement of items on the display. In some implementations, the CCS may generate one or more new routes based on the monitoring. For example, the CCS may generate one or more new routes and assign the new routes to one or more users, such as a new user MSD (e.g., without a current route). The new route may also be assigned to users with a current route, such that the route replaces a current route or is a route that is started after their current route ends.

In some implementations, the CCS may make routing decisions based on newly received customer orders. For example, the CCS may update routes, cancel routes, and/or generate new routes based on a newly received customer order. In some implementations, the CCS may update routes, cancel routes, and/or generate new routes based on a combination of newly received orders along with users' picking and/or movement. Newly received orders may include new items. The new items may be added to existing routes, which may be done by incrementing an item count if someone has ordered the same item. In some implementations, a customer may cancel an order after a route is assigned (e.g., before or during picking). In this case, the canceled items may be removed from the routes (e.g., items removed from the MSD). In some implementations, receipt of a new customer order or new items may cause generation of a route that may pick existing items (e.g., items already assigned to an existing route) in a more efficient fashion. For example, if a new customer order is assigned to a new route that includes other items/locations in already existing routes, or items being picked by roaming MSDs, some items may be removed from the existing routes and assigned to the new route.

In some cases, a customer may make a modification (e.g., addition/subtraction) to their order. For example, the customer may make a modification after a route is generated for their order. The modification may be made after generation of the route, but prior to picking the first item. The modification may also be made after the user has picked some items from the route. The CCS/MSDs may modify one or more routes based on the customer modification. For example, the CCS/MSDs may update routes as described herein, such as by adding items to a route, subtracting items from a route, and/or generating one or more new routes. In some cases, if a customer orders an item and then cancels, the item may still be picked on a route. The picked item can then be used for another customer order that is currently being picked (e.g., the same item from another customer order). In this case, the item may remain on one or more routes. In some cases, the CCS/MSD may instruct the user that the picked item was canceled and should be placed in the packing zone for later use (e.g., in a designated area or tub). In some cases, the CCS/MSD may generate such an indication if the CCS/MSD predicts that the item will be picked soon, such as when the item is currently in a customer's pending list (e.g., for pickup at a later time). The CCS/MSD may also generate such an indication if the item is commonly picked (e.g., based on a number of times the item is picked within a period of time).

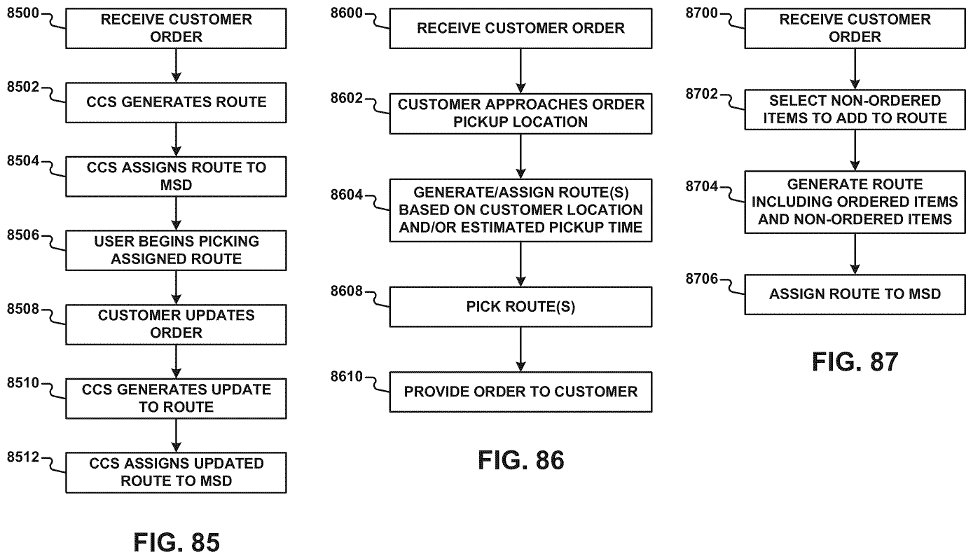

FIG. 85 illustrates an example method for updating routes based on customer modifications to a customer order while the order is being picked. In block 8500, the CCS receives a customer order. In blocks 8502-8504, the CCS generates a route for the customer order and assigns the route to an MSD. Although the CCS may generate/update a single route for an MSD based on the customer order in the method of FIG. 85, in other implementations the CCS may generate/update one or more routes for one or more MSDs based on the customer order.

In block 8506, the user begins picking items from the assigned route. While picking items from the assigned route, the customer updates the customer order in block 8508. For example, the customer may add and/or remove items from the customer order while the user is picking the assigned route. In blocks 8510-8512, the CCS generates an update to the route based on the updates to the customer order and assigns the updated route to the MSD. Example updates may include addition and/or removal of items. For example, if the customer adds items to the customer order, the CCS may add the new items to the route. Although a store employee or third party picker may receive an updated route based on a customer order modification in the method of FIG. 85, in some cases, a customer may modify their own route that they are picking. For example, a customer may add/subtract items from their own route, which may cause modifications to the route. As another example, a first customer may modify their shopping list while another customer (e.g., a spouse, family member, friend, etc.) is picking the route.

The CCS may handle an added item in a variety of ways. In some implementations, the CCS may assign the added item to the picker that is picking the original route. For example, the CCS may assign the added item to the same picker if the newly added item is on the route, such as when the added item is an incremented item addition (e.g., an additional item that was previously ordered). As another example, the CCS may assign the added item to the same picker if the new item is in/near future locations (e.g., zones) on the route. In the case that the item is not in/near future locations on the same picker's route, the CCS may assign the new item to another picker's route, such as another picker that is currently near the new item or will be near the new item on their current route.

As another example, if the customer removes items from the customer order, the CCS may remove the items from the route if the picker has not yet picked the items. The CCS may handle removal of already picked items from a customer order in a variety of ways. In some implementations, the CCS may notify the picker via an MSD GUI that one or more picked items have been removed from a customer order. For example, the MSD GUI may generate a GUI message indicating the removed item is no longer needed for the customer order. In some cases, the MSD GUI may provide further instructions, such as instructing the user to replace the item back in its original location from where it was picked, or place the item in a different location, such as a location dedicated to picked items that are not needed (e.g., a location in the packing area). In some cases, a packer may handle the removed item by removing the item from the customer order during packing. In some cases, a packer MSD GUI may instruct the packer to remove the item.

A variety of example route modification/update triggers are now described. In some implementations, picking of an item may trigger a route modification. For example, one user may pick an item that is on another user's route. This may happen in a case where one picker is roaming and ends up picking items on another route. In this case, the item may be removed from the original pickers route. Additionally, or alternatively, the route (or part of the route) including the item may be assigned to the roaming picker. In some implementations, user movement may trigger an update. For example, if a user deviates from a route (e.g., for a threshold amount of time and/or distance), a route modification for the user (or other user) may be triggered. For example, items near the deviating MSD may be reassigned in a new route to the deviating MSD. Locations/items from which the user deviated may be assigned to another user on a new route.

In some implementations, the MSD may generate a GUI that notifies the user that they are off route and the items are being reassigned. The MSD may also generate a GUI that notifies a user that they have picked an item that is not on their route. The user may interact with the GUI (e.g., GUI buttons) to confirm that they are off the route and/or they have picked an item that is not on their route. For example, the user may indicate that they know they are off the route and plan on returning to the route. The user may move off their route for any number of reasons (e.g., to help a customer or clean a spill). In another example, the user may pick an item that is off their route intentionally. For example, the user may pick an item they know is needed (e.g., based on a verbal request by another user/customer), but has not been entered into the CCS (e.g., by a customer or other party). The user may confirm in the GUI that they are intentionally picking and scanning the item that is not on their route.

In some implementations, the CCS/MSDs may modify/generate/cancel routes in response to time-based triggers. For example, the CCS/MSDs may modify routes at certain times, such as periodically, or after a period of time after a previous assignment. In some implementations, the CCS/MSDs may cancel a route that has been assigned if the route has not been started and/or completed by a threshold period of time after assignment. In some implementations, the CCS can modify a route if a user is not responsive, as indicated by a lack in picking, a lack in movement, and/or incorrect movement according to a route (e.g., deviation).

In some implementations, completion of a route may trigger generation of a new route and/or modification of other routes. For example, the CCS/MSDs may generate a new route after a user has finished picking the last item in a current route, or otherwise indicated that a route is complete (e.g., based on a manual entry in a GUI). In some implementations, the CCS/MSDs may generate a new route and/or modify other routes after the completion of a route. For example, items/locations in previous routes may be assigned to an MSD that has just finished the route, thereby redistributing the work among a plurality of pickers to increase efficiency. Any of the updates/modifications/cancellations described herein can be based on one or more MSDs movements and/or pickings. Any of the updates/modification/cancellations can be modifications to one or more routes that are sent to one or more MSDs.

In some implementations, the OFS may be configured to automatically assign routes to users and/or update/cancel routes. For example, the user may not have an input as to whether a route is assigned to them (e.g., their MSD) and/or which route is assigned to them. In some implementations, the user may have input as to whether a route is assigned to them and/or which route is assigned to them. For example, the CCS may send a suggested route to an MSD and the user can be prompted to accept or decline the route in the MSD GUI. In this example, the MSD may generate a GUI that includes a notification that a route is being suggested for the user. The MSD may also display the route path and/or items on the route in the GUI in some implementations. The GUI may receive input from the user, such as touch input indicating whether a route is accepted or denied. The GUI may also display multiple suggested routes to the user and allow the user to accept/deny one or more of the routes (e.g., via a touchscreen selection). The CCS/MSDs may also suggest modifications/cancellations of routes to the users in some cases.

In some implementations, the CCS may be configured to reassign items from existing routes in order to minimize picking time. For example, in order to minimize time for picking a customer order, the CCS may reassign items from the customer order to one or more other MSD routes. The reassignment may be based on any of the factors described herein. In one example, the CCS may be configured to split a single customer order to multiple routes to minimize picking time. For example, if picking time is a priority, the CCS may split items from a single customer order into two or more routes to different MSDs so that the MSDs can pick the same order together. In some cases, the CCS may split the order prior to assigning the routes. In other cases, the CCS may split a customer order while the order is already being picked.

The CCS/MSDs may end a route for a variety of reasons. In some implementations, the CCS/MSDs may end a route when all of the locations in the route have been traversed. In some implementations, the CCS/MSDs may end a route when all the items have been picked in the route. In some implementations, the CCS/MSDs may end a route when all the items have been picked and all the zones are traversed in the route. In some implementations, the CCS/MSDs may end a route when the user enters a specific location, such as moving into a packing zone. In some implementations, ending a route may cause remaining items to be passed on to other MSDs (e.g., in routes and/or roaming).

The route cancellation can be manual or automatic. For example, the MSD may automatically determine that a route has ended for any of the reasons descried herein. In some implementations, the user may be prompted by the MSD GUI to confirm that the route has ended. In other implementations, the user may be required to manually indicate that the route has ended (e.g., without prompting). In some implementations, the CCS may cancel a route in response to a customer cancelling a customer order for the route. Similarly, the CCS may modify a route in response to a customer modifying a customer order (e.g., adding/removing items) for the route.

In some implementations, the MSD GUI may provide a user with an interface element (e.g., a selection button) to indicate that they are stopping the route. The user may interact with the interface element (e.g., touch/click the button) to indicate to the CCS/MSDs that they are done picking the route. Any remaining items may be reassigned to other MSDs.

The CCS may generate a route for customer items at any time. In some implementations, the CCS may generate a route in response to receiving the customer order, such as when the customer order is placed and the customer is charged (e.g., a customer credit card is charged). In some implementations, the CCS may generate a route that includes items that are part of a customer order that has not yet been finalized (e.g., submitted and/or paid for), such as when the customer is adding items to a shopping cart on a store web/application. Similarly, the CCS may generate a route that includes items that are part of a customer order that is stored at the CCS and not yet finalized. In some implementations, the CCS may generate a route in response to a customer indicating that they will be picking up the order (e.g., an indication by an application). In some implementations, the CCS may generate a route in response to a customer arriving at the store. The CCS may assign the generated route for picking any time after generation. For example, the CCS may assign a generated route in response to any of the following occurrences: 1) a customer placing a final order, 2) a customer adding items to a shopping cart, 3) a customer indicating that they will be picking up the order, and 4) a customer arriving at the store to pick up the placed order. In some implementations, a customer shopping application may provide the customer with a GUI in which the customer may explicitly request that the customer order be picked. In some cases, the customer may request that an order be picked when they arrive at the store and plan on picking up the order after performing other tasks, such as picking their own fruit/vegetables or other items a customer may want to pick for themselves.

FIG. 86 illustrates an example method for generating and/or assigning routes based on the location of a customer and/or an estimated time of arrival for a customer. In block 8600, the CCS receives a customer order. In block 8602, the customer approaches the order pickup location at the store. In block 8604, the CCS may generate one or more routes including items from the customer order based on the customer location and/or an estimated pickup time for the order. In block 8604, the CCS may also assign the generated route(s) based on the customer location and/or the estimated pickup time for the order. In block 8606, one or more MSDs may pick the assigned route(s). In block 8608, the customer order is provided to the customer.

In block 8604, the route generation and/or assignment may be triggered in response to the customer location and/or estimated pickup time. In some implementations, the CCS may determine the customer location via a shopping application used by the customer to place the order. The CCS may be configured to trigger generation and/or assignment of a route in response to a variety of conditions described herein. In one example, if the customer places a customer order from their home address (or other location), the CCS may generate/assign a route in response to the customer leaving their home address (e.g., as specified in the application), or the other location, and/or traveling to the store to pick up the order. In another example, the CCS may generate/assign a route in response to customer arrival at the store from another location (e.g., home). In another example, if the customer places the customer order while at the store, the CCS may generate/assign the route in response to the customer being present in the store while placing the customer order. Such a scenario may allow the customer to shop at the store, or in a location near the store (e.g., another nearby store), and decide to pick up some items after they are finished shopping in the store for other items, such as produce or other items they would like to personally handle. In some implementations, the CCS may generate/assign a route in response to a customer making a request in the shopping application GUI. For example, using the shopping application, a customer may select (e.g., touch/click) a GUI element that requests that the order be picked and presented to the customer. The customer may interact with the shopping application to indicate that they will be arriving at the store according to any of the above scenarios described with respect to block 8604.

In some implementations, the CCS may determine an estimated pickup time for a customer order. For example, the CCS may determine an estimated pickup time based on a current customer location relative to the store. In this example, the CCS may estimate the customer time of arrival using server-side or client mapping/driving applications. In some implementations, the CCS may determine an estimated pickup time based on a time entered by the customer. In some implementations, the CCS may determine an estimated pickup time based on a prearranged time window (e.g., selected by the customer in the shopping application). The CCS may generate and/or assign one or more routes based on any of the one or more customer location determinations and estimated pickup time techniques described herein.

In some implementations, the location of a third party delivery driver and/or the estimated pickup time for a third party delivery driver may trigger the generation/assignment of one or more routes in a similar manner as described herein with respect to customer location and/or estimated pickup time. For example, the location of a delivery driver relative to the store may trigger generation/assignment of one or more routes for the order(s) to be delivered by the driver. As another example, an estimated time at which the third party delivery driver will arrive at the store may trigger generation/assignment of one or more routes for the orders(s) to be delivered by the driver.

In some implementations, routes generated before a customer is set to arrive at the store may be placed in a collection/packing area. For example, complete customer orders can be stored in the collection/packing area for later customer pickup/delivery. The scheduled pickup/delivery need not be immediate. Instead, the items may be stored in the collection/packing area for any amount of time. In some implementations, the CCS may generate routes that include items not currently ordered by customers (“non-ordered items”). In these cases, the items may be stored in the collection/packing area and used for later received customer orders. The CCS may generate routes that include items not currently ordered in the case that the items are frequently ordered by customers and are likely to be ordered within a short period of time. Example commonly ordered items may include milk, soda, and bread.

FIG. 87 illustrates an example method for generating routes that include non-ordered items. In block 8700, the CCS receives a customer order including a plurality of items. In block 8702, the CCS selects non-ordered items to add to a route along with one or more of the ordered items in the received customer order. In some implementations, the CCS may maintain a list of non-ordered items for picking (e.g., commonly picked items). In these implementations, the CCS may select non-ordered items from the list to assign to routes. In block 8704, the CCS may generate a route that includes ordered items and non-ordered items. In block 8706, the CCS assigns the route to an MSD. In some implementations, the CCS may further assign additional non-ordered items to a route while the user is picking the route.

The CCS may select non-ordered items for routes in a variety of ways in block 8702. In some implementations, the CCS may select non-ordered items for routes that include the same ordered items or are included in the same locations (e.g., same zones) that are already included in the routes. In some implementations, the CCS may select non-ordered items for routes that deviate from the ordered items on the routes (e.g., by less than a threshold distance). In some implementations, the CCS may assign non-ordered items to an MSD based on the location of the MSD prior to assigning a route to the MSD. For example, the CCS may assign non-ordered items to an MSD that are currently near an MSD, or will be near an MSD on the way to the starting point of the upcoming route. Although the CCS may take into account the route and/or location of the MSD to receive the route, in some implementations, the CCS may assign non-ordered items to the MSD without regard to routes or locations. Although the non-ordered items may be added to routes with customer orders, the non-ordered items may also be used to make up entire routes of non-ordered items.

The MSD GUI may render non-ordered items in a variety of ways. In some implementations, the MSD GUI may render non-ordered items in the same manner as ordered items. In some implementations, the MSD GUI may render non-ordered items in a manner that differentiates the non-ordered items from ordered items. For example, the MSD GUI may include additional text (e.g., “non-ordered item”) along with the item, modified formatting (e.g., text font, color, etc.), and/or additional rendering modifications (e.g., color/shading). In some examples, the MSD GUI may include the non-ordered items in a different list (e.g., a list under the route being picked). In some implementations, the MSD GUI may allow the user to request that non-ordered items be added to the route.

In some implementations, the CCS may generate routes based on historical picking by the MSDs and/or historical movement by the MSDs. Historical picking/movement may refer to picking/movement that recently occurred (e.g., within seconds/minutes) or has occurred over a longer period of time (e.g., hours, days, weeks, etc.). Historical picking/movement may refer to picking (e.g., scanning) of one or more items and/or movement through one or more zones within a recent time and/or over a longer period of time. The recency of the picking/movement data may be defined in a variety of ways. In some implementations, the recency of the picking/movement data may be defined in terms of time (e.g., one or more time thresholds). In some implementations, the recency of the picking/movement data may be defined in terms of the number of items picked (e.g., scanned). For example, historic picking/movement data may be analyzed for a threshold number of recently picked items (e.g., a last 5, 20, or 100 items) as well as picked items over a longer period (e.g., 200, 500, or 1000 items). In some implementations, the recency of the picking/movement data may be defined in terms of the distance moved by the user. For example, recent historic picking/movement data may be defined in terms of a short distance of user movement in terms of any location technology described herein (e.g., 1 meter, 10 meters, 1 zone, 3 zones, etc.). In this example, more long-term historic picking/movement data may include longer distances of user movement and/or more zones traversed (e.g., 100 meters, 1000 meters, 10 zones, 100 zones, etc.). In some implementations, the CCS may use the same threshold to determine recent vs. long term data. In other implementations, the CCS may use a first threshold to determine recent data and a second threshold that is different than the first threshold to determine long term data. Although the scan log data may be generated based on picked items, in some implementations, the scan log data may be acquired passively as an MSD scans items while a user moves throughout the store.

In some implementations, the CCS may be configured to assign items/locations to MSDs based on items that were recently picked (e.g., within less than a threshold amount of time) by the MSDs. In one example, the CCS may be configured to assign an item to an MSD if the user is about to pick the item (e.g., on a route or based on proximity). The CCS may determine that the user is about to pick the item based on the arrangement of items on the MSD (e.g., display) and/or the order in which items have been picked leading up to the item. In a specific example, the CCS may determine that the user is about to pick the item when the item is a next item on the user's MSD. In some implementations, the CCS may determine that the user is about to pick an item when the item is adjacent to other items being picked.

In some implementations, the CCS may be configured to assign items to an MSD that just picked the item. For example, the CCS may assign an item from a new customer order to an MSD if the MSD has just picked the item within less than a threshold amount of time (e.g., within seconds), since the user may be near the item. In some implementations, in order to prevent backtracking by the user, and to move the user along the route, the CCS may be configured to refrain from assigning items to the user that the user has recently picked. For example, the CCS may refrain from assigning items to the user when the user has moved on from the item and scanned other items. In one example, the CCS may determine that the user has moved on from the item after the user has been detected picking one or more additional items on the list subsequent to the item. Additionally, or alternatively, the CCS may determine that the user has moved on from the item after a period of time has elapsed (e.g., greater than a threshold period of time). In some implementations, the CCS may determine that the user is near an item (e.g., a recently picked item) based on item adjacency or other location technology. In some implementations, the CCS may determine an item picking trajectory through the store (e.g., a sequence of one or more items/locations), which may be used to predict which items are about to be picked. For example, the CCS may determine the trajectory based on past items picked, past movements, item adjacency and/or locations associated with the items (e.g., as described herein).

In some implementations, the CCS may be configured to assign items/locations to MSDs based on locations that were recently traversed (e.g., within less than a threshold amount of time) by the user. For example, the CCS may be configured to assign items to an MSD if the MSD is about to move to a location including the items (e.g., based on a route or trajectory). The CCS may determine that the user is about to move to the location when the user is near the location and/or moving toward the location. In a specific example, the CCS may determine that the user is about to move to the location when the location is a subsequent location (e.g., next location) on the user's route.

In some implementations, the CCS may determine a trajectory of the user through the store based on two or more traversed locations (e.g., a historical path) that indicate one or more future locations that may be traversed (e.g., one or more adjacent locations when roaming or on a route). The trajectory may be used to predict which locations are about to be visited by the user. The CCS may determine a trajectory for one or more MSDs in the store. The CCS may also predict one or more future locations of the users based on the trajectory. The CCS may generate routes for one or more MSDs based on the trajectory and/or predicted future location(s) of the user. For example, the CCS may assign items on (e.g., in a predicted location), or near (e.g., in an adjacent or near location), the predicted future location of the user.

In some implementations, the CCS may be configured to assign items to an MSD if the MSD is in the location or near the location of the items. For example, the CCS may assign an item from a new customer order to an MSD if the MSD is located within the location of the item or has just left the location within less than a threshold amount of time. In some implementations, in order to prevent backtracking by the user, and to move the user along the route, the CCS may be configured to refrain from assigning items in locations that the user has recently traversed. For example, the CCS may refrain from assigning items to the user when the user has moved on from the location including the item. In one example, the CCS may determine that the user has moved on from the location after the user has been detected in other locations, such as an adjacent location, a threshold number locations from the location, and/or a specified distance from the location. Additionally, or alternatively, the CCS may determine that the user has moved on from the location after a period of time has elapsed after the user has left the location.

In some implementations, the CCS may be configured to assign items/locations to MSDs based on locations that were recently traversed and/or items that were recently picked, as described herein. Additionally, or alternatively, the CCS may be configured to assign items/locations to an MSD that just picked the item and/or traversed a zone, as described herein. Additionally, or alternatively, in order to prevent backtracking by the user, and to move the user along the route, the CCS may be configured to refrain from assigning items/locations to the user that the user has recently picked/traversed, as described herein. The CCS may also take into account a user's trajectory for picking items and traversing locations to predict future items/locations for route assignment.

In some implementations, the CCS may learn which items a user commonly picks (e.g., specific items or types/categories of items). The CCS may learn the items over a short period of time, such as items picked within the last hour or day. The CCS may also learn the items over a longer period of time, such as over a week or more. The CCS may determine which items the user picks in a variety of ways. For example, the CCS may determine that the user commonly picks items based on the number of times the user has picked the item (e.g., a total number of times the item was picked). In one example, the CCS may determine that the user commonly picks items based on a variety of factors, such as 1) the number of times the items were picked within a period of time, 2) the most picked items by the user, 3) the ratio of picks for a specific item relative to total numbers of items picked, and/or 4) other statistical distributions indicating a number of different items that the user commonly picks. The commonly picked items may be associated with an MSD (e.g., an MSD ID) and/or user (e.g., a user ID) at the CCS. In some implementations, the CCS may rank the items (e.g., individual items, item types, etc.) picked by the user based on a variety of factors, such as the most common items/types for the user.

In some implementations, the CCS may assign items to the user/MSD that the user commonly picks. For example, the CCS may preferentially assign items to the user/MSD (e.g., over another user/route). Learning commonly picked items for a user/MSD and subsequently assigning those items to the user/MSD may allow the CCS to automatically adjust to picking habits/assignments of users/MSDs. For example, if a specific user/MSD is typically used to pick specific items (e.g., specific item categories/departments), or if a store uses specific users/MSDs to pick specific items (e.g., specific item categories/departments), the CCS may learn which specific items should be associated with the users/MSDs. In a specific example, a store may employ specific users or MSDs to pick specific grocery departments. The CCS in this case may determine which items are typically picked by the users/MSDs.

In some implementations, the CCS/MSDs may store a log of the locations traversed by users/MSDs (e.g., movement/location logs). For example, the CCS may store the locations (e.g., zones) along with time data that indicates when the user entered/exited the zones and/or the amount of time spent in the zones. The CCS may generate routes and/or assign items to users/MSDs based on the movement logs. Movement logs may include movement data (e.g., locations) that is separate from scan log data (e.g., the locations of scanned items), but may include some of the data from scan log data. For example, movement log data may align with scan log data at times when the user scans items. The movement data may indicate a user's location over time using any of the location techniques described herein (e.g., location indicators, GPS, etc.). The movement data may be analyzed to determine common locations including the user, common sequences of locations traversed, time spent in locations (e.g., time spent in individual locations, sections, groups of locations, etc.), and other movement parameters.

In some implementations, the CCS may learn which locations a user commonly traverses. The CCS may learn the locations over a short period of time (e.g., within a short threshold period of time before the current time), such as locations traversed within the last hour or day. The CCS may also learn the locations over a longer period of time (e.g., within a longer threshold period of time before the current time), such as over a week or more. The CCS may determine which locations the user traverses in a variety of ways. For example, the CCS may determine that the user commonly traverses locations based on the number of times the user has traversed a location, the amount of time the user has spent in the locations, the number of items a user has picked from a location, and/or based on statistical distributions that indicate the user's presence in a location relative to other locations (e.g., a ratio of time spent in the location relative to all locations). The commonly traversed locations may be associated with an MSD (e.g., an MSD ID) and/or user (e.g., a user ID). In some implementations, the CCS may rank the locations or groups of locations based on a variety of factors, such as the most common locations for the user, the amount of time spent by the user in the locations, etc.

In some implementations, the CCS may assign locations to the user/MSD that the user commonly traverses. The CCS may also assign items in the locations that the user/MSD commonly traverses. For example, the CCS may preferentially assign locations to the user/MSD (e.g., over another user/route). Learning commonly traversed locations for a user/MSD and subsequently assigning those locations to the user/MSD may allow the CCS to automatically adjust to picking habits/assignments of users/MSDs. For example, if a specific user/MSD is typically used to pick in specific locations (e.g., specific departments), or if a store uses specific users/MSDs to pick specific locations, the CCS may learn which specific locations should be associated with the users/MSDs. In a specific example, a store may employ specific users or MSDs to pick specific grocery departments.

In some implementations, the CCS may learn common sequences of locations traversed by the users/MSDs and/or items picked by the users/MSDs. The CCS may use these sequences to generate routes in some cases. For example, the CCS may generate routes that include common sequences of locations. In some implementations, common item/location sequences from a plurality of past orders may indicate the sequence in which locations should be traversed and/or the sequence in which newly ordered items should be picked. For example, common item/location sequences may be used by the CCS to determine the arrangement in which items/locations should be arranged for picking a new customer order. In a specific example, if a series of items are typically picked in a location (e.g., an aisle) in a specific sequence, the CCS/MSD may arrange the series of items in the typically picked sequence for future routes. In some implementations, the CCS/MSDs may learn minimum times for picking two or more items in sequence based on historical picking times (e.g., in scan logs). The CCS may arrange items/locations in a route in a matter than minimizes time for picking the sequence of two or more items. The common sequences of locations/items and the generation of routes based on the common sequences may be user-specific or used across different users.

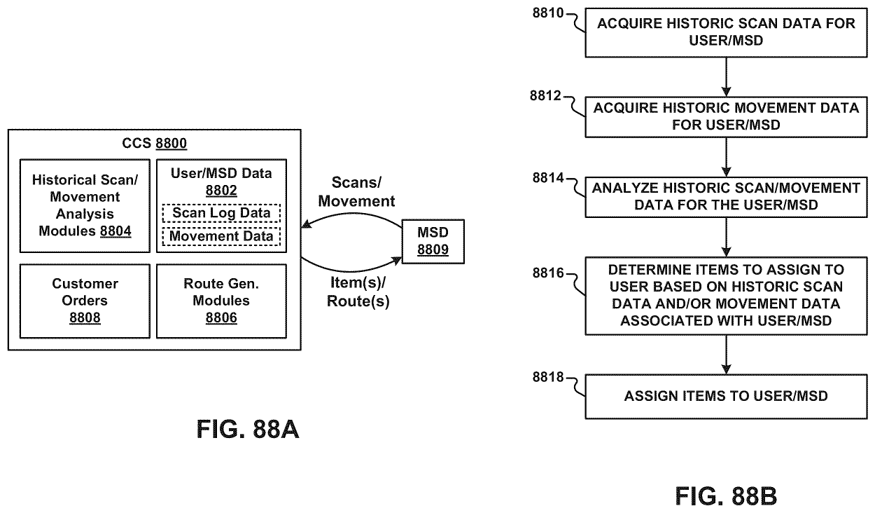

FIGS. 88A-88B are directed to an example CCS 8800 that analyzes historical picking and movement data to determine which items/locations to assign to a user/MSD. The CCS 8800 includes historical user/MSD data 8802 that indicates historical user/MSD behavior. The historical user/MSD behavior is included in scan log data that indicates historical item scans over a period of time for the user. The historical user/MSD behavior is also included in user movement data (e.g., user movement logs) that indicates historical movement for the user over time. The CCS 8800 also includes historical scan/movement analysis modules 8804 that may analyze the historical user scan data and movement data to make the determinations described herein with respect to historical user movement data and scan data. The historical scan/movement analysis modules 8804 may predict future user movement (e.g., trajectory) and scans based on the historical user movement and scan data. The historical scan/movement analysis modules 8804 may also perform analysis on recent user movement data and scan data in order to determine which items should be assigned to a user at the present time. The historical scan/movement analysis modules 8804 may also perform more long term analysis on the user movement data and scan data to learn various patterns associated with the user, such as the locations in which the user typically moves and the items that the user typically picks. The CCS 8800 (e.g., route generation modules 8806) may use the raw historical scan data, raw historical movement data, and/or the analyzed movement/scan data to assign items to users for current customer orders 8808.

FIG. 88B illustrates an example method that describes item/location assignment to users based on historical scan/movement data. In block 8810, the CCS 8800 acquires historical scan data for a user/MSD 8809. In block 8812, the CCS 8800 acquires historical movement data for the user/MSD 8809. Note that the data acquisition performed in blocks 8810-8812 may be performed at the same time for the user/MSD 8809. In block 8814, the historical scan/movement analysis modules 8804 may analyze the historical data to determine the various values used to make the decisions described herein regarding historical data, such as user trajectory, user preferred locations/items, and/or whether to backtrack to pick additional items. In block 8816, the route generation modules 8806 determine items to assign to the user/MSD 8809 based on the historical scan data and/or movement data associated with the user/MSD 8809. In block 8818, the CCS 8800 assigns the items determined in block 8816 to the user/MSD 8809.

In some implementations, the CCS may be configured to assign items/locations to a user/MSD according to one or more item constraint parameters. Item constraint parameters may be associated with a number of items (e.g., min/max number), size of the items (e.g., max size per item and/or total), weight of the items (e.g., max weight per item and/or total), and/or other item parameters. In some implementations, the CCS may be configured to assign items/locations to a user/MSD according to one or more location constraint parameters. Location constraint parameters may be associated with the number of locations (e.g., min/max number), distance traveled (e.g., min/max distance), and/or other location parameters. In some implementations, the item and location constraint parameters may include various threshold values described herein. In some implementations, the CCS may be configured to assign items/locations to a user/MSD according to filters described herein (e.g., blacklists) that may be included in the item and location constraint parameters, or in addition to the constraint parameters.

In some implementations, the constraint parameters may be applied across a plurality of users/MSDs. In some implementations, the constraint parameters may be specific for a user/MSD. In some implementations, users (e.g., managers) may set the constraint parameters across one or more users/MSDs. In some implementations, the CCS may determine the constraint parameters for users (e.g., groups of users or for specific users) based on historical movement and picking data (e.g., data for groups of users or user-specific data).

In some implementations, the CCS can be configured to assign items according to item threshold values. For example, the CCS may be configured to assign fewer than a maximum threshold number of items to an MSD. Limiting the number of items assigned to an MSD may prevent overburdening the user with too many items. As another example, the CCS may be configured to assign greater than a minimum threshold number of items to an MSD. In some implementations, the threshold numbers may be configured by the owner/operator of the OFS. In some implementations, the threshold numbers may be MSD/user specific. In some implementations, the threshold numbers may be automatically determined based on the speed at which the user picks. In some implementations, the threshold numbers may be assigned based on the locations in which the user picks (e.g., based on item size/weight and frozen/unfrozen status). The total number of items may be used as a limiting factor for generating a route (e.g., the route generation ends when a total number of items is assigned).

In some implementations, the CCS can be configured to assign items on a route based on item size limits (e.g., volume limits) and/or item weight limits. For example, the CCS may be configured to assign a group of items that together are less than a threshold size limit (e.g., a volume limit). As another example, the CCS may be configured to assign a group of items that together weigh less than a maximum weight limit. Limiting the total size and weight of items assigned to an MSD may prevent a user from being burdened with too large of a volume/weight of items. The total size/weight of items may be used as a limiting factor for generating a route (e.g., the route generation ends when a total size/weight of assigned items is reached).

The CCS can be configured to assign locations according to location threshold values. For example, the CCS may be configured to assign fewer than a maximum threshold number of locations (e.g., zones) to an MSD. Limiting the number of locations (e.g., zones) assigned to an MSD may prevent overburdening the user with a route that is too long. As another example, the CCS may be configured to assign greater than a minimum threshold number of locations (e.g., zones) to an MSD so that a user receives a sufficiently long route. In some implementations, the threshold number of locations may be configured by the owner/operator of the OFS. In some implementations, the threshold number of locations may be MSD/user specific. In some implementations, the threshold numbers may be automatically determined based on the speed at which the user moves (e.g., zones per minute). In some implementations, the threshold numbers may be assigned based on the locations in which the user picks. For example, an MSD used to pick from the entire store may be assigned a greater number of locations than an MSD that is limited to a subset of zones (e.g., one or more sections). The total number of locations (e.g., zones) may be used as a limiting factor for generating a route (e.g., the route generation ends when a threshold number of zones is assigned).

In some implementations, the CCS may take into account the physical length of the route when assigning locations/items to users. The CCS may determine a physical distance of the route based on location sizes associated with the locations in the route. Example location sizes described herein may include zone values that indicate the sizes of zones. In some implementations, the location sizes may be values that indicate relative size or actual physical sizes (e.g., in meters or feet). In some implementations, the CCS may be configured to assign a route that is shorter than a maximum length. The CCS may also be configured to assign a route that is greater than a minimum length.

In some implementations, the CCS/MSDs may implement item filter rules. In these implementations, the CCS may assign items to MSDs according to item filter rules. Additionally, or alternatively, the MSDs may arrange/display items based on item filter rules. In some implementations, item filter rules may indicate items that should and/or should not be assigned to users/MSDs. For example, when assigning items to users/MSDs, the CCS may filter out specific items for the users/MSDs based on filtering rules that indicate specific items that should and/or should not be assigned to specific users/MSDs. In a specific example, the CCS may include blacklists (denylists) for items that should not be assigned to specific users/MSDs. In another specific example, the CCS may include whitelists (allowlists) that indicate items that should be assigned to specific users/MSDs. In some implementations, the CCS may preferentially assign items in a whitelist to specific MSDs/users. In some implementations, the whitelisting/blacklisting may be set based on item category/type. For example, if a picker is tasked to pick specific item categories, the CCS may assign items included in the item categories to the picker and refrain from assigning items in other item categories. As another example, if a picker is tasked to pick one or more specific store departments, the CCS may assign items included in the specific store departments and refrain from assigning items in other store departments. In some implementations, the whitelisting/blacklisting may be set based on item size and/or weight. For example, heavy items may be assigned to specific users, such as stronger users or fork truck drivers.

In some implementations, item filter rules may filter out specific items based on other items in the order and/or items that are already assigned to a user. For example, the CCS may be configured to separate items that should not be picked together into different routes for different MSDs. In a specific example, with respect to item type, the CCS may be configured to separate frozen items from other items that are not temperature sensitive when assigning items to MSDs. In this specific example, if a picker has already been assigned cooled/frozen items, the CCS may continue to assign cooled/frozen items to the picker in order to ensure that the picker can focus on picking the cooled/frozen items and get the cooled/frozen items to a freezer in the collection/packing area. This scenario may prevent unwanted heating/melting of already-picked frozen items that may occur if the picker is routed away to pick items that are not temperature sensitive. In another example, the CCS may be configured to assign specific items to users that are not handling food products. For example, the CCS may be configured to refrain from assigning food items to pickers that have been assigned various chemicals (e.g., fertilizers).

In some implementations, the CCS/MSDs may implement location filter rules. In these implementations, the CCS may assign locations (e.g., zones) to MSDs according to location filter rules. Additionally, or alternatively, the MSDs may arrange/display items based on location filter rules. Although some users/MSDs may be constrained to pick specific items/locations based on filter rules, some users/MSDs may not be subject to the item/location filter rules.

In some implementations, location filter rules may indicate locations that should and/or should not be assigned to users/MSDs. For example, when assigning locations to users/MSDs, the CCS may filter out specific locations for the users/MSDs based on filter rules that indicate specific locations that should and/or should not be assigned to specific users/MSDs. In a specific example, the CCS may include blacklists (denylists) for locations that should not be assigned to specific users/MSDs. In another specific example, the CCS may include whitelists (allowlists) that indicate locations that should be assigned to specific users/MSDs. In some implementations, the CCS may preferentially assign locations in a whitelist to specific MSDs/users. In some implementations, the whitelisting/blacklisting may be set based on other data associated with the locations, such as the types of items included in the location and/or the department associated with the location.

In some implementations, location filter rules may filter out specific locations based on other locations in the route and/or locations that are already assigned to a user. For example, the CCS may be configured to separate locations that should not be picked together into different routes for different MSDs. In a specific example, the CCS may be configured to separate locations for frozen items from other locations that do not include temperature sensitive items. In another specific example, the CCS may be configured to separate locations for various chemicals (e.g., fertilizers) from other locations including food products.

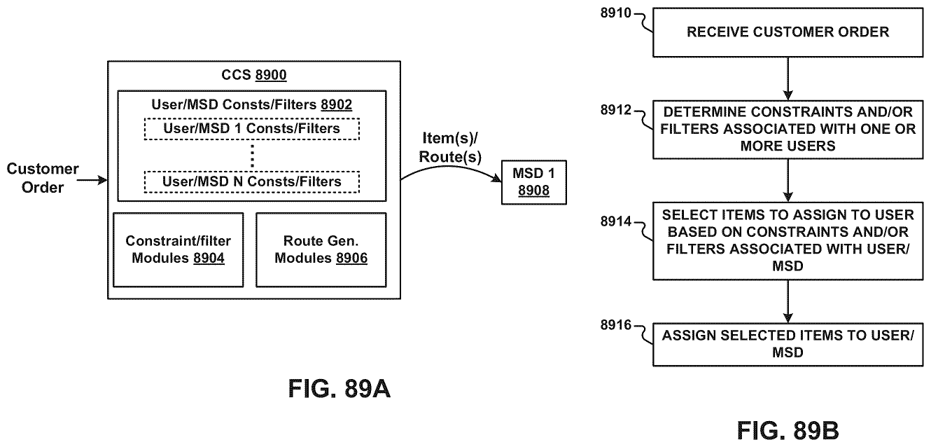

FIG. 89A illustrates an example CCS 8900 that may implement various item/location constraints and filters when assigning items and/or generating routes. The CCS 8900 includes specific constraints and filters for different users/MSDs. For example, the CCS 8900 stores N sets of constraints and filters 8902 associated with N different users/MSDs. The CCS 8900 includes constraint/filter modules 8904 that may generate the constraints/filters for the users/MSDs as described herein. The constraint/filter modules 8904 may also retrieve and apply constraints/filters for users/MSDs when the route generation modules 8906 assign items/locations to the pickers (e.g., in a route).

FIG. 89B illustrates an example method that describes operation of the CCS 8900 in FIG. 89A that may implement item/location constraints and filters for a received customer order. In block 8910, the CCS 8900 receives a customer order. In block 8912, the CCS 8900 (e.g., constraint/filter modules 8904) determines constraints/filters associated with one or more users/MSDs that may pick the customer order. The constraints/filters may limit which items/locations can be assigned to the users/MSDs. In some implementations, some users/MSDs may not have associated constraints/filters. In block 8914, the route generation modules 8906 select items from the customer order to assign to the MSD 8908 (e.g., in a route) based on the constraints/filters associated with the MSD 8908. In block 8916, the CCS 8900 assigns the selected items to the MSD 8908. Although the method of FIG. 89B is illustrated for a single customer order, constraints/filters maybe applied for users/MSDs when assigning items from a queue of different customer orders.

In some implementations, locations in the store may be described herein as “sections.” A section may refer to a set of one or more locations (e.g., a plurality of locations). Put another way, a section may refer to a set of one or more sub-locations (e.g., zones), where each sub-location may make up a portion of the section. For example, a section may include a set of one or more zones. In some implementations, a section may include a plurality of locations (e.g., a plurality of zones). The plurality of locations (e.g., zones) in a section may be connected in some examples. In these examples, the set of locations in a section may be connected together such that a user can walk throughout the set of locations without entering another section. In other examples, the plurality of locations assigned to a section may include some locations that are not connected to one another. Although a section may include a plurality of locations (e.g., zones), in some implementations, a section may include a single location (e.g., a single zone).

Sections may be defined using any of the mapping techniques described herein. For example, sections may be defined by readable location indicators, location indicators that transmit location signals, and/or using any other mapping technique. Accordingly, sections that are illustrated and described as including one or more zones (e.g., defined by location indicators) are only example sections.

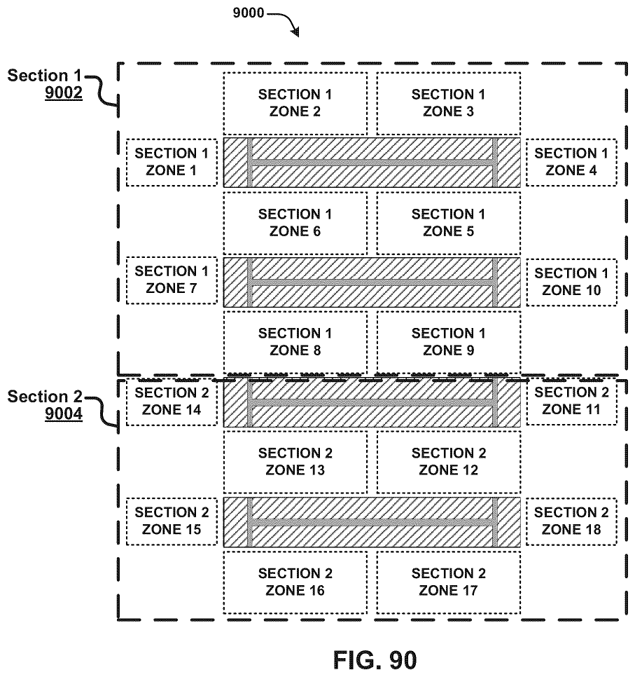

FIGS. 90-94B illustrate implementations of example sections. FIG. 90 illustrates a portion of an example store 9000 that includes two sections (Section 1 9002 and Section 2 9004). Each of the sections 9002, 9004 includes a plurality of zones. For example, section 1 9002 and section 2 9004 include 10 zones and 8 zones, respectively. In implementations of the OFS that include sections, the different locations (e.g., zones) within a section may be identified by a location ID (e.g., a zone ID) as well as a section ID (e.g., a number, name, or other ID) indicating the section including the location (e.g., zone). For example, a single location (e.g., zone) in the store may be identified by a section ID and another location ID within the section (e.g., a sub-location ID). The locations (e.g., zones) and sections may also be associated with metadata that describe the location/section, such as associated physical locations (e.g., departments, aisle numbers, etc.).

The sections illustrated in FIG. 90 may be defined in a variety of ways. In some implementations, the sections may be defined by location indicators. For example, in some implementations, where zones are defined by readable location indicators, the readable location indicators may include a readable section ID. In some cases, a readable location indicator may include a section ID and another location ID (e.g., the sub-location zone ID), such that the location indicator explicitly indicates both the section and the sub-location within the section. In other cases, the readable location indicator may include a location ID that is later interpreted/assigned as a sub-location within a specific section. For example, if a zone is associated with a location ID, such as a random number sequence, the location ID may not explicitly indicate a section ID and a sub-location ID, but the CCS may later associate the random number sequence to a specific sub-location in a specific section. In some implementations, a readable location indicator may have separate readable codes for section and sub-location.

In some implementations, where zones are defined by location indicators that transmit location signals, the location signals may indicate the section ID. In some cases, a location indicator may transmit one or more signals (e.g., a single code or multiple codes) that indicate a section ID and another location ID (e.g., the sub-location zone ID), such that the location indicator explicitly indicates both the section and the sub-location within the section. In other cases, the location indicator may transmit a location ID that is later interpreted/assigned as a sub-location within a specific section. For example, if a zone is associated with a location ID, such as a random number sequence, the location ID may not explicitly indicate a section ID and a sub-location ID, but the CCS may later associate the random number sequence to a specific sub-location in a specific section. In some implementations, a location indicator may transmit separate location IDs indicating section and sub-location.

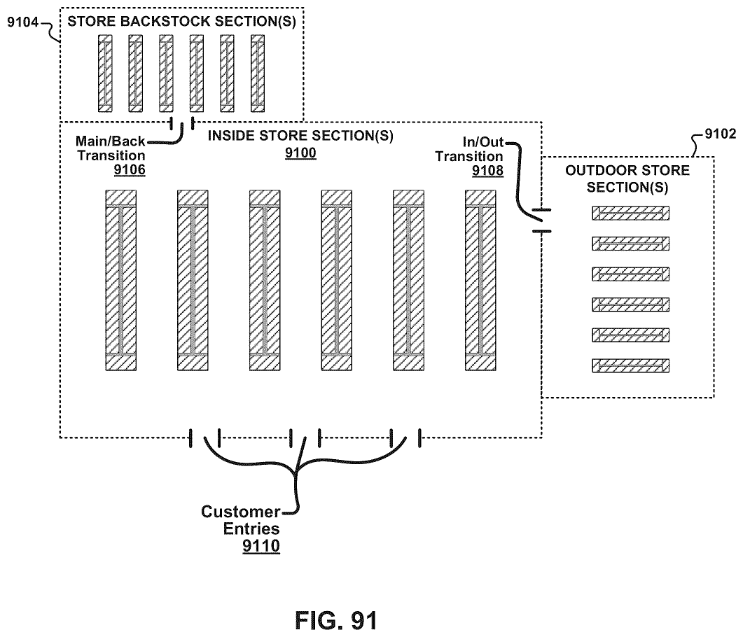

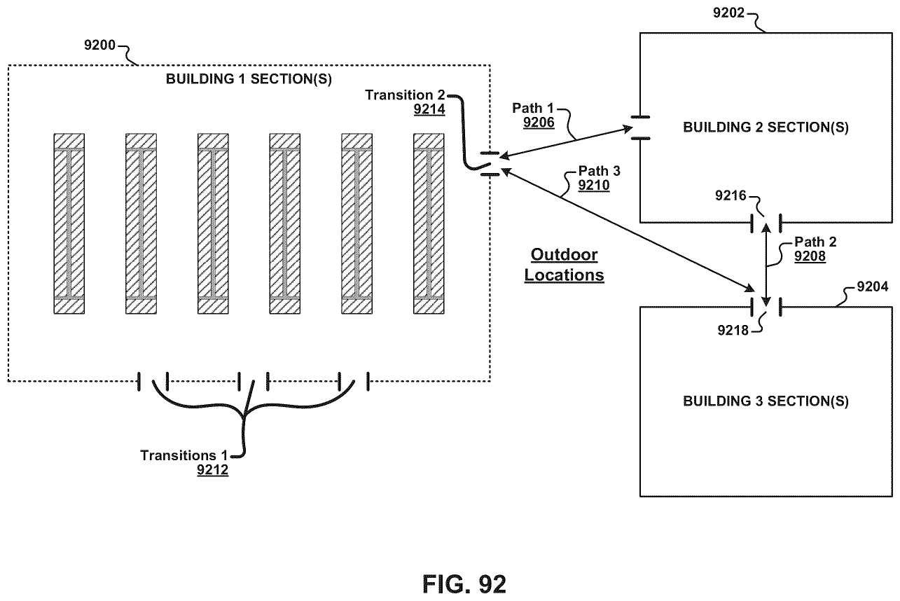

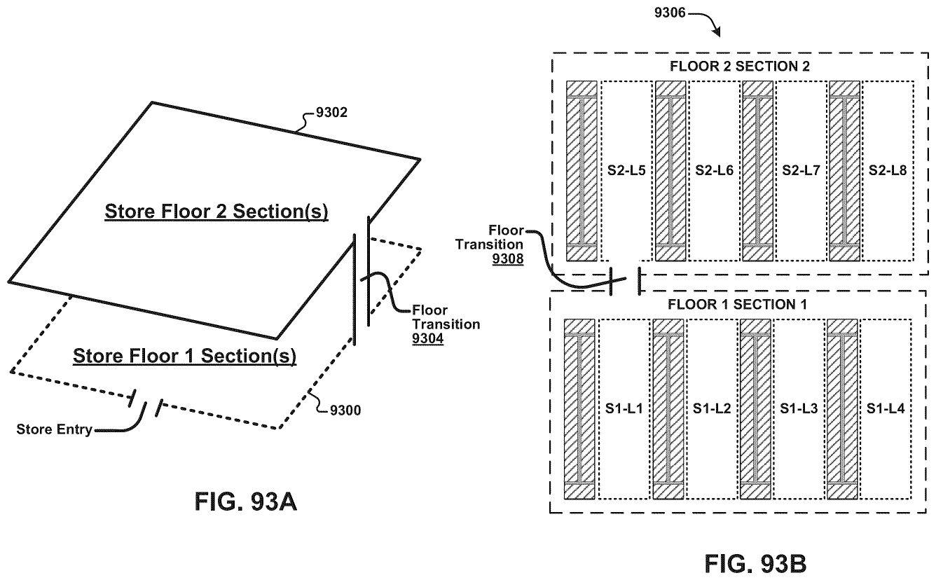

In some implementations, a section may be associated with physical locations that are meaningful to the users. For example, different sections may be associated with different departments of a store (e.g., one or more sections to a department), such as a dry goods department, a frozen department, a fresh fruit department, an electronics department, a grocery department, etc. Similarly, different sections may be associated with different item types, such as cereals, frozen pizzas, frozen entrees, fruit, etc. In this example, different item types may be grouped by section. As another example, different sections may be associated with different aisle numbers. The sections may also be defined according to different types of physical locations, such as different floors of a store (e.g., see FIG. 93A), different areas of a store (e.g., see FIG. 91), and/or different buildings of a complex (e.g., see FIG. 92). In a similar manner as grocery stores, different sections for a factory complex may be associated with different factory locations/buildings.

Sections (e.g., section IDs) may be manually and/or automatically assigned. In some implementations, the sections may be manually assigned by an employee of the store (e.g., manager/administrator). In one example, the sections may be explicitly defined by the location indicator as a section ID that is readable or transmitted by the location indicator. In another example, the sections may be defined in software at the CCS. For example, the sections may be manually assigned to existing locations (e.g., according to department, floor number, item type, aisle number, or other physical description).

In some implementations, the CCS may provide a user interface in which a user (e.g., employee, manager, and/or administrator) may define the sections manually. A user interface for defining sections may include lists of locations for the user to select and group into a section. The user interface may be used to define sections before and/or after a location map including the sub-locations has been generated. The user interface may also provide GUI elements (e.g., text entry elements or menus) that receive user-defined section names (e.g., aisle names, department names, floor names, etc.). In some implementations, a user interface for defining sections may include lists of items for the user to select and group into a section. In these implementations, the CCS may group together locations including the items into a section.

In implementations where location indicators provide location IDs that explicitly define section and sub-location, placement of the location indicators by the users (e.g., store employees) may define the sections as the store location map is generated according to the techniques of the present disclosure (e.g., see FIGS. 40-44B). For example, if a readable location indicator includes a section ID and a sub-location ID (e.g., as separate codes or a concatenated code), a user may place the location indicators according to their desired section layout. In a specific example, if the user wants to define different floors as different sections, the user may place location indicators with the same first section ID, but different sub-location IDs, on a first floor. In this specific example, the user may place location indicators having a second section ID, but different sub-location IDs, on a second floor. Such an arrangement of location indicators with first section IDs and second section IDs may indicate locations on the first floor and the section floor, respectively. In a similar manner, a user may place location indicators that define different store departments, aisles, rooms, etc.

In some implementations, sections may be automatically defined by the CCS/MSDs. In one example, items can be associated with locations (e.g., zones), as described herein. Locations including items of a defined item type may then be associated with a defined section. For example, locations including frozen entrees may have a section ID of “Frozen Entrees” assigned to the zones. In some implementations, sections may be defined based on the number of items picked from the section, such as the rate at which items are picked. For example, the CCS/MSDs may define sections such that the sections have similar numbers of items picked, then assign sections to different pickers. In this example, the picking workload may be spread across a number of users. Additionally, in this example, the section definitions may be redefined over time (e.g., over hours) to adjust the number of items assigned to the pickers. In some implementations, the sections may be defined by the size of the locations (e.g., zone sizes) included in the section. For example, sections may be assigned to locations in a manner that produces sections of similar size. Producing sections of similar size may spread movement out evenly across multiple users.

In some implementations, sections may be automatically defined based on acquired images. For example, a section may be defined based on images of an aisle number associated with a set of zones. As another example, a section may be defined based on images of a department name associated with a set of zones. Images of other physical locations may also be used to automatically define sections. In some implementations, the CCS/MSDs may be operated in a section/location mapping mode that automatically generates the section ID and metadata. Additionally, or alternatively, the section IDs and metadata may be manually assigned. Additionally, or alternatively, the section IDs and metadata may be generated while the users are picking.

In some implementations, the CCS may be configured to automatically generate location maps including sections while users (e.g., customers, employees, third parties, etc.) are picking, as described herein. For example, the CCS may generate a location map including sections while users are moving MSDs throughout the store while picking items for customer orders. In some implementations, the CCS may also be configured to update location maps to include new sections and/or remove old sections automatically. For example, detection of new section IDs over time may result in the addition of section IDs to the location map. As another example, lack of acquired section IDs over time (e.g., after a threshold period of time) may result in the CCS removing the sections from the location map.

In some implementations, a user may place an MSD into a mapping mode to generate a location map including sections and/or sub-locations. For example, a user may place an MSD into a mapping mode and manually enter a section name into the MSD (e.g., by typing or in a selection menu). The user may then proceed to walk through the section they wish to define and scan location indicators (e.g., read location indicators, pickup location signals, etc.), acquire images, and/or use any other mapping technology described herein. In the mapping mode, the CCS/MSD may associate the locations with the defined section (e.g., the entered section name). In a specific example, the user may enter the section name “First Floor” and then proceed to generate a location map of the first floor, as described herein. The result of this specific example would be a location map of the first floor, as described herein, where the locations on the first floor are associated with the section named “First Floor.”

In some implementations, location indicators that define sections may be different than location indicators that define sub-locations. For example, additional location indicators may be added to the store to define sections. In a first specific example, different readable codes for sections may be placed near readable codes for the store sub-locations. In this specific example, a user (e.g., store employee) may place readable location indicators in a first set of locations and then place additional readable location indicators that specify sections (e.g., section indicators) in areas of the store where they wish to define a section. In this case, the section indicators for the same section may include the same readable codes. The CCS may determine that the section indicators adjacent to the location indicators indicate that the location indicators are sub-locations within the section. In some implementations, sections may be defined by different location technology than the sub-locations. For example, sections may be defined by readable location indicators and/or images, while sub-locations may be defined by location indicators that transmit location signals.

The number and size of sections in a store may vary, depending on the implementation. Additionally, the number and sizes of zones within a section may vary. For example, a single section may cover an entire floor with a plurality of sub-locations. In another example, a single floor may include a plurality of sections for different departments on the floor, where each of the sections includes a plurality of sub-locations. As another example, a single store department may include a plurality of sections, each of which includes a plurality of sub-locations. The CCS/MSDs may generate location maps including any number of sections and sub-locations as described herein. In some implementations, the CCS/MSDs may determine that sections are adjacent to one another based on adjacency of sub-locations of the sections. In implementations using separate section indicators, the CCS/MSDs may determine that sections are adjacent to each other in a manner similar to determining that two locations are adjacent to each other (e.g., based on reading/scanning section indicators within a threshold period of time).

FIG. 91 illustrates an implementation in which different portions of the store each include one or more sections. In this implementation, the different sections may represent different physical aspects of the store. For example, a main portion of the store (e.g., inside of the store 9100) that is visited by customers may include one or more sections. Additionally, an outdoor portion of the store 9102, which may include specific types of items, may include one or more sections. For example, an outdoor portion of the store may include lawn and garden items. The store of FIG. 91 also includes a backstock area 9104 that may include one or more backstock sections. A backstock section of the store may include additional items (e.g., refrigerated/frozen and/or non-refrigerated) that may also be included in the inside/outdoor sections of the store. In some implementations, a backstock section may include a walk-in refrigerator/freezer. In some cases, the backstock section of the store may not be accessible by the customers. Instead, the backstock sections of the store may be used by employees of the store and/or other third parties that are granted access. In some implementations, the backstock section of the store may be used to house items for filling customer orders that were placed remotely (e.g., online customer orders). In these implementations, the backstock section may be used as an alternative picking area for the store in order to maximize picking speed and minimize movement in customer occupied areas. Additionally, the backstock section may be used along with other sections of the store for picking customer orders. Note that the different areas of the store may be different rooms of the store. For example, the inside store sections may be included in a single room that is separate from one or more rooms of the backstock section(s).

FIG. 91 includes illustrated transitions between different portions of the store. For example, there is a physical transition 9106 between the inside store portion and the backstock store portion. Additionally, there is an indoor/outdoor transition 9108 between the inside store portion and the outdoor store portion. Transitions illustrated in the figures may be physical locations in the store that separate other physical locations (e.g., rooms, floors, buildings, etc.). For example, transitions may include, but are not limited to: 1) physical separations between indoor/outdoor areas, 2) separations between customer/backstock areas, 3) separation between outside/customer areas (e.g., customer entries 9110), 4) separation between multiple floors (e.g., ramps, stairs, escalators, ladders, etc.), 5) separations (e.g., paths) between different buildings, and 6) doorways.

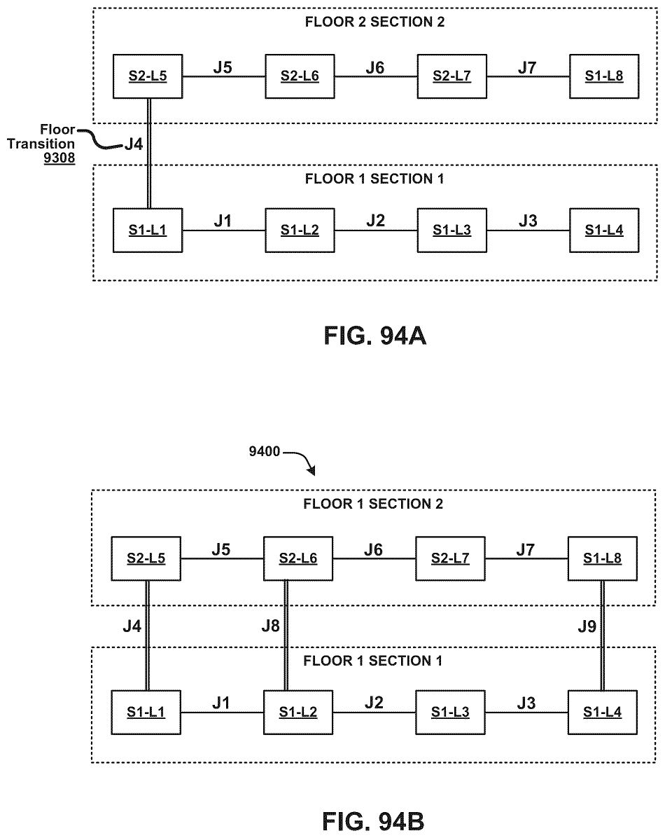

In some implementations, the physical separation between different portions of the store (or building complex) may be represented by data at the CCS, although such transitions are not required to be represented by data. The transitions may be represented in a variety of different manners. For example, the transitions may be separated by locations in a location map (e.g., zones). In this example, the transitions may not include items in some cases. When transitions are represented by mapped locations (e.g., zones), the transitions may be represented by any of the mapping techniques described herein, such as location indicators and/or images. In some implementations, the transitions may be represented by junctions between locations (e.g., see FIGS. 94A-94B).

FIG. 92 illustrates an implementation in which different buildings (e.g., 3 buildings 9200, 9202, 9204) of a complex each include one or more sections. Example multi-building complexes may include, but are not limited to, a multi-building store, a plurality of different stores (e.g., a strip of stores and/or an outdoor/indoor market), a multi-building warehouse, and a multi-building factory. Users may traverse paths (e.g., paths 1-3 9206, 9208, 9210) between the buildings. Users may enter and exit the buildings through the illustrated transitions (e.g., building entries 9212, 9214, 9216, 9218). The paths and transitions may be represented in data as different junctions and/or locations (e.g., zones), as described herein.

FIGS. 93A-93B illustrate an implementation in which different floors 9300, 9302 of a building each include one or more sections. Users may move from one floor 9300 to another 9302 via one or more floor transitions 9304, such as stairs, ramps, ladders, elevators, escalators, etc. The floor transitions may be represented in data as different junctions and/or locations (e.g., zones), as described herein. FIG. 93B illustrates an example store 9306 having four locations on each floor (S1-L1, . . . , S1-L4 and S2-L5, . . . , S2-L8). The floor transition 9308 is located between locations S1-L1 and S2-L5.

FIG. 94A illustrates an example map of the multi-level building (e.g., store, warehouse, etc.) of FIG. 93B including a junction J4 that represents the floor transition 9308. FIG. 94B illustrates another example multi-level building 9400. The multi-level building 9400 of FIG. 94B includes additional junctions J8 and J9 that may represent additional floor transitions (e.g., ramps, stairs, elevators, etc.). Note that the junctions representing transitions are illustrated with double lines in FIGS. 94A-94B. Also note that the transitions may be represented in data as additional locations (e.g., in place of the junctions).

In some implementations, transitions may be associated with items that are located higher on racks, such as racks that may be out of reach to users without additional equipment (e.g., a movable staircase, pallet stacker, forklift, etc.). For example, the items on higher racks may be higher than 7 ft high (e.g., from 8-20 ft high on upper racks). Items located higher on racks may be associated with different location values than those items located beneath them and within a user's reach. The locations located higher up on the racks may be connected by junctions/zones to the locations associated with the items beneath them. In some cases, the locations associated with items located higher on racks may be assigned to specific users/MSDs that may use the proper equipment for picking the items. Associating higher items may also allow the OFS to efficiently route users when customer orders include items located at different heights.

Some transitions may be more time consuming for a user to traverse. As one example, stairs between floors may take longer to traverse than doorways between parts of a building or moving between adjacent departments. As another example, long paths between buildings may take longer to traverse than other types of transitions. The potential inefficiency of travelling between different sections (e.g., via transitions) may be handled by the OFS in a variety of ways. In some implementations, the estimated size and/or traversal time associated with a transition may be represented in data. For example, in a manner similar to zone size values indicating a size or traversal time for a zone, transitions may be associated with transition size/time numbers that indicate their size or traversal time. In one specific example, a transition may be represented as a junction with an associated junction value that indicates the size or traversal time associated with the transition. In another specific example, a transition may be represented as a location (e.g., zone) with an associated zone size value that indicates the size or traversal time associated with the transition. Although transition size/time numbers may be used in generating maps and picking items, the OFS may be implemented without using such numbers.

The CCS/MSDs may store data associated with the locations (e.g., zones), sections, and junctions in order to assign items/locations to MSDs for mapping and picking as described herein. Additionally, the CCS/MSDs may use data associated with ordered items to assign items/locations, such as data that indicates a customer order number, a priority (e.g., if the item is required immediately), an order time at which the order was placed or will be picked, etc.

In some implementations, the CCS/MSDs may store location data (e.g., zone data), such as a location ID/name, location values (e.g., associated traversal times/sizes), and whether/which MSDs/users may pick the items from the locations or traverse the locations. In some implementations, the CCS/MSDs may store section data, such as section name/ID and whether/which users can pick from the sections or traverse the sections. The CCS/MSDs may also store junction data, such as junction name/ID, junction type (e.g., transition type, such as stairs, path, upper item, etc.), junction values (e.g., indicating traversal times), and whether/which MSDs can cross the junctions.

As described herein, the CCS/MSDs may store a variety of data associated with customer orders and items. For example, an item and/or customer order may have a priority value associated with the item and/or customer order that indicates a level of picking priority. In a specific example, a 0 value may indicate no/low priority (e.g., the item is not needed immediately) and a value greater than 0 (e.g., 1 or a larger integer) may indicate a higher priority (e.g., a 1 or greater value may indicate the item should be picked as soon as possible). The CCS/MSDs may use the priority values to prioritize items for routes that are needed immediately. In some implementations, an item may have one or more picking time values, such as a time the item's order was placed and/or a time the item should be picked. The CCS/MSDs may use the time values to determine whether/when to add items to a route. For example, the CCS/MSDs may add items to a route if the item should be picked soon (e.g., based on a scheduled pickup time). In some implementations, an item may have an item type assigned (e.g., frozen or not frozen). In some implementations, an MSD may be assigned to pick specific item types for a route, such as items that are frozen or not frozen. In a specific example, an MSD may be restricted to picking frozen items on a route when an order is nearly ready for pickup/delivery to prevent melting.

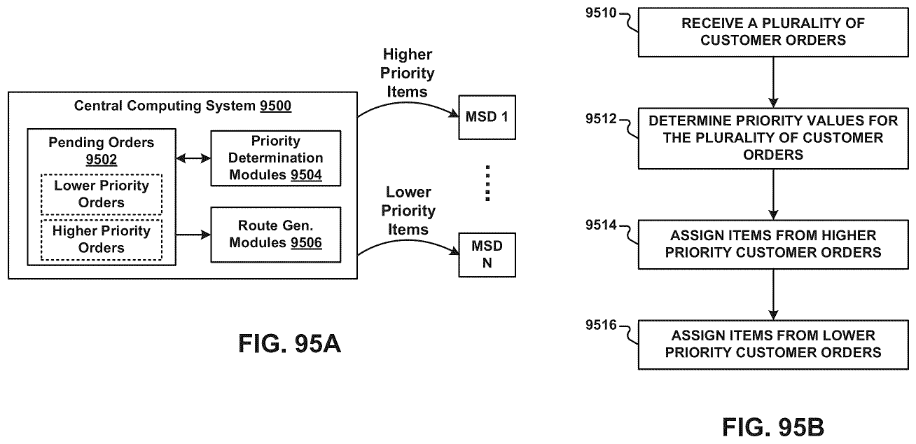

FIG. 95A illustrates an example CCS 9500 that may determine priority data associated with customer orders/items. The CCS 9500 in FIG. 95A receives a plurality of customer orders 9502 and determines priority data (e.g., priority values) associated with the customer orders. For example, the CCS 9500 includes priority determination modules 9504 that determine priority values for pending customer orders 9502, as described herein. The CCS 9500 (e.g., route generation modules 9506) may assign items/routes to users/MSDs based on the priority data.

In some implementations, the CCS 9500 may assign priority values at the customer order level. In these cases, the items included in the customer order may be associated with the same level of priority as the customer order. In some cases, the CCS 9500 may assign different priority levels to items. For example, if some items are not yet picked/packed for a customer order, the CCS 9500 may increase the priority level associated with the items.

In some implementations, the CCS 9500 may implement two priority values (e.g., 0/1), which may be referred to as a higher priority level and a lower priority level. In these implementations, the higher priority level orders/items (e.g., associated with a first priority value) may be assigned in a manner that provides for more immediate picking relative to lower priority level orders/items (e.g., items associated with a second priority value). For example, as described herein, the CCS 9500 may first assign the high priority orders/items to MSDs before assigning the lower priority orders/items (e.g., assign all or most high priority orders/items first).

In some implementations, the CCS 9500 may implement additional priority levels to further prioritize the picking of some orders/items. For example, the CCS 9500 may increase priority levels for orders/items that are deemed more urgent at the time. In a specific example, a higher priority item may become an even higher priority (e.g., by incrementing the priority value) if a customer has arrived at the store and is waiting for the order. In some implementations, a higher priority level (e.g., larger priority value) may indicate that an item is a relatively greater priority for picking than an item associated with a lower priority level (e.g., smaller priority value).

In some implementations, the CCS 9500 may determine priority values based on timing factors. For example, the CCS 9500 may determine priority values based on at least one of: 1) the time the order was placed (e.g., age of the order), 2) the amount of time the items/order have been assigned to pickers, 3) the time the order is needed for pickup by a customer at the store, and 4) the time the order is needed for pickup by a delivery driver at the store.

In examples where the CCS 9500 determines priority values for orders/items based on the time the order was placed (e.g., the age of the order), the CCS may assign a higher priority to orders/items that were placed earlier (e.g., older orders). In some implementations, the CCS 9500 may use a threshold time value to determine which items are higher priority and which are lower priority. For example, orders that were placed greater than a threshold time before the present time (e.g., greater than a threshold age) may be given a higher priority value than more recently placed orders (e.g., orders less than a threshold age). In some implementations, the CCS 9500 may include multiple thresholds that define multiple time ranges, each associated with different priority values, where higher priority levels are associated with older time ranges.

In examples where the CCS 9500 determines priority values for orders/items based on when the orders/items were assigned to pickers, the CCS 9500 may assign a higher priority to orders/items that have been assigned for a longer period of time. For example, the CCS 9500 may use a threshold time to determine which orders/items are higher in priority. In a specific example, orders/items that have been assigned to pickers for greater than a threshold amount of time may be given a higher priority value than more recently assigned orders/items. In some implementations, the CCS 9500 may include multiple thresholds that define multiple time ranges associated with assigned orders. Each of the time ranges may be associated with different priority values, where higher priority levels are associated with orders/items that were assigned for longer periods of time.

In examples where the CCS 9500 determines priority values for orders/items based on when orders/items are needed for pickup by a customer or delivery driver, the CCS 9500 may assign a higher priority to orders/items that are needed for pickup sooner. For example, the CCS 9500 may use a threshold time to determine which orders/items are higher in priority. In a specific example, orders/items that are needed for pickup within less than a threshold amount of time may be assigned a higher priority than orders/items that are needed later. In this specific example, if the customer order is needed immediately (e.g., is needed now or has been needed), the CCS 9500 may assign a higher priority value to the order. Assigning a higher priority in this case may assure that a customer/driver is not held up waiting for an order at the store. In some implementations, the CCS 9500 may include multiple thresholds that define multiple time ranges associated with a time the order is needed for pickup. Each of the time ranges may be associated with different priority values, where higher priority levels are associated with orders/items that are needed sooner.

In some implementations, the CCS 9500 may determine priority values based on location factors. For example, the CCS 9500 may determine priority values based on the location of the customer or delivery driver (e.g., locations determined based on GPS data from customer/driver computing devices). In examples where the CCS 9500 determines priority values based on the location of the customer, the CCS 9500 may assign a higher priority to orders/items for customers that are at, or near, the store. For example, the CCS 9500 may assign highest priority to orders/items for customers waiting at the store. In this example, the CCS 9500 may assign lower priority to orders/items for customers that are farther away from the store. In another specific example, the CCS 9500 may assign higher priority to orders/items that are associated with customers based on their distance from the store. In this specific example, customers within a threshold distance may have the highest priority orders/items. The CCS 9500 may assign multiple different priority values to the customer orders/items based on different threshold locations (e.g., at home, approaching the store within X miles of the store, at the store waiting, etc.).

In a manner similar to assigning priority based on customer location, the CCS 9500 may assign priority levels to orders/items based on the location of a delivery driver that is tasked with delivering the items. For example, the CCS 9500 may assign higher priority to drivers that are nearer to the store. In one example, the CCS 9500 may assign the highest priority to drivers that are at, or near (e.g., approaching), the store. Similar to priority values associated with customer location, the CCS 9500 may assign two or more priority values to the customer orders/items based on different threshold locations of the delivery driver. In some implementations, the highest priority value may be assigned for a delivery driver that is waiting at the store. Assigning highest priority to customers/drivers at the store waiting for orders may prevent the customers/drivers from being held up waiting at the store.

The CCS 9500 may assign priority values to orders/items based on one or more of the factors described herein. For example, the CCS 9500 may assign priority values based on one or more timing factors and/or one or more location factors. In a specific example, the CCS 9500 may assign the highest priority value to a customer that is located at the store and has been waiting for greater than a threshold period of time. In this case, the customers that are at the store waiting the longest (e.g., greater than a threshold period of time) may be served first. Note that the CCS 9500 may assign orders/items to pickers based on priority level and/or other assignment/routing factors described herein.

As described herein, the priority values may be determined for entire orders and/or individual items. In one example, an initial priority value may be assigned to an entire customer order. In this example, a first portion of the order may be picked according to the priority level. After time has elapsed and/or customers/drivers have changed location (e.g., nearer the store or arrived at the store), the CCS 9500 may assign higher priority values to the remaining items in the second portion of the customer order according the timing and locations factors described herein.

The CCS 9500 may implement a variety of assignment/routing decisions based on priority levels associated with the orders/items. In some implementations, the CCS 9500 may be configured to assign the highest priority orders/items prior to assigning the lower priority orders/items. For example, the CCS may be configured to assign higher priority orders/items to pickers until there are no more higher priority orders/items. After assigning all higher priority orders/items, the CCS may begin assigning lower priority orders/items.

In some implementations, the CCS 9500 may be configured to split higher priority orders to different pickers in order to maximize the picking speed of the overall order. For example, the CCS 9500 may be configured to split a high priority order in a manner that increases the picking speed based on the current location of the pickers. In a specific example, the CCS 9500 may split a high priority order to pickers that are near items in the order. In some implementations, lower priority orders may be assigned at a later time and/or entirely assigned to pickers that are provided with more time to pick the orders.

FIG. 95B illustrates an example method that describes operation of a CCS 9500 that may determine priority values and assign orders/items to pickers based on the determined priority values. In block 9510, the CCS 9500 receives a plurality of customer orders. In block 9512, the CCS 9500 determines priority values for the plurality of customer orders. In block 9514, the CCS 9500 assigns items from higher priority customer orders to one or more pickers. In block 9516, the CCS 9500 assigns items from lower priority customer orders to one or more pickers. In FIG. 95B, the higher priority orders are assigned first (e.g., to MSD 1), and the lower priority orders are assigned later (e.g., MSD N).

In some implementations, the MSDs may store the assigned customer orders and prompt the user to pick the customer orders in order of priority. For example, an MSD may store a high priority order and a low priority order. In this case, the MSD may generate an interface for picking the high priority order first. After the high priority order is picked, the MSD may generate an interface for picking the low priority order.

In some implementations, the CCS/MSDs may store MSD/user specific values for items, such as values that indicate whether the item is allowed to be picked by an MSD/user, whether a zone may be entered by the MSD/user, and whether a section may be entered/assigned to the MSD/user or is off limits. The junction data may also be MSD/user specific, such as whether MSDs/users should cross junctions and/or whether the MSDs/users are disincentivized from crossing the junctions.

In some implementations, the CCS/MSDs may implement filters for users. For example, specific locations (e.g., sections/zones) and junctions may be filtered out for specific pickers/MSDs. In a specific example, one MSD may be prohibited from having specific sections/zones and/or items in the specific sections/zones assigned to the MSD. In a specific example with respect to a junction, an MSD may have junction traversal prohibited in order to prevent generation of a route for the picker that crosses the junction. A junction filter may be useful in implementations where crossing a junction is inefficient, such as moving upstairs or walking to a new building.

As described herein, instead of using hard filters for junctions, in some implementations, the CCS/MSDs may disincentivize movement across a junction by assigning a junction value that represents the inefficiency of traversing the junction. Assigning hard filters and/or values to junctions and sections/zones may optimize picker efficiency since it may disincentivize inefficient movements for pickers. In the case of multiple floors, there may be one junction/zone for a transition separating the two sections or zones between floors. In this case, the junction/zone may represent stairs, a ramp, escalator, or other structure for accessing the multiple floors. Such structures may be inefficient for pickers to traverse, especially if another picker is picking items on the other side of the junction (e.g., other floor or building). Division of locations (e.g., sections/zones) into multiple floors may provide for efficient picking in compact footprint multi-floor stores, such as grocery stores with multiple floors or a multi-story warehouse.

The CCS/MSDs may generate location maps that include sections in a similar manner as described with respect to zones. For example, the CCS/MSDs may generate location maps for the store that include sections along with junctions that define the adjacency of sections (e.g., see FIGS. 94A-94B). Location maps that include sections may also include data for the different zones within the sections (e.g., zone size data, junction data, and zone adjacency data). FIGS. 94A-94B graphically illustrate example map data that may be stored by the CCS/MSDs in stores that implement sections and zones. In the examples of FIGS. 94A-94B, each location in the store may be mapped by zone and section. In some implementations, the locations (e.g., sections/zones) may include names/IDs that identify the locations (e.g., sections/zones). In some cases, a section name can be human readable. For example, a section may be named dairy, dry goods, frozen, pets, first floor, second floor, etc., in order to indicate where the sections are located.

Although items may be mapped in the store, in some implementations, some items may not be mapped (i.e., unmapped items). In some implementations, the MSDs may display the unmapped items in a different manner to the user, such as in a separate section of the display (e.g., grouped in a separate section of the display).

The CCS/MSDs may generate routes for sections in a similar manner as the CCS/MSDs generate routes for other locations described herein. For example, the CCS/MSDs may generate routes for sections according to any of the factors described above. In a specific example, sections may be assigned to users based on historical/current/future locations of the MSD/user, historical/current/future items associated with an MSD/user, and/or location/item filters associated with the MSD/user. In some implementations, the CCS/MSDs may generate routes based on sections and then determine the routes within the section(s) (e.g., section sub-routes). For example, the CCS/MSDs may select a section for a route and then generate a route through the section (e.g., a sequence of zones through the section). As another example, the CCS/MSDs may select a sequence of one or more sections for a route and then generate sub-routes through the zones of each section. Additional mapping and routing techniques using sections/zones are described hereinafter.

In some implementations, the MSDs may arrange sections on their displays based on user location and/or based on an assigned route. In one example, if the MSD is assigned a route, the MSD may group items by section within the route for display. In this example, the MSD may arrange the sections in the order in which the route should be picked. The MSD may also arrange the items on the display based on the order in which items should be picked. If a user is picking items without a fixed route, the MSD may group items by section and arrange the sections based on their relative location to the user. The MSD may also arrange items on the display within the section based on their location relative to the user, as described herein.

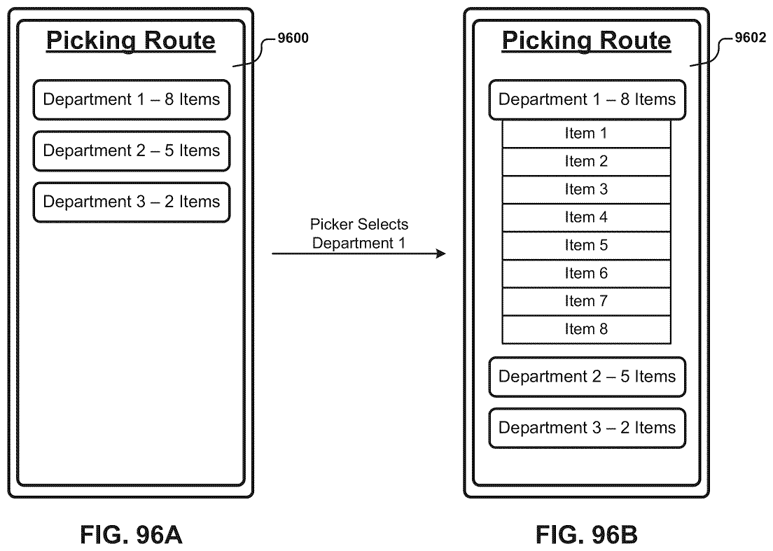

FIGS. 96A-96B illustrate an example MSD interface for an MSD that is assigned a route including items in three sections, which are referred to as Department 1, Department 2, and Department 3. Department 1, Department 2, and Department 3 include 8 items, 5 items, and 2 items, respectively. In FIG. 96A, the MSD GUI 9600 arranges sections (e.g., Departments 1-3) in the order in which the sections should be picked. Specifically, the MSD indicates to the user that they will be picking Department 1, 2, and 3 in order. In some implementations, the sections may remain in a fixed order (e.g., for a fixed route). In other implementations, the sections may rearrange when the user moves throughout the store. For example, the sections may rearrange on the display based on their relative location to the user. In this example, a section including the user, or most near the user, may be arranged at the top of the display. Sections farther from the user may be arranged in order of distance under the top section, as described herein with respect to locations.

In FIG. 96A, the user (e.g., picker) selects the Department 1 GUI element (e.g., button). For example, a user may select the Department 1 GUI element by touching the GUI element. Referring to the GUI 9602 of FIG. 96B, selecting the Department 1 GUI element expands the list of items 1-8 included in the route in the Department 1 section. Items 1-8 may be arranged according to the route (e.g., if the route is fixed). In some implementations, items 1-8 may be arranged according to their relative location to the user. In some implementations, movement of the user throughout the store may cause the items to be reorganized under the Department GUI element. In addition to rearranging the items during user movement, the department GUI elements of FIG. 96B may also be rearranged based on location relative to the user. The user may select the Department 1 GUI element to collapse the GUI back to the state illustrated in FIG. 96A. The user may also select other Department GUI elements to expand the item lists, which may rearrange based on user location or be fixed based on a fixed route. Although the GUIs of FIGS. 96A-96B illustrate groupings by department, any other type of section grouping described herein may be implemented, such as floor groupings, building groupings, room groupings, store groupings, etc.

In some implementations, MSDs may be subjected to filtering based on section. In this case, one or more sections (e.g., items/zones in the section) may be assigned to specific MSDs/users and prohibited for other MSDs/users. In some cases, the filters may be assigned at the MSD level and/or the user level. For example, the CCS may filter out items that are not included in the section for the MSD (e.g., based on an MSD ID, user ID, and/or section ID). In some implementations, the CCS may include blacklists/whitelists for sections for MSDs (e.g., MSD IDs and/or user IDs). In some implementations, filtering may be based on the past, current, or future location of the user. For example, if a user enters a second floor, the user may not be shown items on the first floor, or preferentially shown items on the second floor, unless picking items on the first floor is more efficient. Filtered-out items may be removed from the MSD displays and/or moved to a portion of the MSD display that indicates the items are inefficient to pick (e.g., arranged at the end of a list on the display). For example, items that are inefficient to pick may be grouped lower in the display (e.g., farther down the screen).

In some implementations, the CCS may assign sections to MSDs based on the number of available MSDs. For example, if a single MSD is being used for picking, the single MSD may pick from all sections. In the case one or more additional MSDs are available, the CCS may assign different sections to one or more of the available MSDs (e.g., based on the volume of items and/or size of the section). In one specific example, if a single user is assigned to pick a first floor, a second user may be subsequently assigned to pick a second floor. In this specific example, if there are 2 users in a two-floor store, each user may be assigned to a different floor. If a third picker is added, the third picker may be assigned to pick the floor based on the need for the picker (e.g., assign the picker to the floor with more items and/or higher priority items).

In some implementations, the number of users assigned to a section may depend on the current number of ordered items in the section, where additional MSDs may be assigned to a section that includes a large/larger number of items (e.g., greater than a threshold number of items). In some implementations, the number of MSDs assigned to a section may depend on the size of the section (e.g., based on the zone sizes for the section) and/or the number of stocked items in the section that may be ordered for picking (e.g., a total number of items in the section and/or a rate at which the items have been ordered historically). For example, a greater number of MSDs may be assigned to pick sections that include more items, are larger in size, and/or have more outstanding items.

In some implementations, the MSD may generate GUIs associated with locations (e.g., sections/zones) and items. For example, the MSD may generate a GUI that allows the picker to manually select a section/zone on the display (e.g., a list menu or graphic shown at startup or in a settings section of the MSD). The MSD may also generate a GUI that allows the picker to select the types of items they will pick. The CCS/MSDs may generate routes based on the user selections of locations/items in the interface.

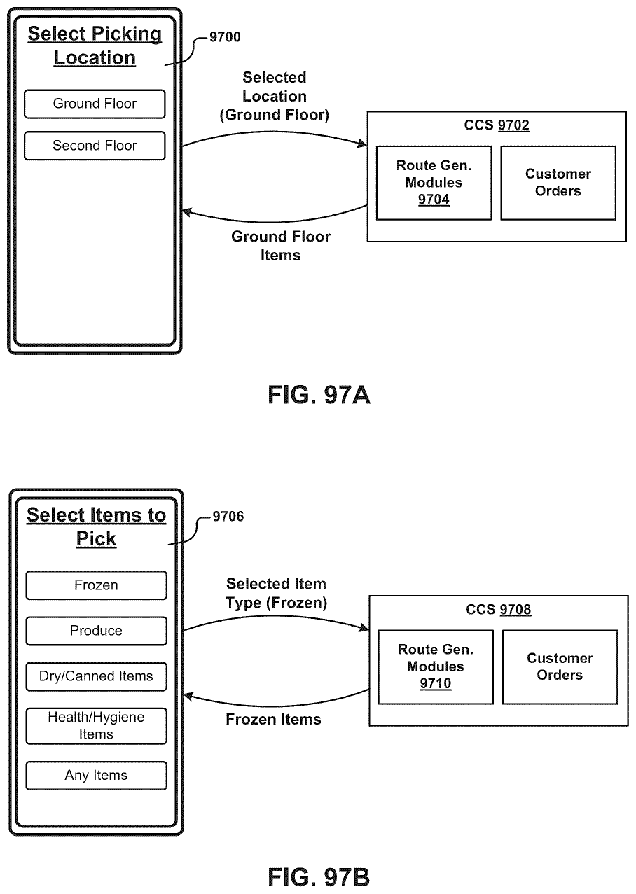

FIG. 97A illustrates an example MSD GUI 9700 that allow pickers to manually select a picking location. In FIG. 97A, the MSD generates a GUI 9700 that includes multiple location selection GUI elements that a user may select (e.g., touch). Specifically, in FIG. 97A, the user may select either a Ground Floor location or a Second Floor location. The CCS 9702 may take into account the selected location when assigning items, orders, and/or routes to the user/MSD. For example, the selected location may act as a location-based filter. In one example, the CCS 9700 may assign items associated with the selected location. In this example, the CCS 9700 may also refrain from assigning items outside of the location. A location selection GUI (e.g., as illustrated in FIG. 97A) may provide pickers in the OFS with picking location flexibility.

In FIG. 97A, the user can select from one of two optional locations. The locations in FIG. 97A are for a store that includes at least 2 floors. For example, the store may include a lower Ground Floor and an upper Second Floor. In FIG. 97A, the user selects the Ground Floor selection GUI element. In response to the selection, the CCS 9700 (e.g., routing generation modules 9704) may assign items to the user that are on the Ground Floor. As described herein, the Ground Floor may include one or more zones and one or more sections. For example, the Ground Floor may be covered by a single section that includes a plurality of zones. As another example, the Ground Floor may include a single zone (e.g., in the case the floor is not separated into multiple zones).

Although the user-selectable locations included in FIG. 97A are floors of a store, any of the locations described herein may be selectable. For example, any sections/zones defined in any manner may be selected by a user. Example other locations that may be selected may include, but are not limited to, store departments, buildings, rooms, aisles, stores, and other locations described herein.

In some implementations, the location selection GUI may include location selection GUI elements that specify locations and sub-locations. For example, a location selection GUI element may indicate “Floor 1, Aisles 5-10.” As another example, a location selection GUI element may indicate “Floor 2, Department 2.” Although a single location selection GUI may be rendered, multiple different location selection GUIs may be rendered for specifying locations. For example, sequential location selection GUIs may be rendered that each allow a user to specify a location for picking. In a specific example, a first GUI may include a plurality of floors from which to select. In this specific example, a second GUI may specify one or more aisles that may be selected by the user. In some implementations, a user may select multiple locations to indicate their desire to pick in multiple different locations. In these implementations, the CCS may filter according to the multiple locations.

FIG. 97B illustrates an example MSD GUI 9706 that allow pickers to manually select item types for picking. In FIG. 97B, the MSD generates a GUI 9706 that includes multiple item type selection GUI elements that a user may select (e.g., touch). Specifically, in FIG. 97B, the user may select from frozen items, produce items, dry/canned items, health/hygiene items, and “Any Items.” The “Any Items” button may indicate to the CCS 9708 that the user is open to pick any type of items. The CCS 9708 may take into account the selected item types when assigning items, orders, and/or routes to the user/MSD. For example, the selected item type may act as an item type filter. In one example, the CCS 9708 (e.g., route generation modules 9710) may assign items associated with the selected item type. In this example, the CCS 9708 may also refrain from assigning items that are not associated with the selected item type. An item type selection GUI (e.g., as illustrated in FIG. 97B) may provide pickers in the OFS with item picking flexibility.

In FIG. 97B, the user can select from one of five item type options. The item types in FIG. 97B may be for a store that includes the listed item types along with other possible item types (e.g., accessible by scrolling down in the GUI of FIG. 97B). In FIG. 97B, the user selects the Frozen selection GUI element. In response to the selection, the CCS 9708 may assign items to the user that are associated with the type “frozen.” A selection of “Any Items” may indicate to the CCS 9708 that the CCS 9708 should not be restrained to assigning items based on item type. The item types listed in FIG. 97B are only a set of example item types. As such, additional/alternative item types may be provided for user selection in an MSD GUI. Each item type selection GUI element may include one or more item types. In some implementations, a user may select multiple item type selection GUI elements to indicate their desire to pick multiple types of items.

An MSD may provide one or more selection GUIs (e.g., as illustrated in FIGS. 97A-97B) described herein. For example, in some implementations, an MSD may provide selection GUIS for both location(s) and item type(s). As described herein, the CCS may filter locations and/or item types for users based on the user selections. Additionally, or alternatively, the CCS may implement preferences for assigning the locations and/or item types selected by the user. When making item assignments/routes for users based on manually selected locations and/or item types, the CCS may also take into account any other item assignment/routing considerations described herein (e.g., relative location to a user, priority, etc.). Selection of the location and/or item type by the user may simplify routing considerations/calculations by the CCS.

In some implementations, the selection GUI elements in FIGS. 97A-97B may be dynamic. For example, the selection GUI elements displayed may depend on whether there are items available to pick associated with the selection GUI elements. With respect to FIG. 97A, it may be assumed that the Ground Floor and the Second Floor include items for picking. Note that the store may have additional floors or sections in FIG. 97A, but may not have items for picking in those sections. In one example, if there are no items on the second floor at the current time, the GUI of FIG. 97A may not show the second floor selection option. In the case there is only one option for a selection menu, the CCS/MSD may not provide the selection GUI, and instead automatically assign the user to the section. The item type selection GUI element may also be rendered in a different manner if there are no items of a specific item type for picking. For example, if there are no frozen items for picking, the GUI of FIG. 97B may remove the Frozen selection GUI element.

As described herein, junctions and/or locations (e.g., sections/zones) may include data (e.g., size data, junction values, etc.) that may be used by the CCS/MSDs to determine routes. For example, in some cases, a transition across a junction between two zones/sections may be penalized and/or prohibited in order to separate the sections/zones for different users. In some implementations, the CCS/MSDs may make exceptions to the penalization/prohibition, such as in circumstances when traversing into the section(s) is beneficial. In one example, the CCS/MSDs may make an exception in the case there is only one picker for multiple sections and/or the items are closer to a picker that is typically penalized for entering the section/zone. Using junction values and zone values that indicate the size/desirability of traversal may help maintain picking efficiency by preventing users from unnecessarily traversing zones/junctions that lead to inefficient picking. Additionally, or alternatively, using junction, section, and/or zone filters along with item filters may efficiently distribute picking across a plurality of users. In some implementations, the CCS/MSDs can determine which locations (e.g., sections/zones) are preferred/prohibited automatically. For example, the CCS may automatically assign one or more sections to a user and/or prohibit a user from picking in one or more other sections (e.g., based on items in a section, based on other route assignments, etc.).

Example hard filters for sections, zones, items, and junctions are described herein. For example, the CCS/MSDs may include filters that define sections, zones, and items that may not be assigned to specific MSDs. With respect to junctions, the CCS/MSDs may define junctions as prohibited. In these examples, the CCS/MSDs may refrain from generating routes that traverse the junction from one section/zone to another section/zone. This may prevent/dissuade movement of specific MSDs from one section/zone to another section/zone, such as moving upstairs, to another building, or from one store department to another (e.g., from frozen goods to dry goods).

In addition to hard filters, or as an alternative to hard filters, the locations and/or junctions may have assigned preferences for specific MSDs (e.g., levels of priority for the MSDs). For example, an MSD may be routed through preferred sections/zones/junctions. As another example, an MSD may be routed to pick preferred items. An MSD may be routed through preferred locations or to preferred items until the preferred locations/items have been traversed or picked. Then, the CCS/MSDs may generate routes to other non-preferred items. Preferences may cause MSDs to pick within specific preferred areas until other conditions are met. For example, MSDs may pick preferred locations/items until the preferred locations/items are not associated with any ordered items and/or other locations/items take priority. At that time, the MSDs may be assigned to typically less preferred locations/items.

Rules for movement and item picking may be implemented by the CCS/MSDs. For example, rules may be generated based on any routing factors described herein, such as number of pickers, a location of pickers, the number of items to be picked, the locations of items, the types of items, a priority level of the orders/items, etc. In a specific example, in some implementations, the CCS/MSDs may implement zone/section rules for picking, such as rules that instruct an MSD to: 1) only pick in a specific location when other locations have already been picked, 2) only pick in a specific location when it is required to pick a current order, 3) only pick in a specific zone when it includes items that have been pending picking for greater than a threshold period of time, 4) not pick a section if another MSD is assigned to the section, and/or 5) only pick a section if there are greater than a threshold number of items in the section (e.g., in pending customer orders).

In addition to filters/preferences, or as an alternative to filters/preferences, the CCS/MSDs may implement various values for locations (e.g., zones/sections/junctions) that indicate properties of the locations. For example, the CCS/MSDs may assign zone values to zones that indicate the relative sizes of the zones and/or the actual zone sizes (e.g., in feet or meters). In some implementations, the zone sizes may be automatically determined based on an amount of time spent within the zones and/or an amount of movement (e.g., GPS-based and/or acceleration based) by users while in the zones (e.g., an amount of motion while detecting a location signal for the zone). In some implementations, the zone sizes may be manually entered by users.

The CCS/MSDs may assign junction values that indicate a level of desirability for traversing the junction. The junction values may be used in addition to, or as an alternative to, the location values. In some implementations, the junction values may indicate a distance. For example, junctions between adjacent zones may have a zero value or a small value (e.g., 1) to indicate the zones are close together. In this example, other junctions, such as those that are between buildings or floors, may have larger assigned values. For example, a long junction between two buildings may have a large junction value relative to other junctions in the store. Although zones and junctions may be assigned values that disincentivize traversal, in some implementations, the zones and/or junctions may be assigned values that incentivize traversal. Such values may be used in various optimization/traversal algorithms that generate routes.

In some implementations, the CCS/MSDs may take into account zone values and/or junction values when generating routes. For example, the CCS/MSDs may attempt to generate routes that are less than a threshold size, as indicated by the sum of the location values through which a user traverses. As another example, the CCS/MSDs may attempt to generate routes in which larger junction values are avoided. For example, the CCS/MSDs may attempt to generate routes that minimize the sum of traversed junction values, or eliminate junction values entirely. In this example, larger junction numbers may disincentivize traversal via the junction. In some implementations, the CCS/MSDs may also attempt to generate routes that maximize the number of items picked. In some implementations, the CCS/MSDs may generate routes that attempt to optimize multiple factors, such as total zone size traversed (e.g., sum of zone values), total junction values traversed (e.g., sum of junction values), and total items picked (e.g., the sum of the total items in the route). In some implementations, the CCS may assign initial customer orders and/or routes, and the MSDs may individually optimize the routes based on the user's past/current location or items picked.

The various filtering rules (e.g., location/item filtering), preference rules, optimization rules, and other rules described herein may be implemented by the CCS/MSDs in order to optimize routing for one or more MSDs in a variety of different stores. The various rules may be implemented in a variety of ways. In some implementations, the rules may be implemented as one or more optimization problems. For example, the CCS/MSDs may determine routes using one or more objective functions and one or more constraints (e.g., inequality constraints). In some implementations, the CCS/MSDs may implement weighting functions that are based on a number of items, number of junctions, and/or zone sizes traversed. In these implementations, the functions may incentivize maximal picking and minimal zone/junction traversal. In some implementations, the CCS/MSDs may implement one or more traversal algorithms in which the location maps (e.g., sections/zones/junctions) are traversed according to various rules in order to determine routes (e.g., sufficient/optimal routes). In a specific example, the CCS/MSDs may implement tree/graph traversal algorithms on the location maps to determine routes. In some implementations, the optimization/traversal algorithms may be simplified by the filters associated with MSDs that may limit the total location space and item space assigned to the MSDs. In some implementations, the optimization/traversal algorithms may be simplified by defining a start point (e.g., a current location or preset location) and stopping point (e.g., a packing/collection area) for a route. The routing algorithms may be implemented for one or more MSDs independently, or as a group. For example, the CCS/MSDs may optimize the routes for each MSD alone, or attempt to optimize routing of a plurality of MSDs (e.g., a portion or all MSDs) as a whole.

Various examples have been described. These and other examples are within the scope of the following claims.

1. A system comprising:
a plurality of stocked items arranged throughout a store for picking, wherein each of the stocked items is associated with one of a plurality of locations in the store;
a central computing system configured to:
receive a customer order that includes a plurality of ordered items indicating which of the stocked items are to be picked;
determine historical movement of a user through a set of locations in the store; and
generate a route for the customer order based on the historical movement of the user, wherein the route indicates a sequence in which one or more of the ordered items should be picked; and
a mobile scanning device comprising a display, the mobile scanning device configured to:
wirelessly receive the route from the central computing system; and
arrange items included in the route on the display based on the sequence indicated in the route.

2. The system of claim 1, wherein the central computing system is configured to generate a user movement log for the user that indicates historical movement of the user over a period of time prior to receipt of the customer order.

3. The system of claim 2, wherein the user movement log includes a list of locations.

4. The system of claim 3, wherein the locations in the list of locations are associated with time values that indicate an amount of time the user has spent in the locations.

5. The system of claim 3, wherein at least some of the locations in the list of locations include timestamps indicating when the user entered the locations and when the user exited the locations.

6. The system of claim 1, wherein the historical movement is recent historical movement through less than a threshold number of locations.

7. The system of claim 1, wherein the historical movement is recent historical movement through less than a threshold distance.

8. The system of claim 1, wherein the historical movement is recent historical movement that has occurred less than a threshold period of time before the current time.

9. The system of claim 1, wherein the historical movement is through greater than a threshold number of locations.

10. The system of claim 1, wherein the historical movement is through greater than a threshold distance.

11. The system of claim 1, wherein the historical movement has occurred over greater than a threshold time period before the current time.

12. The system of claim 1, wherein the central computing system is configured to refrain from assigning items to the route that the user has passed by within a threshold period of time.

13. The system of claim 1, wherein the central computing system is configured to refrain from assigning locations to the route that the user has passed by within a threshold period of time.

14. The system of claim 1, wherein the central computing system is configured to assign items to the route that are on a trajectory of the user, and wherein the central computing system is configured to determine the trajectory of the user based on the historical movement of the user.

15. The system of claim 1, wherein the central computing system is configured to identify one or more commonly traversed locations associated with the historical movement of the user.

16. The system of claim 15, wherein the central computing system is configured to assign items to the route that are included in the identified commonly traversed locations.

17. The system of claim 15, wherein the central computing system is configured to assign locations to the route that are included in the commonly traversed locations.

18. The system of claim 1, wherein the central computing system is configured to:
determine historical item scans associated with the user; and
generate the route for the customer order based on the historical item scans associated with the user.

19-164. (canceled)
